(19) United States
(12) Patent Application Publication
(10) Pub. No.: US 2014/0309244 A1
(43) Pub. Date: Oct. 16, 2014

(54) NOVEL MICROBIOCIDES

(71) Applicants: Werner Zambach, Stein (CH); Daniel Stierli, Stein (CH); Kurt Nebel, Stein (CH); Andrea Bortolato, Stein (CH); Clara Massol, Stein (CH)

(72) Inventors: Werner Zambach, Stein (CH); Daniel Stierli, Stein (CH); Kurt Nebel, Stein (CH); Andrea Bortolato, Stein (CH); Clara Massol, Stein (CH)

(73) Assignee: SYNGENTA PARTICIPATIONS AG, Basel (CH)

(21) Appl. No.: 13/825,808

(22) PCT Filed: Sep. 23, 2011
(86) PCT No.: PCT/EP11/66553

§ 371 Date: May 20, 2013

(30) Foreign Application Priority Data
Sep. 23, 2010 (EP) 10178593.9
Nov. 12, 2010 (EP) 10190955.4
Jan. 11, 2011 (EP) 11150654.9

(51) Int. Cl. A01N 43/40; A01N 43/54; A01N 43/42

(52) U.S. Cl. CPC A01N 43/40; A01N 43/42; A01N 43/54
USPC 514/266.21; 546/264; 514/332; 546/102; 514/297; 546/157; 514/312; 546/152; 514/314; 544/253; 544/333; 514/256; 546/81; 514/292

(57) ABSTRACT

The present invention provides compounds of formula (I) wherein R¹, R², A, X, D¹, D² and Y³ are as defined in the claims. The invention further provides intermediates used in the preparation of these compounds, to compositions which comprise these compounds and to their use in agriculture or horticulture for controlling or preventing infestation of plants by phytopathogenic microorganisms, preferably fungi.

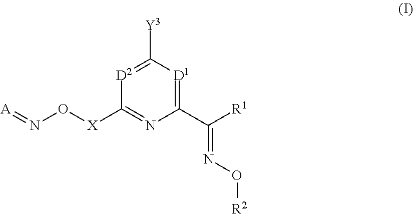

The present invention relates to novel microbiocidally active, in particular fungicidally active, oxime derivatives. It further relates to intermediates used in the preparation of these compounds, to compositions which comprise these compounds and to their use in agriculture or horticulture for controlling or preventing infestation of plants by phytopathogenic microorganisms, preferably fungi.

Fungicidally active bisoximes are described in WO08074418.

Surprisingly, it has been found that novel oxime derivatives have microbiocidal activity.

The present invention accordingly relates to bisoxime derivatives of formula (I)

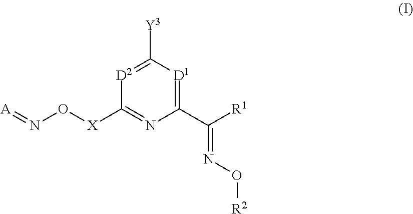

wherein

R¹ represents hydrogen, halogen, CN, SH, C₁-C₈ alkylthio, C₁-C₈ alkylsulphinyl, C₁-C₈ alkylsulphonyl, NH₂, C₁-C₁₀ alkyl, C₃-C₈ cycloalkyl, C₂-C₈ alkenyl, C₂-C₈ alkynyl, (R⁸O)carbonyl(C₁-C₄ alkyl), phenyl or pyridyl, wherein the alkyl, cycloalkyl, alkenyl, alkynyl, phenyl and pyridyl are optionally substituted by one or more groups independently selected from halogen, CN, NH₂, NH—C₁-C₈ alkyl, N(C₁-C₈ alkyl)₂, NO₂, OR⁸, C₁-C₄ alkyl, C₁-C₄ haloalkyl, C₃-C₆ cycloalkyl and a 5- or 6-membered heterocycle containing one to three heteroatoms independently selected from O, S and N, providing that the heterocycle does not contain adjacent oxygen atoms, adjacent sulphur atoms, or adjacent sulphur and oxygen atoms;

R² represents hydrogen, C₁-C₈ alkyl, C₃-C₈ cycloalkyl, C₃-C₈ alkenyl, C₃-C₈ alkynyl, benzyl, phenyl or pyridyl, wherein the alkyl, cycloalkyl, alkenyl, alkynyl, phenyl, benzyl and pyridyl are optionally substituted by one or more groups independently selected from halogen, CN, NH₂, NO₂, OH, C₁-C₄ alkyl, C₁-C₄ haloalkyl, C₁-C₄ alkoxy and C₁-C₄ haloalkoxy;

D¹ represents N or C—Y¹;

D² represents N or C—Y²;

wherein both D¹ and D² cannot be N;

A represents group A-1, A-2, or A-3:

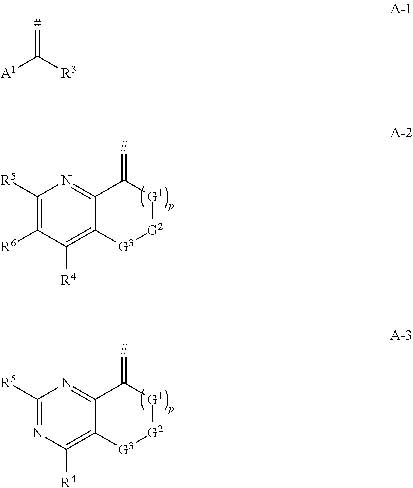

Wherein A¹ represents the cycle A^{1a}, A^{1b}, or A^{1c}:

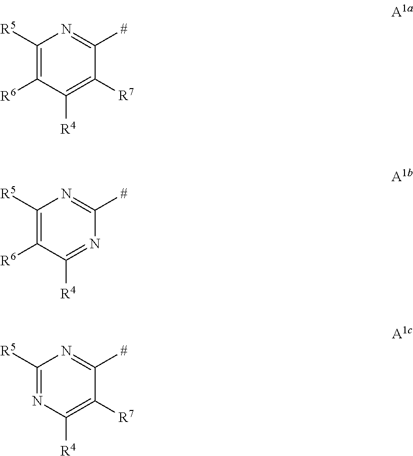

R³ represents hydrogen, halogen, CN, SH, C₁-C₈ alkylthio, C₁-C₈ alkylsulphinyl, C₁-C₈ alkylsulphonyl, NH₂, C₁-C₁₀ alkyl, C₃-C₈ cycloalkyl, C₂-C₈ alkenyl, C₂-C₈ alkynyl, (R⁸O)carbonyl(C₁-C₄ alkyl), phenyl or pyridyl, wherein the alkyl, cycloalkyl, alkenyl, alkynyl, phenyl and pyridyl are optionally substituted by one or more groups independently selected from halogen, CN, NH₂, NH—C₁-C₈ alkyl, N(C₁-C₈ alkyl)₂, NO₂, OR⁸, C₁-C₄ alkyl, C₁-C₄ haloalkyl, C₃-C₆ cycloalkyl and a 5- or 6-membered heterocycle containing one to three heteroatoms independently selected from O, S and N, providing that the heterocycle does not contain adjacent oxygen atoms, adjacent sulphur atoms, or adjacent sulphur and oxygen atoms;

R⁴, R⁵, R⁶ and R⁷ independently of one another represent hydrogen, halogen, CN, NO₂, C₁-C₈ alkyl, C₃-C₈ cycloalkyl, C₂-C₈ alkenyl, C₂-C₈ alkynyl, phenyl, a 5- or 6-membered heterocycle containing one to three heteroatoms independently selected from O, S and N, providing that the heterocycle does not contain adjacent oxygen atoms, adjacent sulphur atoms, or adjacent sulphur and oxygen atoms, COR⁹, OR⁸, SH, C₁-C₈-alkylthio, C₁-C₈-alkylsulphinyl, C₁-C₈-alkylsulphonyl, phenylthio, phenylsulphinyl, phenylsulphonyl, N(R¹⁰)₂, CO₂R⁸, O(CO)R⁹, CON(R¹⁰)₂, NR¹⁰COR⁹ or CR⁹N—OR⁸, wherein the alkyl, cycloalkyl, alkenyl, alkynyl, phenyl and heterocycle are optionally substituted by one or more groups independently selected from halogen, CN, NH₂, NO₂, OR⁸, C₁-C₄ alkyl and C₁-C₄ haloalkyl;

or, when A is A-1, wherein A¹ is A^{1a} or A^{1b}, or when A is A-2, R⁵ and R⁶, R⁶ and R⁴, or R⁷ and R⁴ together with the fragment of the ring to which they are attached may form a partially or fully unsaturated 5- to 7-membered carbocyclic ring or a partially or fully unsaturated 5- to 7-membered heterocyclic ring containing one to three heteroatoms independently selected from O, S, N and N(R¹⁰), providing that the heterocycle does not contain adjacent oxygen atoms, adjacent sulphur atoms, or adjacent sulphur and oxygen atoms, and wherein the ring formed by R⁵ and R⁶, R⁶ and R⁴, or R⁷ and R⁴ is optionally substituted by one or more groups independently selected from halogen, CN, NH₂, NO₂, OH, C₁-C₄ alkyl, C₁-C₄ haloalkyl, C₁-C₄ alkoxy and C₁-C₄ haloalkoxy;

G¹ and G² independently of one another represent —C(R¹²R¹³)—;

G³ represents —C(R¹²R¹³)—, O, N(R¹⁴) or S;

or G¹ and G², or G² and G³, or G¹ and G¹ together represent —CR¹²═CR¹³—;

each R¹² and R¹³ independently of one another represent hydrogen, halogen, C₁-C₄ alkyl, C₁-C₄ haloalkyl, C₁-C₄ alkoxy or C₁-C₄ haloalkoxy;

R¹⁴ represents hydrogen, OH, C₁-C₄ alkyl, C₁-C₄ alkoxy, C₃-C₆ cycloalkyl, C₁-C₈ alkylcarbonyl or C₁-C₈ haloalkylcarbonyl;

p represents 0, 1 or 2;

X represents X-2, X-3, X-4 or X-5:

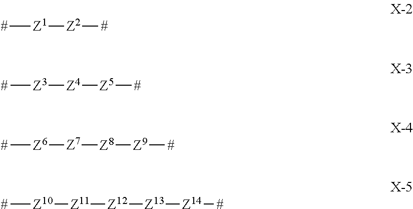

Z¹, Z², Z³, Z⁵, Z⁶, Z⁷, Z⁸, Z⁹, Z¹⁰, Z¹¹, Z¹³ and Z¹⁴ independently of one another represent CR¹⁵R¹⁶, C═O or C═CR¹⁷R¹⁸;

Z⁴ and Z¹² represent CR¹⁹R²⁰, SiR²¹R²², C═O or C═CR¹⁷R¹⁸;

each R¹⁵ and R¹⁶ independently of one another represent hydrogen, halogen, CN, OH, C₁-C₄ alkyl, C₁-C₄ haloalkyl or phenyl, wherein the phenyl is optionally substituted by one or more groups independently selected from halogen, CN, C₁-C₄ alkyl, C₁-C₄ haloalkyl, C₁-C₄ alkoxy and C₁-C₄ haloalkoxy;

or R¹⁵ and R¹⁶ together with the carbon atom to which they are attached may form a C₃-C₆ cycloalkyl group or a C₃-C₆ halocycloalkyl group;

each R¹⁷ and R¹⁸ independently of one another represent hydrogen, halogen, C₁-C₄ alkyl or C₁-C₄ haloalkyl;

each R¹⁹, R²⁰, R²¹ and R²² independently of one another represent hydrogen, halogen, CN, OH, C₁-C₄ alkyl, C₁-C₄ haloalkyl or phenyl, wherein phenyl is optionally substituted by one or more groups independently selected from halogen, CN, C₁-C₄ alkyl, C₁-C₄ haloalkyl, C₁-C₄ alkoxy and C₁-C₄ haloalkoxy;

or R¹⁹ and R²⁰ together with the carbon atom to which they are attached may form a C₃-C₆ cycloalkyl group or a C₃-C₆ halocycloalkyl group;

wherein the groupings X-2, X-3, X-4 and X-5 contain at most one ring which contains either only one of the radicals Z¹ to Z¹⁴ or two radicals Z¹ to Z¹⁴ or three radicals Z¹ to Z¹⁴ or four radicals Z¹ to Z¹⁴ as ring members; wherein radicals Z¹, Z³, Z⁶ and Z¹⁰ are not substituted by OH; and wherein none of Z¹, Z², Z³, Z⁴, Z⁵, Z⁶, Z⁷, Z⁸, Z⁹, Z¹⁰, Z¹¹, Z¹², Z¹³ and Z¹⁴ represent a carbon atom substituted by two OH;

Y¹, Y² and Y³ independently of one another represent hydrogen, halogen, CN, NO₂, C₁-C₈ alkyl, C₃-C₈ cycloalkyl, C₂-C₈ alkenyl, C₂-C₈ alkynyl, phenyl, a 5- or 6-membered heterocycle containing one to three heteroatoms independently selected from O, S and N, providing that the heterocycle does not contain adjacent oxygen atoms, adjacent sulphur atoms, or adjacent sulphur and oxygen atoms, COR⁹, OR⁸, SH, C₁-C₈-alkylthio, C₁-C₈-alkylsulphinyl, C₁-C₈-alkylsulphonyl, phenylthio, phenylsulphinyl, phenylsulphonyl, N(R¹⁰)₂, CO₂R⁸, O(CO)R⁹, CON(R¹⁰)₂, NR¹⁰COR⁹ or CR⁹N—OR⁸, wherein the alkyl, cycloalkyl, alkenyl, alkynyl, phenyl, and heterocycle are optionally substituted by one or more groups independently selected from halogen, CN, NH₂, NO₂, OR⁸, C₁-C₄ alkyl and C₁-C₄ haloalkyl;

or Y¹ and Y³, or Y² and Y³ together with the fragment of the pyridyl ring to which they are attached may form a partially or fully unsaturated 5- to 7-membered carbocyclic ring or a partially or fully unsaturated 5- to 7-membered heterocyclic ring containing one to three heteroatoms independently selected from O, S, N and N(R¹⁰), providing that the heterocycle does not contain adjacent oxygen atoms, adjacent sulphur atoms, or adjacent sulphur and oxygen atoms, and wherein the ring formed by Y¹ and Y³, or Y² and Y³ is optionally substituted by one or more groups independently selected from halogen, CN, NH₂, NO₂, OH, C₁-C₄ alkyl, C₁-C₄ haloalkyl, C₁-C₄ alkoxy and C₁-C₄ haloalkoxy;

each R⁸ independently of one another represents hydrogen, C₁-C₈ alkyl, C₃-C₈ cycloalkyl, C₃-C₈ alkenyl, C₃-C₈ alkynyl, phenyl, benzyl or a 5- or 6-membered heterocycle containing one to three heteroatoms independently selected from O, S and N, providing that the heterocycle does not contain adjacent oxygen atoms, adjacent sulphur atoms, or adjacent sulphur and oxygen atoms, wherein the alkyl, cycloalkyl, alkenyl, alkynyl, phenyl, benzyl and heterocycle are optionally substituted by one or more groups independently selected from halogen, CN, NH₂, NO₂, OH, C₁-C₄ alkyl, C₁-C₄-haloalkyl, C₁-C₄ alkoxy, C₁-C₄ haloalkoxy, and C₁-C₄-alkoxy-C₁-C₄-alkyl;

each R⁹ independently of one another represents hydrogen, C₁-C₈ alkyl, C₃-C₈ cycloalkyl, C₂-C₈ alkenyl, C₂-C₈ alkynyl, phenyl, benzyl or pyridyl, wherein the alkyl, cycloalkyl, alkenyl, alkynyl, phenyl, benzyl and pyridyl are optionally substituted by one or more groups independently selected from halogen, CN, NH₂, NO₂, OH, C₁-C₄ alkyl, C₁-C₄ haloalkyl, C₁-C₄ alkoxy and C₁-C₄ haloalkoxy;

each R¹⁰ independently of one another represents hydrogen, OH, C₁-C₈ alkyl, C₁-C₈ alkoxy, C₁-C₈-alkoxy-C₁-C₄-alkyl, C₃-C₈ alkenyl, C₃-C₈ alkynyl, or COR⁹, wherein the alkyl, alkoxy, alkenyl and alkynyl are optionally substituted by one or more halogen;

wherein when two radicals R¹⁰ are attached to the same nitrogen atom, these radicals can be identical or different;

wherein when two radicals R¹⁰ are attached to the same nitrogen atom, both of these radicals cannot be OH, C₁-C₄ alkoxy or C₁-C₄ haloalkoxy;

and wherein when two radicals R¹⁰ are attached to the same nitrogen atom, these two radicals together with the nitrogen atom to which they are attached may form a cycle B-1, B-2, B-3, B-4, B-5, B-6, B-7 or B-8:

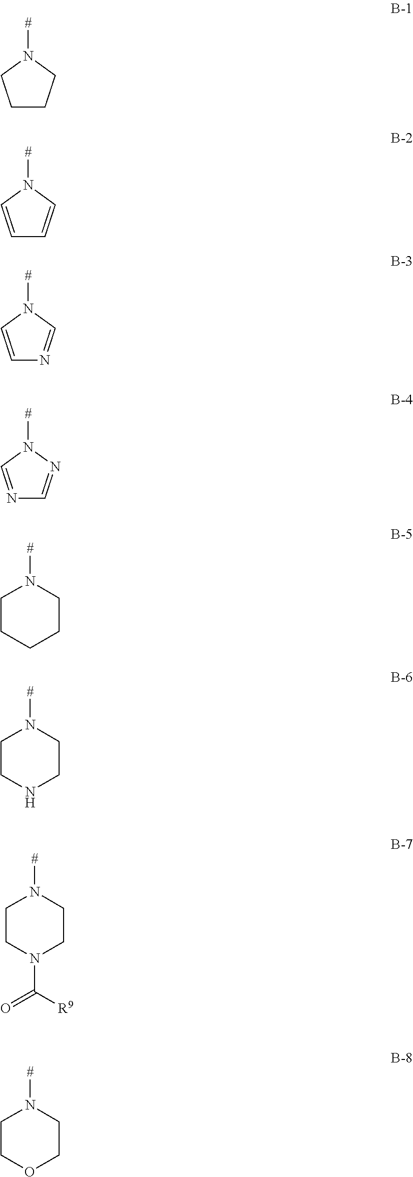

wherein the cycle formed is optionally substituted by one or more groups independently selected from halogen, CN, NH₂, NO₂, OH, C₁-C₄ alkyl, C₁-C₄ haloalkyl, C₁-C₄ alkoxy and C₁-C₄ haloalkoxy;

or a salt or an N-oxide thereof.

The invention covers all agronomically acceptable salts, isomers, structural isomers, stereoisomers, diastereoisomers, enantiomers, tautomers, atropisomers and N-oxides of those compounds. The compounds of formula I may exist in different geometric or optical isomeric forms or in different tautomeric forms. One or more centres of chirality may be present, in which case compounds of the formula I may be present as pure enantiomers, mixtures of enantiomers, pure diastereomers or mixtures of diastereomers. There may be double bonds present in the molecule, such as C═C or C═N bonds, in which case compounds of formula I may exist as single isomers or mixtures of isomers. Centres of tautomerisation may be present. This invention covers all such isomers and tautomers and mixtures thereof in all proportions as well as isotopic forms such as deuterated compounds. Also atropisomerism may occur as a result of a restricted rotation about a single bond.

Halogen, either as a lone substituent or in combination with another substituent (e.g. haloalkyl) is generally fluorine, chlorine, bromine or iodine, and usually fluorine, chlorine or bromine.

Each alkyl moiety (including the alkyl moiety of alkoxy, alkylthio, etc.) is a straight or branched chain and, depending on the number of carbon atoms it contains, is, for example, methyl, ethyl, n-propyl, n-butyl, n-pentyl, n-hexyl, iso-propyl, sec-butyl, iso-butyl, tert-butyl, neo-pentyl, n-heptyl or 1,3-dimethylbutyl, and usually methyl or ethyl.

The alkenyl and alkynyl groups can be mono- or di-unsaturated and are examples thereof are derived from the above mentioned alkyl groups.

Haloalkyl moieties are alkyl moieties which are substituted by one or more of the same or different halogen atoms and are, for example, monofluoromethyl, difluoromethyl, trifluoromethyl, monochloromethyl, dichloromethyl, trichloromethyl, 2,2,2-trifluoroethyl, 2,2-difluoroethyl, 2-fluoroethyl, 1,1-difluoroethyl, 1-fluoroethyl, 2-chloroethyl, pentafluoroethyl, 1,1-difluoro-2,2,2-trichloroethyl, 2,2,3,3-tetrafluoroethyl and 2,2,2-trichloroethyl, and typically trichloromethyl, difluorochloromethyl, difluoromethyl, trifluoromethyl and dichlorofluoromethyl.

Alkoxy is, for example, methoxy, ethoxy, propoxy, iso-propoxy, n-butoxy, iso-butoxy, sec-butoxy and tert-butoxy, and usually methoxy or ethoxy.

Haloalkoxy is, for example, fluoromethoxy, difluoromethoxy, trifluoromethoxy, 2,2,2-trifluoroethoxy, 1,1,2,2-tetrafluoroethoxy, 2-fluoroethoxy, 2-chloroethoxy, 2,2-difluoroethoxy and 2,2,2-trichloroethoxy, and usually difluoromethoxy, 2-chloroethoxy and trifluoromethoxy.

Alkylthio is, for example, methylthio, ethylthio, propylthio, iso-propylthio, n-butylthio, iso-butylthio, sec-butylthio or tert-butylthio, and usually methylthio or ethylthio.

Alkylsulphonyl is, for example, methylsulphonyl, ethylsulphonyl, propylsulphonyl, iso-propylsulphonyl, n-butylsulphonyl, iso-butylsulphonyl, sec-butylsulphonyl or tert-butylsulphonyl, and usually methylsulphonyl or ethylsulphonyl.

Alkylsulphinyl is, for example, methylsulphinyl, ethylsulphinyl, propylsulphinyl, iso-propylsulphinyl, n-butylsulphinyl, iso-butylsulphinyl, sec-butylsulphinyl or tert-butylsulphinyl, and usually methylsulphinyl or ethylsulphinyl.

Cycloalkyl may be saturated or partially unsaturated, preferably fully saturated, and is, for example, cyclopropyl, cyclobutyl, cyclopentyl or cyclohexyl.

Alkoxyalkyl is, for example, methoxymethyl, methoxyethyl, ethoxymethyl, ethoxyethyl, n-propoxymethyl, n-propoxyethyl, iso-propoxymethyl or iso-propoxyethyl.

Aryl includes phenyl, naphthyl, anthracyl, fluorenyl and indanyl, but is usually phenyl.

Carbocycle includes cycloalkyl groups and aryl groups.

Heterocycloalkyl is a non-aromatic ring that may be saturated or partially unsaturated, preferably fully saturated, containing carbon atoms as ring members and at least one heteroatom selected from O, S and N as ring members. Examples include oxiranyl, oxetanyl, tetrahydrofuranyl, tetrahydropyranyl, 1,3-dioxolanyl, 1,4-dioxanyl, aziridinyl, azetidinyl, pyrrolidinyl, piperidinyl, oxazinanyl, morpholinyl, thiomorpholinyl, imidazolidinyl, pyrazolidinyl and piperazinyl, preferably morpholinyl, pyrrolidinyl, piperidinyl and piperazinyl, more preferably morpholinyl and pyrollidinyl.

Heteroaryl is, for example, a monovalent monocyclic or bicyclic aromatic hydrocarbon radical. Examples of monocyclic groups include pyridyl, pyridazinyl, pyrimidinyl, pyrazinyl, pyrrolyl, pyrazolyl, imidazolyl, triazolyl, tetrazolyl, furanyl, thiophenyl, oxazolyl, isoxazolyl, oxadiazolyl, thiazolyl, isothiazolyl, and thiadiazolyl. Examples of bicyclic groups include quinolinyl, cinnolinyl, quinoxalinyl, benzimidazolyl, benzothiophenyl, and benzothiadiazolyl. Monocyclic heteroaryl groups are preferred, preferably pyridyl, pyrrolyl, imidazolyl and triazolyl, e.g. 1,2,4 triazolyl, pyridyl and imidazolyl being most preferred.

The terms “heterocycle” and “heterocyclic ring” are used interchangeably and are defined to include heterocycloalkyl and heteroaryl groups. Any reference herein to a heterocycle or heterocyclic ring preferably refers to the specific examples given under the definition of heteroaryl and heterocycloalkyl above, and are preferably morpholinyl, pyrrolidinyl, piperidinyl, piperazinyl pyridyl, pyrrolyl, imidazolyl and triazolyl, e.g. 1,2,4 triazolyl, more preferably morpholinyl, pyrollidinyl, pyridyl and imidazolyl.

Where a moiety is indicated as being (optionally) substituted, e.g. alkyl, this includes those moieties where they are part of a larger group, e.g. the alkyl in the alkylthio group. The same applies, e.g. to the phenyl moiety in phenylthio etc. Where a moiety is indicated as being optionally substituted by one or more other groups, preferably there are one to five optional substituents, more preferably one to three optional substituents. Where a moiety is substituted by a cyclic group, e.g. aryl, heteroaryl, cycloalkyl, preferably there are no more than two such substituents, more preferably no more than one such substituent.

The following substituents definitions, including preferred definitions, may be combined in any combination:

R¹ represents hydrogen, halogen, CN, SH, C₁-C₈ alkylthio, C₁-C₈ alkylsulphinyl, C₁-C₈ alkylsulphonyl, NH₂, C₁-C₁₀ alkyl, C₃-C₈ cycloalkyl, C₂-C₈ alkenyl, C₂-C₈ alkynyl, (R⁸O)carbonyl(C₁-C₄ alkyl), phenyl or pyridyl, wherein the alkyl, cycloalkyl, alkenyl, alkynyl, phenyl and pyridyl are optionally substituted by one or more groups independently selected from halogen, CN, NH₂, NH—C₁-C₈ alkyl, N(C₁-C₈ alkyl)₂, NO₂, OR⁸, C₁-C₄ alkyl, C₁-C₄ haloalkyl, C₃-C₆ cycloalkyl and a 5- or 6-membered heterocycle containing one to three heteroatoms independently selected from O, S and N, providing that the heterocycle does not contain adjacent oxygen atoms, adjacent sulphur atoms, or adjacent sulphur and oxygen atoms.

Preferably, R¹ represents hydrogen, C₁-C₈ alkyl, C₂-C₈ alkenyl, C₂-C₈ alkynyl, C₃-C₈ cycloalkyl, phenyl, pyridyl, or (R⁸O)carbonyl(C₁-C₄ alkyl), wherein the alkyl, alkenyl, alkynyl, cycloalkyl, phenyl and pyridyl are optionally substituted by one or more groups independently selected from halogen, CN, OR⁸, NH₂, NH—C₁-C₈ alkyl, N(C₁-C₈ alkyl)₂, C₁-C₄ alkyl, C₁-C₄ haloalkyl, C₃-C₆ cycloalkyl and pyridyl.

More preferably, R¹ represents hydrogen, C₁-C₄ alkyl, C₂-C₄ alkenyl, phenyl or pyridyl, wherein the alkyl, alkenyl, phenyl and pyridyl are optionally substituted by one or more groups independently selected from halogen, CN, OH, NH₂, NH—C₁-C₄ alkyl, N(C₁-C₄ alkyl)₂, C₁-C₄ alkyl, C₁-C₄ haloalkyl, C₁-C₄ alkoxy, C₁-C₄ haloalkoxy and C₃-C₆ cycloalkyl.

Even more preferably, R¹ represents hydrogen, C₁-C₄ alkyl, C₁-C₄ haloalkyl, phenyl or pyridin-2-yl, wherein the phenyl and pyridin-2-yl are optionally substituted by one or more groups independently selected from halogen, CN, methyl, halomethyl, methoxy and halomethoxy.

In one group of compounds, R¹ represents C₁-C₄ alkyl, C₂-C₄ alkenyl, phenyl or pyridyl, wherein the alkyl, alkenyl, phenyl and pyridyl are optionally substituted by one or more groups independently selected from halogen, CN, C₁-C₄ alkoxy and C₁-C₄ haloalkoxy.

In another group of compounds, R¹ represents hydrogen, C₁-C₄ alkyl, C₁-C₄ haloalkyl and phenyl, wherein the phenyl is optionally substituted by one or more groups independently selected from halogen, CN, methyl, halomethyl, methoxy and halomethoxy.

In this group of compounds, preferably, R¹ represents hydrogen, C₁-C₄ alkyl or phenyl, wherein the phenyl is optionally substituted by one or more groups independently selected from halogen, CN, methyl, halomethyl, methoxy and halomethoxy.

More preferably in this group, R¹ represents hydrogen, C₁-C₄ alkyl or phenyl.

R² represents hydrogen, C₁-C₈ alkyl, C₃-C₈ cycloalkyl, C₃-C₈ alkenyl, C₃-C₈ alkynyl, benzyl, phenyl or pyridyl, wherein the alkyl, cycloalkyl, alkenyl, alkynyl, phenyl, benzyl and pyridyl are optionally substituted by one or more groups independently selected from halogen, CN, NH₂, NO₂, OH, C₁-C₄ alkyl, C₁-C₄ haloalkyl, C₁-C₄ alkoxy and C₁-C₄ haloalkoxy.

Preferably, R² represents hydrogen, C₁-C₈ alkyl, C₁-C₈ haloalkyl, C₃-C₈ cycloalkyl, C₃-C₈ halocycloalkyl, C₃-C₈ alkenyl, C₃-C₈ haloalkenyl, C₃-C₈ alkynyl, C₃-C₈ haloalkynyl, benzyl or pyridyl, wherein the benzyl and pyridyl are optionally substituted by one or more groups independently selected from halogen, CN, C₁-C₄ alkyl, C₁-C₄ haloalkyl, C₁-C₄ alkoxy and C₁-C₄ haloalkoxy.

More preferably, R² represents C₁-C₄ alkyl, C₃-C₆ alkenyl, C₃-C₆ alkynyl or benzyl, wherein the alkyl, alkenyl, alkynyl and benzyl are optionally substituted by one or more groups independently selected from halogen, CN, C₁-C₄ alkoxy and C₁-C₄ haloalkoxy.

Even more preferably, R² represents hydrogen, C₁-C₈ alkyl, or C₁-C₈ haloalkyl.

In one group of compounds R² represents hydrogen, C₁-C₄ alkyl, C₃-C₆ alkenyl, C₃-C₆ alkynyl or benzyl, wherein the alkyl, alkenyl, alkynyl and benzyl are optionally substituted by one or more groups, e.g. one to five groups, independently selected from C₁-C₄ alkyl, C₁-C₄ haloalkyl, halogen, CN, C₁-C₄ alkoxy and C₁-C₄ haloalkoxy.

In another group of compounds, R² represents hydrogen, C₁-C₄ alkyl, C₃-C₆ alkenyl or C₃-C₆ alkynyl, wherein the alkyl, alkenyl, or alkynyl are optionally substituted by one or more groups independently selected from halogen, CN, C₁-C₄ alkoxy and C₁-C₄ haloalkoxy.

In this group, preferably R² represents hydrogen, C₁-C₄ alkyl, C₃-C₆ alkenyl or C₃-C₆ alkynyl, wherein the alkyl, alkenyl, or alkynyl are optionally substituted by one or more groups independently selected from halogen, CN, methyl, halomethyl, methoxy and halomethoxy.

More preferably in this group of compounds, R² represents hydrogen, C₁-C₄ alkyl, C₃-C₆ alkenyl or C₃-C₆ alkynyl.

In one group of compounds, D¹ is C—Y¹ and D² is C—Y².

In another group of compounds, D¹ is C—Y¹ and D² is N.

In a further group of compounds, D¹ is N and D² is C—Y².

Preferably D¹ is C—Y¹ and D² is C—Y², and more preferably, D¹ and D² are CH.

R³ represents hydrogen, halogen, CN, SH, C₁-C₈ alkylthio, C₁-C₈ alkylsulphinyl, C₁-C₈ alkylsulphonyl, NH₂, C₁-C₁₀ alkyl, C₃-C₈ cycloalkyl, C₂-C₈ alkenyl, C₂-C₈ alkynyl, (R⁹O)carbonyl(C₁-C₄ alkyl), phenyl or pyridyl, wherein the alkyl, cycloalkyl, alkenyl, alkynyl, phenyl and pyridyl are optionally substituted by one or more groups, e.g. one to five groups, independently selected from halogen, CN, NH₂, NH—C₁-C₈ alkyl, N(C₁-C₈ alkyl)₂, NO₂, OR⁸, C₁-C₄ alkyl, C₁-C₄ haloalkyl, C₃-C₆ cycloalkyl and a 5- or 6-membered heterocycle containing one to three heteroatoms independently selected from O, S and N, providing that the heterocycle does not contain adjacent oxygen atoms, adjacent sulphur atoms, or adjacent sulphur and oxygen atoms. The heterocycle is preferably one as defined herein, preferably morpholinyl, pyrrolidinyl, piperidinyl, piperazinyl, pyridyl, pyrrolyl, imidazolyl or triazolyl, e.g. 1,2,4 triazolyl, more preferably morpholinyl, pyrollidinyl, pyridyl or imidazolyl.

Preferably, R³ represents hydrogen, C₁-C₈ alkyl, C₂-C₈ alkenyl, C₂-C₈ alkynyl, C₃-C₈ cycloalkyl, phenyl, pyridyl or (R⁸O)carbonyl(C₁-C₄ alkyl), wherein the alkyl, alkenyl, alkynyl, cycloalkyl, phenyl and pyridyl are optionally substituted by one or more groups, e.g. one to five groups, independently selected from halogen, CN, OR⁸, NH₂, NH—C₁-C₈ alkyl, N(C₁-C₈ alkyl)₂, C₁-C₄ alkyl, C₁-C₄ haloalkyl, C₃-C₆ cycloalkyl and pyridyl.

More preferably, R³ represents hydrogen, C₁-C₄ alkyl, C₂-C₄ alkenyl, phenyl or pyridyl, wherein the alkyl, alkenyl, phenyl and pyridyl are optionally substituted by one or more groups, e.g. one to five groups, independently selected from halogen, CN, OH, NH₂, NH—C₁-C₄ alkyl, N(C₁-C₄ alkyl)₂, C₁-C₄ alkyl, C₁-C₄ haloalkyl, C₁-C₄ alkoxy, C₁-C₄ haloalkoxy and C₃-C₆ cycloalkyl.

In one preferred group of compounds, R³ represents C₁-C₄ alkyl, C₂-C₄ alkenyl, phenyl or pyridyl, wherein the alkyl, alkenyl, phenyl and pyridyl are optionally substituted by one or more groups, e.g. one to five groups, independently selected from halogen, CN, C₁-C₄ alkoxy and C₁-C₄ haloalkoxy.

In another preferred group of compounds, R³ represents hydrogen, C₁-C₄ alkyl, C₁-C₄ haloalkyl, phenyl or pyridin-2-yl, wherein the phenyl and pyridin-2-yl are optionally substituted by one or more groups, e.g. one to five groups, independently selected from halogen, CN, methyl, halomethyl, methoxy and halomethoxy.

In another group of compounds, R³ represents hydrogen, CN, C₁-C₄ alkyl, C₃-C₆ cycloalkyl, C₂-C₄ alkenyl, C₂-C₄ alkynyl, (C₁-C₄alkoxy)carbonyl(C₁-C₄ alkyl), phenyl or pyridyl, wherein the alkyl, cycloalkyl, alkenyl, alkynyl, phenyl and pyridyl are optionally substituted by one or more groups independently selected from halogen, CN, NH₂, NH—C₁-C₈ alkyl, N(C₁-C₈ alkyl)₂, NO₂, OH, C₁-C₄ alkyl, C₁-C₄ haloalkyl, C₃-C₆ cycloalkyl, pyridyl or pyrroline

In this group of compounds, preferably R³ represents hydrogen, CN, C₁-C₄ alkyl, C₂-C₄ alkenyl, C₂-C₄ alkynyl or phenyl, wherein the alkyl, cycloalkyl, alkenyl, alkynyl and phenyl are optionally substituted by one or more groups independently selected from halogen, CN, NH₂, NH—C₁-C₄ alkyl, N(C₁-C₄ alkyl)₂, OH, C₁-C₄ alkyl, C₁-C₄ haloalkyl, C₃-C₆ cycloalkyl, pyridyl or pyrroline.

More preferably in this group of compounds, R³ represents hydrogen, C₁-C₄ alkyl, phenyl, wherein the alkyl and phenyl pyridyl are optionally substituted by one or more groups independently selected from halogen, CN, NH₂, NH—C₁-C₄ alkyl, N(C₁-C₄ alkyl)₂, OH, C₁-C₄ alkyl, C₁-C₄ haloalkyl, C₃-C₆ cycloalkyl or pyrroline.

A represents group A-1, A-2, or A-3.

Preferably A represents group A-1, wherein A¹ represents A^{1a} or A-1 represents A-2.

In one group of compounds, A represents group A-1. Preferably in this group, A¹ represents cycle A.

In another group of compounds, A represents cycle A-2 or A-3. Preferably in this group, A represents cycle A-2.

R⁴, R⁵, R⁶ and R⁷ independently of one another represent hydrogen, halogen, CN, NO₂, C₁-C₈ alkyl, C₃-C₈ cycloalkyl, C₂-C₈ alkenyl, C₂-C₈ alkynyl, phenyl, a 5- or 6-membered heterocycle containing one to three heteroatoms independently selected from O, S and N, providing that the heterocycle does not contain adjacent oxygen atoms, adjacent sulphur atoms, or adjacent sulphur and oxygen atoms (e.g. a heterocycle as defined herein, preferably morpholinyl, pyrrolidinyl, piperidinyl, piperazinyl, pyridyl, pyrrolyl, imidazolyl or triazolyl, e.g. 1,2,4 triazolyl, more preferably morpholinyl, pyrollidinyl, pyridyl or imidazolyl), COR⁹, OR⁸, SH, C₁-C₈-alkylthio, C₁-C₈-alkylsulphonyl, phenylthio, phenylsulphinyl, phenylsulphonyl, N(R¹⁰)₂, CO₂R⁸, O(CO)R⁹, CON(R¹⁰)₂, NR¹⁰COR⁹ or CR⁹N—OR⁸, wherein the alkyl, cycloalkyl, alkenyl, alkynyl, phenyl and heterocycle are optionally substituted by one or more groups, e.g. one to five groups, independently selected from halogen, CN, NH₂, NO₂, OR⁸, C₁-C₄ alkyl, C₁-C₄ haloalkyl;

or, when A is A-1, wherein A¹ is A^{1a} or A^{1b}, or when A is A-2, R⁵ and R⁶, R⁶ and R⁴, or R⁷ and R⁴ together with the fragment of the ring to which they are attached may form a partially or fully unsaturated 5- to 7-membered carbocyclic ring or a partially or fully unsaturated 5- to 7-membered heterocyclic ring containing one to three heteroatoms independently selected from O, S, N and N(R¹⁰), providing that the heterocycle does not contain adjacent oxygen atoms, adjacent sulphur atoms, or adjacent sulphur and oxygen atoms, and wherein the ring formed by R⁵ and R⁶, R⁶ and R⁴, or R⁷ and R⁴ is optionally substituted by one or more groups, e.g. one to five groups, independently selected from halogen, CN, NH₂, NO₂, OH, C₁-C₄ alkyl, C₁-C₄ haloalkyl, C₁-C₄ alkoxy and C₁-C₄ haloalkoxy. Preferably, R⁴, R⁵, R⁶ and R⁷ independently of one another represent hydrogen, halogen, CN, OR⁸, C₁-C₈ alkyl, C₂-C₈ alkenyl, C₃-C₈ cycloalkyl, phenyl, pyridyl, N(R¹⁰)₂, CO₂R⁸, NR¹⁰COR⁹, SH, C₁-C₈-alkylsulphonyl, phenylthio, phenylsulphinyl or phenylsulphonyl, wherein the alkyl, alkenyl, cycloalkyl, phenyl and pyridyl are optionally substituted by one or more groups, e.g. one to five groups, independently selected from halogen, CN, OR⁸, C₁-C₄ alkyl and C₁-C₄ haloalkyl;

or when A is A-1, wherein A¹ is A^{1a} or A^{1b} or A-2, R⁵ and R⁶, R⁶ and R⁴, or R⁴ and R⁷, together with the fragment of the pyridyl ring to which they are attached may form a partially or fully unsaturated 5- to 7-membered carbocyclic ring or a partially or fully unsaturated 5- to 7-membered heterocyclic ring containing one to three heteroatoms independently selected from O, S, N and N(R¹⁰), providing that the heterocycle does not contain adjacent oxygen atoms, adjacent sulphur atoms, or adjacent sulphur and oxygen atoms, wherein the ring formed by R⁵ and R⁶, R⁶ and R⁴, or R⁴ and R⁷ is optionally substituted by one or more groups, e.g. one to five groups, independently selected from halogen, CN, C₁-C₄ alkyl, C₁-C₄ haloalkyl, C₁-C₄ alkoxy and C₁-C₄ haloalkoxy;

More preferably, R⁴, R⁵, R⁶ and R⁷ independently of one another represent hydrogen, halogen, OR⁸, CN, C₁-C₄ alkyl, C₃-C₆ cycloalkyl, N(R¹⁰)₂, phenyl, CO₂R⁸ or NR¹⁰COR⁹, wherein the alkyl, cycloalkyl and phenyl are optionally substituted by one or more groups, e.g. one to five groups, independently selected from halogen, CN, C₁-C₄ alkyl, C₁-C₄-haloalkyl, C₁-C₄ alkoxy and C₁-C₄ haloalkoxy;

or, when A is A-1, wherein A¹ is A^{1a} or A^{1b} or A-2, R⁵ and R⁶, R⁶ and R⁴, or R⁴ and R⁷, together with the fragment of the pyridyl ring to which they are attached may form a fully or partially unsaturated 5- or 6-membered carbocyclic ring optionally substituted by one or more groups, e.g. one to five groups, independently selected from halogen, methyl and halomethyl.

More preferably, R⁴, R⁵, R⁶ and R⁷ independently of one another represent hydrogen, halogen, OH, CN, C₁-C₄ alkyl, C₁-C₄ alkoxy, C₃-C₆ alkenyloxy, C₃-C₆ cycloalkyl, N(R¹⁰)₂, phenyl or CO₂R⁸, wherein the alkyl, alkoxy, alkenyloxy, cycloalkyl and phenyl are optionally substituted by one or more groups, e.g. one to five groups, independently selected from halogen, CN, C₁-C₄ alkyl, C₁-C₄-haloalkyl, C₁-C₄ alkoxy and C₁-C₄ haloalkoxy;

or, when A is A-1, wherein A¹ is A^{1a} or A^{1b}, or when A is A-2, R⁵ and R⁶, R⁶ and R⁴, or R⁴ and R⁷, together with the fragment of the pyridyl ring to which they are attached may form a fully or partially unsaturated 6-membered carbocyclic ring optionally substituted by one or more groups, e.g. one to five groups, independently selected from halogen, methyl and halomethyl.

More preferably, R⁴, R⁵, R⁶ and R⁷ independently of one another represent hydrogen, halogen, OH, CN, C₁-C₄ alkyl, C₁-C₄ alkoxy, C₃-C₆ alkenyloxy, C₃-C₆ cycloalkyl, N(R¹⁰)₂, phenyl or CO₂R⁸, wherein the alkyl, alkoxy, alkenyloxy, cycloalkyl and phenyl are optionally substituted by one or more groups, e.g. one to five groups, independently selected from halogen, CN, C₁-C₄ alkyl, C₁-C₄-haloalkyl, C₁-C₄ alkoxy and C₁-C₄ haloalkoxy.

More preferably, R⁴, R⁵, R⁶ and R⁷ independently of one another represent hydrogen, C₁-C₄ alkyl, CN or C₁-C₄ alkoxy, wherein the alkyl and alkoxy are optionally substituted by one or more groups, e.g. one to five groups, independently selected from halogen, CN, C₁-C₄ alkoxy and C₁-C₄ haloalkoxy.

In another group of compounds, R⁵ represents hydrogen, C₁-C₄ alkyl, C₁-C₄ haloalkyl, OH, C₁-C₄ alkoxy, C₁-C₄ haloalkoxy, phenyl or pyridyl, wherein the phenyl and pyridyl are optionally substituted by one or more groups independently selected from halogen, CN, NH₂, NO₂, OH, C₁-C₄ alkyl, C₁-C₄ haloalkyl, C₁-C₄ alkoxy and C₁-C₄ haloalkoxy.

In a further group of compounds, R⁴ and R⁶ independently of one another represent hydrogen, CN, OR⁸, NH₂, halogen, C₁-C₈ alkyl, C₁-C₈ haloalkyl, C₂-C₈ alkenyl, C₂-C₈ alkynyl, C₃-C₈ cycloalkyl, SH, C₁-C₈ alkylthio, N(R¹⁰)₂, NR¹⁰COR⁹, phenyl or pyridyl, wherein phenyl and pyridyl are optionally substituted by one or more groups independently selected from halogen, methyl, CN, methoxy, halomethyl and halomethoxy;

each R⁸ independently represents one another represents hydrogen, C₁-C₈ alkyl, C₃-C₈ cycloalkyl, C₃-C₈ alkenyl, C₃-C₈ alkynyl, benzyl, phenyl or pyridyl, wherein the alkyl, cycloalkyl, alkenyl, alkynyl, phenyl, benzyl and pyridyl are optionally substituted by one or more groups independently selected from halogen, CN, NH₂, NO₂, OH, C₁-C₄ alkyl, C₁-C₄-haloalkyl, C₁-C₄ alkoxy, C₁-C₄ haloalkoxy and C₁-C₄-alkoxy-C₁-C₄-alkyl;

each R⁹ independently of one another represents C₁-C₄-alkyl or C₁-C₄ haloalkyl;

each R¹⁹ independently of one another represent hydrogen or C₁-C₄ alkyl;

wherein when two radicals R¹⁰ are attached to the same nitrogen atom, these radicals can be identical or different;

and wherein when two radicals R¹⁰ are attached to the same nitrogen atom, these two radicals together with the nitrogen atom to which they are attached may form a cycle B-1, B-2, B-3, B-4 or B-5, wherein the cycle formed is optionally substituted by one or more groups independently selected from halogen, methyl and halomethyl.

In yet another group of compounds, R⁴ and R⁶ independently of one another represent hydrogen, CN, OH, NH₂, halogen, C₁-C₄ alkyl, C₁-C₄ haloalkyl, C₁-C₄ alkoxy, C₁-C₄ haloalkoxy, C₃-C₆ cycloalkyl, N(R¹⁰)₂, NR¹⁰COR⁹ or phenyl, wherein phenyl is optionally substituted by one or more groups independently selected from halogen, methyl, CN, methoxy, halomethyl and halomethoxy;

each R⁹ independently represents C₁-C₄-alkyl or C₁-C₄ haloalkyl;

each R¹⁰ independently of one another represent hydrogen or C₁-C₄ alkyl;

wherein when two radicals R¹⁰ are attached to the same nitrogen atom, these radicals can be identical or different;

and wherein when two radicals R¹⁰ are attached to the same nitrogen atom, these two radicals together with the nitrogen atom to which they are attached may form a cycle B-1, B-2, B-3, B-4 or B-5, wherein the cycle formed is optionally substituted by one or more groups independently selected from halogen, methyl and halomethyl.

In another group of compounds, R⁴ represents hydrogen, halogen, CN, C₁-C₆ alkyl, C₃-C₆ cycloalkyl, C₂-C₆ alkenyl, C₂-C₆ alkynyl, phenyl, OH, C₁-C₄ alkoxy, NH₂, NH(C₁-C₄ alkyl), N(C₁-C₄ alkyl)₂, CO(C₁-C₄ alkyl), wherein the alkyl, cycloalkyl, alkenyl, alkynyl and phenyl are optionally substituted by one or more groups independently selected from halogen, CN, methyl, halomethyl, methoxy and halomethoxy.

Preferably in this group of compounds, R⁴ represents hydrogen, halogen, CN, C₁-C₆ alkyl, C₃-C₆ cycloalkyl, C₂-C₄ alkenyl, C₂-C₄ alkynyl, phenyl, C₁-C₄ alkoxy or CO(C₁-C₄ alkyl), wherein the alkyl, cycloalkyl, alkenyl, alkynyl and phenyl are optionally substituted by one or more groups independently selected from halogen, CN, methyl, halomethyl, methoxy and halomethoxy.

More preferably in this group of compounds, R⁴ represents hydrogen, halogen, CN, C₁-C₄ alkyl, C₁-C₄ alkoxy, C₁-C₄ haloalkyl, C₃-C₆ cycloalkyl, CO(C₁-C₄ alkyl).

G¹ and G² independently of one another represent —C(R¹²R¹³)—;

G³ represents —C(R¹²R¹³)—, O, N(R¹⁴) or S;

or G¹ and G², or G² and G³, or G¹ and G¹ together represent —CR¹²═CR¹³—.

Each R¹² and R¹³ independently of one another represent hydrogen, halogen, C₁-C₄ alkyl, C₁-C₄ haloalkyl, C₁-C₄ alkoxy or C₁-C₄ haloalkoxy.

R¹⁴ represents hydrogen, OH, C₁-C₄ alkyl, C₁-C₄ alkoxy, C₃-C₆ cycloalkyl, C₁-C₈ alkylcarbonyl or C₁-C₈ haloalkylcarbonyl.

Preferably, G¹ and G² independently of one another represent —C(R¹²R¹³)—;

G³ represents —C(R¹²R¹³)—, O, N(R¹⁴) or S;

each R¹² and R¹³ independently of one another represent hydrogen, halogen, C₁-C₄ alkyl, C₁-C₄ haloalkyl, C₁-C₄ alkoxy or C₁-C₄ haloalkoxy;

R¹⁴ represents hydrogen, OH, C₁-C₄ alkyl, C₁-C₄ alkoxy, C₃-C₆ cycloalkyl, C₁-C₈ alkylcarbonyl or C₁-C₈ haloalkylcarbonyl.

Preferably, G¹, G² and G³ represent C(R³⁴)₂, wherein each R³⁴ independently of one another represents hydrogen or C₁-C₄ alkyl.

In another group of compounds, G¹ represents —CH₂—;

G² represents —C(R¹²R¹³)—;

G³ represents —C(R¹²R¹³)—, O, N(R¹⁴) or S;

each R¹² and R¹³ independently of one another represent hydrogen or C₁-C₄ alkyl;

R¹⁴ represents hydrogen or C₁-C₄ alkyl.

p represents 0, 1 or 2. Preferably, p is 1 or 2. More preferably, p is 1.

X represents X-2, X-3, X-4 or X-5.

Preferably X represents X-3 or X-5.

More preferably X represents X-3.

Z¹, Z², Z³, Z⁵, Z⁶, Z⁷, Z⁸, Z⁹, Z¹⁰, Z¹¹, Z¹³ and Z¹⁴ independently of one another represent CR¹⁵R¹⁶, or C═O or C═CR¹⁷R¹⁸, preferably CR¹⁵R¹⁶ or C═CR¹⁷R¹⁸.

Z⁴ and Z¹² represent CR¹⁹R²⁰, SiR²¹R²², C═O or C═CR¹⁷R¹⁸; preferably CR¹⁹R²⁰ or C═CR¹⁷R¹⁸. In one group of compounds, Z⁴ is preferably CR¹⁹R²⁰.

When X is X-2 preferably one of Z¹ and Z² is methylene or halomethylene, preferably methylene.

When X is X-3, preferably two of Z³, Z⁴ and Z⁵ are independently methylene or halomethylene, preferably methylene. Preferably Z³ and Z⁵ are methylene or halomethylene, preferably methylene.

When X is X-4, preferably three of Z⁶, Z⁷, Z⁸ and Z⁹ are independently methylene or halomethylene, preferably methylene.

When X is X-5, preferably four of Z¹⁰, Z¹¹, Z¹², Z¹³ and Z¹⁴ are independently methylene or halomethylene, preferably methylene. Preferably Z¹⁰, Z¹¹, Z¹³ and Z¹⁴ are independently methylene or halomethylene, preferably methylene.

Wherein radicals Z¹, Z³, Z⁶ and Z¹⁰ are not substituted by OH; and none of Z¹, Z², Z³, Z⁴, Z⁵, Z⁶, Z⁷, Z⁸, Z⁹, Z¹⁰, Z¹¹, Z¹², Z¹³ and Z¹⁴ represent a carbon atom substituted by two OH groups.

Each R¹⁵ and R¹⁶ independently of one another represent hydrogen, halogen, CN, OH, C₁-C₄ alkyl, C₁-C₄ haloalkyl or phenyl, wherein the phenyl is optionally substituted by one or more groups, e.g. one to five groups, independently selected from halogen, CN, C₁-C₄ alkyl, C₁-C₄ haloalkyl, C₁-C₄ alkoxy and C₁-C₄ haloalkoxy;

or R¹⁵ and R¹⁶ together with the carbon atom to which they are attached may form a C₃-C₆ cycloalkyl group or a C₃-C₆ halocycloalkyl group.

Preferably, each R¹⁵ and R¹⁶ independently of one another represent hydrogen, halogen, CN, OH, C₁-C₄ alkyl or C₁-C₄ haloalkyl.

Each R¹⁷ and R¹⁸ independently of one another represent hydrogen, halogen, C₁-C₄ alkyl or C₁-C₄ haloalkyl.

Preferably, each R¹⁷ and R¹⁸ independently of one another represent hydrogen, halogen, methyl or halomethyl.

Each R¹⁹ and R²⁰ independently of one another represent hydrogen, halogen, CN, OH, C₁-C₄ alkyl, C₁-C₄ haloalkyl or phenyl, wherein phenyl is optionally substituted by one or more groups, e.g. one to five groups, independently selected from halogen, CN, C₁-C₄ alkyl, C₁-C₄ haloalkyl, C₁-C₄ alkoxy and C₁-C₄ haloalkoxy;

or R¹⁹ and R²⁰ together with the carbon atom to which they are attached may form a C₃-C₆ cycloalkyl group or a C₃-C₆ halocycloalkyl group.

Preferably, each R¹⁹ and R²⁰ independently of one another represent hydrogen, halogen, CN, OH, C₁-C₄ alkyl, C₁-C₄ haloalkyl or phenyl, wherein the phenyl is optionally substituted by one or more groups, e.g. one to five groups, independently selected from halogen, CN, methyl, halomethyl, methoxy and halomethoxy;

or R¹⁹ and R²⁰ together with the carbon atom to which they are attached may form a C₃-C₆ cycloalkyl group or a C₃-C₆ halocycloalkyl group.

Each R²¹ and R²² independently of one another represent hydrogen, halogen, CN, OH, C₁-C₄ alkyl, C₁-C₄ haloalkyl or phenyl, wherein phenyl is optionally substituted by one or more groups, e.g. one to five groups, independently selected from halogen, CN, C₁-C₄ alkyl, C₁-C₄ haloalkyl, C₁-C₄ alkoxy and C₁-C₄ haloalkoxy.

Preferably, each R²¹ and R²² independently of one another represent hydrogen, halogen, CN, OH, C₁-C₄ alkyl, C₁-C₄ haloalkyl or phenyl, wherein the phenyl is optionally substituted by one or more groups, e.g. one to five groups, independently selected from halogen, CN, methyl, halomethyl, methoxy and halomethoxy.

More preferably, each R²¹ and R²² independently of one another represent halogen, C₁-C₄ alkyl, C₁-C₄ haloalkyl or phenyl, wherein the phenyl is optionally substituted by one or more groups, e.g. one to five groups, independently selected from halogen, CN, methyl, halomethyl, methoxy and halomethoxy.

Y¹, Y² and Y³ independently of one another represent hydrogen, halogen, CN, NO₂, C₁-C₈ alkyl, C₃-C₈ cycloalkyl, C₂-C₈ alkenyl, C₂-C₈ alkynyl, phenyl, a 5- or 6-membered heterocycle containing one to three heteroatoms independently selected from O, S and N, providing that the heterocycle does not contain adjacent oxygen atoms, adjacent sulphur atoms, or adjacent sulphur and oxygen atoms (e.g. a heterocycle as defined herein, preferably morpholinyl, pyrrolidinyl, piperidinyl, piperazinyl, pyridyl, pyrrolyl, imidazolyl or triazolyl, e.g. 1,2,4 triazolyl, more preferably morpholinyl, pyrollidinyl, pyridyl or imidazolyl), COR⁹, OR⁸, SH, C₁-C₈-alkylthio, C₁-C₈-alkylsulphinyl, C₁-C₈-alkylsulphonyl, phenylthio, phenylsulphinyl, phenylsulphonyl, N(R¹⁰)₂, CO₂R⁸, O(CO)R⁹, CON(R¹⁰)₂, NR¹⁰COR⁹ or CR⁹N—OR⁸, wherein the alkyl, cycloalkyl, alkenyl, alkynyl, phenyl and heterocycle are optionally substituted by one or more groups, e.g. one to five groups, independently selected from halogen, CN, NH₂, NO₂, OR⁸, C₁-C₄ alkyl and C₁-C₄ haloalkyl;

or Y¹ and Y³, or Y² and Y³ together with the fragment of the pyridyl ring to which they are attached may form a partially or fully unsaturated 5- to 7-membered carbocyclic ring or a partially or fully unsaturated 5- to 7-membered heterocyclic ring containing one to three heteroatoms independently selected from O, S, N and N(R¹⁰), providing that the heterocycle does not contain adjacent oxygen atoms, adjacent sulphur atoms, or adjacent sulphur and oxygen atoms and wherein the ring formed by Y¹ and Y³, or Y² and Y³ is optionally substituted by one or more groups, e.g. one to five groups, independently selected from halogen, CN, NH₂, NO₂, OH, C₁-C₄ alkyl, C₁-C₄ haloalkyl, C₁-C₄ alkoxy and C₁-C₄ haloalkoxy.

Preferably, Y¹, Y² and Y³ independently of one another represent hydrogen, halogen, CN, OR⁸, C₁-C₈ alkyl, C₂-C₈ alkenyl, C₃-C₈ cycloalkyl, phenyl, pyridyl, N(R¹⁰)₂, CO₂R⁸, NR¹⁰COR⁹, SH, C₁-C₈-alkylthio, C₁-C₈-alkylsulphinyl, C₁-C₈-alkylsulphonyl, phenylthio, phenylsulphinyl or phenylsulphonyl, wherein the alkyl, alkenyl, cycloalkyl, phenyl and pyridyl are optionally substituted by one or more groups, e.g. one to five groups, independently selected from halogen, CN, OR⁸, C₁-C₄ alkyl and C₁-C₄ haloalkyl.

More preferably Y¹, Y² and Y³ independently of one another represent hydrogen, halogen, OR⁸, CN, C₁-C₄ alkyl, C₃-C₆ cycloalkyl, N(R¹⁰)₂, phenyl, CO₂R⁸ or NR¹⁰COR⁹, wherein the alkyl, cycloalkyl and phenyl are optionally substituted by one or more groups, e.g. one to five groups, independently selected from halogen, CN, C₁-C₄ alkyl, C₁-C₄-haloalkyl, C₁-C₄ alkoxy and C₁-C₄ haloalkoxy.

More preferably, Y¹, Y², and Y³ independently of one another represent hydrogen, halogen, OH, CN, C₁-C₄ alkyl, C₁-C₄ alkoxy, C₃-C₆ alkenyloxy, C₃-C₆ cycloalkyl, N(R¹⁰)₂, phenyl or CO₂R⁸, wherein the alkyl, alkoxy, alkenyloxy, cycloalkyl and phenyl are optionally substituted by one or more groups, e.g. one to five groups, independently selected from halogen, CN, C₁-C₄ alkyl, C₁-C₄-haloalkyl, C₁-C₄ alkoxy and C₁-C₄ haloalkoxy.

More preferably Y¹, Y² and Y³ independently of one another represent hydrogen, C₁-C₄ alkyl, CN or C₁-C₄ alkoxy, wherein the alkyl and alkoxy are optionally substituted by one or more groups, e.g. one to five groups, independently selected from halogen, CN, C₁-C₄ alkoxy and C₁-C₄ haloalkoxy.

In one group of compounds Y¹ and Y² independently of one another represent hydrogen, C₁-C₄ alkyl, CN or C₁-C₄ alkoxy, wherein the alkyl and alkoxy are optionally substituted by one or more groups, e.g. one to five groups, independently selected from halogen, CN, C₁-C₄ alkoxy and C₁-C₄ haloalkoxy and Y³ is as defined according to any of the definitions above.

In another group of compounds, Y¹ and Y² each represent H;

Y³ represents hydrogen, halogen, CN, C₁-C₄ alkyl, C₃-C₆ cycloalkyl, C₂-C₆ alkenyl, C₂-C₆ alkynyl or C₁-C₄ alkoxy wherein the alkyl, cycloalkyl, alkenyl and alkynyl are optionally substituted by one or more groups independently selected from halogen, CN, NH₂, NO₂, OH, C₁-C₄ alkyl and C₁-C₄ haloalkyl.

Preferably in this group of compounds, Y¹ and Y² each represent H;

Y³ represents hydrogen, halogen, CN, C₁-C₄ alkyl, C₂-C₆ alkenyl, C₂-C₆ alkynyl or C₁-C₄ alkoxy wherein the alkyl, cycloalkyl, alkenyl and alkynyl are optionally substituted by one or more groups independently selected from halogen, CN, NH₂, NO₂, OH, C₁-C₄ alkyl and C₁-C₄ haloalkyl.

Even more preferably in this group of compounds, Y¹ and Y² each represent H;

Y³ represents hydrogen, methyl, methoxy, methoxymethyl, wherein the methyl, methoxy, methoxymethyl are optionally substituted by one or more halogen.

Each R⁸ independently of one another represents hydrogen, C₁-C₈ alkyl, C₃-C₈ cycloalkyl, C₃-C₈ alkenyl, C₃-C₈ alkynyl, phenyl, benzyl or a 5- or 6-membered heterocycle containing one to three heteroatoms independently selected from O, S and N, providing that the heterocycle does not contain adjacent oxygen atoms, adjacent sulphur atoms, or adjacent sulphur and oxygen atoms, wherein the alkyl, cycloalkyl, alkenyl, alkynyl, phenyl, benzyl and heterocycle are optionally substituted by one or more groups, e.g. one to five groups, independently selected from halogen, CN, NH₂, NO₂, OH, C₁-C₄ alkyl, C₁-C₄-haloalkyl, C₁-C₄ alkoxy, C₁-C₄ haloalkoxy and C₁-C₄-alkoxy-C₁-C₄-alkyl. The heterocycle is preferably one as defined herein, preferably morpholinyl, pyrrolidinyl, piperidinyl, piperazinyl, pyridyl, pyrrolyl, imidazolyl or triazolyl, e.g. 1,2,4 triazolyl, more preferably morpholinyl, pyrollidinyl, pyridyl or imidazolyl.

Preferably, each R⁸ independently of one another represents hydrogen, C₁-C₈ alkyl, C₁-C₈ haloalkyl, C₃-C₈ alkenyl, C₃-C₈ haloalkenyl, C₃-C₈ haloalkynyl, phenyl, benzyl or pyridyl, wherein the phenyl, benzyl and pyridyl are optionally substituted by one or more groups, e.g. one to five groups, independently selected from halogen, CN, NH₂, NO₂, OH, C₁-C₄ alkyl, C₁-C₄-haloalkyl, C₁-C₄ alkoxy and C₁-C₄ haloalkoxy.

More preferably, each R⁸ independently of one another represents hydrogen, C₁-C₈ alkyl, C₁-C₈ haloalkyl, C₃-C₈ alkenyl, C₃-C₈ haloalkenyl, C₃-C₈ alkynyl, C₃-C₈ haloalkynyl, phenyl, benzyl, or pyridyl, wherein the phenyl, benzyl and pyridyl are optionally substituted by one or more groups, e.g. one to five groups, independently selected from halogen, CN, C₁-C₄ alkyl, C₁-C₄-haloalkyl, C₁-C₄ alkoxy and C₁-C₄ haloalkoxy.

More preferably, each R⁸ independently of one another represents hydrogen, C₁-C₄ alkyl or C₁-C₄ haloalkyl.

In one group of compounds, each R⁸ independently of one another represents hydrogen, C₁-C₈ alkyl, C₃-C₈ cycloalkyl, C₃-C₈ alkenyl, C₃-C₈ alkynyl, phenyl, benzyl or pyridyl, wherein the alkyl, cycloalkyl, alkenyl, alkynyl, phenyl, benzyl and pyridyl are optionally substituted by one or more groups independently selected from halogen, CN, NH₂, NO₂, OH, C₁-C₄ alkyl, C₁-C₄-haloalkyl, C₁-C₄ alkoxy, C₁-C₄ haloalkoxy and C₁-C₄-alkoxy-C₁-C₄-alkyl.

Preferably in this group of compounds, each R⁸ independently of one another represents hydrogen, C₁-C₄ alkyl, C₃-C₆ alkenyl, C₃-C₆ alkynyl, phenyl or benzyl.

Each R⁹ independently of one another represents hydrogen, C₁-C₈ alkyl, C₃-C₈ cycloalkyl, C₂-C₈ alkenyl, C₂-C₈ alkynyl, phenyl, benzyl or pyridyl, wherein the alkyl, cycloalkyl, alkenyl, alkynyl, phenyl, benzyl and pyridyl are optionally substituted by one or more groups, e.g. one to five groups, independently selected from halogen, CN, NH₂, NO₂, OH, C₁-C₄ alkyl, C₁-C₄ haloalkyl, C₁-C₄ alkoxy and C₁-C₄ haloalkoxy.

Preferably, each R⁹ independently of one another represents hydrogen, C₁-C₈ alkyl or C₁-C₈ haloalkyl.

More preferably each R⁹ independently of one another represents hydrogen, C₁-C₄ alkyl or C₁-C₄ haloalkyl.

Each R¹⁰ independently of one another represents hydrogen, OH, C₁-C₈ alkyl, C₁-C₈ alkoxy, C₁-C₈-alkoxy-C₁-C₄-alkyl, C₃-C₈ alkenyl, C₃-C₈ alkynyl, or COR⁹, wherein the alkyl, alkoxy, alkenyl and alkynyl are optionally substituted by one or more halogen; wherein when two radicals R¹⁰ are attached to the same nitrogen atom, these radicals can be identical or different; wherein when two radicals R¹⁰ are attached to the same nitrogen atom, both of these radicals cannot be OH, C₁-C₄ alkoxy or C₁-C₄ haloalkoxy; and wherein when two radicals R¹⁰ are attached to the same nitrogen atom, these two radicals together with the nitrogen atom to which they are attached may form a cycle B-1, B-2, B-3, B-4, B-5, B-6, B-7 or B-8:

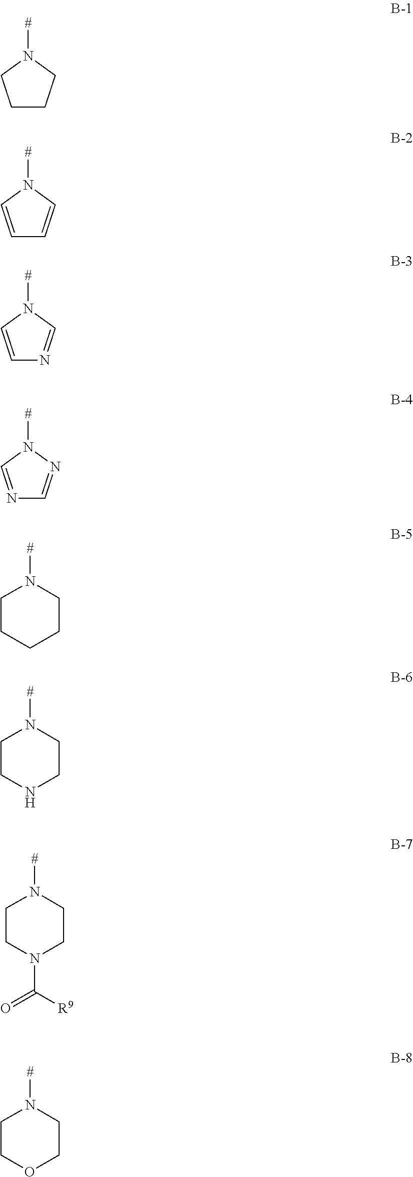

wherein the cycle formed is optionally substituted by one or more groups, e.g. one to five groups, independently selected from halogen, CN, NH₂, NO₂, OH, C₁-C₄ alkyl, C₁-C₄ haloalkyl, C₁-C₄ alkoxy and C₁-C₄ haloalkoxy.

Preferably, each R¹⁰ independently of one another represents hydrogen, C₁-C₈ alkyl or COR⁹; wherein when two radicals R¹⁰ are attached to the same nitrogen atom, these radicals can be identical or different; and wherein when two radicals R¹⁹ are attached to the same nitrogen atom, these two radicals together with the nitrogen atom to which they are attached may form a cycle B-1, B-2, B-3, B-4 or B-5 wherein the cycle formed is optionally substituted by one or more groups, e.g. one to five groups, independently selected from halogen, methyl and halomethyl.

More preferably, each R¹⁰ independently of one another represents hydrogen or C₁-C₄ alkyl; wherein when two radicals R¹⁰ are attached to the same nitrogen atom, these radicals can be identical or different; and wherein when two radicals R¹⁰ are attached to the same nitrogen atom, these two radicals together with the nitrogen atom to which they are attached may form a cycle B-1, B-2, B-3, B-4 or B-5 wherein the cycle formed is optionally substituted by one or more groups, e.g. one to five groups, independently selected from halogen, methyl and halomethyl.

In one preferred group of compounds:

R¹ represents hydrogen, C₁-C₈ alkyl, C₂-C₈ alkenyl, C₂-C₈ alkynyl, C₃-C₈ cycloalkyl, phenyl, pyridyl or (R⁸O)carbonyl(C₁-C₄ alkyl), wherein the alkyl, alkenyl, alkynyl, cycloalkyl, phenyl and pyridyl are optionally substituted by one or more groups independently selected from halogen, CN, OR⁸, NH₂, NH—C₁-C₈ alkyl, N(C₁-C₈ alkyl)₂, C₁-C₄ alkyl, C₁-C₄ haloalkyl, C₃-C₆ cycloalkyl and pyridyl;

R² represents hydrogen, C₁-C₈ alkyl, C₁-C₈ haloalkyl, C₃-C₈ cycloalkyl, C₃-C₈ halocycloalkyl, C₃-C₈ alkenyl, C₃-C₈ haloalkenyl, C₃-C₈ alkynyl, C₃-C₈ haloalkynyl, benzyl or pyridyl, wherein the benzyl and pyridyl are optionally substituted by one or more groups independently selected from halogen, CN, C₁-C₄ alkyl, C₁-C₄ haloalkyl, C₁-C₄ alkoxy and C₁-C₄ haloalkoxy;

R³ represents hydrogen, C₁-C₈ alkyl, C₂-C₈ alkenyl, C₂-C₈ alkynyl, C₃-C₈ cycloalkyl, phenyl, pyridyl, or (R⁸O)carbonyl(C₁-C₄ alkyl), wherein the alkyl, alkenyl, alkynyl, cycloalkyl, phenyl and pyridyl are optionally substituted by one or more groups independently selected from halogen, CN, OR⁸, NH₂, NH—C₁-C₈ alkyl, N(C₁-C₈ alkyl)₂, C₁-C₄ alkyl, C₁-C₄ haloalkyl, C₃-C₆ cycloalkyl and pyridyl;

A represents group A-1, A-2, or A-3;

R⁴, R⁵, R⁶ and R⁷ independently of one another represent hydrogen, halogen, CN, OR⁸, C₁-C₈ alkyl, C₂-C₈ alkenyl, C₃-C₈ cycloalkyl, phenyl, pyridyl, N(R¹⁰)₂, CO₂R⁸, NR¹⁰COR⁹, SH, C₁-C₈-alkylsulphonyl, phenylthio, phenylsulphinyl or phenylsulphonyl, wherein the alkyl, alkenyl, cycloalkyl, phenyl and pyridyl are optionally substituted by one or more groups independently selected from halogen, CN, OR⁸, C₁-C₄ alkyl and C₁-C₄ haloalkyl;

or, when A is A-1, wherein A¹ is A^{1a} or A^{1b}, or when A is A-2, R⁵ and R⁶, R⁶ and R⁴, or R⁴ and R⁷, together with the fragment of the pyridyl ring to which they are attached may form a partially or fully unsaturated 5- to 7-membered carbocyclic ring or a partially or fully unsaturated 5- to 7-membered heterocyclic ring containing one to three heteroatoms independently selected from O, S, N and N(R¹⁰), providing that the heterocycle does not contain adjacent oxygen atoms, adjacent sulphur atoms, or adjacent sulphur and oxygen atoms, wherein the ring formed by R⁵ and R⁶, R⁶ and R⁴, or R⁴ and R⁷ is optionally substituted by one or more groups independently selected from halogen, CN, C₁-C₄ alkyl, C₁-C₄ haloalkyl, C₁-C₄ alkoxy and C₁-C₄ haloalkoxy;

X represents X-3 or X-5;

Z³, Z⁵, Z¹⁰, Z¹¹, Z¹³ and Z¹⁴ independently of one another represent CR¹⁵R¹⁶ or C═CR¹⁷R¹⁸;

Z⁴ and Z¹² represent CR¹⁹R²⁰ or C═CR¹⁷R¹⁸;

each R¹⁵ and R¹⁶ independently of one another represent hydrogen, halogen, CN, OH, C₁-C₄ alkyl or C₁-C₄ haloalkyl;

each R¹⁷ and R¹⁸ independently of one another represent hydrogen, halogen, C₁-C₄ alkyl or C₁-C₄ haloalkyl;

each R¹⁹ and R²⁰ independently of one another represent hydrogen, halogen, CN, OH, C₁-C₄ alkyl, C₁-C₄ haloalkyl or phenyl, wherein the phenyl is optionally substituted by one or more groups independently selected from halogen, CN, methyl, halomethyl, methoxy and halomethoxy;

or R¹⁹ and R²⁰ together with the carbon atom to which they are attached may form a C₃-C₆ cycloalkyl group or a C₃-C₆ halocycloalkyl group;

Y¹, Y² and Y³ independently of one another represent hydrogen, halogen, CN, OR⁸, C₁-C₈ alkyl, C₂-C₈ alkenyl, C₃-C₈ cycloalkyl, phenyl, pyridyl, N(R¹⁰)₂, CO₂R⁸, NR¹⁰COR⁹, SH, C₁-C₈-alkylthio, C₁-C₈-alkylsulphonyl, phenylthio, phenylsulphinyl or phenylsulphonyl, wherein the alkyl, alkenyl, cycloalkyl, phenyl and pyridyl are optionally substituted by one or more groups independently selected from halogen, CN, OR⁸, C₁-C₄ alkyl and C₁-C₄ haloalkyl;

each R⁸ independently of one another represents hydrogen, C₁-C₈ alkyl, C₁-C₈ haloalkyl, C₃-C₈ alkenyl, C₃-C₈ haloalkenyl, C₃-C₈ haloalkynyl, phenyl, benzyl or pyridyl, wherein the phenyl, benzyl and pyridyl are optionally substituted by one or more groups independently selected from halogen, CN, NH₂, NO₂, OH, C₁-C₄ alkyl, C₁-C₄-haloalkyl, C₁-C₄ alkoxy and C₁-C₄ haloalkoxy;

each R⁹ independently of one another represents hydrogen, C₁-C₈ alkyl or C₁-C₈ haloalkyl;

each R¹⁰ independently of one another represents hydrogen, C₁-C₈ alkyl or COR^{S};

wherein when two radicals R¹⁰ are attached to the same nitrogen atom, these radicals can be identical or different;

and wherein when two radicals R¹⁰ are attached to the same nitrogen atom, these two radicals together with the nitrogen atom to which they are attached may form a cycle B-1, B-2, B-3, B-4 or B-5 wherein the cycle formed is optionally substituted by one or more groups independently selected from halogen, methyl and halomethyl.

In a more preferred group of compounds:

R¹ represents hydrogen, C₁-C₄ alkyl, C₂-C₄ alkenyl, phenyl or pyridyl, wherein the alkyl, alkenyl, phenyl and pyridyl are optionally substituted by one or more groups independently selected from halogen, CN, OH, NH₂, NH—C₁-C₄ alkyl, N(C₁-C₄ alkyl)₂, C₁-C₄ alkyl, C₁-C₄ haloalkyl, C₁-C₄ alkoxy, C₁-C₄ haloalkoxy and C₃-C₆ cycloalkyl;

R² represents C₁-C₄ alkyl, C₃-C₆ alkenyl, C₃-C₆ alkynyl or benzyl, wherein the alkyl, alkenyl, alkynyl and benzyl are optionally substituted by one or more groups independently selected from halogen, CN, C₁-C₄ alkoxy and C₁-C₄ haloalkoxy;

R³ represents hydrogen, C₁-C₄ alkyl, C₂-C₄ alkenyl, phenyl or pyridyl, wherein the alkyl, alkenyl, phenyl and pyridyl are optionally substituted by one or more groups independently selected from halogen, CN, OH, NH₂, NH—C₁-C₄ alkyl, N(C₁-C₄ alkyl)₂, C₁-C₄ alkyl, C₁-C₄ haloalkyl, C₁-C₄ alkoxy, C₁-C₄ haloalkoxy and C₃-C₆ cycloalkyl;

A represents group A-1, A-2, or A-3;

R⁴, R⁵, R⁶ and R⁷ independently of one another represent hydrogen, halogen, OR⁸, CN, C₁-C₄ alkyl, C₃-C₆ cycloalkyl, N(R¹⁰)₂, phenyl, CO₂R⁸ or NR¹⁰COR⁹, wherein the alkyl, cycloalkyl and phenyl are optionally substituted by one or more groups independently selected from halogen, CN, C₁-C₄ alkyl, C₁-C₄-haloalkyl, C₁-C₄ alkoxy and C₁-C₄ haloalkoxy;

or, when A is A-1, wherein A¹ is A^{1a} or A^{1b}, or when A is A-2, R⁵ and R⁶, R⁶ and R⁴, or R⁴ and R⁷, together with the fragment of the pyridyl ring to which they are attached may form a fully or partially unsaturated 5- or 6-membered carbocyclic ring, optionally substituted by one or more groups independently selected from halogen, methyl and halomethyl;

X represents X-3;

Z³ and Z⁵ independently of one another represent CR¹⁵R¹⁶ or C═CR¹⁷R¹⁸;

Z⁴ represents CR¹⁹R²⁰ or C═CR¹⁷R¹⁸;

each R¹⁵ and R¹⁶ independently of one another represent hydrogen, halogen, CN, OH, C₁-C₄ alkyl or C₁-C₄ haloalkyl;

each R¹⁷ and R¹⁸ independently of one another represent hydrogen, halogen, C₁-C₄ alkyl or C₁-C₄ haloalkyl;

each R¹⁹ and R²⁰ independently of one another represent hydrogen, halogen, CN, OH, C₁-C₄ alkyl, C₁-C₄ haloalkyl or phenyl, wherein the phenyl is optionally substituted by one or more groups independently selected from halogen, CN, methyl, halomethyl, methoxy and halomethoxy;

or R¹⁹ and R²⁰ together with the carbon atom to which they are attached may form a C₃-C₆ cycloalkyl group or a C₃-C₆ halocycloalkyl group;

wherein at least two of Z³, Z⁴ and Z⁵ are methylene;

Y¹, Y² and Y³ independently of one another represent hydrogen, halogen, OR⁸, CN, C₁-C₄ alkyl, C₃-C₆ cycloalkyl, N(R¹⁰)₂, phenyl, CO₂R⁸ or NR¹⁰COR⁹ wherein the alkyl, cycloalkyl and phenyl are optionally substituted by one or more groups independently selected from halogen, CN, C₁-C₄ alkyl, C₁-C₄-haloalkyl, C₁-C₄ alkoxy and C₁-C₄ haloalkoxy;

each R⁸ independently of one another represents hydrogen, C₁-C₈ alkyl, C₁-C₈ haloalkyl, C₃-C₈ alkenyl, C₃-C₈ haloalkenyl, C₃-C₈ alkynyl, C₃-C₈ haloalkynyl, phenyl, benzyl, or pyridyl, wherein the phenyl, benzyl and pyridyl are optionally substituted by one or more groups independently selected from halogen, CN, C₁-C₄ alkyl, C₁-C₄-haloalkyl, C₁-C₄ alkoxy and C₁-C₄ haloalkoxy;

each R⁹ independently of one another represents hydrogen, C₁-C₄ alkyl or C₁-C₄ haloalkyl;

each R¹⁰ independently of one another represents hydrogen or C₁-C₄ alkyl;

wherein when two radicals R¹⁰ are attached to the same nitrogen atom, these radicals can be identical or different;

and wherein when two radicals R¹⁰ are attached to the same nitrogen atom, these two radicals together with the nitrogen atom to which they are attached may form a cycle B-1, B-2, B-3, B-4 or B-5 wherein the cycle formed is optionally substituted by one or more groups independently selected from halogen, methyl and halomethyl.

In another group of compounds:

R¹ represents hydrogen, C₁-C₄ alkyl, C₁-C₄ haloalkyl, phenyl or pyridin-2-yl, wherein the phenyl and pyridin-2-yl are optionally substituted by one or more groups independently selected from halogen, CN, methyl, halomethyl, methoxy and halomethoxy;

R² represents hydrogen, C₁-C₈ alkyl, or C₁-C₈ haloalkyl; R³ represents hydrogen, C₁-C₄ alkyl, C₁-C₄ haloalkyl, phenyl or pyridin-2-yl, wherein the phenyl and pyridin-2-yl are optionally substituted by one or more groups independently selected from halogen, CN, methyl, halomethyl, methoxy and halomethoxy;

A represents group A-1, A-2 or A-3;

R⁴, R⁵, R⁶ and R⁷ independently of one another represent hydrogen, halogen, OH, CN, C₁-C₄ alkyl, C₁-C₄ alkoxy, C₃-C₆ alkenyloxy, C₃-C₆ cycloalkyl, N(R¹⁰)₂, phenyl or CO₂R⁸, wherein the alkyl, alkoxy, alkenyloxy, cycloalkyl and phenyl are optionally substituted by one or more groups independently selected from halogen, CN, C₁-C₄ alkyl, C₁-C₄-haloalkyl, C₁-C₄ alkoxy and C₁-C₄ haloalkoxy;

X represents X-3;

Z³ and Z⁵ independently of one another represent CR¹⁵R¹⁶ or C═CR¹⁷R¹⁸;

Z⁴ represents CR¹⁹R²⁰ or C═CR¹⁷R¹⁸;

each R¹⁵ and R¹⁶ independently of one another represent hydrogen, halogen, CN, OH, C₁-C₄ alkyl or C₁-C₄ haloalkyl;

each R¹⁷ and R¹⁸ independently of one another represent hydrogen, halogen, methyl or halomethyl;

each R¹⁹ and R²⁰ independently of one another represent hydrogen, halogen, CN, OH, C₁-C₄ alkyl, C₁-C₄ haloalkyl or phenyl, wherein the phenyl is optionally substituted by one or more groups independently selected from halogen, CN, methyl, halomethyl, methoxy and halomethoxy;

or R¹⁹ and R²⁰ together with the carbon atom to which they are attached may form a C₃-C₆ cycloalkyl group or a C₃-C₆ halocycloalkyl group;

wherein at least two of Z³, Z⁴ and Z⁵ are methylene;

Y¹, Y², and Y³ independently of one another represent hydrogen, halogen, OH, CN, C₁-C₄ alkyl, C₁-C₄ alkoxy, C₃-C₆ alkenyloxy, C₃-C₆ cycloalkyl, N(R¹⁰)₂, phenyl or CO₂R⁸, wherein the alkyl, alkoxy, alkenyloxy, cycloalkyl and phenyl are optionally substituted by one or more groups independently selected from halogen, CN, C₁-C₄ alkyl, C₁-C₄-haloalkyl, C₁-C₄ alkoxy and C₁-C₄ haloalkoxy;

each R⁸ independently or one another represents hydrogen, C₁-C₄ alkyl or C₁-C₄ haloalkyl;

each R¹⁰ independently of one another represents hydrogen or C₁-C₄ alkyl;

wherein when two radicals R¹⁰ are attached to the same nitrogen atom, these radicals can be identical or different;

and wherein when two radicals R¹¹ are attached to the same nitrogen atom, these two radicals together with the nitrogen atom to which they are attached may form a cycle B-1, B-2, B-3, B-4 or B-5, wherein the cycle formed is optionally substituted by one or more groups independently selected from halogen, methyl and halomethyl.

In one group of compounds, R¹ represents C₁-C₄ alkyl, C₂-C₄ alkenyl, phenyl or pyridyl, wherein the alkyl, alkenyl, phenyl and pyridyl are optionally substituted by one or more groups independently selected from halogen, CN, C₁-C₄ alkoxy and C₁-C₄ haloalkoxy.

In one group of compounds R³ represents pyridyl, optionally substituted by one or more groups independently selected from halogen, CN, NH₂, NO₂, OH, C₁-C₄ alkyl, C₁-C₄ haloalkyl, C₁-C₄ alkoxy, C₁-C₄ haloalkoxy, C₃-C₆ cycloalkyl and a 5- or 6-membered heterocycle containing one to three heteroatoms independently selected from O, S and N, providing that the heterocycle does not contain adjacent oxygen atoms, adjacent sulphur atoms, or adjacent sulphur and oxygen atoms.

The heterocycle is preferably one as defined herein, preferably morpholinyl, pyrrolidinyl, piperidinyl, piperazinyl, pyridyl, pyrrolyl, imidazolyl or triazolyl, e.g. 1,2,4 triazolyl, more preferably morpholinyl, pyrollidinyl, pyridyl or imidazolyl.

In another group of compounds A¹ is A^{1a} and R³ represents pyridin-2-yl, optionally substituted by one or more groups independently selected from halogen, CN, NH₂, NO₂, OH, C₁-C₄-alkyl, C₁-C₄-haloalkyl, C₁-C₄-alkoxy, C₁-C₄-haloalkoxy, C₃-C₆ cycloalkyl and a 5 or 6-membered heterocycle containing one to three heteroatoms independently selected from O, S and N, providing that the heterocycle does not contain adjacent oxygen atoms, adjacent sulphur atoms, or adjacent sulphur and oxygen atoms. The heterocycle is preferably one as defined herein, preferably morpholinyl, pyrrolidinyl, piperidinyl, piperazinyl, pyridyl, pyrrolyl, imidazolyl or triazolyl, e.g. 1,2,4 triazolyl, more preferably morpholinyl, pyrollidinyl, pyridyl or imidazolyl.

In another group of compounds A¹ and R³ represent identical substituents.

In another group of compounds:

X represents X-3;

Z³ and Z⁵ represent methylene;

Z⁴ represents CR¹⁹R²⁰ or C═CR¹⁷R¹⁸;

each R¹⁷ and R¹⁸ independently of one another represent hydrogen, halogen, methyl or halomethyl;

each R¹⁹ and R²⁰ independently of one another represent hydrogen, halogen, CN, OH, C₁-C₄ alkyl, C₁-C₄ haloalkyl or phenyl, wherein the phenyl is optionally substituted by one or more groups independently selected from halogen, CN, methyl, halomethyl, methoxy and halomethoxy;

or R¹⁹ and R²⁰ together with the carbon atom to which they are attached may form a C₃-C₆ cycloalkyl group optionally substituted by halogen.

In one group of compounds, Y¹ and Y³, Y² and Y³, R⁵ and R⁶, R⁶ and R⁴, or R⁴ and R⁷ together with the fragment of the pyridyl ring to which they are attached may form a partially or fully unsaturated 5- to 7-membered carbocyclic ring or a 5- to 7-membered heterocyclic ring containing one to three heteroatoms independently selected from O, S, N and N(R⁵), providing that the heterocycle does not contain adjacent oxygen atoms, adjacent sulphur atoms, or adjacent sulphur and oxygen atoms, and wherein the ring formed by Y¹ and Y³, Y² and Y³, R⁵ and R⁶, R⁶ and R⁴, or R⁴ and R⁷ is optionally substituted by one or more groups independently selected from halogen, CN, NH₂, NO₂, OH, C₁-C₄ alkyl, C₁-C₄ haloalkyl, C₁-C₄ alkoxy and C₁-C₄ haloalkoxy.

Preferably in this group of compounds, Y¹ and Y³, Y² and Y³, R⁵ and R⁶, R⁶ and R⁴, or R⁴ and R⁷, together with the fragment of the ring to which they are attached may form a fully or partially unsaturated 6-membered carbocyclic ring optionally substituted by one or more groups independently selected from halogen, methyl and halomethyl.

In another group of compounds, R⁵ and R⁶, R⁶ and R⁴, or R⁴ and R⁷ together with the fragment of the ring to which they are attached may form a partially or fully unsaturated 5- to 7-membered carbocyclic ring or a 5- to 7-membered heterocyclic ring containing one to three heteroatoms independently selected from O, S, N and N(R⁵), providing that the heterocycle does not contain adjacent oxygen atoms, adjacent sulphur atoms, or adjacent sulphur and oxygen atoms, and wherein the ring formed by R⁵ and R⁶, R⁶ and R⁴, or R⁴ and R⁷ is optionally substituted by one or more groups independently selected from halogen, CN, NH₂, NO₂, OH, C₁-C₄ alkyl, C₁-C₄ haloalkyl, C₁-C₄ alkoxy and C₁-C₄ haloalkoxy.

In this group of compounds, R⁵ and R⁶, R⁶ and R⁴, or R⁴ and R⁷, together with the fragment of the ring to which they are attached may preferably form a fully or partially unsaturated 6-membered carbocyclic ring optionally substituted by one or more groups independently selected from halogen, methyl and halomethyl.

In any group of compounds wherein R⁵ and R⁶, R⁶ and R⁴, or R⁴ and R⁷, together with the fragment of the ring to which they are attached may form ring, preferably this ring will only be formed by R⁵ and R⁶ together with the fragment of the ring to which they are attached.

In another group of compounds:

R¹ represents hydrogen, C₁-C₄ alkyl, C₁-C₄ haloalkyl and phenyl, wherein the phenyl is optionally substituted by one or more groups independently selected from halogen, CN, methyl, halomethyl, methoxy and halomethoxy;

R² represents hydrogen, C₁-C₄ alkyl, C₃-C₆ alkenyl or C₃-C₆ alkynyl, wherein the alkyl, alkenyl, or alkynyl are optionally substituted by one or more groups independently selected from halogen, CN, C₁-C₄ alkoxy and C₁-C₄ haloalkoxy;

D¹ represents C—Y¹;

D² represents C—Y²;

A represents group A-1, A-2, or A-3;

A¹ represents the cycle A^{1a}, A^{1b}, or A^{1c};

R³ represents hydrogen, CN, C₁-C₄ alkyl, C₃-C₆ cycloalkyl, C₂-C₄ alkenyl, C₂-C₄ alkynyl, (C₁-C₄alkoxy)carbonyl(C₁-C₄ alkyl), phenyl or pyridyl, wherein the alkyl, cycloalkyl, alkenyl, alkynyl, phenyl and pyridyl are optionally substituted by one or more groups independently selected from halogen, CN, NH₂, NH—C₁-C₈ alkyl, N(C₁-C₈ alkyl)₂, NO₂, OH, C₁-C₄ alkyl, C₁-C₄ haloalkyl, C₃-C₆ cycloalkyl, pyridyl or pyrroline;

R⁴ represents hydrogen, halogen, CN, C₁-C₆ alkyl, C₃-C₆ cycloalkyl, C₂-C₆ alkenyl, C₂-C₆ alkynyl, phenyl, OH, C₁-C₄ alkoxy, NH₂, NH(C₁-C₄ alkyl), N(C₁-C₄ alkyl)₂, CO(C₁-C₄ alkyl), wherein the alkyl, cycloalkyl, alkenyl, alkynyl and phenyl are optionally substituted by one or more groups independently selected from halogen, CN, methyl, halomethyl, methoxy and halomethoxy;

R⁵ represents hydrogen, halogen, CN, C₁-C₈ alkyl, C₃-C₆ cycloalkyl, C₂-C₈ alkenyl, C₂-C₈ alkynyl, phenyl, pyridyl, CO(C₁-C₄ alkyl), OH, C₁-C₄ alkoxy, NH₂, NH(C₁-C₄ alkyl), N(C₁-C₄ alkyl)₂ or CO₂(C₁-C₄ alkyl), wherein the alkyl, cycloalkyl, alkenyl, alkynyl, phenyl and pyridyl are optionally substituted by one or more groups independently selected from halogen, CN, NH₂, OR⁸, C₁-C₄ alkyl, C₁-C₄ haloalkyl;

R⁶ represents hydrogen, halogen, CN, C₁-C₄ alkyl, C₃-C₆ cycloalkyl, C₂-C₆ alkenyl, C₂-C₆ alkynyl, phenyl, C₁-C₄ alkoxy or benzyloxy, wherein the alkyl, cycloalkyl, alkenyl, alkynyl and phenyl are optionally substituted by one or more groups independently selected from halogen, CN, methyl, halomethyl, methoxy and halomethoxy;

or R⁵ and R⁶ together with the fragment of the ring to which they are attached may form a partially or fully unsaturated 5- to 7-membered carbocyclic ring or a partially or fully unsaturated 5- to 7-membered heterocyclic ring containing one heteroatom independently selected from O, S, N NH and N(C₁-C₄ alkyl), wherein the ring formed is optionally substituted by one or more groups independently selected from halogen, CN, methyl, halomethyl, methoxy and halomethoxy;

R⁷ represents hydrogen, halogen, CN, C₁-C₄ alkyl, C₃-C₆ cycloalkyl, C₂-C₄ alkenyl, C₂-C₄ alkynyl, OH, C₁-C₄ alkoxy, NH₂, NH(C₁-C₄ alkyl), N(C₁-C₄ alkyl)₂, CO₂(C₁-C₄ alkyl) and CO₂(C₁-C₄ alkyl), wherein the alkyl, cycloalkyl, alkenyl and alkynyl are optionally substituted by one or more groups independently selected from halogen, CN, methyl, halomethyl, methoxy and halomethoxy;

G¹ and G² independently of one another represent —C(R¹²R¹³)—;

G³ represents —C(R¹²R¹³)—, O, N(R¹⁴) or S;

each R¹² and R¹³ independently of one another represent hydrogen, halogen, C₁-C₄ alkyl, C₁-C₄ haloalkyl, C₁-C₄ alkoxy or C₁-C₄ haloalkoxy;

R¹⁴ represents hydrogen, OH, C₁-C₄ alkyl, C₁-C₄ alkoxy, C₃-C₆ cycloalkyl, C₁-C₈ alkylcarbonyl or C₁-C₈ haloalkylcarbonyl;

p represents 1 or 2;

X represents X-3;

Z³ and Z⁵ independently of one another represent CR¹⁵R¹⁶ or C═CR¹⁷R¹⁸;

Z⁴ represent CR¹⁹R²⁰;

each R¹⁵ and R¹⁶ independently of one another represent hydrogen, halogen, C₁-C₄ alkyl or C₁-C₄ haloalkyl;

each R¹⁷ and R¹⁸ independently of one another represent hydrogen, halogen, methyl or halomethyl;

each R¹⁹, R²⁰ independently of one another represent hydrogen, halogen, CN, OH, C₁-C₄ alkyl or C₁-C₄ haloalkyl;

or R¹⁹ and R²⁰ together with the carbon atom to which they are attached may form a C₃-C₆ cycloalkyl group or a C₃-C₆ halocycloalkyl group;

Y¹ and Y² each represent H;

Y³ represents hydrogen, halogen, CN, C₁-C₄ alkyl, C₃-C₆ cycloalkyl, C₂-C₆ alkenyl, C₂-C₆ alkynyl or C₁-C₄ alkoxy wherein the alkyl, cycloalkyl, alkenyl and alkynyl are optionally substituted by one or more groups independently selected from halogen, CN, NH₂, NO₂, OH, C₁-C₄ alkyl and C₁-C₄ haloalkyl;

each R⁸ independently of one another represents hydrogen, C₁-C₈ alkyl, C₃-C₈ cycloalkyl, C₃-C₈ alkenyl, C₃-C₈ alkynyl, phenyl, benzyl or pyridyl, wherein the alkyl, cycloalkyl, alkenyl, alkynyl, phenyl, benzyl and pyridyl are optionally substituted by one or more groups independently selected from halogen, CN, NH₂, NO₂, OH, C₁-C₄ alkyl, C₁-C₄-haloalkyl, C₁-C₄ alkoxy, C₁-C₄ haloalkoxy and C₁-C₄-alkoxy-C₁-C₄-alkyl.

In a further group of compounds:

R¹ represents hydrogen, C₁-C₄ alkyl, C₁-C₄ haloalkyl and phenyl, wherein the phenyl is optionally substituted by one or more groups independently selected from halogen, CN, methyl, halomethyl, methoxy and halomethoxy;

R² represents hydrogen, C₁-C₄ alkyl, C₃-C₆ alkenyl or C₃-C₆ alkynyl, wherein the alkyl, alkenyl, or alkynyl are optionally substituted by one or more groups independently selected from halogen, CN, methyl, halomethyl, methoxy and halomethoxy;

D¹ represents C—Y¹;

D² represents C—Y²;

A represents group A-1, A-2, or A-3;

A¹ represents the cycle A^{1a}, A^{1b}, or A^{1c};

R³ represents hydrogen, CN, C₁-C₄ alkyl, C₂-C₄ alkenyl, C₂-C₄ alkynyl or phenyl, wherein the alkyl, cycloalkyl, alkenyl, alkynyl and phenyl pyridyl are optionally substituted by one or more groups independently selected from halogen, CN, NH₂, NH—C₁-C₄ alkyl, N(C₁-C₄ alkyl)₂, OH, C₁-C₄ alkyl, C₁-C₄ haloalkyl, C₃-C₆ cycloalkyl, pyridyl or pyrroline;

R⁴ represents hydrogen, halogen, CN, C₁-C₆ alkyl, C₃-C₆ cycloalkyl, C₂-C₄ alkenyl, C₂-C₄ alkynyl, phenyl, C₁-C₄ alkoxy, or CO(C₁-C₄ alkyl), wherein the alkyl, cycloalkyl, alkenyl, alkynyl and phenyl are optionally substituted by one or more groups independently selected from halogen, CN, methyl, halomethyl, methoxy and halomethoxy;

R⁵ represents hydrogen, halogen, CN, C₁-C₈ alkyl, C₃-C₆ cycloalkyl, C₂-C₈ alkenyl, C₂-C₈ alkynyl, phenyl, pyridyl, CO(C₁-C₄ alkyl), OH, C₁-C₄ alkoxy, NH₂, NH(C₁-C₄ alkyl), N(C₁-C₄ alkyl)₂ or CO₂(C₁-C₄ alkyl), wherein the alkyl, cycloalkyl, alkenyl, alkynyl, phenyl and pyridyl are optionally substituted by one or more groups independently selected from halogen, CN, NH₂, OR⁸, C₁-C₄ alkyl, C₁-C₄ haloalkyl;

R⁶ represents hydrogen, halogen, CN, C₁-C₄ alkyl, C₁-C₄ alkoxy or benzyloxy, wherein the alkyl and phenyl are optionally substituted by one or more groups independently selected from halogen, CN, methyl, halomethyl, methoxy and halomethoxy;

or R⁵ and R⁶ together with the fragment of the ring to which they are attached may form a partially or fully unsaturated 5- to 7-membered carbocyclic ring or a partially or fully unsaturated 5- to 7-membered heterocyclic ring containing one heteroatom independently selected from O or S, wherein the ring formed is optionally substituted by one or more groups independently selected from halogen, CN, methyl, halomethyl, methoxy and halomethoxy;

R⁷ represents hydrogen, halogen, CN, C₁-C₄ alkyl, C₃-C₆ cycloalkyl, C₂-C₄ alkenyl, Cᵣ C₄ alkynyl, OH, C₁-C₄ alkoxy, NH₂, NH(C₁-C₄ alkyl), N(C₁-C₄ alkyl)₂, CO₂(C₁-C₄ alkyl) and CO₂(C₁-C₄ alkyl), wherein the alkyl, cycloalkyl, alkenyl and alkynyl are optionally substituted by one or more groups independently selected from halogen, CN, methyl, halomethyl, methoxy and halomethoxy;

G¹ represents —CH₂—;

G² represents —C(R¹²R¹³)—;

G³ represents —C(R¹²R¹³)—, O, N(R¹⁴) or S;

each R¹² and R¹³ independently of one another represent hydrogen or C₁-C₄ alkyl;

R¹⁴ represents hydrogen or C₁-C₄ alkyl;

p represents 1 or 2;

X represents X-3;

Z³ and Z⁵ independently of one another represent CR¹⁵R¹⁶ or C═CR¹⁷R¹⁸;

Z⁴ represent CR¹⁹R²⁰;

each R¹⁵ and R¹⁶ independently of one another represent hydrogen, halogen, C₁-C₄ alkyl or C₁-C₄ haloalkyl;

each R¹⁷ and R¹⁸ independently of one another represent hydrogen, halogen, methyl or halomethyl;

each R¹⁹, R²⁰ independently of one another represent hydrogen, halogen, CN, OH, C₁-C₄ alkyl or C₁-C₄ haloalkyl;

or R¹⁹ and R²⁰ together with the carbon atom to which they are attached may form a C₃-C₆ cycloalkyl group or a C₃-C₆ halocycloalkyl group;

wherein the grouping X-3 contains at most one ring which contains either only one of the radicals Z³ to Z⁵ or two radicals Z³ to Z⁵ or three radicals Z³ to Z⁵ as ring members;

Y¹ and Y² each represent H;

Y³ represents hydrogen, halogen, CN, C₁-C₄ alkyl, C₂-C₆ alkenyl, C₂-C₆ alkynyl or C₁-C₄ alkoxy wherein the alkyl, cycloalkyl, alkenyl and alkynyl are optionally substituted by one or more groups independently selected from halogen, CN, NH₂, NO₂, OH, C₁-C₄ alkyl and C₁-C₄ haloalkyl;

each R⁸ independently of one another represents hydrogen, C₁-C₆ alkyl, C₃-C₆ alkenyl, C₃-C₄ alkynyl, phenyl or benzyl.

The invention also provides compounds of formula I-i

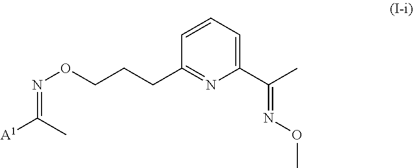

wherein A¹, and preferred definitions thereof, are as defined for compounds of formula I.

The invention also provides compounds of formula I-ii

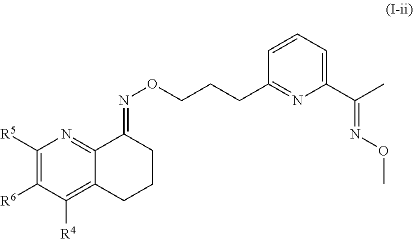

wherein R⁴, R⁵ and R⁶, and preferred definitions thereof, are as defined for compounds of formula I.

The invention also provides compounds of formula I-iii

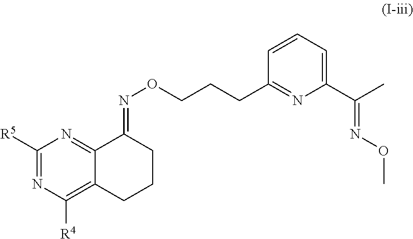

wherein R⁴ and R⁵, and preferred definitions thereof, are as defined for compounds of formula I. Intermediates that can be used to prepare compounds of formula (I) also form part of the present invention. Accordingly, in a further aspect, the invention provides a compound of formula (II)

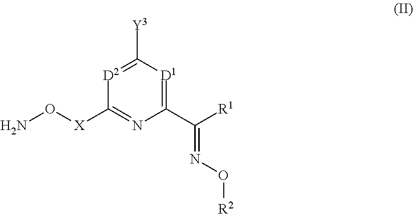

wherein D¹, D², X, Y¹, Y², Y³, R¹ and R² are as defined herein for compounds of formula (I); or a salt or N-oxide thereof. The preferred definitions of X, Y¹, Y², Y³, R¹ and R² defined in respect of compounds of formula (I) also apply to compounds of formula (II).

In a further aspect, the invention provides a compound of formula (III)

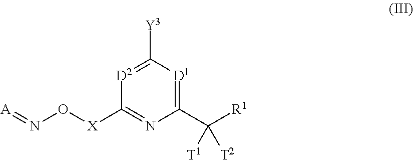

wherein T¹ and T² independently of one another represent C₁-C₈ alkoxy, or T¹ and T² together with the carbon they are attached to form a carbonyl group or an acetal or ketal function of the form C(O—C₁-C₆-alkylidene-O), wherein the alkylidene fragment is optionally substituted by one to four C₁-C₆ alkyl;

D¹, D², A, X, Y¹, Y², Y³ and R¹ are as defined herein for compounds of formula (I); or a salt or N-oxide thereof. The preferred definitions of A, R¹, X, Y¹, Y², Y³ and R² defined in respect of compounds of formula (I) also apply to compounds of formula (III).

In a further aspect, the invention provides a compound of formula (IV)

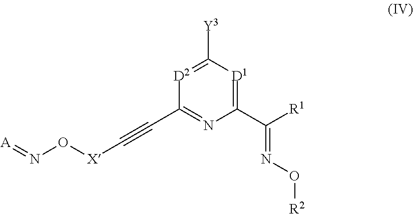

wherein X′ represents X′-1, X′-2 or X′-3

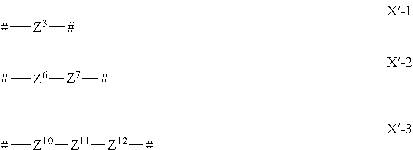

wherein D¹, D², A, Z³, Z⁶, Z⁷, Z¹⁰, Z¹¹, Z¹², Y¹, Y², Y³, R¹ and R² are as defined herein for compounds of formula (I); or a salt or N-oxide thereof. The preferred definitions of A, Z³, Z⁶, Z⁷, Z¹⁰, Z¹¹, Z¹², Y¹, Y², Y³, R¹ and R² defined in respect of compounds of formula (I) also apply to compounds of formula (VI).

In a further aspect, the invention provides a compound of formula (V)

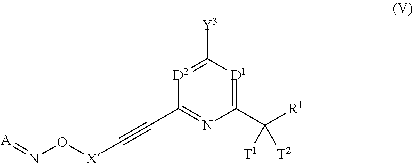

wherein X′ represents X′-1, X′-2 or X′-3

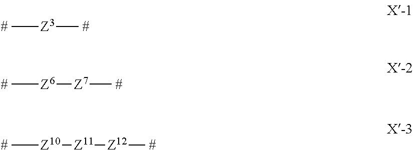

T¹ and T² independently of one another represent C₁-C₈ alkoxy, or T¹ and T² together with the carbon they are attached to form a carbonyl group or an acetal or ketal function of the form C(O—C₁-C₆-alkylidene-O), wherein the alkylidene fragment is optionally substituted by one to four C₁-C₆ alkyl;

D¹, D², A, Z³, Z⁶, Z⁷, Z¹⁰, Z¹¹, Z¹², Y¹, Y², Y³ and R¹ are as defined herein for a compound of formula (I); or a salt or N-oxide thereof. The preferred definitions of A, Z³, Z⁶, Z⁷, Z¹⁰, Z¹¹, Z¹², Y¹, Y², Y³ and R¹ defined in respect of compounds of formula (I) also apply to compounds of formula (V).

In a further aspect, the invention provides a compound of formula (VI)

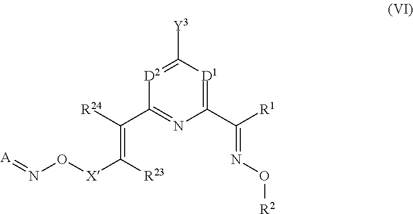

wherein X′ represents X′-1, X′-2 or X′-3

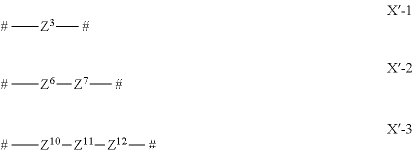

R²³ and R²⁴ independently of one another represent hydrogen, halogen, CN, C₁-C₄ alkyl, C₁-C₄ haloalkyl or phenyl, wherein phenyl is optionally substituted by one or more groups, e.g. one to five groups, independently selected from halogen, CN, C₁-C₄ alkyl, C₁-C₄ haloalkyl, C₁-C₄ alkoxy and C₁-C₄ haloalkoxy;

D¹, D², A, Z³, Z⁶, Z⁷, Z¹⁰, Z¹¹, Z¹², Y¹, Y², Y³, R¹ and R² are as defined herein for a compound of formula (I); or a salt or N-oxide thereof. The preferred definitions of A, Z³, Z⁶, Z⁷, Z¹⁰, Z¹¹, Z¹², Y¹, Y², Y³, R¹ and R² defined in respect of compounds of formula (I) also apply to compounds of formula (VI).

In a further aspect, the invention provides a compound of formula (VII)

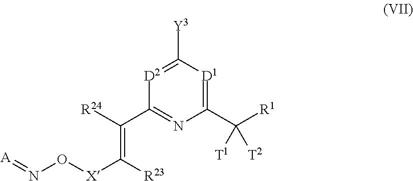

wherein X′ represents X′-1, X′-2 or X′-3

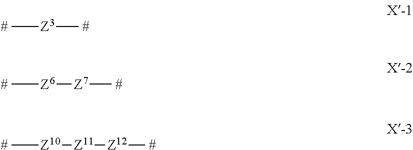

R²³ and R²⁴ independently of one another represent hydrogen, halogen, CN, C₁-C₄ alkyl, C₁-C₄ haloalkyl or phenyl, wherein phenyl is optionally substituted by one or more groups, e.g. one to five groups, independently selected from halogen, CN, C₁-C₄ alkyl, C₁-C₄ haloalkyl, C₁-C₄ alkoxy and C₁-C₄ haloalkoxy;

T¹ and T² independently of one another represent C₁-C₈ alkoxy, or T¹ and T² together with the carbon they are attached to form a carbonyl group or an acetal or ketal function of the form C(O—C₁-C₆-alkylidene-O), wherein the alkylidene fragment is optionally substituted by one to four C₁-C₆ alkyl;

D¹, D², A, Z³, Z⁶, Z⁷, Z¹⁰, Z¹¹, Z¹², Y¹, Y², Y³ and R¹ are as defined herein for compounds of formula (I); or a salt or N-oxide thereof. The preferred definitions of A, Z³, Z⁶, Z⁷, Z¹⁰, Z¹¹, Z¹², Y¹, Y², Y³ and R¹ defined in respect of compounds of formula (I) also apply to compounds of formula (VII).

In a further aspect, the invention provides a compound of formula (VIII)

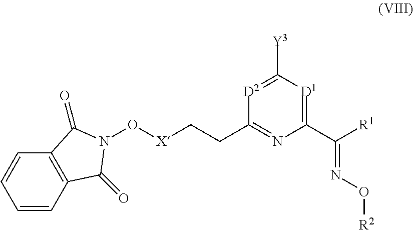

wherein X′ represents X′-1, X′-2 or X′-3

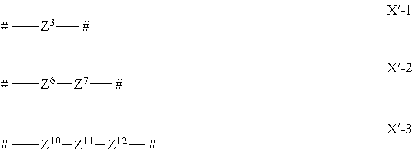

D¹, D², Z³, Z⁶, Z⁷, Z¹⁰, Z¹¹, Z¹², Y¹, Y², Y³, and R² are as defined herein for a compound of formula (I); or a salt or N-oxide thereof. The preferred definitions of Z³, Z⁶, Z⁷, Z¹⁰, Z¹¹, Z¹², Y¹, Y², Y³, R¹ and R² defined in respect of compounds of formula (I) also apply to compounds of formula (VIII).

In a further aspect, the invention provides a compound of formula (IX)

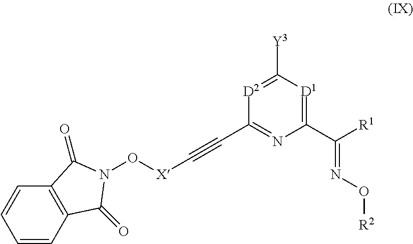

wherein X′ represents X′-1, X′-2 or X′-3

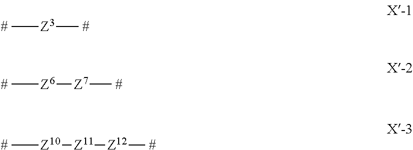

D¹, D², Z³, Z⁶, Z⁷, Z¹⁰, Z¹¹, Z¹², Y¹, Y², Y³, R¹ and R² are as defined herein for a compound of formula (I); or a salt or N-oxide thereof. The preferred definitions of Z³, Z⁶, Z⁷, Z¹⁰, Z¹¹, Z¹², Y¹, Y², Y³, R¹ and R² defined in respect of compounds of formula (I) also apply to compounds of formula (IX).

In a further aspect, the invention provides a compound of formula (X)

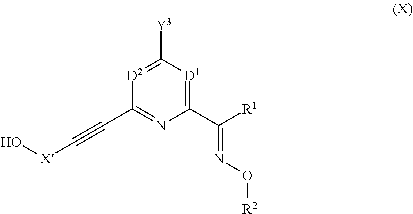

wherein X′ represents X′-1, X′-2 or X′-3

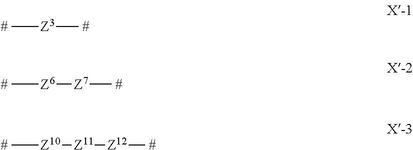

D¹, D², Z³, Z⁶, Z⁷, Z¹⁰, Z¹¹, Z¹², Y¹, Y², Y³, R¹ and R² are as defined herein for a compound of formula (I); or a salt or N-oxide thereof. The preferred definitions of Z³, Z⁶, Z⁷, Z¹⁰, Z¹¹, Z¹², Y¹, Y², Y³, R¹ and R² defined in respect of compounds of formula (I) also apply to compounds of formula (X).

In a further aspect, the invention provides a compound of formula (XI)

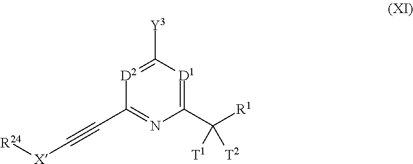

wherein R²⁵ is a halogen or a sulfonic acid ester group, e.g. bromine, iodine, mesylate, triflate, phenylsulfonic acid ester or nonafluorobutylsulfonic acid ester, wherein the phenylsulfonic acid ester is optionally substituted by one or more groups independently selected from halogen, NO₂, CN, C₁-C₄ alkyl, C₁-C₄ haloalkyl, C₁-C₄ alkoxy and C₁-C₄ haloalkoxy, for example tosylate or nitro-phenylsulfonic acid ester;

T¹ and T² independently of one another represent C₁-C₈ alkoxy, or T¹ and T² together with the carbon they are attached to form a carbonyl group or an acetal or ketal function of the form C(O—C₁-C₆-alkylidene-O) whereby the alkylidene fragment, wherein the alkylidene fragment is optionally substituted by one to four C₁-C₆ alkyl;

X′ represents X′-1, X′-2 or X′-3

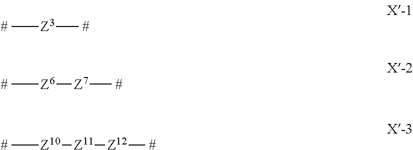

D¹, D², Z³, Z⁶, Z⁷, Z¹⁰, Z¹¹, Z¹², Y¹, Y², Y³ and R¹ are as defined herein for a compound of formula (I); or a salt or N-oxide thereof. The preferred definitions of Z³, Z⁶, Z⁷, Z¹⁰, Z¹¹, Z¹², Y¹, Y², Y³ and R² defined in respect of compounds of formula (I) also apply to compounds of formula (XI).

In a further aspect, the invention provides a compound of formula (XII)

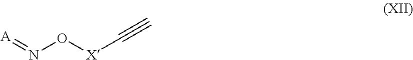

wherein X′ represents X′-1, X′-2 or X′-3

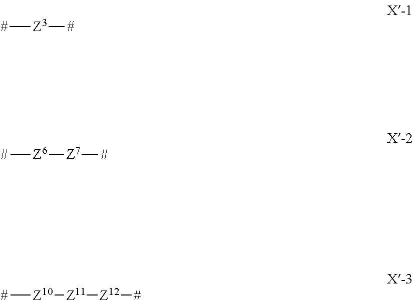

A, Z³, Z⁶, Z⁷, Z¹⁰, Z¹¹ and Z¹² are as defined herein for a compound of formula (I); or a salt or N-oxide thereof. The preferred definitions of A, Z³, Z⁶, Z⁷, Z¹⁰, Z¹¹ and Z¹² defined in respect of compounds of formula (I) also apply to compounds of formula (XII).

In a further aspect, the invention provides a compound of formula (XIII)

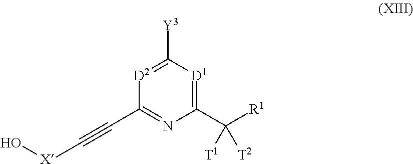

wherein X′ represents X′-1, X′-2 or X′-3

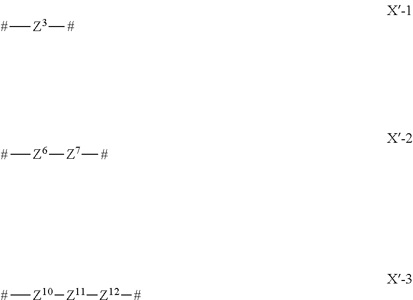

T¹ and T² independently of one another represent C₁-C₈ alkoxy, or T¹ and T² together with the carbon they are attached to form a carbonyl group or an acetal or ketal function of the form C(O—C₁-C₆-alkylidene-O), wherein the alkylidene fragment is optionally substituted by one to four C₁-C₆ alkyl;

D¹, D², Z³, Z⁶, Z⁷, Z¹⁰, Z¹¹, Z¹², Y¹, Y², Y³ and R¹ are as defined herein for a compound of formula (I); or a salt or N-oxide thereof. The preferred definitions of Z³, Z⁶, Z⁷, Z¹⁰, Z¹¹, Z¹², Y¹, Y², Y³ and R¹ defined in respect of compounds of formula (I) also apply to compounds of formula (XII).

In a further aspect, the invention provides a compound of formula (XV)

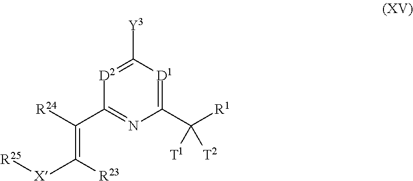

wherein R²⁵ is a halogen or a sulfonic acid ester group, e.g. bromine, iodine, mesylate, tosylate, triflate, phenylsulfonic acid ester, nitro-phenylsulfonic acid ester, or nonafluorobutylsulfonic acid ester, wherein the phenylsulfonic acid ester is optionally substituted by one or more groups independently selected from halogen, NO₂, CN, C₁-C₄ alkyl, C₁-C₄ haloalkyl, C₁-C₄ alkoxy and C₁-C₄ haloalkoxy, for example tosylate or nitro-phenylsulfonic acid ester;

X′ represents X′-1, X′-2 or X′-3

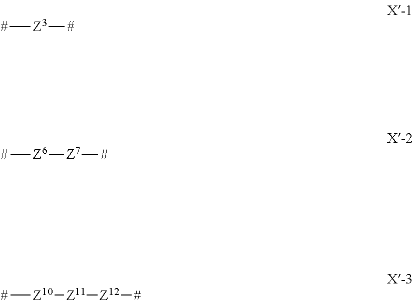

R²³ and R²⁴ independently of one another represent hydrogen, halogen, CN, C₁-C₄ alkyl, C₁-C₄ haloalkyl or phenyl, wherein phenyl is optionally substituted by one or more groups, e.g. one to five groups, independently selected from halogen, CN, C₁-C₄ alkyl, C₁-C₄ haloalkyl, C₁-C₄ alkoxy and C₁-C₄ haloalkoxy;

T¹ and T² independently of one another represent C₁-C₈ alkoxy, or T¹ and T² together with the carbon they are attached to form a carbonyl group or an acetal or ketal function of the form C(O—C₁-C₆-alkylidene-O), wherein the alkylidene fragment is optionally substituted by one to four C₁-C₆ alkyl;

D¹, D², Z³, Z⁶, Z⁷, Z¹⁰, Z¹¹, Z¹², Y¹, Y², Y³ and R¹ are as defined herein for a compound of formula (I); or a salt or N-oxide thereof. The preferred definitions of Z³, Z⁶, Z⁷, Z¹⁰, Z¹¹, Z¹², Y¹, Y², Y³ and R² defined in respect of compounds of formula (I) also apply to compounds of formula (XV).

Preferably the compound of formula (XV) is a compound of formula (XVII)

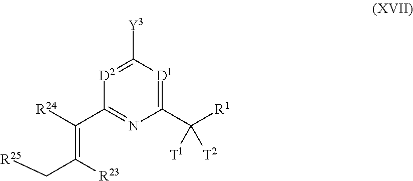

wherein R²⁵ is a halogen or a sulfonic acid ester group, e.g. bromine, iodine, mesylate, tosylate, triflate, phenylsulfonic acid ester, nitro-phenylsulfonic acid ester, or nonafluorobutylsulfonic acid ester, wherein the phenylsulfonic acid ester is optionally substituted by one or more groups independently selected from halogen, NO₂, CN, C₁-C₄ alkyl, C₁-C₄ haloalkyl, C₁-C₄ alkoxy and C₁-C₄ haloalkoxy, for example tosylate or nitro-phenylsulfonic acid ester;

R²³ and R²⁴ independently of one another represent hydrogen, halogen, CN, C₁-C₄ alkyl, C₁-C₄ haloalkyl or phenyl, wherein phenyl is optionally substituted by one or more groups, e.g. one to five groups, independently selected from halogen, CN, C₁-C₄ alkyl, C₁-C₄ haloalkyl, C₁-C₄ alkoxy and C₁-C₄ haloalkyoxy;

T¹ and T² independently of one another represent C₁-C₈ alkoxy, or T¹ and T² together with the carbon they are attached to form a carbonyl group or an acetal or ketal function of the form C(O—C₁-C₆-alkylidene-O), wherein the alkylidene fragment is optionally substituted by one to four C₁-C₆ alky;

D¹, D², Y¹, Y², Y³ and R¹ are as defined herein for a compound of formula (I); or a salt or N-oxide thereof. The preferred definitions of Y¹, Y², Y³ and R¹ defined in respect of compounds of formula (I) also apply to compounds of formula (XVII).

In a further aspect, the invention provides a compound of formula (XVI)

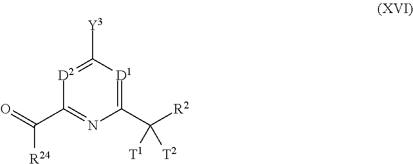

wherein R²⁴ represents hydrogen, halogen, CN, C₁-C₄ alkyl, C₁-C₄ haloalkyl or phenyl, wherein phenyl is optionally substituted by one or more groups, e.g. one to five groups, independently selected from halogen, CN, C₁-C₄ alkyl, C₁-C₄ haloalkyl, C₁-C₄ alkoxy and C₁-C₄ haloalkoxy;

T¹ and T² independently of one another represent C₁-C₈ alkoxy, or T¹ and T² together with the carbon they are attached to form a carbonyl group or an acetal or ketal function of the form C(O—C₁-C₆-alkylidene-O), wherein the alkylidene fragment is optionally substituted by one to four C₁-C₆ alkyl;

D¹, D², Y¹, Y², Y³ and R¹ are as defined herein for compounds of formula (I); or a salt or N-oxide thereof. The preferred definitions of Y¹, Y², Y³ and R¹ defined in respect of compounds of formula (I) also apply to compounds of formula (XVI).

In a further aspect, the invention provides a compound of formula (XVIII)

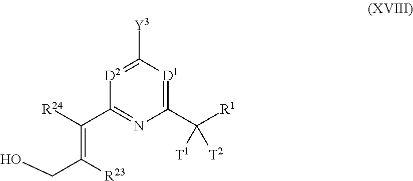

wherein R²³ and R²⁴ independently of one another represent hydrogen, halogen, CN, C₁-C₄ alkyl, C₁-C₄ haloalkyl or phenyl, wherein phenyl is optionally substituted by one or more groups, e.g. one to five groups, independently selected from halogen, CN, C₁-C₄ alkyl, C₁-C₄ haloalkyl, C₁-C₄ alkoxy and C₁-C₄ haloalkoxy;

T¹ and T² independently of one another represent C₁-C₈ alkoxy, or T¹ and T² together with the carbon they are attached to form a carbonyl group or an acetal or ketal function of the form C(O—C₁-C₆-alkylidene-O), wherein the alkylidene fragment is optionally substituted by one to four C₁-C₆ alkyl;

D¹, D², Y¹, Y², Y³ and R¹ are as defined for a compound of formula (I); or a salt or N-oxide thereof. The preferred definitions of Y¹, Y², Y³ and R¹ defined in respect of compounds of formula (I) also apply to compounds of formula (XVIII).

In a further aspect, the invention provides a compound of formula (XIX)

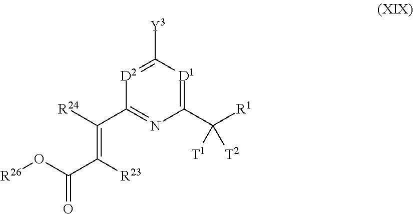

wherein R²⁶ represents C₁-C₄ alkyl;

R²³ and R²⁴ independently of one another represent hydrogen, halogen, CN, C₁-C₄ alkyl, C₁-C₄ haloalkyl or phenyl, wherein phenyl is optionally substituted by one or more groups, e.g. one to five groups, independently selected from halogen, CN, C₁-C₄ alkyl, C₁-C₄ haloalkyl, C₁-C₄ alkoxy and C₁-C₄ haloalkoxy;

T¹ and T² independently of one another represent C₁-C₈ alkoxy, or T¹ and T² together with the carbon they are attached to form a carbonyl group or an acetal or ketal function of the form C(O—C₁-C₆-alkylidene-O), wherein the alkylidene fragment is optionally substituted by one to four C₁-C₆ alkyl;

D¹, D², Y¹, Y², Y³ and R¹ are as defined for a compound of formula (I); or a salt or N-oxide thereof. The preferred definitions of Y¹, Y², Y³ and R¹ defined in respect of compounds of formula (I) also apply to compounds of formula (XIX).

The compounds of formula (I) may exist as different geometric or optical isomers or in different tautomeric forms. These may be separated and isolated by well-known (usually chromatographic) techniques, and all such isomers and tautomers and mixtures thereof in all proportions as well as isotopic forms, such as deuterated compounds, are part of the present invention. In particular, the carbon-nitrogen double bonds of the compound of formula (I) allow the four cis/trans isomers exemplified using compounds where A is A-1 below:

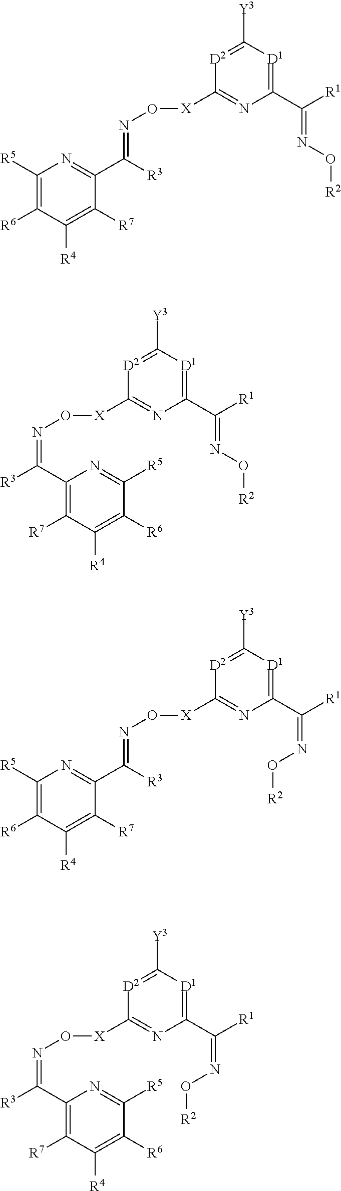

The present invention includes each of these isomers. The invention may provide a compound of formula (I) as just one of these isomers or as a mixture of one or more isomers in any ratio. Likewise, the invention also includes the corresponding isomers of the intermediates described herein, in particular compounds (II), (III), (IV), (V), (VI), (VII), (VIII), (IX), (X), (XI), (XII), (XIII), (XIV), (XV), (XVI), (XVII), (XVIII) and (XIX). In addition, where a reaction scheme depicts synthesis of one geometric isomer, the scheme also includes synthesis of the other geometric isomers where possible. For example reaction scheme A shown below encompasses reaction schemes B, C and D:

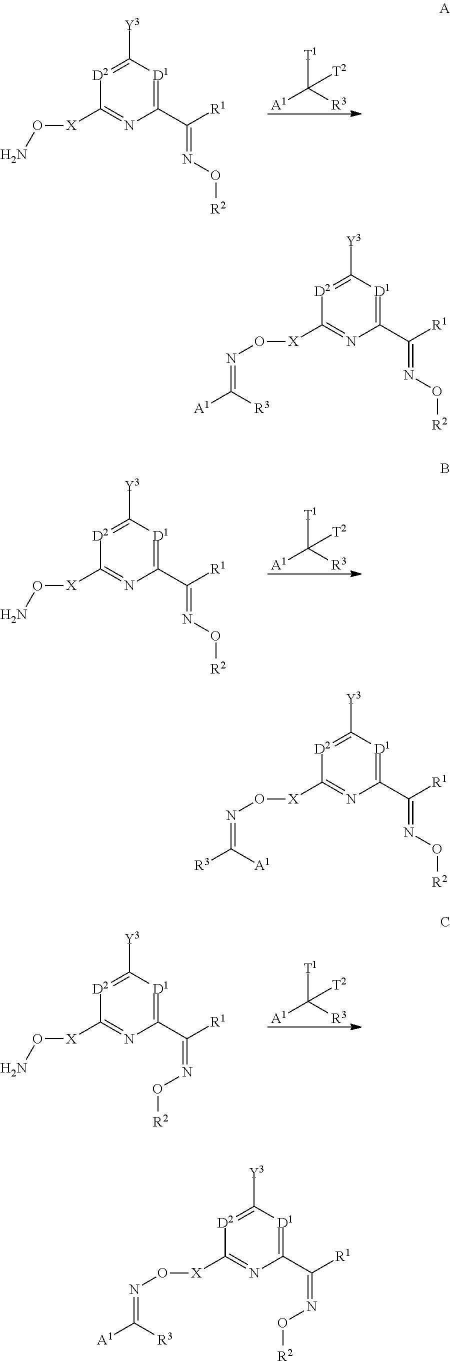

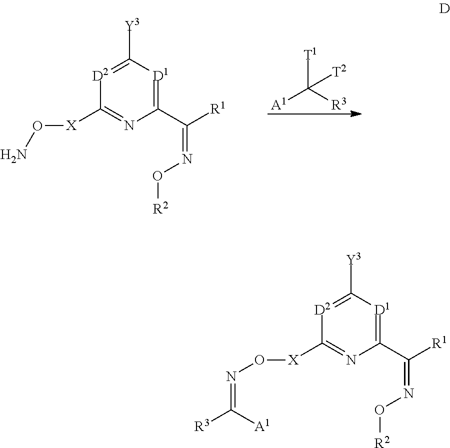

The compounds in tables 1 to 15 illustrate compounds of formula (I).

Table X represents Table 1 (when X is 1), Table 2 (when X is 2), Table 3 (when X is 3), Table 4 (when X is 4), Table 5 (when X is 5), Table 6 (when X is 6), Table 7 (when X is 7), Table 8 (when X is 8), Table 9 (when X is 9), Table 10 (when X is 10), Table 11 (when X is 11), Table 12 (when X is 12), Table 13 (when X is 13), Table 14 (when X is 14) and Table 15 (when X is 15). In all compounds of Table 1-15, A is A-1, wherein A¹ is A^{1a}

TABLE X

| | A^{1a} | R³ | Y¹ | Y² | Y³ |
|---|---|---|---|---|---|
| x.001 | 6-methylpyridin-2-yl | H | CH₃ | H | H |
| x.002 | 6-methylpyridin-2-yl | CH₃ | H | H | H |
| x.003 | 6-methylpyridin-2-yl | CH₃ | H | H | CH₃ |
| x.004 | 6-methylpyridin-2-yl | CH₃ | H | H | CH₂CH₃ |
| x.005 | 6-methylpyridin-2-yl | CH₃ | H | H | CH₂CH(CH₃)₂ |
| x.006 | 6-methylpyridin-2-yl | CH₃ | H | H | CH(CH₃)₂ |
| x.007 | 6-methylpyridin-2-yl | CH₃ | H | H | C(CH₃)₃ |
| x.008 | 6-methylpyridin-2-yl | CH₃ | H | H | cyclopropyl |
| x.009 | 6-methylpyridin-2-yl | CH₃ | H | H | cyclohexyl |
| x.010 | 6-methylpyridin-2-yl | CH₃ | H | H | CH═CH(CH₃) |
| x.011 | 6-methylpyridin-2-yl | CH₃ | H | H | CF₃ |
| x.012 | 6-methylpyridin-2-yl | CH₃ | H | H | CON(CH₃)₂ |
| x.013 | 6-methylpyridin-2-yl | CH₃ | H | H | Br |
| x.014 | 6-methylpyridin-2-yl | CH₃ | H | H | CN |
| x.015 | 6-methylpyridin-2-yl | CH₃ | H | H | OH |
| x.016 | 6-methylpyridin-2-yl | CH₃ | H | H | OCH₃ |
| x.017 | 6-methylpyridin-2-yl | CH₃ | H | H | OCH₂CH₃ |
| x.018 | 6-methylpyridin-2-yl | CH₃ | H | H | OCH(CH₃)₂ |
| x.019 | 6-methylpyridin-2-yl | CH₃ | H | H | OCH₂CH₂CH₃ |
| x.020 | 6-methylpyridin-2-yl | CH₃ | H | H | OCH₂CH═CH₂ |
| x.021 | 6-methylpyridin-2-yl | CH₃ | H | H | OCH₂CH≡CH |
| x.022 | 6-methylpyridin-2-yl | CH₃ | H | H | CH₂OCH₃ |
| x.023 | 6-methylpyridin-2-yl | CH₃ | H | H | CH₂OCH₂CH═CH₂ |
| x.024 | 6-methylpyridin-2-yl | CH₃ | H | H | CH₂OCH₂CH≡CH |
| x.025 | 6-methylpyridin-2-yl | CH₃ | H | H | CH₂OCH₂phenyl |
| x.026 | 6-methylpyridin-2-yl | CH₃ | H | H | CH₂OCH₂(4- |
| | | | | | chlorophenyl) |
| x.027 | 6-methylpyridin-2-yl | CH₃ | H | H | NH₂ |
| x.028 | 6-methylpyridin-2-yl | CH₃ | H | H | NH(CH₃) |
| x.029 | 6-methylpyridin-2-yl | CH₃ | H | H | N(CH₃)₂ |
| x.030 | 6-methylpyridin-2-yl | CH₃ | H | H | N(CH₂CH₃)₂ |
| x.031 | 6-methylpyridin-2-yl | CH₃ | H | H | NHCH₂CH═CH₂ |
| x.032 | 6-methylpyridin-2-yl | CH₃ | H | H | NHCH₂-cyclopropyl |
| x.033 | 6-methylpyridin-2-yl | CH₃ | H | H | NHCOCH₃ |
| x.034 | 6-methylpyridin-2-yl | CH₃ | H | H | N(CH₃)COCH₃ |
| x.035 | 6-methylpyridin-2-yl | CH₃ | H | H | NHCOCH(CH₃)₂ |
| x.036 | 6-methylpyridin-2-yl | CH₃ | H | H | N(COCH₃)₂ |
| x.037 | 6-methylpyridin-2-yl | CH₃ | H | H | NHCOCHCl₂ |
| x.038 | 6-methylpyridin-2-yl | CH₃ | H | H | N(CH₃)COC(CH₃)₃ |
| x.039 | 6-methylpyridin-2-yl | CH₃ | H | H | phenyl |
| x.040 | 6-methylpyridin-2-yl | CH₃ | H | H | 2-CH₃-phenyl |
| x.041 | 6-methylpyridin-2-yl | CH₃ | H | H | 3-F-phenyl |
| x.042 | 6-methylpyridin-2-yl | CH₃ | H | H | 4-Cl-phenyl |
| x.043 | 6-methylpyridin-2-yl | CH₃ | H | H | 2,4-diCl-phenyl |
| x.044 | 6-methylpyridin-2-yl | CH₃ | H | H | 3-CN-phenyl |
| x.045 | 6-methylpyridin-2-yl | CH₃ | H | H | 3-OCH₃-phenyl |
| x.046 | 6-methylpyridin-2-yl | CH₃ | H | H | 4-OCH₃-phenyl |
| x.047 | 6-methylpyridin-2-yl | CH₃ | H | H | 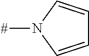 |
| x.048 | 6-methylpyridin-2-yl | CH₃ | H | H | 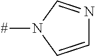 |
| x.049 | 6-methylpyridin-2-yl | CH₃ | H | H | 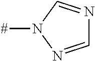 |
| x.050 | 6-methylpyridin-2-yl | CH₃ | H | H | 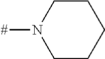 |
| x.051 | 6-methylpyridin-2-yl | CH₃ | H | CH₃ | H |
| x.052 | 6-methylpyridin-2-yl | CH₃ | H | CH₃ | CH₃ |
| x.053 | 6-methylpyridin-2-yl | CH₃ | H | CH₃ | CH₂CH₃ |
| x.054 | 6-methylpyridin-2-yl | CH₃ | H | CH₃ | CH₂CH(CH₃)₂ |
| x.055 | 6-methylpyridin-2-yl | CH₃ | H | CH₃ | CH(CH₃)₂ |
| x.056 | 6-methylpyridin-2-yl | CH₃ | H | CH₃ | C(CH₃)₃ |
| x.057 | 6-methylpyridin-2-yl | CH₃ | H | CH₃ | cyclopropyl |
| x.058 | 6-methylpyridin-2-yl | CH₃ | H | CH₃ | cyclohexyl |
| x.059 | 6-methylpyridin-2-yl | CH₃ | H | CH₃ | CH═CH(CH₃) |
| x.060 | 6-methylpyridin-2-yl | CH₃ | H | CH₃ | CF₃ |
| x.061 | 6-methylpyridin-2-yl | CH₃ | H | CH₃ | CON(CH₃)₂ |
| x.062 | 6-methylpyridin-2-yl | CH₃ | H | CH₃ | Br |
| x.063 | 6-methylpyridin-2-yl | CH₃ | H | CH₃ | CN |
| x.064 | 6-methylpyridin-2-yl | CH₃ | H | CH₃ | OH |
| x.065 | 6-methylpyridin-2-yl | CH₃ | H | CH₃ | OCH₃ |
| x.066 | 6-methylpyridin-2-yl | CH₃ | H | CH₃ | OCH₂CH₃ |
| x.067 | 6-methylpyridin-2-yl | CH₃ | H | CH₃ | OCH(CH₃)₂ |
| x.068 | 6-methylpyridin-2-yl | CH₃ | H | CH₃ | OCH₂CH₂CH₃ |
| x.069 | 6-methylpyridin-2-yl | CH₃ | H | CH₃ | OCH₂CH═CH₂ |
| x.070 | 6-methylpyridin-2-yl | CH₃ | H | CH₃ | OCH₂CH≡CH |
| x.071 | 6-methylpyridin-2-yl | CH₃ | H | CH₃ | CH₂OCH₃ |
| x.072 | 6-methylpyridin-2-yl | CH₃ | H | CH₃ | CH₂OCH₂CH═CH₂ |
| x.073 | 6-methylpyridin-2-yl | CH₃ | H | CH₃ | NH₂ |
| x.074 | 6-methylpyridin-2-yl | CH₃ | H | CH₃ | NH(CH₃) |
| x.075 | 6-methylpyridin-2-yl | CH₃ | H | CH₃ | N(CH₃)₂ |
| x.076 | 6-methylpyridin-2-yl | CH₃ | H | CH₃ | N(CH₂CH₃)₂ |
| x.077 | 6-methylpyridin-2-yl | CH₃ | H | CH₃ | NHCH₂CH═CH₂ |
| x.078 | 6-methylpyridin-2-yl | CH₃ | H | CH₃ | NHCH₂-cyclopropyl |
| x.079 | 6-methylpyridin-2-yl | CH₃ | H | CH₃ | NHCOCH₃ |
| x.080 | 6-methylpyridin-2-yl | CH₃ | H | CH₃ | N(CH₃)COCH₃ |
| x.081 | 6-methylpyridin-2-yl | CH₃ | H | CH₃ | NHCOCH(CH₃)₂ |
| x.082 | 6-methylpyridin-2-yl | CH₃ | H | CH₃ | N(COCH₃)₂ |
| x.083 | 6-methylpyridin-2-yl | CH₃ | H | CH₃ | NHCOCHCl₂ |
| x.084 | 6-methylpyridin-2-yl | CH₃ | H | CH₃ | N(CH₃)COC(CH₃)₃ |
| x.085 | 6-methylpyridin-2-yl | CH₃ | H | CH₃ | phenyl |
| x.086 | 6-methylpyridin-2-yl | CH₃ | H | CH₃ | 2-CH₃-phenyl |
| x.087 | 6-methylpyridin-2-yl | CH₃ | H | CH₃ | 3-F-phenyl |
| x.088 | 6-methylpyridin-2-yl | CH₃ | H | CH₃ | 4-Cl-phenyl |
| x.089 | 6-methylpyridin-2-yl | CH₃ | H | CH₃ | 2,4-diCl-phenyl |
| x.090 | 6-methylpyridin-2-yl | CH₃ | H | CH₃ | 3-CN-phenyl |
| x.091 | 6-methylpyridin-2-yl | CH₃ | H | CH₃ | 3-OCH₃-phenyl |
| x.092 | 6-methylpyridin-2-yl | CH₃ | H | CH₃ | 4-OCH₃-phenyl |
| x.093 | 6-methylpyridin-2-yl | CH₃ | H | CH₃ | 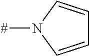 |
| x.094 | 6-methylpyridin-2-yl | CH₃ | H | CH₃ | 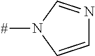 |
| x.095 | 6-methylpyridin-2-yl | CH₃ | H | CH₃ | 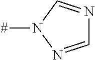 |
| x.096 | 6-methylpyridin-2-yl | CH₃ | H | CH₃ | 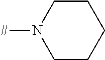 |
| x.097 | 6-methylpyridin-2-yl | CH₃ | CH₃ | H | H |
| x.098 | 6-methylpyridin-2-yl | CH₃ | CH₃ | H | CH₃ |
| x.099 | 6-methylpyridin-2-yl | CH₃ | CH₃ | H | CH₂CH₃ |
| x.100 | 6-methylpyridin-2-yl | CH₃ | CH₃ | H | CH₂CH(CH₃)₂ |
| x.101 | 6-methylpyridin-2-yl | CH₃ | CH₃ | H | CH(CH₃)₂ |
| x.102 | 6-methylpyridin-2-yl | CH₃ | CH₃ | H | C(CH₃)₃ |
| x.103 | 6-methylpyridin-2-yl | CH₃ | CH₃ | H | cyclopropyl |
| x.104 | 6-methylpyridin-2-yl | CH₃ | CH₃ | H | cyclohexyl |
| x.105 | 6-methylpyridin-2-yl | CH₃ | CH₃ | H | CH═CH(CH₃) |
| x.106 | 6-methylpyridin-2-yl | CH₃ | CH₃ | H | CF₃ |
| x.107 | 6-methylpyridin-2-yl | CH₃ | CH₃ | H | CON(CH₃)₂ |
| x.108 | 6-methylpyridin-2-yl | CH₃ | CH₃ | H | Br |
| x.109 | 6-methylpyridin-2-yl | CH₃ | CH₃ | H | CN |
| x.110 | 6-methylpyridin-2-yl | CH₃ | CH₃ | H | OH |
| x.111 | 6-methylpyridin-2-yl | CH₃ | CH₃ | H | OCH₃ |
| x.112 | 6-methylpyridin-2-yl | CH₃ | CH₃ | H | OCH₂CH₃ |
| x.113 | 6-methylpyridin-2-yl | CH₃ | CH₃ | H | OCH(CH₃)₂ |
| x.114 | 6-methylpyridin-2-yl | CH₃ | CH₃ | H | OCH₂CH₂CH₃ |
| x.115 | 6-methylpyridin-2-yl | CH₃ | CH₃ | H | OCH₂CH═CH₂ |
| x.116 | 6-methylpyridin-2-yl | CH₃ | CH₃ | H | OCH₂CH≡CH |
| x.117 | 6-methylpyridin-2-yl | CH₃ | CH₃ | H | CH₂OCH₃ |
| x.118 | 6-methylpyridin-2-yl | CH₃ | CH₃ | H | CH₂OCH₂CH═CH₂ |
| x.119 | 6-methylpyridin-2-yl | CH₃ | CH₃ | H | NH₂ |
| x.120 | 6-methylpyridin-2-yl | CH₃ | CH₃ | H | NH(CH₃) |
| x.121 | 6-methylpyridin-2-yl | CH₃ | CH₃ | H | N(CH₃)₂ |
| x.122 | 6-methylpyridin-2-yl | CH₃ | CH₃ | H | N(CH₂CH₃)₂ |
| x.123 | 6-methylpyridin-2-yl | CH₃ | CH₃ | H | NHCH₂CH═CH₂ |
| x.124 | 6-methylpyridin-2-yl | CH₃ | CH₃ | H | NHCH₂-cyclopropyl |
| x.125 | 6-methylpyridin-2-yl | CH₃ | CH₃ | H | NHCOCH₃ |
| x.126 | 6-methylpyridin-2-yl | CH₃ | CH₃ | H | N(CH₃)COCH₃ |
| x.127 | 6-methylpyridin-2-yl | CH₃ | CH₃ | H | NHCOCH(CH₃)₂ |
| x.128 | 6-methylpyridin-2-yl | CH₃ | CH₃ | H | N(COCH₃)₂ |
| x.129 | 6-methylpyridin-2-yl | CH₃ | CH₃ | H | NHCOCHCl₂ |
| x.130 | 6-methylpyridin-2-yl | CH₃ | CH₃ | H | N(CH₃)COC(CH₃)₃ |
| x.131 | 6-methylpyridin-2-yl | CH₃ | CH₃ | H | phenyl |
| x.132 | 6-methylpyridin-2-yl | CH₃ | CH₃ | H | 2-CH₃-phenyl |
| x.133 | 6-methylpyridin-2-yl | CH₃ | CH₃ | H | 3-F-phenyl |
| x.134 | 6-methylpyridin-2-yl | CH₃ | CH₃ | H | 4-Cl-phenyl |
| x.135 | 6-methylpyridin-2-yl | CH₃ | CH₃ | H | 2,4-diCl-phenyl |
| x.136 | 6-methylpyridin-2-yl | CH₃ | CH₃ | H | 3-CN-phenyl |
| x.137 | 6-methylpyridin-2-yl | CH₃ | CH₃ | H | 3-OCH₃-phenyl |
| x.138 | 6-methylpyridin-2-yl | CH₃ | CH₃ | H | 4-OCH₃-phenyl |
| x.139 | 6-methylpyridin-2-yl | CH₃ | CH₃ | H | 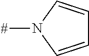 |
| x.140 | 6-methylpyridin-2-yl | CH₃ | CH₃ | H | 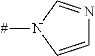 |
| x.141 | 6-methylpyridin-2-yl | CH₃ | CH₃ | H | 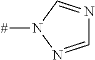 |
| x.142 | 6-methylpyridin-2-yl | CH₃ | CH₃ | C | 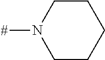 |
| x.143 | 6-methylpyridin-2-yl | CH₃ | H | OCH₃ | H |
| x.144 | 6-methylpyridin-2-yl | CH₃ | H | OCH₃ | CH₃ |
| x.145 | 6-methylpyridin-2-yl | CH₃ | H | OCH₃ | CH₂CH₃ |
| x.146 | 6-methylpyridin-2-yl | CH₃ | H | OCH₃ | cyclopropyl |
| x.147 | 6-methylpyridin-2-yl | CH₃ | H | OCH₃ | CF₃ |
| x.148 | 6-methylpyridin-2-yl | CH₃ | H | OCH₃ | phenyl |
| x.149 | 6-methylpyridin-2-yl | CH₃ | H | OCH₃ | OH |
| x.150 | 6-methylpyridin-2-yl | CH₃ | H | OCH₃ | OCH₃ |
| x.151 | 6-methylpyridin-2-yl | CH₃ | H | OCH₃ | NH(CH₃) |
| x.152 | 6-methylpyridin-2-yl | CH₃ | H | OCH₃ | N(CH₃)₂ |
| x.153 | 6-methylpyridin-2-yl | CH₃ | OCH₃ | H | H |
| x.154 | 6-methylpyridin-2-yl | CH₃ | OCH₃ | H | CH₃ |
| x.155 | 6-methylpyridin-2-yl | CH₃ | OCH₃ | H | CH₂CH₃ |
| x.156 | 6-methylpyridin-2-yl | CH₃ | OCH₃ | H | cyclopropyl |
| x.157 | 6-methylpyridin-2-yl | CH₃ | OCH₃ | H | CF₃ |
| x.158 | 6-methylpyridin-2-yl | CH₃ | OCH₃ | H | phenyl |
| x.159 | 6-methylpyridin-2-yl | CH₃ | OCH₃ | H | OH |
| x.160 | 6-methylpyridin-2-yl | CH₃ | OCH₃ | H | OCH₃ |
| x.161 | 6-methylpyridin-2-yl | CH₃ | OCH₃ | H | NH(CH₃) |
| x.162 | 6-methylpyridin-2-yl | CH₃ | OCH₃ | H | N(CH₃)₂ |
| x.163 | 6-methylpyridin-2-yl | CH₃ | CH₃ | CH₃ | H |
| x.164 | 6-methylpyridin-2-yl | CH₃ | CH₃ | CH₃ | CH₃ |
| x.165 | 6-methylpyridin-2-yl | CH₃ | CH₃ | CH₃ | CH₂CH₃ |
| x.166 | 6-methylpyridin-2-yl | CH₃ | CH₃ | CH₃ | cyclopropyl |
| x.167 | 6-methylpyridin-2-yl | CH₃ | CH₃ | CH₃ | CF₃ |
| x.168 | 6-methylpyridin-2-yl | CH₃ | CH₃ | CH₃ | phenyl |
| x.169 | 6-methylpyridin-2-yl | CH₃ | CH₃ | CH₃ | OH |
| x.170 | 6-methylpyridin-2-yl | CH₃ | CH₃ | CH₃ | OCH₃ |
| x.171 | 6-methylpyridin-2-yl | CH₃ | CH₃ | CH₃ | NH(CH₃) |
| x.172 | 6-methylpyridin-2-yl | CH₃ | CH₃ | CH₃ | N(CH₃)₂ |
| x.173 | 6-methylpyridin-2-yl | CH₃ | N(CH₃)₂ | H | H |
| x.174 | 6-methylpyridin-2-yl | CH₃ | N(CH₃)₂ | H | CH₃ |
| x.175 | 6-methylpyridin-2-yl | CH₃ | N(CH₃)₂ | H | CH₂CH₃ |
| x.176 | 6-methylpyridin-2-yl | CH₃ | N(CH₃)₂ | H | cyclopropyl |
| x.177 | 6-methylpyridin-2-yl | CH₃ | N(CH₃)₂ | H | CF₃ |
| x.178 | 6-methylpyridin-2-yl | CH₃ | N(CH₃)₂ | H | phenyl |
| x.179 | 6-methylpyridin-2-yl | CH₃ | N(CH₃)₂ | H | OH |
| x.180 | 6-methylpyridin-2-yl | CH₃ | N(CH₃)₂ | H | OCH₃ |
| x.181 | 6-methylpyridin-2-yl | CH₃ | H | N(CH₃)₂ | H |
| x.182 | 6-methylpyridin-2-yl | CH₃ | H | N(CH₃)₂ | CH₃ |
| x.183 | 6-methylpyridin-2-yl | CH₃ | H | N(CH₃)₂ | CH₂CH₃ |
| x.184 | 6-methylpyridin-2-yl | CH₃ | H | N(CH₃)₂ | cyclopropyl |
| x.185 | 6-methylpyridin-2-yl | CH₃ | H | N(CH₃)₂ | CF₃ |
| x.186 | 6-methylpyridin-2-yl | CH₃ | H | N(CH₃)₂ | phenyl |
| x.187 | 6-methylpyridin-2-yl | CH₃ | H | N(CH₃)₂ | OH |
| x.188 | 6-methylpyridin-2-yl | CH₃ | H | N(CH₃)₂ | OCH₃ |
| x.189 | 6-methylpyridin-2-yl | CH₃ | OH | H | H |
| x.190 | 6-methylpyridin-2-yl | CH₃ | OCH₂CH₃ | H | H |
| x.191 | 6-methylpyridin-2-yl | CH₃ | OCH(CH₃)₂ | H | H |
| x.192 | 6-methylpyridin-2-yl | CH₃ | OCH₂CH₂CH₃ | H | H |
| x.193 | 6-methylpyridin-2-yl | CH₃ | OCH₂CH═CH₂ | H | H |
| x.194 | 6-methylpyridin-2-yl | CH₃ | OCH₂CH≡CH | H | H |
| x.195 | 6-methylpyridin-2-yl | CH₃ | H | OH | H |
| x.196 | 6-methylpyridin-2-yl | CH₃ | H | OCH₂CH₃ | H |
| x.197 | 6-methylpyridin-2-yl | CH₃ | H | OCH(CH₃)₂ | H |
| x.198 | 6-methylpyridin-2-yl | CH₃ | H | OCH₂CH₂CH₃ | H |
| x.199 | 6-methylpyridin-2-yl | CH₃ | H | OCH₂CH═CH₂ | H |
| x.200 | 6-methylpyridin-2-yl | CH₃ | H | OCH₂CH≡CH | H |
| x.201 | 4,6-dimethylpyridin-2-yl | H | CH₃ | H | H |
| x.202 | 4,6-dimethylpyridin-2-yl | CH₃ | H | H | H |
| x.203 | 4,6-dimethylpyridin-2-yl | CH₃ | H | H | CH₃ |
| x.204 | 4,6-dimethylpyridin-2-yl | CH₃ | H | H | CH₂CH₃ |
| x.205 | 4,6-dimethylpyridin-2-yl | CH₃ | H | H | CH₂CH(CH₃)₂ |
| x.206 | 4,6-dimethylpyridin-2-yl | CH₃ | H | H | CH(CH₃)₂ |
| x.207 | 4,6-dimethylpyridin-2-yl | CH₃ | H | H | C(CH₃)₃ |
| x.208 | 4,6-dimethylpyridin-2-yl | CH₃ | H | H | cyclopropyl |
| x.209 | 4,6-dimethylpyridin-2-yl | CH₃ | H | H | cyclohexyl |
| x.210 | 4,6-dimethylpyridin-2-yl | CH₃ | H | H | CH═CH(CH₃) |
| x.211 | 4,6-dimethylpyridin-2-yl | CH₃ | H | H | CF₃ |
| x.212 | 4,6-dimethylpyridin-2-yl | CH₃ | H | H | CON(CH₃)₂ |
| x.213 | 4,6-dimethylpyridin-2-yl | CH₃ | H | H | Br |
| x.214 | 4,6-dimethylpyridin-2-yl | CH₃ | H | H | CN |
| x.215 | 4,6-dimethylpyridin-2-yl | CH₃ | H | H | OH |
| x.216 | 4,6-dimethylpyridin-2-yl | CH₃ | H | H | OCH₃ |
| x.217 | 4,6-dimethylpyridin-2-yl | CH₃ | H | H | OCH₂CH₃ |
| x.218 | 4,6-dimethylpyridin-2-yl | CH₃ | H | H | OCH(CH₃)₂ |
| x.219 | 4,6-dimethylpyridin-2-yl | CH₃ | H | H | OCH₂CH₂CH₃ |
| x.220 | 4,6-dimethylpyridin-2-yl | CH₃ | H | H | OCH₂CH═CH₂ |
| x.221 | 4,6-dimethylpyridin-2-yl | CH₃ | H | H | OCH₂CH≡CH |
| x.222 | 4,6-dimethylpyridin-2-yl | CH₃ | H | H | CH₂OCH₃ |
| x.223 | 4,6-dimethylpyridin-2-yl | CH₃ | H | H | CH₂OCH₂CH═CH₂ |
| x.224 | 4,6-dimethylpyridin-2-yl | CH₃ | H | H | CH₂OCH₂CH≡CH |
| x.225 | 4,6-dimethylpyridin-2-yl | CH₃ | H | H | CH₂OCH₂phenyl |
| x.226 | 4,6-dimethylpyridin-2-yl | CH₃ | H | H | CH₂OCH₂(4- |
| | | | | | chlorophenyl) |
| x.227 | 4,6-dimethylpyridin-2-yl | CH₃ | H | H | NH₂ |
| x.228 | 4,6-dimethylpyridin-2-yl | CH₃ | H | H | NH(CH₃) |
| x.229 | 4,6-dimethylpyridin-2-yl | CH₃ | H | H | N(CH₃)₂ |
| x.230 | 4,6-dimethylpyridin-2-yl | CH₃ | H | H | N(CH₂CH₃)₂ |
| x.231 | 4,6-dimethylpyridin-2-yl | CH₃ | H | H | NHCH₂CH═CH₂ |
| x.232 | 4,6-dimethylpyridin-2-yl | CH₃ | H | H | NHCH₂-cyclopropyl |
| x.233 | 4,6-dimethylpyridin-2-yl | CH₃ | H | H | NHCOCH₃ |
| x.234 | 4,6-dimethylpyridin-2-yl | CH₃ | H | H | N(CH₃)COCH₃ |
| x.235 | 4,6-dimethylpyridin-2-yl | CH₃ | H | H | NHCOCH(CH₃)₂ |
| x.236 | 4,6-dimethylpyridin-2-yl | CH₃ | H | H | N(COCH₃)₂ |
| x.237 | 4,6-dimethylpyridin-2-yl | CH₃ | H | H | NHCOCHCl₂ |
| x.238 | 4,6-dimethylpyridin-2-yl | CH₃ | H | H | N(CH₃)COC(CH₃)₃ |
| x.239 | 4,6-dimethylpyridin-2-yl | CH₃ | H | H | phenyl |
| x.240 | 4,6-dimethylpyridin-2-yl | CH₃ | H | H | 2-CH₃-phenyl |
| x.241 | 4,6-dimethylpyridin-2-yl | CH₃ | H | H | 3-F-phenyl |
| x.242 | 4,6-dimethylpyridin-2-yl | CH₃ | H | H | 4-Cl-phenyl |
| x.243 | 4,6-dimethylpyridin-2-yl | CH₃ | H | H | 2,4-diCl-phenyl |
| x.244 | 4,6-dimethylpyridin-2-yl | CH₃ | H | H | 3-CN-phenyl |
| x.245 | 4,6-dimethylpyridin-2-yl | CH₃ | H | H | 3-OCH₃-phenyl |
| x.246 | 4,6-dimethylpyridin-2-yl | CH₃ | H | H | 4-OCH₃-phenyl |
| x.247 | 4,6-dimethylpyridin-2-yl | CH₃ | H | H | 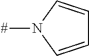 |
| x.248 | 4,6-dimethylpyridin-2-yl | CH₃ | H | H | 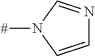 |
| x.249 | 4,6-dimethylpyridin-2-yl | CH₃ | H | H | 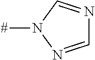 |
| x.250 | 4,6-dimethylpyridin-2-yl | CH₃ | H | H | 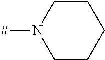 |
| x.251 | 4,6-dimethylpyridin-2-yl | CH₃ | H | CH₃ | H |
| x.252 | 4,6-dimethylpyridin-2-yl | CH₃ | H | CH₃ | CH₃ |
| x.253 | 4,6-dimethylpyridin-2-yl | CH₃ | H | CH₃ | CH₂CH₃ |
| x.254 | 4,6-dimethylpyridin-2-yl | CH₃ | H | CH₃ | CH₂CH(CH₃)₂ |
| x.255 | 4,6-dimethylpyridin-2-yl | CH₃ | H | CH₃ | CH(CH₃)₂ |
| x.256 | 4,6-dimethylpyridin-2-yl | CH₃ | H | CH₃ | C(CH₃)₃ |
| x.257 | 4,6-dimethylpyridin-2-yl | CH₃ | H | CH₃ | cyclopropyl |
| x.258 | 4,6-dimethylpyridin-2-yl | CH₃ | H | CH₃ | cyclohexyl |
| x.259 | 4,6-dimethylpyridin-2-yl | CH₃ | H | CH₃ | CH═CH(CH₃) |
| x.260 | 4,6-dimethylpyridin-2-yl | CH₃ | H | CH₃ | CF₃ |
| x.261 | 4,6-dimethylpyridin-2-yl | CH₃ | H | CH₃ | CON(CH₃)₂ |
| x.262 | 4,6-dimethylpyridin-2-yl | CH₃ | H | CH₃ | Br |
| x.263 | 4,6-dimethylpyridin-2-yl | CH₃ | H | CH₃ | CN |
| x.264 | 4,6-dimethylpyridin-2-yl | CH₃ | H | CH₃ | OH |
| x.265 | 4,6-dimethylpyridin-2-yl | CH₃ | H | CH₃ | OCH₃ |
| x.266 | 4,6-dimethylpyridin-2-yl | CH₃ | H | CH₃ | OCH₂CH₃ |
| x.267 | 4,6-dimethylpyridin-2-yl | CH₃ | H | CH₃ | OCH(CH₃)₂ |
| x.268 | 4,6-dimethylpyridin-2-yl | CH₃ | H | CH₃ | OCH₂CH₂CH₃ |
| x.269 | 4,6-dimethylpyridin-2-yl | CH₃ | H | CH₃ | OCH₂CH═CH₂ |
| x.270 | 4,6-dimethylpyridin-2-yl | CH₃ | H | CH₃ | OCH₂CH≡CH |
| x.271 | 4,6-dimethylpyridin-2-yl | CH₃ | H | CH₃ | CH₂OCH₃ |
| x.272 | 4,6-dimethylpyridin-2-yl | CH₃ | H | CH₃ | CH₂OCH₂CH═CH₂ |
| x.273 | 4,6-dimethylpyridin-2-yl | CH₃ | H | CH₃ | NH₂ |
| x.274 | 4,6-dimethylpyridin-2-yl | CH₃ | H | CH₃ | NH(CH₃) |
| x.275 | 4,6-dimethylpyridin-2-yl | CH₃ | H | CH₃ | N(CH₃)₂ |
| x.276 | 4,6-dimethylpyridin-2-yl | CH₃ | H | CH₃ | N(CH₂CH₃)₂ |
| x.277 | 4,6-dimethylpyridin-2-yl | CH₃ | H | CH₃ | NHCH₂CH═CH₂ |
| x.278 | 4,6-dimethylpyridin-2-yl | CH₃ | H | CH₃ | NHCH₂-cyclopropyl |
| x.279 | 4,6-dimethylpyridin-2-yl | CH₃ | H | CH₃ | NHCOCH₃ |
| x.280 | 4,6-dimethylpyridin-2-yl | CH₃ | H | CH₃ | N(CH₃)COCH₃ |
| x.281 | 4,6-dimethylpyridin-2-yl | CH₃ | H | CH₃ | NHCOCH(CH₃)₂ |
| x.282 | 4,6-dimethylpyridin-2-yl | CH₃ | H | CH₃ | N(COCH₃)₂ |
| x.283 | 4,6-dimethylpyridin-2-yl | CH₃ | H | CH₃ | NHCOCHCl₂ |
| x.284 | 4,6-dimethylpyridin-2-yl | CH₃ | H | CH₃ | N(CH₃)COC(CH₃)₃ |
| x.285 | 4,6-dimethylpyridin-2-yl | CH₃ | H | CH₃ | phenyl |
| x.286 | 4,6-dimethylpyridin-2-yl | CH₃ | H | CH₃ | 2-CH₃-phenyl |
| x.287 | 4,6-dimethylpyridin-2-yl | CH₃ | H | CH₃ | 3-F-phenyl |
| x.288 | 4,6-dimethylpyridin-2-yl | CH₃ | H | CH₃ | 4-Cl-phenyl |
| x.289 | 4,6-dimethylpyridin-2-yl | CH₃ | H | CH₃ | 2,4-diCl-phenyl |
| x.290 | 4,6-dimethylpyridin-2-yl | CH₃ | H | CH₃ | 3-CN-phenyl |
| x.291 | 4,6-dimethylpyridin-2-yl | CH₃ | H | CH₃ | 3-OCH₃-phenyl |
| x.292 | 4,6-dimethylpyridin-2-yl | CH₃ | H | CH₃ | 4-OCH₃-phenyl |
| x.293 | 4,6-dimethylpyridin-2-yl | CH₃ | H | CH₃ | 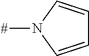 |
| x.294 | 4,6-dimethylpyridin-2-yl | CH₃ | H | CH₃ | 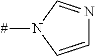 |
| x.295 | 4,6-dimethylpyridin-2-yl | CH₃ | H | CH₃ | 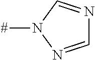 |
| x.296 | 4,6-dimethylpyridin-2-yl | CH₃ | H | CH₃ | 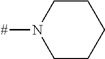 |
| x.297 | 4,6-dimethylpyridin-2-yl | CH₃ | CH₃ | H | H |
| x.298 | 4,6-dimethylpyridin-2-yl | CH₃ | CH₃ | H | CH₃ |
| x.299 | 4,6-dimethylpyridin-2-yl | CH₃ | CH₃ | H | CH₂CH₃ |
| x.300 | 4,6-dimethylpyridin-2-yl | CH₃ | CH₃ | H | CH₂CH(CH₃)₂ |
| x.301 | 4,6-dimethylpyridin-2-yl | CH₃ | CH₃ | H | CH(CH₃)₂ |
| x.302 | 4,6-dimethylpyridin-2-yl | CH₃ | CH₃ | H | C(CH₃)₃ |
| x.303 | 4,6-dimethylpyridin-2-yl | CH₃ | CH₃ | H | cyclopropyl |
| x.304 | 4,6-dimethylpyridin-2-yl | CH₃ | CH₃ | H | cyclohexyl |
| x.305 | 4,6-dimethylpyridin-2-yl | CH₃ | CH₃ | H | CH═CH(CH₃) |
| x.306 | 4,6-dimethylpyridin-2-yl | CH₃ | CH₃ | H | CF₃ |
| x.307 | 4,6-dimethylpyridin-2-yl | CH₃ | CH₃ | H | CON(CH₃)₂ |
| x.308 | 4,6-dimethylpyridin-2-yl | CH₃ | CH₃ | H | Br |
| x.309 | 4,6-dimethylpyridin-2-yl | CH₃ | CH₃ | H | CN |
| x.310 | 4,6-dimethylpyridin-2-yl | CH₃ | CH₃ | H | OH |
| x.311 | 4,6-dimethylpyridin-2-yl | CH₃ | CH₃ | H | OCH₃ |
| x.312 | 4,6-dimethylpyridin-2-yl | CH₃ | CH₃ | H | OCH₂CH₃ |
| x.313 | 4,6-dimethylpyridin-2-yl | CH₃ | CH₃ | H | OCH(CH₃)₂ |
| x.314 | 4,6-dimethylpyridin-2-yl | CH₃ | CH₃ | H | OCH₂CH₂CH₃ |
| x.315 | 4,6-dimethylpyridin-2-yl | CH₃ | CH₃ | H | OCH₂CH═CH₂ |
| x.316 | 4,6-dimethylpyridin-2-yl | CH₃ | CH₃ | H | OCH₂CH≡CH |
| x.317 | 4,6-dimethylpyridin-2-yl | CH₃ | CH₃ | H | CH₂OCH₃ |
| x.318 | 4,6-dimethylpyridin-2-yl | CH₃ | CH₃ | H | CH₂OCH₂CH═CH₂ |
| x.319 | 4,6-dimethylpyridin-2-yl | CH₃ | CH₃ | H | NH₂ |
| x.320 | 4,6-dimethylpyridin-2-yl | CH₃ | CH₃ | H | NH(CH₃) |
| x.321 | 4,6-dimethylpyridin-2-yl | CH₃ | CH₃ | H | N(CH₃)₂ |
| x.322 | 4,6-dimethylpyridin-2-yl | CH₃ | CH₃ | H | N(CH₂CH₃)₂ |
| x.323 | 4,6-dimethylpyridin-2-yl | CH₃ | CH₃ | H | NHCH₂CH═CH₂ |
| x.324 | 4,6-dimethylpyridin-2-yl | CH₃ | CH₃ | H | NHCH₂-cyclopropyl |
| x.325 | 4,6-dimethylpyridin-2-yl | CH₃ | CH₃ | H | NHCOCH₃ |
| x.326 | 4,6-dimethylpyridin-2-yl | CH₃ | CH₃ | H | N(CH₃)COCH₃ |
| x.327 | 4,6-dimethylpyridin-2-yl | CH₃ | CH₃ | H | NHCOCH(CH₃)₂ |
| x.328 | 4,6-dimethylpyridin-2-yl | CH₃ | CH₃ | H | N(COCH₃)₂ |
| x.329 | 4,6-dimethylpyridin-2-yl | CH₃ | CH₃ | H | NHCOCHCl₂ |
| x.330 | 4,6-dimethylpyridin-2-yl | CH₃ | CH₃ | H | N(CH₃)COC(CH₃)₃ |
| x.331 | 4,6-dimethylpyridin-2-yl | CH₃ | CH₃ | H | phenyl |
| x.332 | 4,6-dimethylpyridin-2-yl | CH₃ | CH₃ | H | 2-CH₃-phenyl |
| x.333 | 4,6-dimethylpyridin-2-yl | CH₃ | CH₃ | H | 3-F-phenyl |
| x.334 | 4,6-dimethylpyridin-2-yl | CH₃ | CH₃ | H | 4-Cl-phenyl |
| x.335 | 4,6-dimethylpyridin-2-yl | CH₃ | CH₃ | H | 2,4-diCl-phenyl |
| x.336 | 4,6-dimethylpyridin-2-yl | CH₃ | CH₃ | H | 3-CN-phenyl |
| x.337 | 4,6-dimethylpyridin-2-yl | CH₃ | CH₃ | H | 3-OCH₃-phenyl |
| x.338 | 4,6-dimethylpyridin-2-yl | CH₃ | CH₃ | H | 4-OCH₃-phenyl |
| x.339 | 4,6-dimethylpyridin-2-yl | CH₃ | CH₃ | H | 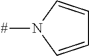 |
| x.340 | 4,6-dimethylpyridin-2-yl | CH₃ | CH₃ | H | 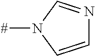 |
| x.341 | 4,6-dimethylpyridin-2-yl | CH₃ | CH₃ | H | 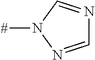 |
| x.342 | 4,6-dimethylpyridin-2-yl | CH₃ | CH₃ | C | 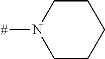 |
| x.343 | 4,6-dimethylpyridin-2-yl | CH₃ | H | OCH₃ | H |
| x.344 | 4,6-dimethylpyridin-2-yl | CH₃ | H | OCH₃ | CH₃ |
| x.345 | 4,6-dimethylpyridin-2-yl | CH₃ | H | OCH₃ | CH₂CH₃ |
| x.346 | 4,6-dimethylpyridin-2-yl | CH₃ | H | OCH₃ | cyclopropyl |
| x.347 | 4,6-dimethylpyridin-2-yl | CH₃ | H | OCH₃ | CF₃ |
| x.348 | 4,6-dimethylpyridin-2-yl | CH₃ | H | OCH₃ | phenyl |
| x.349 | 4,6-dimethylpyridin-2-yl | CH₃ | H | OCH₃ | OH |
| x.350 | 4,6-dimethylpyridin-2-yl | CH₃ | H | OCH₃ | OCH₃ |
| x.351 | 4,6-dimethylpyridin-2-yl | CH₃ | H | OCH₃ | NH(CH₃) |
| x.352 | 4,6-dimethylpyridin-2-yl | CH₃ | H | OCH₃ | N(CH₃)₂ |
| x.353 | 4,6-dimethylpyridin-2-yl | CH₃ | OCH₃ | H | H |
| x.354 | 4,6-dimethylpyridin-2-yl | CH₃ | OCH₃ | H | CH₃ |
| x.355 | 4,6-dimethylpyridin-2-yl | CH₃ | OCH₃ | H | CH₂CH₃ |
| x.356 | 4,6-dimethylpyridin-2-yl | CH₃ | OCH₃ | H | cyclopropyl |
| x.357 | 4,6-dimethylpyridin-2-yl | CH₃ | OCH₃ | H | CF₃ |
| x.358 | 4,6-dimethylpyridin-2-yl | CH₃ | OCH₃ | H | phenyl |
| x.359 | 4,6-dimethylpyridin-2-yl | CH₃ | OCH₃ | H | OH |
| x.360 | 4,6-dimethylpyridin-2-yl | CH₃ | OCH₃ | H | OCH₃ |
| x.361 | 4,6-dimethylpyridin-2-yl | CH₃ | OCH₃ | H | NH(CH₃) |
| x.362 | 4,6-dimethylpyridin-2-yl | CH₃ | OCH₃ | H | N(CH₃)₂ |
| x.363 | 4,6-dimethylpyridin-2-yl | CH₃ | CH₃ | CH₃ | H |
| x.364 | 4,6-dimethylpyridin-2-yl | CH₃ | CH₃ | CH₃ | CH₃ |
| x.365 | 4,6-dimethylpyridin-2-yl | CH₃ | CH₃ | CH₃ | CH₂CH₃ |
| x.366 | 4,6-dimethylpyridin-2-yl | CH₃ | CH₃ | CH₃ | cyclopropyl |
| x.367 | 4,6-dimethylpyridin-2-yl | CH₃ | CH₃ | CH₃ | CF₃ |
| x.368 | 4,6-dimethylpyridin-2-yl | CH₃ | CH₃ | CH₃ | phenyl |
| x.369 | 4,6-dimethylpyridin-2-yl | CH₃ | CH₃ | CH₃ | OH |
| x.370 | 4,6-dimethylpyridin-2-yl | CH₃ | CH₃ | CH₃ | OCH₃ |
| x.371 | 4,6-dimethylpyridin-2-yl | CH₃ | CH₃ | CH₃ | NH(CH₃) |
| x.372 | 4,6-dimethylpyridin-2-yl | CH₃ | CH₃ | CH₃ | N(CH₃)₂ |
| x.373 | 4,6-dimethylpyridin-2-yl | CH₃ | N(CH₃)₂ | H | H |
| x.374 | 4,6-dimethylpyridin-2-yl | CH₃ | N(CH₃)₂ | H | CH₃ |
| x.375 | 4,6-dimethylpyridin-2-yl | CH₃ | N(CH₃)₂ | H | CH₂CH₃ |
| x.376 | 4,6-dimethylpyridin-2-yl | CH₃ | N(CH₃)₂ | H | cyclopropyl |
| x.377 | 4,6-dimethylpyridin-2-yl | CH₃ | N(CH₃)₂ | H | CF₃ |
| x.378 | 4,6-dimethylpyridin-2-yl | CH₃ | N(CH₃)₂ | H | phenyl |
| x.379 | 4,6-dimethylpyridin-2-yl | CH₃ | N(CH₃)₂ | H | OH |
| x.380 | 4,6-dimethylpyridin-2-yl | CH₃ | N(CH₃)₂ | H | OCH₃ |
| x.381 | 4,6-dimethylpyridin-2-yl | CH₃ | H | N(CH₃)₂ | H |
| x.382 | 4,6-dimethylpyridin-2-yl | CH₃ | H | N(CH₃)₂ | CH₃ |
| x.383 | 4,6-dimethylpyridin-2-yl | CH₃ | H | N(CH₃)₂ | CH₂CH₃ |
| x.384 | 4,6-dimethylpyridin-2-yl | CH₃ | H | N(CH₃)₂ | cyclopropyl |
| x.385 | 4,6-dimethylpyridin-2-yl | CH₃ | H | N(CH₃)₂ | CF₃ |
| x.386 | 4,6-dimethylpyridin-2-yl | CH₃ | H | N(CH₃)₂ | phenyl |
| x.387 | 4,6-dimethylpyridin-2-yl | CH₃ | H | N(CH₃)₂ | OH |
| x.388 | 4,6-dimethylpyridin-2-yl | CH₃ | H | N(CH₃)₂ | OCH₃ |
| x.389 | 4,6-dimethylpyridin-2-yl | CH₃ | OH | H | H |
| x.390 | 4,6-dimethylpyridin-2-yl | CH₃ | OCH₂CH₃ | H | H |
| x.391 | 4,6-dimethylpyridin-2-yl | CH₃ | OCH(CH₃)₂ | H | H |
| x.392 | 4,6-dimethylpyridin-2-yl | CH₃ | OCH₂CH₂CH₃ | H | H |
| x.393 | 4,6-dimethylpyridin-2-yl | CH₃ | OCH₂CH═CH₂ | H | H |
| x.394 | 4,6-dimethylpyridin-2-yl | CH₃ | OCH₂CH≡CH | H | H |
| x.395 | 4,6-dimethylpyridin-2-yl | CH₃ | H | OH | H |
| x.396 | 4,6-dimethylpyridin-2-yl | CH₃ | H | OCH₂CH₃ | H |
| x.397 | 4,6-dimethylpyridin-2-yl | CH₃ | H | OCH(CH₃)₂ | H |
| x.398 | 4,6-dimethylpyridin-2-yl | CH₃ | H | OCH₂CH₂CH₃ | H |
| x.399 | 4,6-dimethylpyridin-2-yl | CH₃ | H | OCH₂CH═CH₂ | H |
| x.400 | 4,6-dimethylpyridin-2-yl | CH₃ | H | OCH₂CH≡CH | H |
| x.401 | 6-methyl-4- | CH₃ | H | H | H |
| | isopropoxypyridin-2-yl | | | | |
| x.402 | 6-methyl-4- | CH₃ | H | H | OCH₃ |
| | isopropoxypyridin-2-yl | | | | |
| x.403 | 6-methyl-4- | CH₃ | H | OCH₃ | H |
| | isopropoxypyridin-2-yl | | | | |
| x.404 | 6-methyl-4- | CH₃ | OCH₃ | H | H |
| | isopropoxypyridin-2-yl | | | | |
| x.405 | 6-methyl-4- | CH₃ | H | H | CH₃ |
| | isopropoxypyridin-2-yl | | | | |
| x.406 | 6-methyl-4- | CH₃ | H | CH₃ | H |
| | isopropoxypyridin-2-yl | | | | |
| x.407 | 6-methyl-4- | CH₃ | CH₃ | H | H |
| | isopropoxypyridin-2-yl | | | | |
| x.408 | 6-methyl-4- | CH₃ | H | H | N(CH₃)₂ |
| | isopropoxypyridin-2-yl | | | | |
| x.409 | 6-methyl-4- | CH₃ | H | N(CH₃)₂ | H |
| | isopropoxypyridin-2-yl | | | | |
| x.410 | 6-methyl-4- | CH₃ | N(CH₃)₂ | H | H |
| | isopropoxypyridin-2-yl | | | | |
| x.411 | 6-methyl-4- | CH₃ | H | H | H |
| | cyclopropylpyridin-2-yl | | | | |
| x.412 | 6-methyl-4- | CH₃ | H | H | OCH₃ |
| | cyclopropylpyridin-2-yl | | | | |
| x.413 | 6-methyl-4- | CH₃ | H | OCH₃ | H |
| | cyclopropylpyridin-2-yl | | | | |
| x.414 | 6-methyl-4- | CH₃ | OCH₃ | H | H |
| | cyclopropylpyridin-2-yl | | | | |
| x.415 | 6-methyl-4- | CH₃ | H | H | CH₃ |
| | cyclopropylpyridin-2-yl | | | | |
| x.416 | 6-methyl-4- | CH₃ | H | CH₃ | H |
| | cyclopropylpyridin-2-yl | | | | |
| x.417 | 6-methyl-4- | CH₃ | CH₃ | H | H |
| | cyclopropylpyridin-2-yl | | | | |
| x.418 | 6-methyl-4- | CH₃ | H | H | N(CH₃)₂ |
| | cyclopropylpyridin-2-yl | | | | |
| x.419 | 6-methyl-4- | CH₃ | H | N(CH₃)₂ | H |
| | cyclopropylpyridin-2-yl | | | | |
| x.420 | 6-methyl-4- | CH₃ | N(CH₃)₂ | H | H |
| | cyclopropylpyridin-2-yl | | | | |
| x.421 | 6-methoxy-pyridin-2-yl | CH₃ | H | H | H |
| x.422 | 6-methoxy-pyridin-2-yl | CH₃ | H | H | OCH₃ |
| x.423 | 6-methoxy-pyridin-2-yl | CH₃ | H | OCH₃ | H |
| x.424 | 6-methoxy-pyridin-2-yl | CH₃ | OCH₃ | H | H |
| x.425 | 6-methoxy-pyridin-2-yl | CH₃ | H | H | CH₃ |
| x.426 | 6-methoxy-pyridin-2-yl | CH₃ | H | CH₃ | H |
| x.427 | 6-methoxy-pyridin-2-yl | CH₃ | CH₃ | H | H |
| x.428 | 6-methoxy-pyridin-2-yl | CH₃ | H | H | N(CH₃)₂ |
| x.429 | 6-methoxy-pyridin-2-yl | CH₃ | H | N(CH₃)₂ | H |
| x.430 | 6-methoxy-pyridin-2-yl | CH₃ | N(CH₃)₂ | H | H |
| x.431 | 6-methoxy-4- | CH₃ | H | H | H |
| | methylpyridin-2-yl | | | | |
| x.432 | 6-methoxy-4- | CH₃ | H | H | OCH₃ |
| | methylpyridin-2-yl | | | | |
| x.433 | 6-methoxy-4- | CH₃ | H | OCH₃ | H |
| | methylpyridin-2-yl | | | | |
| x.434 | 6-methoxy-4- | CH₃ | OCH₃ | H | H |
| | methylpyridin-2-yl | | | | |
| x.435 | 6-methoxy-4- | CH₃ | H | H | CH₃ |
| | methylpyridin-2-yl | | | | |
| x.436 | 6-methoxy-4- | CH₃ | H | CH₃ | H |
| | methylpyridin-2-yl | | | | |
| x.437 | 6-methoxy-4- | CH₃ | CH₃ | H | H |
| | methylpyridin-2-yl | | | | |
| x.438 | 6-methoxy-4- | CH₃ | H | H | N(CH₃)₂ |
| | methylpyridin-2-yl | | | | |
| x.439 | 6-methoxy-4- | CH₃ | H | N(CH₃)₂ | H |
| | methylpyridin-2-yl | | | | |
| x.440 | 6-methoxy-4- | CH₃ | N(CH₃)₂ | H | H |
| | methylpyridin-2-yl | | | | |
| x.441 | 6-methyl-4- | CH₃ | H | H | H |
| | dimethylaminopyridin-2- | | | | |
| | yl | | | | |
| x.442 | 6-methyl-4- | CH₃ | H | H | OCH₃ |
| | dimethylaminopyridin-2- | | | | |
| | yl | | | | |
| x.443 | 6-methyl-4- | CH₃ | H | OCH₃ | H |
| | dimethylaminopyridin-2- | | | | |
| | yl | | | | |
| x.444 | 6-methyl-4- | CH₃ | OCH₃ | H | H |
| | dimethylaminopyridin-2- | | | | |
| | yl | | | | |
| x.445 | 6-methyl-4- | CH₃ | H | H | CH₃ |
| | dimethylaminopyridin-2- | | | | |
| | yl | | | | |
| x.446 | 6-methyl-4- | CH₃ | H | CH₃ | H |
| | dimethylaminopyridin-2- | | | | |
| | yl | | | | |
| x.447 | 6-methyl-4- | CH₃ | CH₃ | H | H |
| | dimethylaminopyridin-2- | | | | |
| | yl | | | | |
| x.448 | 6-methyl-4- | CH₃ | H | H | N(CH₃)₂ |
| | dimethylaminopyridin-2- | | | | |
| | yl | | | | |
| x.449 | 6-methyl-4- | CH₃ | H | N(CH₃)₂ | H |
| | dimethylaminopyridin-2- | | | | |
| | yl | | | | |
| x.450 | 6-methyl-4- | CH₃ | N(CH₃)₂ | H | H |
| | dimethylaminopyridin-2- | | | | |
| | yl | | | | |
| x.451 | 6-methyl-5- | CH₃ | H | H | H |
| | methoxypyridin-2-yl | | | | |
| x.452 | 6-methyl-5- | CH₃ | H | H | OCH₃ |
| | methoxypyridin-2-yl | | | | |
| x.453 | 6-methyl-5- | CH₃ | H | OCH₃ | H |
| | methoxypyridin-2-yl | | | | |
| x.454 | 6-methyl-5- | CH₃ | OCH₃ | H | H |
| | methoxypyridin-2-yl | | | | |
| x.455 | 6-methyl-5- | CH₃ | H | H | CH₃ |
| | methoxypyridin-2-yl | | | | |
| x.456 | 6-methyl-5- | CH₃ | H | CH₃ | H |
| | methoxypyridin-2-yl | | | | |
| x.457 | 6-methyl-5- | CH₃ | CH₃ | H | H |
| | methoxypyridin-2-yl | | | | |
| x.458 | 6-methyl-5- | CH₃ | H | H | N(CH₃)₂ |
| | methoxypyridin-2-yl | | | | |
| x.459 | 6-methyl-5- | CH₃ | H | N(CH₃)₂ | H |
| | methoxypyridin-2-yl | | | | |
| x.460 | 6-methyl-5- | CH₃ | N(CH₃)₂ | H | H |
| | methoxypyridin-2-yl | | | | |
| x.461 | 6-methoxy-5- | CH₃ | H | H | H |
| | methylpyridin-2-yl | | | | |
| x.462 | 6-methoxy-5- | CH₃ | H | H | OCH₃ |
| | methylpyridin-2-yl | | | | |
| x.463 | 6-methoxy-5- | CH₃ | H | OCH₃ | H |
| | methylpyridin-2-yl | | | | |
| x.464 | 6-methoxy-5- | CH₃ | OCH₃ | H | H |
| | methylpyridin-2-yl | | | | |
| x.465 | 6-methoxy-5- | CH₃ | H | H | CH₃ |
| | methylpyridin-2-yl | | | | |
| x.466 | 6-methoxy-5- | CH₃ | H | CH₃ | H |
| | methylpyridin-2-yl | | | | |
| x.467 | 6-methoxy-5- | CH₃ | CH₃ | H | H |
| | methylpyridin-2-yl | | | | |
| x.468 | 6-methoxy-5- | CH₃ | H | H | N(CH₃)₂ |
| | methylpyridin-2-yl | | | | |
| x.469 | 6-methoxy-5- | CH₃ | H | N(CH₃)₂ | H |
| | methylpyridin-2-yl | | | | |
| x.470 | 6-methoxy-5- | CH₃ | N(CH₃)₂ | H | H |
| | methylpyridin-2-yl | | | | |
| x.471 | 6-methylpyridin-2-yl | CH₂CH₃ | H | H | H |
| x.472 | 6-methylpyridin-2-yl | CH₂CH₃ | H | H | OCH₃ |
| x.473 | 6-methylpyridin-2-yl | CH₂CH₃ | H | OCH₃ | H |
| x.474 | 6-methylpyridin-2-yl | CH₂CH₃ | OCH₃ | H | H |
| x.475 | 6-methylpyridin-2-yl | CH₂CH₃ | H | H | CH₃ |
| x.476 | 6-methylpyridin-2-yl | CH₂CH₃ | H | CH₃ | H |
| x.477 | 6-methylpyridin-2-yl | CH₂CH₃ | CH₃ | H | H |
| x.478 | 6-methylpyridin-2-yl | CH₂CH₃ | H | H | N(CH₃)₂ |
| x.479 | 6-methylpyridin-2-yl | CH₂CH₃ | H | N(CH₃)₂ | H |
| x.480 | 6-methylpyridin-2-yl | CH₂CH₃ | N(CH₃)₂ | H | H |
| x.481 | 4,6-dimethylpyridin-2-yl | CH₂CH₃ | H | H | H |
| x.482 | 4,6-dimethylpyridin-2-yl | CH₂CH₃ | H | H | OCH₃ |
| x.483 | 4,6-dimethylpyridin-2-yl | CH₂CH₃ | H | OCH₃ | H |
| x.484 | 4,6-dimethylpyridin-2-yl | CH₂CH₃ | OCH₃ | H | H |
| x.485 | 4,6-dimethylpyridin-2-yl | CH₂CH₃ | H | H | CH₃ |
| x.486 | 4,6-dimethylpyridin-2-yl | CH₂CH₃ | H | CH₃ | H |
| x.487 | 4,6-dimethylpyridin-2-yl | CH₂CH₃ | CH₃ | H | H |
| x.488 | 4,6-dimethylpyridin-2-yl | CH₂CH₃ | H | H | N(CH₃)₂ |
| x.489 | 4,6-dimethylpyridin-2-yl | CH₂CH₃ | H | N(CH₃)₂ | H |
| x.490 | 4,6-dimethylpyridin-2-yl | CH₂CH₃ | N(CH₃)₂ | H | H |
| x.491 | 6-methyl-4- | CH₂CH₃ | H | H | H |
| | isopropoxypyridin-2-yl | | | | |
| x.492 | 6-methyl-4- | CH₂CH₃ | H | H | OCH₃ |
| | isopropoxypyridin-2-yl | | | | |
| x.493 | 6-methyl-4- | CH₂CH₃ | H | OCH₃ | H |
| | isopropoxypyridin-2-yl | | | | |
| x.494 | 6-methyl-4- | CH₂CH₃ | OCH₃ | H | H |
| | isopropoxypyridin-2-yl | | | | |
| x.495 | 6-methyl-4- | CH₂CH₃ | H | H | CH₃ |
| | isopropoxypyridin-2-yl | | | | |
| x.496 | 6-methyl-4- | CH₂CH₃ | H | CH₃ | H |
| | isopropoxypyridin-2-yl | | | | |
| x.497 | 6-methyl-4- | CH₂CH₃ | CH₃ | H | H |
| | isopropoxypyridin-2-yl | | | | |
| x.498 | 6-methyl-4- | CH₂CH₃ | H | H | N(CH₃)₂ |
| | isopropoxypyridin-2-yl | | | | |
| x.499 | 6-methyl-4- | CH₂CH₃ | H | N(CH₃)₂ | H |
| | isopropoxypyridin-2-yl | | | | |
| x.500 | 6-methyl-4- | CH₂CH₃ | N(CH₃)₂ | H | H |
| | isopropoxypyridin-2-yl | | | | |
| x.501 | 6-methoxy-4- | CH₂CH₃ | H | H | H |
| | methylpyridin-2-yl | | | | |
| x.502 | 6-methoxy-4- | CH₂CH₃ | H | H | OCH₃ |
| | methylpyridin-2-yl | | | | |
| x.503 | 6-methoxy-4- | CH₂CH₃ | H | OCH₃ | H |
| | methylpyridin-2-yl | | | | |
| x.504 | 6-methoxy-4- | CH₂CH₃ | OCH₃ | H | H |
| | methylpyridin-2-yl | | | | |
| x.505 | 6-methoxy-4- | CH₂CH₃ | H | H | CH₃ |
| | methylpyridin-2-yl | | | | |
| x.506 | 6-methoxy-4- | CH₂CH₃ | H | CH₃ | H |
| | methylpyridin-2-yl | | | | |
| x.507 | 6-methoxy-4- | CH₂CH₃ | CH₃ | H | H |
| | methylpyridin-2-yl | | | | |
| x.508 | 6-methoxy-4- | CH₂CH₃ | H | H | N(CH₃)₂ |
| | methylpyridin-2-yl | | | | |
| x.509 | 6-methoxy-4- | CH₂CH₃ | H | N(CH₃)₂ | H |
| | methylpyridin-2-yl | | | | |
| x.510 | 6-methoxy-4- | CH₂CH₃ | N(CH₃)₂ | H | H |
| | methylpyridin-2-yl | | | | |
| x.511 | 6-methoxypyridin-2-yl | CH₂CH₃ | H | H | H |
| x.512 | 6-methoxypyridin-2-yl | CH₂CH₃ | H | H | OCH₃ |
| x.513 | 6-methoxypyridin-2-yl | CH₂CH₃ | H | OCH₃ | H |
| x.514 | 6-methoxypyridin-2-yl | CH₂CH₃ | OCH₃ | H | H |
| x.515 | 6-methoxypyridin-2-yl | CH₂CH₃ | H | H | CH₃ |
| x.516 | 6-methoxypyridin-2-yl | CH₂CH₃ | H | CH₃ | H |
| x.517 | 6-methoxypyridin-2-yl | CH₂CH₃ | CH₃ | H | H |
| x.518 | 6-methoxypyridin-2-yl | CH₂CH₃ | H | H | N(CH₃)₂ |
| x.519 | 6-methoxypyridin-2-yl | CH₂CH₃ | H | N(CH₃)₂ | H |
| x.520 | 6-methoxypyridin-2-yl | CH₂CH₃ | N(CH₃)₂ | H | H |
| x.521 | 4,6-dimethylpyridin-2-yl | phenyl | H | H | H |
| x.522 | 4,6-dimethylpyridin-2-yl | phenyl | H | H | OCH₃ |
| x.523 | 4,6-dimethylpyridin-2-yl | phenyl | H | OCH₃ | H |
| x.524 | 4,6-dimethylpyridin-2-yl | phenyl | OCH₃ | H | H |
| x.525 | 4,6-dimethylpyridin-2-yl | phenyl | H | H | CH₃ |
| x.526 | 4,6-dimethylpyridin-2-yl | phenyl | H | CH₃ | H |
| x.527 | 4,6-dimethylpyridin-2-yl | phenyl | CH₃ | H | H |
| x.528 | 4,6-dimethylpyridin-2-yl | phenyl | H | H | N(CH₃)₂ |
| x.529 | 4,6-dimethylpyridin-2-yl | phenyl | H | N(CH₃)₂ | H |
| x.530 | 4,6-dimethylpyridin-2-yl | phenyl | N(CH₃)₂ | H | H |
| x.531 | 6-methylpyridin-2-yl | 6-methyl- | H | H | H |
| | | pyridin-2-yl | | | |
| x.532 | 6-methylpyridin-2-yl | 6-methyl- | H | H | OCH₃ |
| | | pyridin-2-yl | | | |
| x.533 | 6-methylpyridin-2-yl | 6-methyl- | H | OCH₃ | H |
| | | pyridin-2-yl | | | |
| x.534 | 6-methylpyridin-2-yl | 6-methyl- | OCH₃ | H | H |
| | | pyridin-2-yl | | | |
| x.535 | 6-methylpyridin-2-yl | 6-methyl- | H | H | CH₃ |
| | | pyridin-2-yl | | | |
| x.536 | 6-methylpyridin-2-yl | 6-methyl- | H | CH₃ | H |
| | | pyridin-2-yl | | | |
| x.537 | 6-methyl-pyridin-2-yl | 6-methyl- | CH₃ | H | H |
| | | pyridin-2-yl | | | |
| x.538 | 6-methylpyridin-2-yl | 6-methyl- | H | H | N(CH₃)₂ |
| | | pyridin-2-yl | | | |
| x.539 | 6-methylpyridin-2-yl | 6-methyl- | H | N(CH₃)₂ | H |
| | | pyridin-2-yl | | | |
| x.540 | 6-methylpyridin-2-yl | 6-methyl- | N(CH₃)₂ | H | H |
| | | pyridin-2-yl | | | |
| x.541 | quinolin-2-yl | CH₃ | H | H | H |
| x.542 | 6-bromopyridin-2-yl | CH₃ | H | H | H |
| x.543 | 6-fluoro-5-chloropyridin- | CH₃ | H | H | H |
| | 2-yl | | | | |
| x.544 | 6-methyl-3- | H | H | H | H |
| | hydroxypyridin-2-yl | | | | |
| x.545 | Pyridin-2-yl | 4-chloro- | H | H | H |
| | | phenyl | | | |
| x.546 | 4-cyanopyridin-2-yl | CH₃ | H | H | H |
| x.547 | 6-methylpyridin-2-yl | H | H | H | H |
| x.548 | 6-phenoxypyridin-2-yl | H | H | H | H |
| x.549 | 6-benzyloxypyridin-2-yl | H | H | H | H |
| x.550 | 5-chloro-3-fluoropyridin- | H | H | H | H |
| | 2-yl | | | | |
| x.551 | 3-chloro-5- | CH₃ | H | H | H |
| | trifluoromethyl-pyridin- | | | | |
| | 2-yl | | | | |
| x.552 | 5-chloro-3-fluoropyridin- | CH(Cl)CH₃ | H | H | H |
| | 2-yl | | | | |
| x.553 | 6-(2- | CH₃ | H | H | H |
| | chlorophenyl)pyridin-2- | | | | |
| | yl | | | | |
| x.554 | 4-(tert- | CH₃ | H | H | H |
| | butylphenyl)pyridin-2-yl | | | | |
| x.555 | 3-methoxycarbonyl-6- | CH₃ | H | H | H |
| | trifluoromethyl-pyridin- | | | | |
| | 2-yl | | | | |
| x.556 | 6-ethoxycarbonyl-4- | CH₃ | H | H | H |
| | methyl-pyridin-2-yl | | | | |
| x.557 | 6-bromopyridin-2-yl | 2-methyl- | H | H | H |
| | | phenyl | | | |
| x.558 | 3-allyloxy-6- | H | H | H | H |
| | methylpyridin-2-yl | | | | |
| x.559 | 6-cyanopyridin-2-yl | CH₃ | H | H | H |
| x.560 | 3-chloro-5- | Pyridin-2-yl | H | H | H |
| | trifluoromethyl-pyridin- | | | | |
| | 2-yl | | | | |
| x.561 | Pyridin-2-yl | Pyridin-2-yl | H | H | H |
| x.562 | Pyridin-2-yl | Phenyl | H | H | H |
| x.563 | Pyridin-2-yl | CH₂CH₃ | H | H | H |

TABLE 1
This table disclosescompounds 1.001 to 1.563 of the formula (I-I)

| | |
|---|---|
| 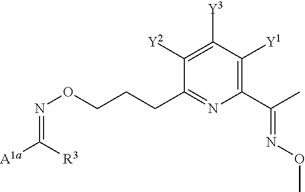 | (I-I) |

wherein A^{1a}, R³, Y¹, Y² and Y³ have the specific meanings given in Table X.

TABLE 2
This table discloses compounds 2.001 to 2.563 of the formula (I-II)

| | |
|---|---|
| 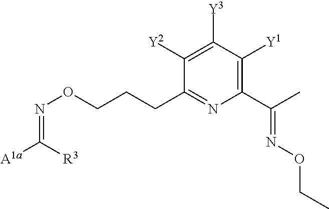 | (I-II) |

wherein A^{1a}, R³, Y¹, Y² and Y³ have the specific meanings given in Table X.

TABLE 3
This table discloses compounds 3.001 to 3.563 of the formula (I-III)

| | |
|---|---|
| 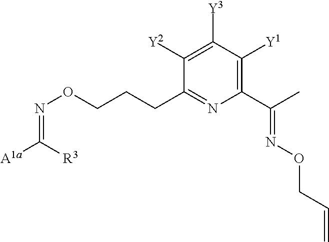 | (I-III) |

wherein A^{1a}, R³, Y¹, Y² and Y³ have the specific meanings given in Table X.

TABLE 4
This table discloses compounds 4.001 to 4.563 of the formula (I-IV)

| | |
|---|---|
| 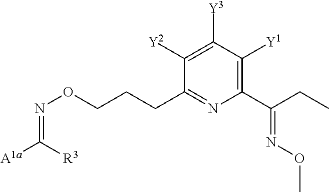 | (I-IV) |

wherein A^{1a}, R³, Y¹, Y² and Y³ have the specific meanings given in Table X.

TABLE 5
This table discloses compounds 5.001 to 5.563 of the formula (I-V)

| | |
|---|---|
| 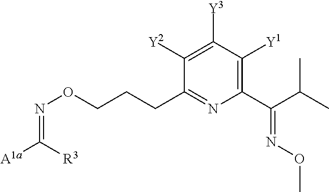 | (I-V) |

wherein A^{1a}, R³, Y¹, Y² and Y³ have the specific meanings given in Table X.

TABLE 6
This table discloses compounds 6.001 to 6.563 of the formula (I-VI)

| | |
|---|---|
| 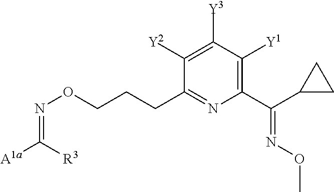 | (I-VI) |

wherein A^{1a}, R³, Y¹, Y² and Y³ have the specific meanings given in Table X.

TABLE 7
This table discloses compounds 7.001 to 7.563 of the formula (I-VII)

| | |
|---|---|
| 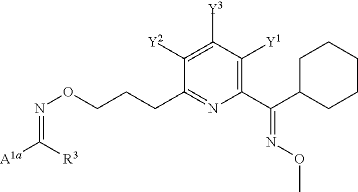 | (I-VII) |

wherein A^{1a}, R³, Y¹, Y² and Y³ have the specific meanings given in Table X.

TABLE 8
This table discloses compounds 8.001 to 8.563 of the formula (I-VIII)

| | |
|---|---|
| 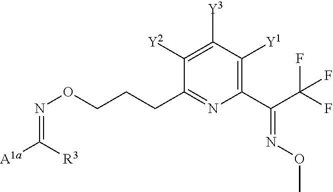 | (I-VIII) |

wherein A^{1a}, R³, Y¹, Y² and Y³ have the specific meanings given in Table X.

TABLE 9
This table discloses compounds 9.001 to 9.563 of the formula (I-IX)

| | |
|---|---|
| 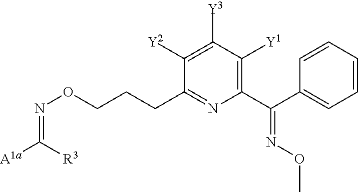 | (I-IX) |

wherein A^{1a}, R³, Y¹, Y² and Y³ have the specific meanings given in Table X.

TABLE 10
This table discloses compounds 10.001 to 10.563 of the formula (I-X)

| | |
|---|---|
| 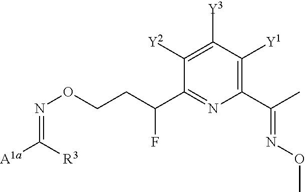 | (I-X) |

wherein A^{1a}, R³, Y¹, Y² and Y³ have the specific meanings given in Table X.

TABLE 11
This table discloses compounds 11.001 to 11.563 of the formula (I-XI)

| | |
|---|---|
| 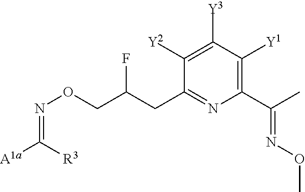 | (I-XI) |

wherein A^{1a}, R³, Y¹, Y² and Y³ have the specific meanings given in Table X.

TABLE 12
This table discloses compounds 12.001 to 12.563 of the formula (I-XII)

| | |
|---|---|
| 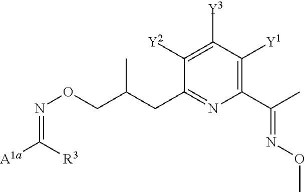 | (I-XII) |

wherein A^{1a}, R³, Y¹, Y² and Y³ have the specific meanings given in Table X.

TABLE 13
This table discloses 13.001 to 13.563 of the formula (I-XIII)

| | |
|---|---|
| 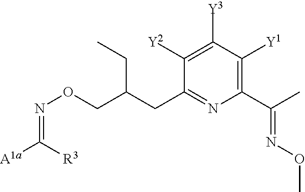 | (I-XIII) |

wherein A^{1a}, R³, Y¹, Y² and Y³ have the specific meanings given in Table X.

TABLE 14
This table discloses compounds 14.001 to 14.563 of the formula (I-XIV)

| | |
|---|---|
| 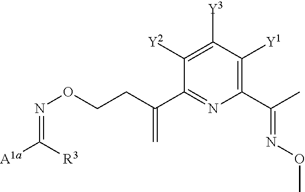 | (I-XIV) |

wherein A^{1a}, R³, Y¹, Y² and Y³ have the specific meanings given in Table X.

TABLE 15
This table discloses compounds 15.001 to 15.563 of the formula (I-XV)

| | |
|---|---|
| 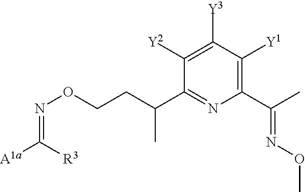 | (I-XV) |

wherein A^{1a}, R³, Y¹, Y² and Y³ have the specific meanings given in Table X.

Table Y represents Table 16 (when Y is 16), Table 17 (when Y is 17), Table 18 (when Y is 18), Table 19 (when Y is 19), Table 20 (when Y is 20), Table 21 (when Y is 21), Table 22 (when Y is 22), Table 23 (when Y is 23), Table 24 (when Y is 24), Table 25 (when Y is 25), Table 26 (when Y is 26), Table 27 (when Y is 27), Table 28 (when Y is 28), Table 29 (when Y is 29), Table 30 (when Y is 30), and Table 31 (when Y is 31).

TABLE Y

| | Y¹ | Y² | Y³ | R⁵ | R⁶ | R⁴ |
|---|---|---|---|---|---|---|
| y.001 | H | H | CH₃ | H | H | H |
| y.002 | H | H | CH₂CH₃ | H | H | H |
| y.003 | H | H | OCH₃ | H | H | H |
| y.004 | H | H | OCH₂C≡CH | H | H | H |
| y.005 | H | H | N(CH₃)₂ | H | H | H |
| y.006 | H | CH₃ | CH₃ | H | H | H |
| y.007 | CH₃ | H | CH₃ | H | H | H |
| y.008 | H | CH₃ | OCH₃ | H | H | H |
| y.009 | CH₃ | H | OCH₃ | H | H | H |
| y.010 | H | H | H | H | H | H |
| y.011 | H | H | H | CH₃ | H | H |
| y.012 | H | H | H | CH₂CH₃ | H | H |
| y.013 | H | H | H | CH(CH₃)₂ | H | H |
| y.014 | H | H | H | C(CH₃)₃ | H | H |
| y.015 | H | H | H | cyclopropyl | H | H |
| y.016 | H | H | H | cyclohexyl | H | H |
| y.017 | H | H | H | CF₃ | H | H |
| y.018 | H | H | H | CHF₂ | H | H |
| y.019 | H | H | H | CH₂F | H | H |
| y.020 | H | H | H | CCl₃ | H | H |
| y.021 | H | H | H | CHCl₂ | H | H |
| y.022 | H | H | H | CH₂CN | H | H |
| y.023 | H | H | H | CH₂OCH₃ | H | H |
| y.024 | H | H | H | CH₂SCH₃ | H | H |
| y.025 | H | H | H | CH₂SO₂CH₃ | H | H |
| y.026 | H | H | H | CHO | H | H |
| y.027 | H | H | H | F | H | H |
| y.028 | H | H | H | Cl | H | H |
| y.029 | H | H | H | Br | H | H |
| y.030 | H | H | H | CN | H | H |
| y.031 | H | H | H | OH | H | H |
| y.032 | H | H | H | OCH₃ | H | H |
| y.033 | H | H | H | OCH₂CH₃ | H | H |
| y.034 | H | H | H | OCH(CH₃)₂ | H | H |
| y.035 | H | H | H | OCH₂CH₂CH₃ | H | H |
| y.036 | H | H | H | OCH₂CH═CH₂ | H | H |
| y.037 | H | H | H | OCH₂C≡CH | H | H |
| y.038 | H | H | H | OCHF₂ | H | H |
| y.039 | H | H | H | O-cyclopropyl | H | H |
| y.040 | H | H | H | OCH₂CH₂O—CH₃ | H | H |
| y.041 | H | H | H | O-phenyl | H | H |
| y.042 | H | H | H | O-4-Cl-phenyl | H | H |
| y.043 | H | H | H | O-3-CH₃-phenyl | H | H |
| y.044 | H | H | H | O-2,4-diCl-phenyl | H | H |
| y.045 | H | H | H | O-3-CN-phenyl | H | H |
| y.046 | H | H | H | NH₂ | H | H |
| y.047 | H | H | H | NH(CH₃) | H | H |
| y.048 | H | H | H | N(CH₃)₂ | H | H |
| y.049 | H | H | H | N(CH₂CH₃)₂ | H | H |
| y.050 | H | H | H | NHCH₂—CH═CH₂ | H | H |
| y.051 | H | H | H | 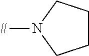 | H | H |
| y.052 | H | H | H | NHCOCH₃ | H | H |
| y.053 | H | H | H | N(CH₃)COCH₃ | H | H |
| y.054 | H | H | H | N(COCH₃)₂ | H | H |
| y.055 | H | H | H | NHCOCHCl₂ | H | H |
| y.056 | H | H | H | S—CH₃ | H | H |
| y.057 | H | H | H | S—CH₂CH₃ | H | H |
| y.058 | H | H | H | SO—CH₃ | H | H |
| y.059 | H | H | H | SO₂—CH₃ | H | H |
| y.060 | H | H | H | S—CHF₂ | H | H |
| y.061 | H | H | H | phenyl | H | H |
| y.062 | H | H | H | 2-CH₃-phenyl | H | H |
| y.063 | H | H | H | 4-CH₃-phenyl | H | H |
| y.064 | H | H | H | 2,4-diCH₃-phenyl | H | H |
| y.065 | H | H | H | 2-F-phenyl | H | H |
| y.066 | H | H | H | 3,5-diF-phenyl | H | H |
| y.067 | H | H | H | 2,6-diF-phenyl | H | H |
| y.068 | H | H | H | 4-Cl-phenyl | H | H |
| y.069 | H | H | H | 2,4-diCl-phenyl | H | H |
| y.070 | H | H | H | 3-CN-phenyl | H | H |
| y.071 | H | H | H | 3-CH₃O-phenyl | H | H |
| y.072 | H | H | H | 4-CH₃O-phenyl | H | H |
| y.073 | H | H | H | pyridin-2-yl | H | H |
| y.074 | H | H | H | 6-CH₃-pyridin-2-yl | H | H |
| y.075 | H | H | H | 4,6-diCH₃-pyridin-2-yl | H | H |
| y.076 | H | H | H | 6-Br-pyridin-2-yl | H | H |
| y.077 | H | H | H | 6-CH₃O-pyridin-2-yl | H | H |
| y.078 | H | H | H | 6-CH₃-4-OCH₃- | H | H |
| | | | | pyridin-2-yl | | |
| y.079 | H | H | H | 3,5-diCl-pyridin-2-yl | H | H |
| y.080 | H | H | H | 3,5-pyridin-2-yl | H | H |
| y.081 | H | H | H | 6-CH₃-4-Cl-pyridin-3-yl | H | H |
| y.082 | H | H | H | 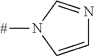 | H | H |
| y.083 | H | H | H | 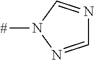 | H | H |
| y.084 | H | H | H | 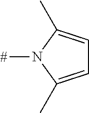 | H | H |
| y.085 | H | H | CH₃ | CH₃ | H | H |
| y.086 | H | H | CH₂CH₃ | CH₃ | H | H |
| y.087 | H | H | CH(CH₃)₂ | CH₃ | H | H |
| y.088 | H | H | C(CH₃)₃ | CH₃ | H | H |
| y.089 | H | H | cyclopropyl | CH₃ | H | H |
| y.090 | H | H | cyclohexyl | CH₃ | H | H |
| y.091 | H | H | CF₃ | CH₃ | H | H |
| y.092 | H | H | CHF₂ | CH₃ | H | H |
| y.093 | H | H | CH₂F | CH₃ | H | H |
| y.094 | H | H | CCl₃ | CH₃ | H | H |
| y.095 | H | H | CHCl₂ | CH₃ | H | H |
| y.096 | H | H | CH₂CN | CH₃ | H | H |
| y.097 | H | H | CH₂OCH₃ | CH₃ | H | H |
| y.098 | H | H | CH₂SCH₃ | CH₃ | H | H |
| y.099 | H | H | CH₂SO₂CH₃ | CH₃ | H | H |
| y.100 | H | H | CHO | CH₃ | H | H |
| y.101 | H | H | F | CH₃ | H | H |
| y.102 | H | H | Cl | CH₃ | H | H |
| y.103 | H | H | Br | CH₃ | H | H |
| y.104 | H | H | CN | CH₃ | H | H |
| y.105 | H | H | OH | CH₃ | H | H |
| y.106 | H | H | OCH₃ | CH₃ | H | H |
| y.107 | H | H | OCH₂CH₃ | CH₃ | H | H |
| y.108 | H | H | OCH(CH₃)₂ | CH₃ | H | H |
| y.109 | H | H | OCH₂CH₂CH₃ | CH₃ | H | H |
| y.110 | H | H | OCH₂CH═CH₂ | CH₃ | H | H |
| y.111 | H | H | OCH₂C≡CH | CH₃ | H | H |
| y.112 | H | H | OCHF₂ | CH₃ | H | H |
| y.113 | H | H | O-cyclopropyl | CH₃ | H | H |
| y.114 | H | H | OCH₂CH₂—OCH₃ | CH₃ | H | H |
| y.115 | H | H | O-phenyl | CH₃ | H | H |
| y.116 | H | H | O-4-Cl-phenyl | CH₃ | H | H |
| y.117 | H | H | O-3-CH₃-phenyl | CH₃ | H | H |
| y.118 | H | H | O-2,4-diCl-phenyl | CH₃ | H | H |
| y.119 | H | H | O-3-CN-phenyl | CH₃ | H | H |
| y.120 | H | H | NH₂ | CH₃ | H | H |
| y.121 | H | H | NH(CH₃) | CH₃ | H | H |
| y.122 | H | H | N(CH₃)₂ | CH₃ | H | H |
| y.123 | H | H | N(CH₂CH₃)₂ | CH₃ | H | H |
| y.124 | H | H | NHCH₂—CH═CH₂ | CH₃ | H | H |
| y.125 | H | H | 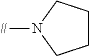 | CH₃ | H | H |
| y.126 | H | H | NHCOCH₃ | CH₃ | H | H |
| y.127 | H | H | N(CH₃)COCH₃ | CH₃ | H | H |
| y.128 | H | H | N(COCH₃)₂ | CH₃ | H | H |
| y.129 | H | H | NHCOCHCl₂ | CH₃ | H | H |
| y.130 | H | H | S—CH₃ | CH₃ | H | H |
| y.131 | H | H | S—CH₂CH₃ | CH₃ | H | H |
| y.132 | H | H | SO—CH₃ | CH₃ | H | H |
| y.133 | H | H | SO₂—CH₃ | CH₃ | H | H |
| y.134 | H | H | S—CHF₂ | CH₃ | H | H |
| y.135 | H | H | phenyl | CH₃ | H | H |
| y.136 | H | H | 2-CH₃-phenyl | CH₃ | H | H |
| y.137 | H | H | 4-CH₃-phenyl | CH₃ | H | H |
| y.138 | H | H | 2,4-diCH₃-phenyl | CH₃ | H | H |
| y.139 | H | H | 2-F-phenyl | CH₃ | H | H |
| y.140 | H | H | 3,5-diF-phenyl | CH₃ | H | H |
| y.141 | H | H | 2,6-diF-phenyl | CH₃ | H | H |
| y.142 | H | H | 4-Cl-phenyl | CH₃ | H | H |
| y.143 | H | H | 2,4-diCl-phenyl | CH₃ | H | H |
| y.144 | H | H | 3-CN-phenyl | CH₃ | H | H |
| y.145 | H | H | 3-CH₃O-phenyl | CH₃ | H | H |
| y.146 | H | H | 4-CH₃O-phenyl | CH₃ | H | H |
| y.147 | H | H | pyridin-2-yl | CH₃ | H | H |
| y.148 | H | H | 6-CH₃-pyridin-2-yl | CH₃ | H | H |
| y.149 | H | H | 4,6-diCH₃-pyridin-2-yl | CH₃ | H | H |
| y.150 | H | H | 6-Br-pyridin-2-yl | CH₃ | H | H |
| y.151 | H | H | 6-CH₃O-pyridin-2-yl | CH₃ | H | H |
| y.152 | H | H | 6-CH₃-4-CH₃O- | CH₃ | H | H |
| | | | pyridin-2-yl | | | |
| y.153 | H | H | 3,5-diCl-pyridin-2-yl | CH₃ | H | H |
| y.154 | H | H | 3,5-pyridin-2-yl | CH₃ | H | H |
| y.155 | H | H | 6-CH₃-4-Cl-pyridin-3-yl | CH₃ | H | H |
| y.156 | H | H | 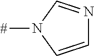 | CH₃ | H | H |
| y.157 | H | H | 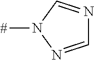 | CH₃ | H | H |
| y.158 | H | H | 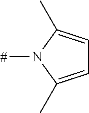 | CH₃ | H | H |
| y.159 | CH₃ | H | H | CH₃ | H | H |
| y.160 | CH₂CH₃ | H | H | CH₃ | H | H |
| y.161 | cyclopropyl | H | H | CH₃ | H | H |
| y.162 | CH₂OCH₃ | H | H | CH₃ | H | H |
| y.163 | CH₂F | H | H | CH₃ | H | H |
| y.164 | CHF₂ | H | H | CH₃ | H | H |
| y.165 | CF₃ | H | H | CH₃ | H | H |
| y.166 | phenyl | H | H | CH₃ | H | H |
| y.167 | OCH₃ | H | H | CH₃ | H | H |
| y.168 | OCH₂C≡CH | H | H | CH₃ | H | H |
| y.169 | SCH₃ | H | H | CH₃ | H | H |
| y.170 | NH(CH₃) | H | H | CH₃ | H | H |
| y.171 | N(CH₃)₂ | H | H | CH₃ | H | H |
| y.172 | 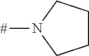 | H | H | CH₃ | H | H |
| y.173 | 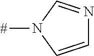 | H | H | CH₃ | H | H |
| y.174 | H | CH₃ | H | CH₃ | H | H |
| y.175 | H | CH₂CH₃ | H | CH₃ | H | H |
| y.176 | H | cyclopropyl | H | CH₃ | H | H |
| y.177 | H | CH₂OCH₃ | H | CH₃ | H | H |
| y.178 | H | CH₂F | H | CH₃ | H | H |
| y.179 | H | CHF₂ | H | CH₃ | H | H |
| y.180 | H | CF₃ | H | CH₃ | H | H |
| y.181 | H | phenyl | H | CH₃ | H | H |
| y.182 | H | OCH₃ | H | CH₃ | H | H |
| y.183 | H | OCH₂C≡CH | H | CH₃ | H | H |
| y.184 | H | SCH₃ | H | CH₃ | H | H |
| y.185 | H | NH(CH₃) | H | CH₃ | H | H |
| y.186 | H | N(CH₃)₂ | H | CH₃ | H | H |
| y.187 | H | 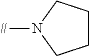 | H | CH₃ | H | H |
| y.188 | H | 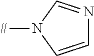 | H | CH₃ | H | H |
| y.189 | CH₃ | H | CH₃ | CH₃ | H | H |
| y.190 | CH₃ | H | OCH₃ | CH₃ | H | H |
| y.191 | CH₃ | H | OCH₂C≡CH | CH₃ | H | H |
| y.192 | CH₃ | H | SCH₃ | CH₃ | H | H |
| y.193 | CH₃ | H | N(CH₃)₂ | CH₃ | H | H |
| y.194 | H | CH₃ | CH₃ | CH₃ | H | H |
| y.195 | H | CH₃ | OCH₃ | CH₃ | H | H |
| y.196 | H | CH₃ | OCH₂C≡CH | CH₃ | H | H |
| y.197 | H | CH₃ | SCH₃ | CH₃ | H | H |
| y.198 | H | CH₃ | N(CH₃)₂ | CH₃ | H | H |
| y.199 | CH₃ | CH₃ | CH₃ | CH₃ | H | H |
| y.200 | CH₃ | CH₃ | OCH₃ | CH₃ | H | H |
| y.201 | CH₃ | CH₃ | OCH₂C≡CH | CH₃ | H | H |
| y.202 | CH₃ | CH₃ | SCH₃ | CH₃ | H | H |
| y.203 | CH₃ | CH₃ | N(CH₃)₂ | CH₃ | H | H |
| y.204 | OCH₃ | CH₃ | CH₃ | CH₃ | H | H |
| y.205 | OCH₃ | CH₃ | OCH₃ | CH₃ | H | H |
| y.206 | OCH₃ | CH₃ | OCH₂C≡CH | CH₃ | H | H |
| y.207 | OCH₃ | CH₃ | SCH₃ | CH₃ | H | H |
| y.208 | OCH₃ | CH₃ | N(CH₃)₂ | CH₃ | H | H |
| y.209 | CH₃ | OCH₃ | CH₃ | CH₃ | H | H |
| y.210 | CH₃ | OCH₃ | OCH₃ | CH₃ | H | H |
| y.211 | CH₃ | OCH₃ | OCH₂C≡CH | CH₃ | H | H |
| y.212 | CH₃ | OCH₃ | SCH₃ | CH₃ | H | H |
| y.213 | CH₃ | OCH₃ | N(CH₃)₂ | CH₃ | H | H |
| y.214 | CH₃ | H | CH₃ | CH₃ | H | CH₃ |
| y.215 | CH₃ | H | OCH₃ | CH₃ | H | CH₃ |
| y.216 | CH₃ | H | OCH₂C≡CH | CH₃ | H | CH₃ |
| y.217 | CH₃ | H | SCH₃ | CH₃ | H | CH₃ |
| y.218 | CH₃ | H | N(CH₃)₂ | CH₃ | H | CH₃ |
| y.219 | H | CH₃ | CH₃ | CH₃ | H | CH₃ |
| y.220 | H | CH₃ | OCH₃ | CH₃ | H | CH₃ |
| y.221 | H | CH₃ | OCH₂C≡CH | CH₃ | H | CH₃ |
| y.222 | H | CH₃ | SCH₃ | CH₃ | H | CH₃ |
| y.223 | H | CH₃ | N(CH₃)₂ | CH₃ | H | CH₃ |
| y.224 | CH₃ | CH₃ | CH₃ | CH₃ | H | CH₃ |
| y.225 | CH₃ | CH₃ | OCH₃ | CH₃ | H | CH₃ |
| y.226 | CH₃ | CH₃ | OCH₂C≡CH | CH₃ | H | CH₃ |
| y.227 | CH₃ | CH₃ | SCH₃ | CH₃ | H | CH₃ |
| y.228 | CH₃ | CH₃ | N(CH₃)₂ | CH₃ | H | CH₃ |
| y.229 | OCH₃ | CH₃ | CH₃ | CH₃ | H | CH₃ |
| y.230 | OCH₃ | CH₃ | OCH₃ | CH₃ | H | CH₃ |
| y.231 | OCH₃ | CH₃ | OCH₂C≡CH | CH₃ | H | CH₃ |
| y.232 | OCH₃ | CH₃ | SCH₃ | CH₃ | H | CH₃ |
| y.233 | OCH₃ | CH₃ | N(CH₃)₂ | CH₃ | H | CH₃ |
| y.234 | CH₃ | OCH₃ | CH₃ | CH₃ | H | CH₃ |
| y.235 | CH₃ | OCH₃ | OCH₃ | CH₃ | H | CH₃ |
| y.236 | CH₃ | OCH₃ | OCH₂C≡CH | CH₃ | H | CH₃ |
| y.237 | CH₃ | OCH₃ | SCH₃ | CH₃ | H | CH₃ |
| y.238 | CH₃ | OCH₃ | N(CH₃)₂ | CH₃ | H | CH₃ |
| y.239 | H | H | H | CH₃ | H | CH₃ |
| y.240 | H | H | CH₃ | CH₃ | H | CH₃ |
| y.241 | H | H | CH₂CH₃ | CH₃ | H | CH₃ |
| y.242 | H | H | cyclopropyl | CH₃ | H | CH₃ |
| y.243 | H | H | CH₂OCH₃ | CH₃ | H | CH₃ |
| y.244 | H | H | CH₂F | CH₃ | H | CH₃ |
| y.245 | H | H | CHF₂ | CH₃ | H | CH₃ |
| y.246 | H | H | CF₃ | CH₃ | H | CH₃ |
| y.247 | H | H | phenyl | CH₃ | H | CH₃ |
| y.248 | H | H | OCH₃ | CH₃ | H | CH₃ |
| y.249 | H | H | OCH₂C≡CH | CH₃ | H | CH₃ |
| y.250 | H | H | SCH₃ | CH₃ | H | CH₃ |
| y.251 | H | H | NH(CH3) | CH₃ | H | CH₃ |
| y.252 | H | H | N(CH₃)₂ | CH₃ | H | CH₃ |
| y.253 | H | H | 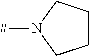 | CH₃ | H | CH₃ |
| y.254 | H | H | 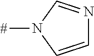 | CH₃ | H | CH₃ |
| y.255 | H | H | H | CH₃ | H | OCH₃ |
| y.256 | H | H | CH₃ | CH₃ | H | OCH₃ |
| y.257 | H | H | CH₂CH₃ | CH₃ | H | OCH₃ |
| y.258 | H | H | cyclopropyl | CH₃ | H | OCH₃ |
| y.259 | H | H | CH₂OCH₃ | CH₃ | H | OCH₃ |
| y.260 | H | H | CH₂F | CH₃ | H | OCH₃ |
| y.261 | H | H | CHF₂ | CH₃ | H | OCH₃ |
| y.262 | H | H | CF₃ | CH₃ | H | OCH₃ |
| y.263 | H | H | phenyl | CH₃ | H | OCH₃ |
| y.264 | H | H | OCH₃ | CH₃ | H | OCH₃ |
| y.265 | H | H | OCH₂C≡CH | CH₃ | H | OCH₃ |
| y.266 | H | H | SCH₃ | CH₃ | H | OCH₃ |
| y.267 | H | H | NH(CH₃) | CH₃ | H | OCH₃ |
| y.268 | H | H | N(CH₃)₂ | CH₃ | H | OCH₃ |
| y.269 | H | H | 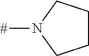 | CH₃ | H | OCH₃ |
| y.270 | H | H | 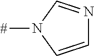 | CH₃ | H | OCH₃ |
| y.271 | H | H | H | CH₃ | H | OCH₂CH₃ |
| y.272 | H | H | CH₃ | CH₃ | H | OCH₂CH₃ |
| y.273 | H | H | CH₂CH₃ | CH₃ | H | OCH₂CH₃ |
| y.274 | H | H | OCH₃ | CH₃ | H | OCH₂CH₃ |
| y.275 | H | H | OCH₂C≡CH | CH₃ | H | OCH₂CH₃ |
| y.276 | H | H | phenyl | CH₃ | H | OCH₂CH₃ |
| y.277 | H | H | SCH₃ | CH₃ | H | OCH₂CH₃ |
| y.278 | H | H | N(CH₃)₂ | CH₃ | H | OCH₂CH₃ |
| y.279 | H | H | H | CH₃ | H | OCH₂C≡CH |
| y.280 | H | H | CH₃ | CH₃ | H | OCH₂C≡CH |
| y.281 | H | H | CH₂CH₃ | CH₃ | H | OCH₂C≡CH |
| y.282 | H | H | OCH₃ | CH₃ | H | OCH₂C≡CH |
| y.283 | H | H | OCH₂C≡CH | CH₃ | H | OCH₂C≡CH |
| y.284 | H | H | phenyl | CH₃ | H | OCH₂C≡CH |
| y.285 | H | H | SCH₃ | CH₃ | H | OCH₂C≡CH |
| y.286 | H | H | N(CH₃)₂ | CH₃ | H | OCH₂C≡CH |
| y.287 | H | H | H | CH₃ | H | N(CH₃)₂ |
| y.288 | H | H | CH₃ | CH₃ | H | N(CH₃)₂ |
| y.289 | H | H | CH₂CH₃ | CH₃ | H | N(CH₃)₂ |
| y.290 | H | H | OCH₃ | CH₃ | H | N(CH₃)₂ |
| y.291 | H | H | OCH₂C≡CH | CH₃ | H | N(CH₃)₂ |
| y.292 | H | H | phenyl | CH₃ | H | N(CH₃)₂ |
| y.293 | H | H | SCH₃ | CH₃ | H | N(CH₃)₂ |
| y.294 | H | H | N(CH₃)₂ | CH₃ | H | N(CH₃)₂ |
| y.295 | H | H | H | CH₃ | H | SCH₃ |
| y.296 | H | H | CH₃ | CH₃ | H | SCH₃ |
| y.297 | H | H | CH₂CH₃ | CH₃ | H | SCH₃ |
| y.298 | H | H | OCH₃ | CH₃ | H | SCH₃ |
| y.299 | H | H | OCH₂C≡CH | CH₃ | H | SCH₃ |
| y.300 | H | H | phenyl | CH₃ | H | SCH₃ |
| y.301 | H | H | SCH₃ | CH₃ | H | SCH₃ |
| y.302 | H | H | N(CH₃)₂ | CH₃ | H | SCH₃ |
| y.303 | H | H | H | CH₃ | H | CH₂CH₃ |
| y.304 | H | H | CH₃ | CH₃ | H | CH₂CH₃ |
| y.305 | H | H | CH₂CH₃ | CH₃ | H | CH₂CH₃ |
| y.306 | H | H | OCH₃ | CH₃ | H | CH₂CH₃ |
| y.307 | H | H | OCH₂C≡CH | CH₃ | H | CH₂CH₃ |
| y.308 | H | H | phenyl | CH₃ | H | CH₂CH₃ |
| y.309 | H | H | SCH₃ | CH₃ | H | CH₂CH₃ |
| y.310 | H | H | N(CH₃)₂ | CH₃ | H | CH₂CH₃ |
| y.311 | H | H | H | CH₃ | H | phenyl |
| y.312 | H | H | CH₃ | CH₃ | H | phenyl |
| y.313 | H | H | CH₂CH₃ | CH₃ | H | phenyl |
| y.314 | H | H | OCH₃ | CH₃ | H | phenyl |
| y.315 | H | H | OCH₂C≡CH | CH₃ | H | phenyl |
| y.316 | H | H | phenyl | CH₃ | H | phenyl |
| y.317 | H | H | SCH₃ | CH₃ | H | phenyl |
| y.318 | H | H | N(CH₃)₂ | CH₃ | H | phenyl |
| y.319 | H | H | H | CH₃ | H | CF₃ |
| y.320 | H | H | CH₃ | CH₃ | H | CF₃ |
| y.321 | H | H | CH₂CH₃ | CH₃ | H | CF₃ |
| y.322 | H | H | OCH₃ | CH₃ | H | CF₃ |
| y.323 | H | H | OCH₂C≡CH | CH₃ | H | CF₃ |
| y.324 | H | H | phenyl | CH₃ | H | CF3 |
| y.325 | H | H | SCH₃ | CH₃ | H | CF3 |
| y.326 | H | H | N(CH₃)₂ | CH₃ | H | CF3 |
| y.327 | H | H | H | CH₂CH₃ | H | CH₃ |
| y.328 | H | H | CH₃ | CH₂CH₃ | H | CH₃ |
| y.329 | H | H | CH₂CH₃ | CH₂CH₃ | H | CH₃ |
| y.330 | H | H | OCH₃ | CH₂CH₃ | H | CH₃ |
| y.331 | H | H | OCH₂C≡CH | CH₂CH₃ | H | CH₃ |
| y.332 | H | H | phenyl | CH₂CH₃ | H | CH₃ |
| y.333 | H | H | SCH₃ | CH₂CH₃ | H | CH₃ |
| y.334 | H | H | N(CH₃)₂ | CH₂CH₃ | H | CH₃ |
| y.335 | H | H | H | OCH₃ | H | CH₃ |
| y.336 | H | H | CH₃ | OCH₃ | H | CH₃ |
| y.337 | H | H | CH₂CH₃ | OCH₃ | H | CH₃ |
| y.338 | H | H | OCH₃ | OCH₃ | H | CH₃ |
| y.339 | H | H | OCH₂C≡CH | OCH₃ | H | CH₃ |
| y.340 | H | H | phenyl | OCH₃ | H | CH₃ |
| y.341 | H | H | SCH₃ | OCH₃ | H | CH₃ |
| y.342 | H | H | N(CH₃)₂ | OCH₃ | H | CH₃ |
| y.343 | H | H | H | CH₃ | CH₃ | H |
| y.344 | H | H | CH₃ | CH₃ | CH₃ | H |
| y.345 | H | H | CH₂CH₃ | CH₃ | CH₃ | H |
| y.346 | H | H | OCH₃ | CH₃ | CH₃ | H |
| y.347 | H | H | OCH₂C≡CH | CH₃ | CH₃ | H |
| y.348 | H | H | phenyl | CH₃ | CH₃ | H |
| y.349 | H | H | SCH₃ | CH₃ | CH₃ | H |
| y.350 | H | H | N(CH₃)₂ | CH₃ | CH₃ | H |
| y.351 | H | H | H | CH₃ | OCH₃ | H |
| y.352 | H | H | CH₃ | CH₃ | OCH₃ | H |
| y.353 | H | H | CH₂CH₃ | CH₃ | OCH₃ | H |
| y.354 | H | H | OCH₃ | CH₃ | OCH₃ | H |
| y.355 | H | H | OCH₂C≡CH | CH₃ | OCH₃ | H |
| y.356 | H | H | phenyl | CH₃ | OCH₃ | H |
| y.357 | H | H | SCH₃ | CH₃ | OCH₃ | H |
| y.358 | H | H | N(CH₃)₂ | CH₃ | OCH₃ | H |
| y.359 | H | H | H | CH₃ | N(CH₃)₂ | H |
| y.360 | H | H | CH₃ | CH₃ | N(CH₃)₂ | H |
| y.361 | H | H | CH₂CH₃ | CH₃ | N(CH₃)₂ | H |
| y.362 | H | H | OCH₃ | CH₃ | N(CH₃)₂ | H |
| y.363 | H | H | OCH₂C≡CH | CH₃ | N(CH₃)₂ | H |
| y.364 | H | H | phenyl | CH₃ | N(CH₃)₂ | H |
| y.365 | H | H | SCH₃ | CH₃ | N(CH₃)₂ | H |
| y.366 | H | H | N(CH₃)₂ | CH₃ | N(CH₃)₂ | H |
| y.367 | H | H | H | CH₃ | CH₃ | CH₃ |
| y.368 | H | H | CH₃ | CH₃ | CH₃ | CH₃ |
| y.369 | H | H | CH₂CH₃ | CH₃ | CH₃ | CH₃ |
| y.370 | H | H | OCH₃ | CH₃ | CH₃ | CH₃ |
| y.371 | H | H | OCH₂C≡CH | CH₃ | CH₃ | CH₃ |
| y.372 | H | H | phenyl | CH₃ | CH₃ | CH₃ |
| y.373 | H | H | SCH₃ | CH₃ | CH₃ | CH₃ |
| y.374 | H | H | N(CH₃)₂ | CH₃ | CH₃ | CH₃ |

| | | | | | |
|---|---|---|---|---|---|
| y.375 | H | H | H | CH═CH—CH═CH | H |
| y.376 | H | H | CH₃ | CH═CH—CH═CH | H |
| y.377 | H | H | CH₂CH₃ | CH═CH—CH═CH | H |
| y.378 | H | H | OCH₃ | CH═CH—CH═CH | H |
| y.379 | H | H | OCH₂C≡CH | CH═CH—CH═CH | H |
| y.380 | H | H | phenyl | CH═CH—CH═CH | H |
| y.381 | H | H | SCH₃ | CH═CH—CH═CH | H |
| y.382 | H | H | N(CH₃)₂ | CH═CH—CH═CH | H |
| y.383 | H | H | H | CH═CH—CH═CH | CH₃ |
| y.384 | H | H | CH₃ | CH═CH—CH═CH | CH₃ |
| y.385 | H | H | CH₂CH₃ | CH═CH—CH═CH | CH₃ |
| y.386 | H | H | OCH₃ | CH═CH—CH═CH | CH₃ |
| y.387 | H | H | OCH₂C≡CH | CH═CH—CH═CH | CH₃ |
| y.388 | H | H | phenyl | CH═CH—CH═CH | CH₃ |
| y.389 | H | H | SCH₃ | CH═CH—CH═CH | CH₃ |
| y.390 | H | H | N(CH₃)₂ | CH═CH—CH═CH | CH₃ |
| y.391 | H | H | H | CH═CH—CH═CH | OCH₃ |
| y.392 | H | H | CH₃ | CH═CH—CH═CH | OCH₃ |
| y.393 | H | H | CH₂CH₃ | CH═CH—CH═CH | OCH₃ |
| y.394 | H | H | OCH₃ | CH═CH—CH═CH | OCH₃ |
| y.395 | H | H | OCH₂C≡CH | CH═CH—CH═CH | OCH₃ |
| y.396 | H | H | phenyl | CH═CH—CH═CH | OCH₃ |
| y.397 | H | H | SCH₃ | CH═CH—CH═CH | OCH₃ |
| y.398 | H | H | N(CH₃)₂ | CH═CH—CH═CH | OCH₃ |
| y.399 | CH₃ | H | H | CH═CH—CH═CH | H |
| y.400 | CH₃ | H | CH₃ | CH═CH—CH═CH | H |
| y.401 | CH₃ | H | CH₂CH₃ | CH═CH—CH═CH | H |
| y.402 | CH₃ | H | OCH₃ | CH═CH—CH═CH | H |
| y.403 | CH₃ | H | OCH₂C≡CH | CH═CH—CH═CH | H |
| y.404 | CH₃ | H | phenyl | CH═CH—CH═CH | H |
| y.405 | CH₃ | H | SCH₃ | CH═CH—CH═CH | H |
| y.406 | CH₃ | H | N(CH₃)₂ | CH═CH—CH═CH | H |
| y.407 | CH₃ | H | H | CH═CH—CH═CH | CH₃ |
| y.408 | CH₃ | H | CH₃ | CH═CH—CH═CH | CH₃ |
| y.409 | CH₃ | H | CH₂CH₃ | CH═CH—CH═CH | CH₃ |
| y.410 | CH₃ | H | OCH₃ | CH═CH—CH═CH | CH₃ |
| y.411 | CH₃ | H | OCH₂C≡CH | CH═CH—CH═CH | CH₃ |
| y.412 | CH₃ | H | phenyl | CH═CH—CH═CH | CH₃ |
| y.413 | CH₃ | H | SCH₃ | CH═CH—CH═CH | CH₃ |
| y.414 | CH₃ | H | N(CH₃)₂ | CH═CH—CH═CH | CH₃ |
| y.415 | H | CH₃ | H | CH═CH—CH═CH | H |
| y.416 | H | CH₃ | CH₃ | CH═CH—CH═CH | H |
| y.417 | H | CH₃ | CH₂CH₃ | CH═CH—CH═CH | H |
| y.418 | H | CH₃ | OCH₃ | CH═CH—CH═CH | H |
| y.419 | H | CH₃ | OCH₂C≡CH | CH═CH—CH═CH | H |
| y.420 | H | CH₃ | phenyl | CH═CH—CH═CH | H |
| y.421 | H | CH₃ | SCH₃ | CH═CH—CH═CH | H |
| y.422 | H | CH₃ | N(CH₃)₂ | CH═CH—CH═CH | H |
| y.423 | H | CH₃ | H | CH═CH—CH═CH | CH₃ |
| y.424 | H | CH₃ | CH₃ | CH═CH—CH═CH | CH₃ |
| y.425 | H | CH₃ | CH₂CH₃ | CH═CH—CH═CH | CH₃ |
| y.426 | H | CH₃ | OCH₃ | CH═CH—CH═CH | CH₃ |
| y.427 | H | CH₃ | OCH₂C≡CH | CH═CH—CH═CH | CH₃ |
| y.428 | H | CH₃ | phenyl | CH═CH—CH═CH | CH₃ |
| y.429 | H | CH₃ | SCH₃ | CH═CH—CH═CH | CH₃ |
| y.430 | H | CH₃ | N(CH₃)₂ | CH═CH—CH═CH | CH₃ |
| y.431 | H | H | H | CH═CH—CH═CH | CH₂CH₃ |
| y.432 | H | H | H | CH═CH—CH═CH | CH(CH₃)₂ |
| y.433 | H | H | H | CH═CH—CH═CH | (CH₂)₂CH₃ |
| y.434 | H | H | H | CH═CH—CH═CH | CH(CH₃)₂ |
| y.435 | H | H | H | CH═CH—CH═CH | (CH₂)₃CH₃ |
| y.436 | H | H | H | CH═CH—CH═CH | CH(CH₃)—CH₂CH₃ |
| y.437 | H | H | H | CH═CH—CH═CH | CH(CH₂)₂ |
| y.438 | H | H | H | CH═CH—CH═CH | C₆H₅ |
| y.439 | H | H | H | CH═CH—CH═CH | SCH₃ |
| y.440 | H | H | H | CH═CH—CH═CH | N(CH₃)₂ |
| y.441 | H | H | H | CH═CH—CH═CH | Cl |
| y.442 | H | H | H | CCl═CH—CH═CH | H |
| y.443 | H | H | H | CCl═CH—CH═CH | CH₃ |
| y.444 | H | H | H | CCl═CH—CH═CH | CH₂CH₃ |
| y.445 | H | H | H | C(CH₃)═CH—CH═CH | H |
| y.446 | H | H | H | C(CH₃)═CH—CH═CH | CH₃ |
| y.447 | H | H | H | C(CH₃)═CH—CH═CH | CH₂CH₃ |
| y.448 | H | H | H | CH═CCl—CH═CH | H |
| y.449 | H | H | H | CH═CCl—CH═CH | CH₃ |
| y.450 | H | H | H | CH═CCl—CH═CH | CH₂CH₃ |
| y.451 | H | H | H | CH═C(CH₃)—CH═CH | H |
| y.452 | H | H | H | CH═C(CH₃)—CH═CH | CH₃ |
| y.453 | H | H | H | CH═C(CH₃)—CH═CH | CH₂CH₃ |
| y.454 | H | H | H | CH═CH—CCl═CH | H |
| y.455 | H | H | H | CH═CH—CCl═CH | CH₃ |
| y.456 | H | H | H | CH═CH—CCl═CH | CH₂CH₃ |
| y.457 | H | H | H | CH═CH—CCl═CH | (CH₂)₃CH₃ |
| y.458 | H | H | H | CH═CH—CCl═CH | OCH₃ |
| y.459 | H | H | H | CH═CH—CCl═CH | SCH₃ |
| y.460 | H | H | H | CH═CH—CCl═CH | N(CH₃)₂ |
| y.461 | H | H | H | CH═CH—CBr═CH | CH₃ |
| y.462 | H | H | H | CH═CH—CF═CH | CH₃ |
| y.463 | H | H | H | CH═CH—C(CH₃)═CH | CH₃ |
| y.464 | H | H | H | CH═CH—C(OCH₃)═CH | CH₃ |
| y.465 | H | H | H | CH═CH—C(NO₂)═CH | CH₃ |
| y.466 | H | H | H | CH═CH—C(NH₂)═CH | CH₃ |
| y.467 | H | H | H | CH═CH—CH═CCl | H |
| y.468 | H | H | H | CH═CH—CH═CCl | CH₃ |
| y.469 | H | H | H | CH═CH—CH═CCl | CH₂CH₃ |
| y.470 | H | H | H | CH═CH—CH═C(CH₃) | H |
| y.471 | H | H | H | CH═CH—CH═C(CH₃) | CH₃ |
| y.472 | H | H | H | CH═CH—CH═C(CH₃) | CH₂CH₃ |
| y.473 | H | H | H | CCl═CH—CH═CCl | H |
| y.474 | H | H | H | CCl═CH—CH═CCl | CH₃ |
| y.475 | H | H | H | CCl═CH—CH═CCl | CH₂CH₃ |
| y.476 | H | H | H | CH═CH—CCl═CCl | CH₃ |
| y.477 | H | H | H | CH═CH—CCl═CCl | CH₃ |
| y.478 | H | H | H | CH═CH—CCl═C(CH₂CH₃) | CH₃ |
| y.479 | H | H | H | CH═C(OCH₃)—C(OCH₃)═CH | CH₃ |

TABLE 16
This table discloses compounds 16.001 to 16.479 of the formula (I-XVI)

| | |
|---|---|
| 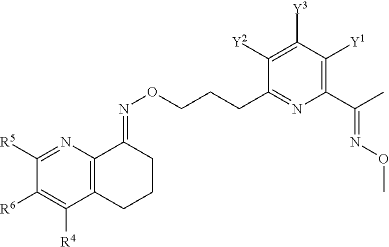 | (I-XVI) |

wherein Y¹, Y², Y³, R⁴, R⁵ and R⁶ have the specific meanings given in Table Y.

TABLE 17
This table discloses compounds 17.001 to 17.479 of the formula (I-XVII)

| | |
|---|---|
| 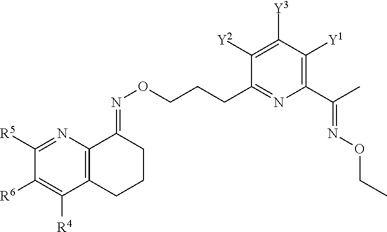 | (I-XVII) |

wherein Y¹, Y², Y³, R⁴, R⁵ and R⁶ have the specific meanings given in Table Y.

TABLE 18
This table discloses compounds 18.001 to 18.479 of the formula (I-XVIII)

| | |
|---|---|
| 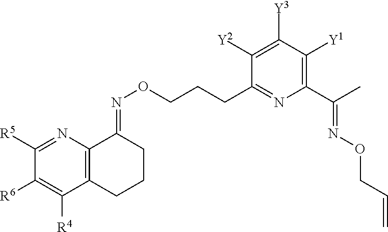 | (I-XVIII) |

wherein Y¹, Y², Y³, R⁴, R⁵ and R⁶ have the specific meanings given in Table Y.

TABLE 19
This table discloses compounds 19.001 to 19.479 of the formula (I-XIX)

| | |
|---|---|
| 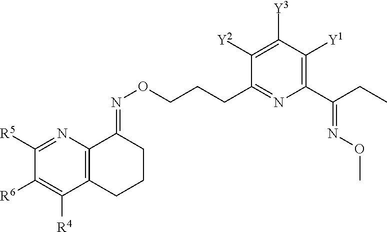 | (I-XIX) |

wherein Y¹, Y², Y³, R⁴, R⁵ and R⁶ have the specific meanings given in Table Y.

TABLE 20
This table discloses compounds 20.001 to 20.479 of the formula (I-XX)

| | |
|---|---|
| 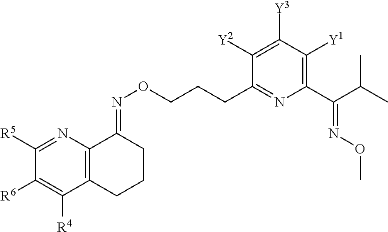 | (I-XX) |

wherein Y¹, Y², Y³, R⁴, R⁵ and R⁶ have the specific meanings given in Table Y.

TABLE 21
This table discloses compounds 21.001 to 21.479 of the formula (I-XXI)

| | |
|---|---|
| 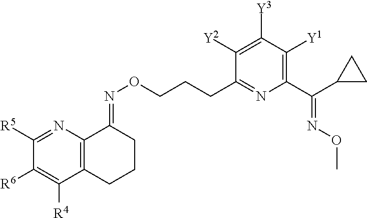 | (I-XXI) |

wherein Y¹, Y², Y³, R⁴, R⁵ and R⁶ have the specific meanings given in Table Y.

TABLE 22
This table discloses compounds 22.001 to 22.479 of the formula (I-XXII)

| | |
|---|---|
| 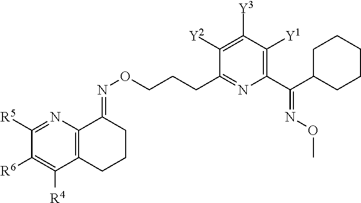 | (I-XXII) |

wherein Y¹, Y², Y³, R⁴, R⁵ and R⁶ have the specific meanings given in Table Y.

TABLE 23
This table discloses compounds 23.001 to 23.479 of the formula (I-XXIII)

| | |
|---|---|
| 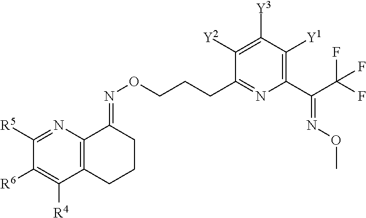 | (I-XXIII) |

wherein Y¹, Y², Y³, R⁴, R⁵ and R⁶ have the specific meanings given in Table Y.

TABLE 24
This table discloses compounds 24.001 to 24.479 of the formula (I-XXIV)

| | |
|---|---|
| 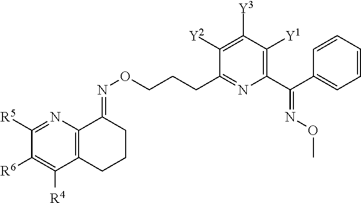 | (I-XXIV) |

wherein Y¹, Y², Y³, R⁴, R⁵ and R⁶ have the specific meanings given in Table Y.

TABLE 25
This table discloses compounds 25.001 to 25.479 of the formula (I-XXV)

| | |
|---|---|
| 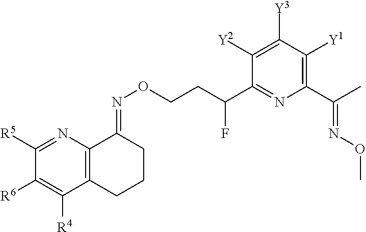 | (I-XXV) |

wherein Y¹, Y², Y³, Y⁴, Y⁵ and Y⁶ have the specific meanings given in Table Y.

TABLE 26
This table discloses compounds 26.001 to 26.4793 of the formula (I-XXVI)

| | |
|---|---|
| 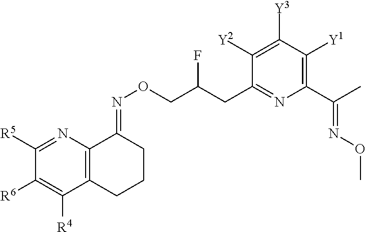 | (I-XXVI) |

wherein Y¹, Y², Y³, R⁴, R⁵ and R⁶ have the specific meanings given in Table Y.

TABLE 27
This table discloses compounds 27.001 to 27.479 of the formula (I-XXVII)

| | |
|---|---|
| 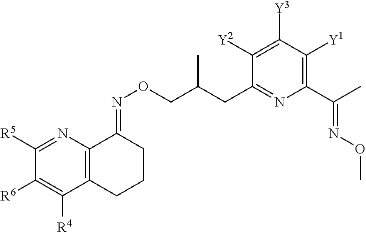 | (I-XXVII) |

wherein Y¹, Y², Y³, R⁴, R⁵ and R⁶ have the specific meanings given in Table Y.

TABLE 28
This table discloses compounds 28.001 to 28.479 of the formula (I-XXVIII)

| | |
|---|---|
| 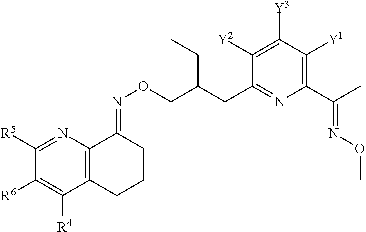 | (I-XXVIII) |

wherein Y¹, Y², Y³, R⁴, R⁵ and R⁶ have the specific meanings given in Table Y.

TABLE 29
This table discloses compounds 29.001 to 29.479 of the formula (I-XXIX)

| | |
|---|---|
| 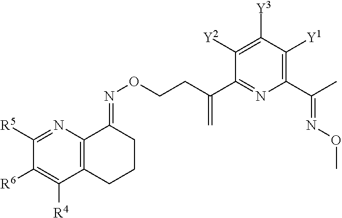 | (I-XXIX) |

wherein Y¹, Y², Y³, R⁴, R⁵ and R⁶ have the specific meanings given in Table Y.

TABLE 30
This table discloses compounds 30.001 to 30.479 of the formula (I-XXX)

| | |
|---|---|
| 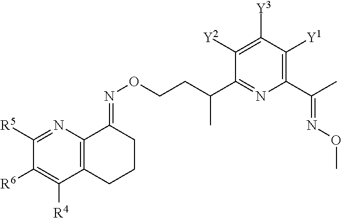 | (I-XXX) |

wherein Y¹, Y², Y³, R⁴, R⁵ and R⁶ have the specific meanings given in Table Y.

TABLE 31
This table discloses compounds 31.001 to 31.479 of the formula (I-XXXI)

| | |
|---|---|
| 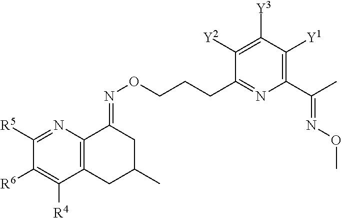 | (I-XXXI) |

wherein Y¹, Y², Y³, R⁴, R⁵ and R⁶ have the specific meanings given in Table Y.

Table Z represents Table 32 (when Z is 32), Table 33 (when Z is 33), Table 34 (when Z is 34)

TABLE Z

| | A | R³ | R⁴ | R⁵ | R⁶ | R⁷ | G¹-G²-G³ | Y³ |
|---|---|---|---|---|---|---|---|---|
| z.001 | A^{1b} | CH₃ | H | H | H | | | H |
| z.002 | A^{1b} | CH₃ | CH₃ | H | H | | | H |
| z.003 | A^{1b} | CH₃ | OCH₃ | H | H | | | H |
| z.004 | A^{1b} | CH₃ | OCH₂CH₃ | H | H | | | H |
| z.005 | A^{1b} | CH₃ | CH₃ | CH₃ | H | | | H |
| z.006 | A^{1b} | CH₃ | CH(CH2)2 | CH₃ | H | | | H |
| z.007 | A^{1b} | CH₃ | OCH₃ | CH₃ | H | | | H |
| z.008 | A^{1b} | CH₃ | OCH₃ | OCH₃ | H | | | H |
| z.009 | A^{1b} | CH₃ | OCH₂CH₃ | OCH₂CH₃ | H | | | H |
| z.010 | A^{1b} | Ph | OCH₃ | OCH₃ | H | | | H |
| z.011 | A^{1b} | CH₃ | CH₃ | CH₃ | CH₃ | | | H |
| z.012 | A^{1b} | CH₃ | CH₃ | —CH═CH—CH═CH— | | | | H |
| z.013 | A^{1b} | CH₂CH₃ | H | H | H | | | H |
| z.014 | A^{1b} | CH₂CH₃ | CH₃ | CH₃ | H | | | H |
| z.015 | A^{1b} | CH₂CH₃ | OCH₃ | CH₃ | H | | | H |
| z.016 | A^{1b} | CH₃ | CH₃ | CH₃ | H | | | CH₃ |
| z.017 | A^{1b} | CH₃ | OCH₃ | CH₃ | H | | | CH₃ |
| z.018 | A^{1c} | CH₃ | H | H | | H | | H |
| z.019 | A^{1c} | CH₃ | CH₃ | H | | H | | H |
| z.020 | A^{1c} | CH₃ | Cl | H | | H | | H |
| z.021 | A^{1c} | CH₃ | OCH₃ | H | | H | | H |
| z.022 | A^{1c} | CH₃ | SCH₃ | H | | H | | H |
| z.023 | A^{1c} | CH₃ | H | CH₃ | | H | | H |
| z.024 | A^{1c} | CH₃ | H | OCH₃ | | H | | H |
| z.025 | A^{1c} | CH₃ | H | SCH₃ | | H | | H |
| z.026 | A^{1c} | CH₃ | H | Ph | | H | | H |
| z.027 | A^{1c} | CH₃ | H | 6-CH₃-2-pyridinyl | | H | | H |
| z.028 | A^{1c} | CH₃ | CH₃ | CH₃ | | H | | H |
| z.029 | A^{1c} | CH₃ | OCH₃ | CH₃ | | H | | H |
| z.030 | A^{1c} | CH₃ | CH₃ | OCH₃ | | H | | H |
| z.031 | A-3 | | H | H | | | (CH₂)₃ | H |
| z.032 | A-3 | | H | CH₃ | | | (CH₂)₃ | H |
| z.033 | A-3 | | H | Ph | | | (CH₂)₃ | H |
| z.034 | A-3 | | H | 2-CH₃Ph | | | (CH₂)₃ | H |
| z.035 | A-3 | | H | 6-CH₃-2-pyridinyl | | | (CH₂)₃ | H |
| z.036 | A-3 | | H | OCH₃ | | | (CH₂)₃ | H |
| z.037 | A-3 | | H | SCH₃ | | | (CH₂)₃ | H |
| z.038 | A-3 | | H | NHCH₃ | | | (CH₂)₃ | H |
| z.039 | A-3 | | H | NHPh | | | (CH₂)₃ | H |
| z.040 | A-3 | | H | CH₂Ph | | | (CH₂)₃ | H |
| z.041 | A-3 | | CH₃ | H | | | (CH₂)₃ | H |
| z.042 | A-3 | | CH₃ | CH3 | | | (CH₂)₃ | H |
| z.043 | A-3 | | CH₃ | Ph | | | (CH₂)₃ | H |

TABLE 32
This table discloses compounds 32.001 to 32.043
of the formula (I-XXXII)

| | |
|---|---|
| 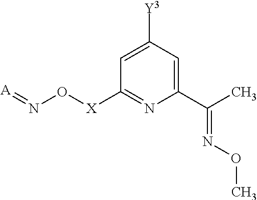 | (I-XXXII) |

wherein X represents —CH₂—CH₂—CH₂— and A, Y³, G¹-G²-G³, R⁴, R⁵, R⁶ and R⁷ have the specific meanings given in Table Z.

TABLE 33
This table discloses compounds 33.001 to 33.043
of the formula (I-XXXIII)

| | |
|---|---|
| 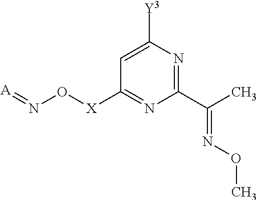 | (I-XXXIII) |

wherein X represents —CH₂—CH₂—CH₂— and A, Y³, G¹-G²-G³, R⁴, R⁵, R⁶ and R⁷ have the specific meanings given in Table Z.

TABLE 34
This table discloses compounds 34.001 to 34.043
of the formula (I-XXXIV)

| | |
|---|---|
| 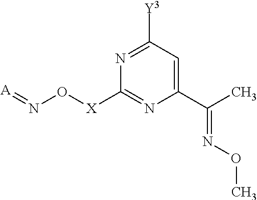 | (I-XXXIV) |

wherein X represents —CH₂—CH₂—CH₂— and A, Y³, G¹-G²-G³, R⁴, R⁵, R⁶ and R⁷ have the specific meanings given in Table Z.

The compounds in Tables 1 to 34 include all isomers, tautomers and mixtures thereof, including the cis/trans isomers shown above.

The compounds of the invention may be made by a variety of methods, illustrated in schemes 1-12. The compounds depicted in the schemes also indicate any isomers and tautomers, in particular the geometric isomers arising from the oxime and oxime ether moieties.

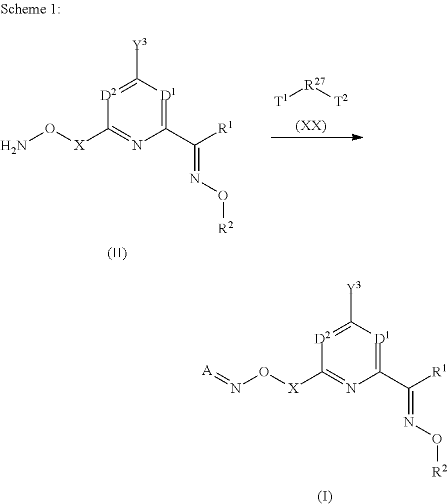

1) Compounds of formula (I) may be prepared by reacting a compound of formula (II) with a compound of formula (XX), wherein R²⁷ represents group A-6, A-7, A-8, A-9 or A-10:

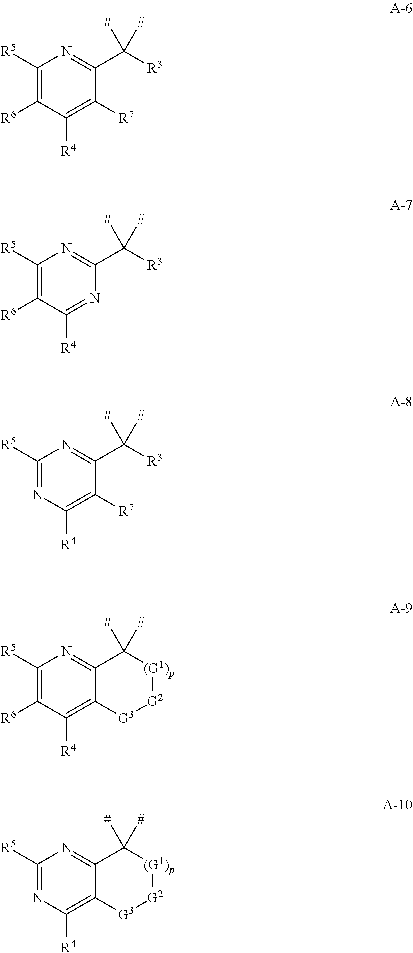

T¹ and T² are C₁-C₈ alkoxy, or T¹ and T² together with the carbon they are attached to form a carbonyl group or an acetal or ketal function of the form C(O—C₁-C₆-alkylidene-O) whereby the alkylidene fragment may optionally be mono- to tetra-substituted by C₁-C₆ alkyl and D¹, D², R³, R⁵, R⁶ and R⁷ are as defined herein for compounds of formula (I), as seen in scheme 1.

A general description of condensation reactions is given below, and typical reaction conditions for this type of reaction may be found in Journal of Organic Chemistry, 52(22), 4978-84; 1987; Chemical & Pharmaceutical Bulletin, 51(2), 138-151; 2003; Organic Letters, 10(2), 285-288; 2008; Journal of the American Chemical Society, 130(12), 4196-4201; 2008; Chemistry & Biology, 9(1), 113-129; 2002; Organic Preparations and Procedures International, 32(2), 153-159; 2000; Scientia Pharmaceutica, 66(1), 9-21; 1998, Journal of Medicinal Chemistry, 49(17), 5177-5186; 2006, Journal of Agricultural and Food Chemistry, 38(3), 839-44; 1990; Tetrahedron: Asymmetry, 8(2), 253-263; 1997; Journal of Medicinal Chemistry, 44(21), 3339-3342; 2001; Bioorganic & Medicinal Chemistry Letters, 12(3), 341-344; 2002; US 2007032470; WO 07/058,504; Journal of Organic Chemistry, 73(5), 2007-2010; 2008; Bioorganic & Medicinal Chemistry Letters, 19(10), 2683-2687; 2009; and Bioorganic & Medicinal Chemistry Letters, 19(10), 2654-2660; 2009.

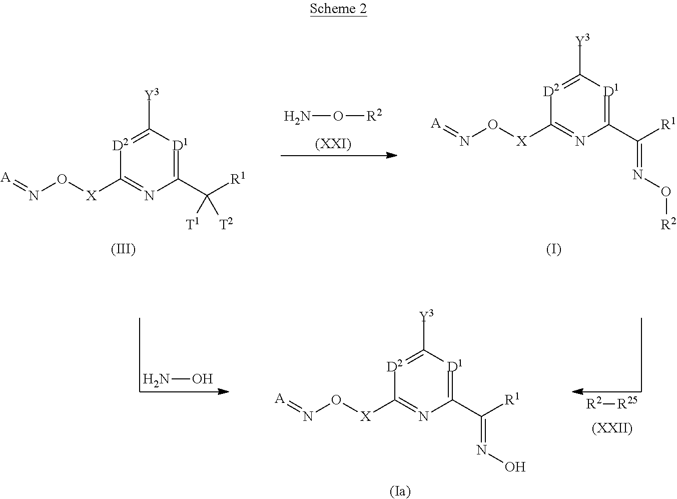

2) Alternatively, as seen in scheme 2, compounds of formula (I) may be prepared by reacting a compound of formula (III), wherein D¹, D², A, X, and Y³ and R¹ are as defined herein for compounds of formula (I) and T¹ and T² are C₁-C₈ alkoxy, or T¹ and T² together with the carbon they are attached to form a carbonyl group or an acetal or ketal function of the form C(O—C₁-C₆-alkylidene-O) whereby the alkylidene fragment may optionally be mono- to tetra-substituted by C₁-C₆ alkyl, and a compound of formula (XXI), wherein R² is as defined herein for compounds of formula (I) under conditions described in procedure 1.

3) Alternatively, as seen in scheme 2, compounds of formula (I) may be prepared by reacting a compound of formula (Ia), that is a compound of formula (I) wherein R² is hydrogen, and a compound of formula (XXII), wherein R² is as defined herein for compounds of formula (I) and R²⁵ is a halogen, in particular chlorine, bromine or iodine, or a sulfonic acid ester group, such as mesylate, tosylate, triflate, phenylsulfonic acid ester, nitro-phenylsulfonic acid ester, or nonafluorobutylsulfonic acid ester.

Typical reaction conditions for alkylation reactions such as this may be found below. These are further illustrated in Chinese Journal of Chemistry, 27(1), 33-42; 2009; WO 09/049,846; Journal of Antibiotics, 61(10), 603-614; 2008; Bioorganic & Medicinal Chemistry Letters, 18(24), 6471-6475; 2008; Journal of Medicinal Chemistry, 51(15), 4601-4608; 2008; WO 06/123145, Archiv der Pharmazie (Weinheim, Germany), 340(4), 202-208; 2007; Synthetic Communications, 37(7), 1155-1165; 2007; Russian Journal of Organic Chemistry, 42(5), 735-738; 2006; Bioinorganic Chemistry and Applications, 1(3-4), 299-308; 2003; Synthetic Communications, 28(14), 2621-2633; 1998; Synthetic Communications, 19(18), 3129-38; 1989.

4) Oximes of formula (Ia) may be obtained by a condensation reaction, whereby a compound of formula (III) is reacted with hydroxylamine, or, alternatively, with a salt of hydroxylamine. A more detailed description of condensation reactions is given below.

Related references include the following: Journal of Heterocyclic Chemistry, 46(1), 116-118; 2009; Journal of Medicinal Chemistry, 20(5), 718-21; 1977; Journal of Organic Chemistry, 73(11), 4017-4026; 2008; EJEAFChe, Electronic Journal of Environmental, Agricultural and Food Chemistry, 5(5), 1515-1521; 2006; Advanced Synthesis & Catalysis, 346(13-15), 1798-1811; 2004.

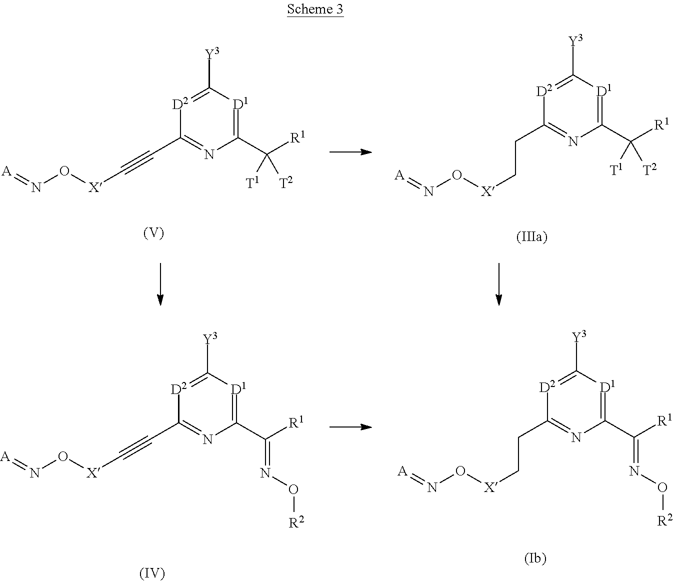

5) Alternatively, as seen in scheme 3, compounds of formula (Ib), that is a compound of formula (I) wherein X is X-3, X-4 or X-5, wherein Z⁴, Z⁵, Z⁸, Z⁹, Z¹³ and Z¹⁴ are methylene and Z³, Z⁶, Z⁷, Z¹⁰, Z¹¹ and Z¹² (represented in the scheme collectively as X′) are as defined herein for compounds of formula (I), may be prepared by catalytic hydrogenation from compounds of formula (IV) in the presence of a metal catalyst, for example palladium, nickel or platinum. The reaction is usually carried out in the presence of a solvent under a hydrogen atmosphere. In some cases it is necessary to apply pressure in the range of 1 to 100 bar. Suitable solvents for such reactions are alcohols, such as methanol or ethanol, cyclic ethers, such as dioxane or tetrahydrofuran or esters like ethyl acetate. The reaction is usually carried out at a reaction temperature ranging from 0° C. to the boiling point of the solvent. Examples for the hydrogenation in the presence of a nickel catalyst can be found in Journal of Organometallic Chemistry, 333(2), 139-53; 1987. Examples for the hydrogenation in the presence of a palladium catalyst can be found in Tetrahedron, 63(26), 6015-6034; 2007 or in Bioorganic & Medicinal Chemistry, 9(11), 2863-2870; 2001. Examples for the hydrogenation in the presence of a platinum catalyst can be found in Journal of Organic Chemistry, 53(2), 386-90; 1988 or in Journal of Medicinal Chemistry, 32(8), 1820-35; 1989

6) Compounds of formula (IV) may be obtained by condensation reaction from compounds of formula (V). The reaction can be carried out analogously to procedure 2 or procedures 3 and 4 as shown in Scheme 2.

7) Alternatively, as seen in scheme 3, compounds of formula (Ib) may be obtained from compounds of formula (IIIa). The reaction can be carried out analogously to procedure 2 or procedures 3 and 4 as shown in Scheme 2.

8) Compounds of formula (IIIa) may be obtained from compounds of (V) by catalytic hydrogenation. The reaction can be carried out analogously to procedure 5 as shown in Scheme 3.

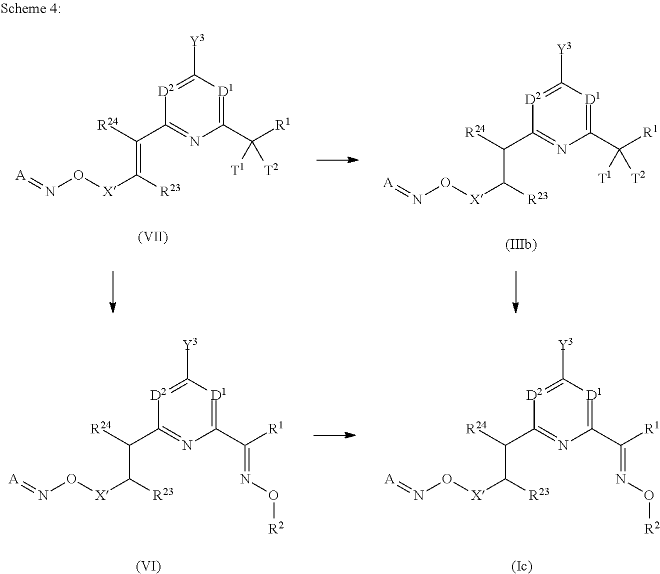

9) Alternatively, as seen in scheme 4, compounds of formula (Ic), that is a compound of formula I wherein Z³, Z⁶, Z⁷, Z¹⁰, Z¹¹ and Z¹² are as defined herein for compounds of formula (I) (depicted in the scheme as X′); CHR²³ represents Z⁴, Z⁸ or Z¹³; CHR²⁴ represents Z⁵, Z⁹ or Z¹⁴; R²³ and R²⁴ independently of one another represent hydrogen, halogen, C₁-C₄ alkyl, C₁-C₄ haloalkyl, phenyl or CN, wherein phenyl is optionally substituted by one or more groups, e.g. one to five groups, independently selected from halogen, CN, C₁-C₄ alkyl, C₁-C₄ haloalkyl, C₁-C₄ alkoxy and C₁-C₄ haloalkyoxy, may be prepared by catalytic hydrogenation from compound (VI) in the presence of a metal catalyst like for example palladium, nickel or platinum. The reaction is usually carried out in the presence of a solvent under a hydrogen atmosphere. In some cases it is necessary to apply pressure in the range of 1 to 100 bar. Suitable solvents for such reactions are alcohols, such as methanol or ethanol, cyclic ethers, such as dioxane or tetrahydrofuran or esters like ethyl acetate. The reaction is usually carried out at a reaction temperature ranging from 0° C. to the boiling point of the solvent.

Examples for the hydrogenation in the presence of a nickel catalyst can be found in Journal of Organic Chemistry, 69(6), 1959-1966; 2004. Examples for the hydrogenation in the presence of a palladium catalyst can be found in Journal of Organic Chemistry, 74(16), 6072-6076; 2009. Examples for hydrogenation in the presence of a platinum catalyst can be found in Organometallics, 5(2), 348-55; 1986.

10) Compounds of formula (VI) may be obtained by condensation reaction from compounds of formula (VII). The reaction can be carried out analogously to procedure 2 or procedures 3 and 4 as shown in Scheme 2.

11) Alternatively, as seen in scheme 4, compounds of formula (Ic) may be obtained from compounds of formula (IIIb), that is a compound of formula (III) wherein Z³, Z⁶, Z⁷, Z¹⁵, Z¹¹ and Z¹² are as defined herein for compounds of formula (I) (depicted in the scheme as X′); CHR²³ represents Z⁴, Z⁵ or Z¹³; CHR²⁴ represents Z⁵, Z⁹ or Z¹⁴; R²³ and R²⁴ independently of one another represent hydrogen, halogen, C₁-C₄ alkyl, C₁-C₄ haloalkyl, phenyl or CN, wherein phenyl is optionally substituted by one or more groups, e.g. one to five groups, independently selected from halogen, CN, C₁-C₄ alkyl, C₁-C₄ haloalkyl, C₁-C₄ alkoxy and C₁-C₄ haloalkyoxy. The reaction can be carried out analogously to procedure 2 or procedures 3 and 4 as shown in Scheme 2.

12) Compounds of formula (IIIb) may be obtained from compounds of (VII) by catalytic hydrogenation. The reaction can be carried out analogously to procedure 9 as shown in Scheme 4.

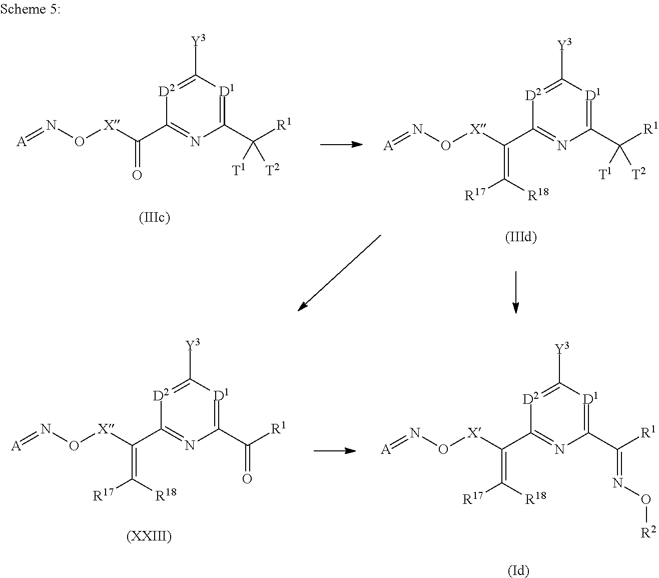

13) Alternatively, as seen in scheme 5, compounds of formula (Id), that is a compound of formula (I) wherein Z⁵, Z⁹ or Z¹⁴ represent C═CR¹⁷R¹⁸ (Z³, Z⁴, Z⁶, Z⁷, Z⁸, Z¹⁰, Z¹¹, Z¹² and Z¹³ are depicted by X″ in the scheme) may be obtained from compounds of formula (IIId), that is a compound of formula (III) wherein Z⁶, Z⁹ or Z¹⁴ represent C═CR¹⁷R¹⁸ (Z³, Z⁴, Z⁶, Z⁷, Z⁸, Z¹⁰, Z¹¹, Z¹² and Z¹³ are depicted by X″ in the scheme). The reaction can be carried out analogously to procedures procedure 2 or procedures 3 and 4 as shown in Scheme 2. In certain cases it may be appropriate to deprotect the ketone function first to obtain compounds of formula (XXIII) wherein X″ represents

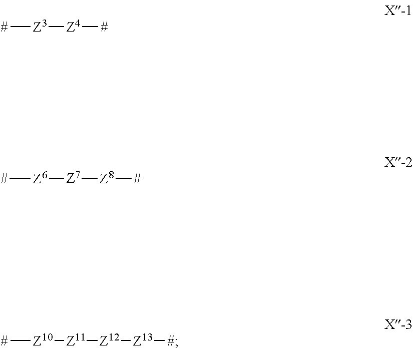

D¹, D², A, R¹, R¹⁷, R¹⁸, Y¹, Y², Y³, Z³, Z⁴, Z⁶, Z⁷, Z⁸, Z¹⁰, Z¹¹, Z¹² and Z¹³ are as defined for a compound of formula (I).

14) Compounds of formula (IIId) may be obtained from compounds of (IIIc), that is a compound of formula (III) wherein Z⁵, Z⁹ or Z¹⁴ represent C═O (Z³, Z⁴, Z⁶, Z⁷, Z⁸, Z¹⁰, Z¹¹, Z¹² and Z¹³ are depicted by X″ in the scheme). This can be done using one of several techniques well known to the person skilled in the art, including Wittig reaction or condensation reactions. The Wittig reaction comprises the reaction between an aldehyde or a ketone, for instance the ketone of formula (IIIc), and a phosphorous ylide. Phosphorous ylides are usually prepared by treatment of a phosphonium salt with a base and phosphonium salts are usually prepared from a triarylphosphine and an alkyl halide. Several improvements and modification of the Wittig reaction are known and are described in the literature well known to the person skilled in the art, for example in March's Advanced Organic Chemistry: Reaction, Mechanisms and Structure, Sixth Edition, 2007 and references therein. Specific reaction conditions may be found in Journal of the American Chemical Society, 131(34), 12344-12353; 2009; Journal of Medicinal Chemistry, 51(22), 7193-7204; 2008 or Journal of Organic Chemistry, 74(11), 4166-4176; 2009.

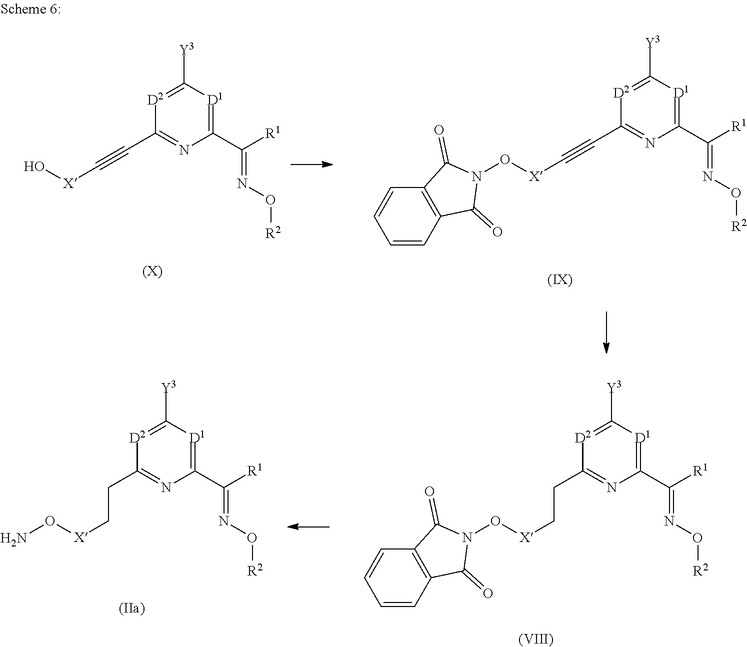

15) Compounds of formula (IIa), that is a compound of formula (II) wherein Z⁴, Z⁵, Z⁸, Z⁹, Z¹³ and Z¹⁴ represent methylene (Z³, Z⁶, Z⁷, Z¹⁰, Z¹¹ and Z¹² are depicted by X′ in the scheme) may be obtained from compounds of (VIII) by cleavage of the phthalimide protecting group. Examples for such deprotections can be found in Greene, T. W., Wuts, P. G. N., Protective Groups in Organic Synthesis, John Wiley & Sons, Inc, 2006.

16) Compounds of formula (VIII) may be obtained by catalytic hydrogenation from compounds of formula (IX). The reaction may be carried out analogously as shown in Scheme 3 for procedure 5.

17) Compounds of formula (IX) may be prepared from compounds of formula (X) by a Mitsunobu reaction. The Mitsunobu reaction comprises the substitution of primary or secondary alcohols with nucleophiles, for example N-hydroxyphthalimide, as seen in Scheme 6, in the presence of a dialkyl azodicarboxylate and a trialkyl- or triaryl phosphine. Several improvements and modifications of the Mitsunobu reaction are known and are described in the literature and are well known to the person skilled in the art, for example in March's Advanced Organic Chemistry: Reaction, Mechanisms and Structure, Sixth Edition, 2007 and references therein. Specific reaction conditions may be found in Organic Preparations and Procedures International, 26(1), 111-13; 1994; Organic Letters, 11(9), 2019-2022; 2009; Tetrahedron Letters, 48(4), 647-650; 2007 or Journal of Organic Chemistry, 70(17), 6995-6998; 2005

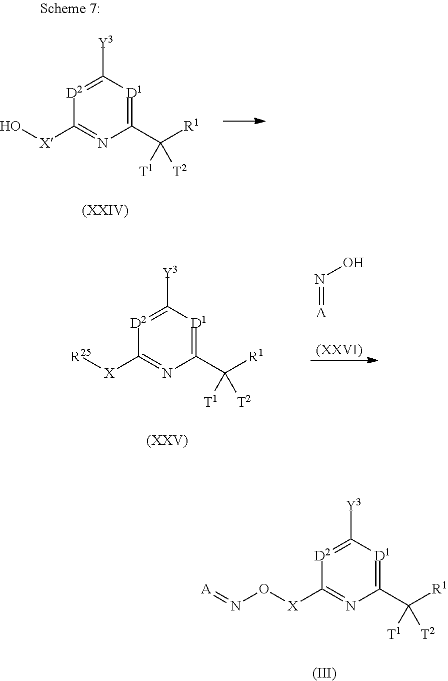

(18) Compounds of formula (III) may be prepared by reacting compounds of formula (XXV) wherein D¹, D², X, Y¹, Y² and Y³ and R¹ are as defined herein for compounds of formula (I) and T¹ and T² are C₁-C₈ alkoxy, or T¹ and T² together with the carbon they are attached to form a carbonyl group or an acetal or ketal function of the form C(O—C₁-C₆-alkylidene-O) whereby the alkylidene fragment may optionally be mono- to tetra-substituted by C₁-C₆ alkyl and R²⁷ is a halogen, in particular chlorine, bromine or iodine, or a sulfonic acid ester group, such as mesylate, tosylate, triflate, phenylsulfonic acid ester, nitro-phenylsulfonic acid ester, or nonafluorobutylsulfonic acid ester and a compound of formula (XXVI) wherein A and R¹ are as defined herein for compounds of formula (I). The alkylation reaction can be carried out analogously to procedure 3 as shown in Scheme 1.

(19) Compounds of formula (XXV) can be prepared from compounds of formula (XXIV), wherein D¹, D², X, Y¹, Y² and Y³ and R¹ are as defined herein for compounds of formula (I) and T¹ and T² are C₁-C₈ alkoxy, or T¹ and T² together with the carbon they are attached to form a carbonyl group or an acetal or ketal function of the form C(O—C₁-C₆-alkylidene-O) whereby the alkylidene fragment may optionally be mono- to tetra-substituted by C₁-C₆ alkyl. Such transformations can be affected using a number of conditions well known to the person skilled in the art.

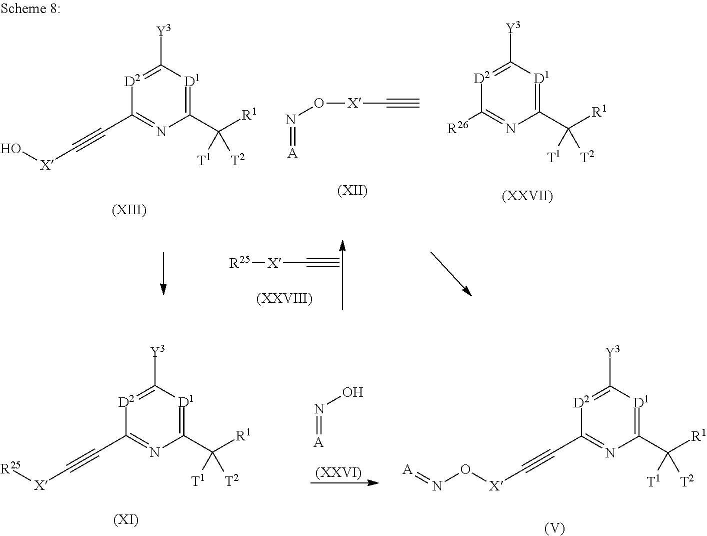

(20) Compounds of formula (V) may be prepared from compounds of formula (XI) and compounds of formula (XXVI). The alkylation reaction can be carried out analogously as shown in Scheme 1 for procedure 3.

(21) Compounds of formula (XI) can be prepared from compounds of formula (XIII). Such transformations can be effected using a number of conditions well known to the person skilled in the art.

(22) Alternatively as seen in Scheme 8 compounds of (V) may be prepared by a Sonogashira reaction of compounds of formula (XXVII) wherein R²⁶ is Cl, Br, I or a sulfonate; T¹ and T² are C₁-C₈ alkoxy, or T¹ and T² together with the carbon they are attached to form a carbonyl group or an acetal or ketal function of the form C(O—C₁-C₆-alkylidene-O) whereby the alkylidene fragment may optionally be mono- to tetra-substituted by C₁-C₆ alkyl; and D¹, D², Y¹, Y², Y³ and R¹ are as defined herein for compounds of formula (I) with compounds of formula (XII). The reaction can be carried out in the presence of a palladium catalyst, for example tetrakis triphenyphosphine palladium (0) or dichlorobis (triphenylphosphine) palladium(II), a copper(I) salt like copper (I) chloride; copper (I) bromide or copper (I) iodide and a base, for example triethylamine, ethyldiisopropylamine, diethylamine, diisopropylamine or dicyclohexylamine. Where possible, the base may also serve as solvent. Examples for other suitable solvents are N,N-dimethylformamide, N,N-di methylacetamide, acetonitrile, dimethylsulfoxide, dioxane or tetrahydrofuran. The reaction is usually carried out at a reaction temperature ranging from 0° C. to the boiling point of the solvent. Examples of Sonogashira reactions can be found in Handbook of Organopalladium Chemistry for Organic Synthesis 2002,1, 493-529.

(23) Compounds of formula (XII) may be prepared by an alkylation reaction from compounds of formula (XXVI) and compounds of (XXVIII) wherein X′ represents X′-1, X′-2 or X′-3

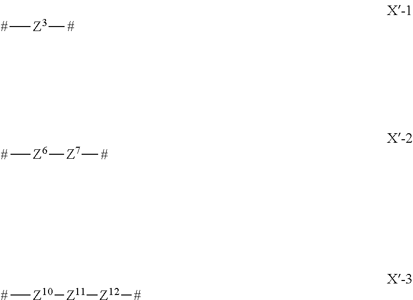

Z³, Z⁴, Z⁶, Z⁷, Z¹⁰, Z¹¹ and Z¹² are as defined herein for a compound of formula (I);

and R²⁵ is a halogen, in particular chlorine, bromine or iodine, or a sulfonic acid ester group, such as mesylate, tosylate, triflate, phenylsulfonic acid ester, nitro-phenylsulfonic acid ester, or nonafluorobutylsulfonic acid ester. Many of such compounds (XXVIII) are known in the literature and are commercially available or can be prepared by methods well known to the person skilled in the art.

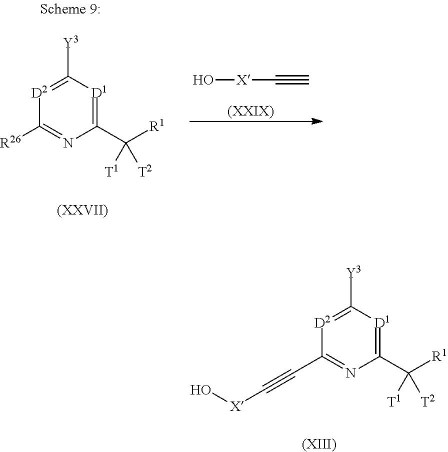

(24) Compounds of formula (XIII) may be prepared by a Sonogashira reaction from compounds of formula (XXIX) wherein X′ represents X′-1, X′-2 or X′-3

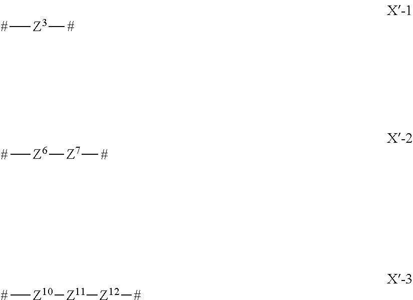

Z³, Z⁴, Z⁶, Z⁷, Z¹⁰, Z¹¹ and Z¹² are as defined herein for a compound of formula (I); and compounds of (XXVII). The Sonogashira reaction can be carried out analogously to procedure 22 as shown in Scheme 8.

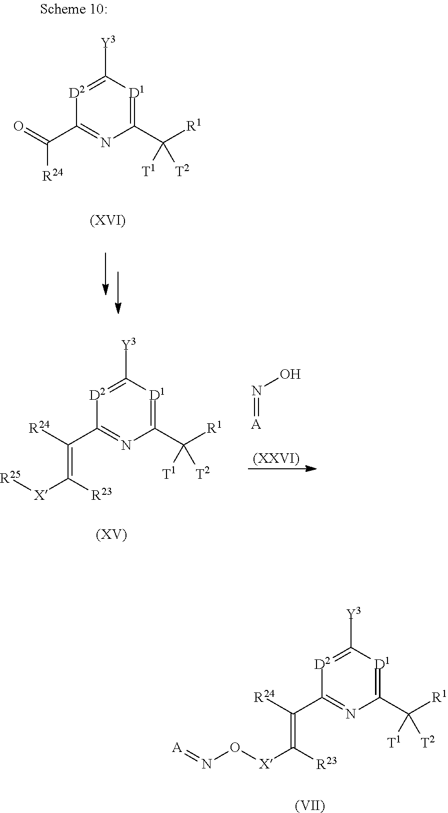

(25) Compounds of formula (XIV) may be prepared from compounds of formula (XV) and compounds of formula (XXVI). The alkylation reaction can be carried out analogously to procedure 3 as shown in Scheme 2.

(26) Compounds of formula (XV) may be prepared from compounds of formula (XVI) in a multistep synthesis. This can be done using one of several techniques well known to the person skilled in the art, including Wittig reaction or Horner-Wadsworth Emmons reactions in the first step and further transformations as seen in Scheme 11.

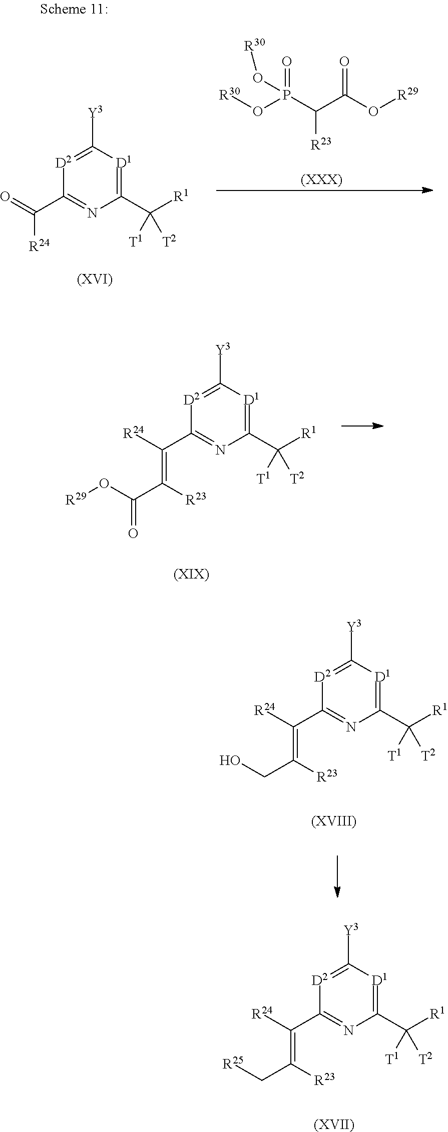

(27) Compounds of formula (XVII) may be prepared from compounds of formula (XVIII). Such transformations can be effected using a number of conditions well known to the person skilled in the art.

(28) Compounds of formula (XVIII) may be prepared from compounds of formula (XIX) by reduction with a metal hydride, for example lithium aluminium hydride or diisobutyl aluminium hydride. Examples for such reductions can found in Journal of Combinatorial Chemistry, 7(6), 958-967; 2005. The reaction is usually carried out at temperatures between −100 to 20° C. in the presence of a solvent.

(29) Compounds of formula (XIX) can be prepared from compounds of formula (XVI) and a phosphonate of formula (XXX) wherein R²⁹ and R³⁰ are C₁-C₄ alkyl using a Horner-Wadsworth Emmons reaction. The reaction is carried out in the presence of a base. Appropriate bases are for example metal hydrides like calcium, lithium, sodium or potassium hydride, organometal compounds like buthyllithium or organic bases like for example triethylamine or ethyldiisopropylamine in combination with lithium chloride. Examples can be found in Bioorganic & Medicinal Chemistry, 11(18), 4015-4026; 2003; Synthesis, (4), 283-5; 1981 or in Journal of Medicinal Chemistry, 53(3), 1200-1210; 2010

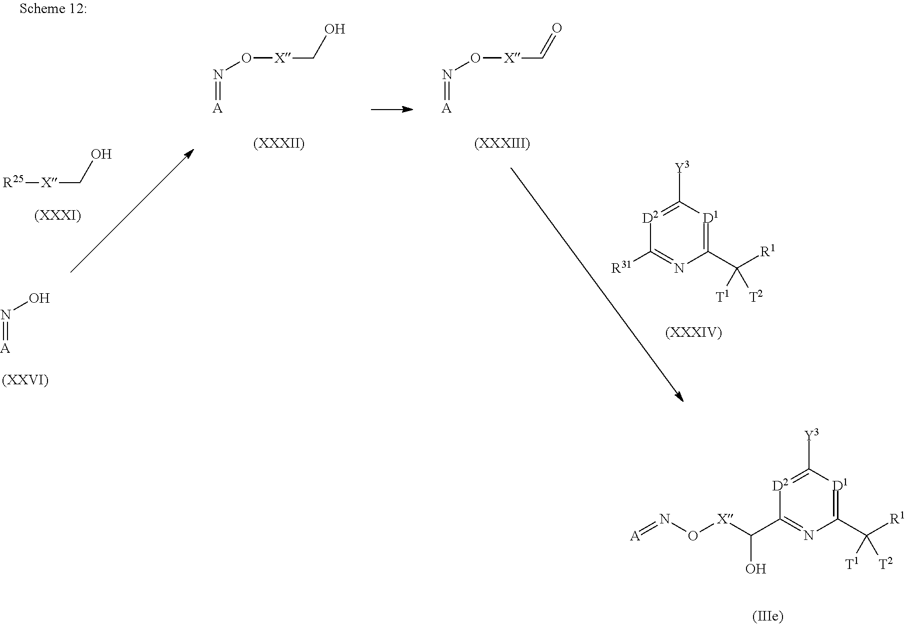

(30) Compounds of formula (IIIe), that is a compound of formula (III) wherein Z², Z⁵, Z⁹ and Z¹⁴ represent CR¹⁵R¹⁶ wherein R¹⁵ represents H and R¹⁶ represents OH (Z¹, Z³, Z⁴, Z⁶, Z⁷, Z⁸, Z¹⁰, Z¹¹, Z¹² and Z¹³ are depicted by X″ in the scheme) may be prepared from aldehydes of formula (XXXIII) and compounds of formula (XXXIV) wherein R³¹ is chlorine, bromine or iodine and D¹, D², Y³, R¹, T¹ and T² are as defined for a compound of formula (III). Such a transformation may be performed by halogen metal exchange in compound (XXXIV) with an appropriate reagent like for example magnesium, isopropyl magnesium chloride, or n-buthyllithium and the reaction of this metalated pyridine intermediate with a compound of formula (XXXIII) wherein X″ represents

X″-1, X″-2, X″-3 or X″-4

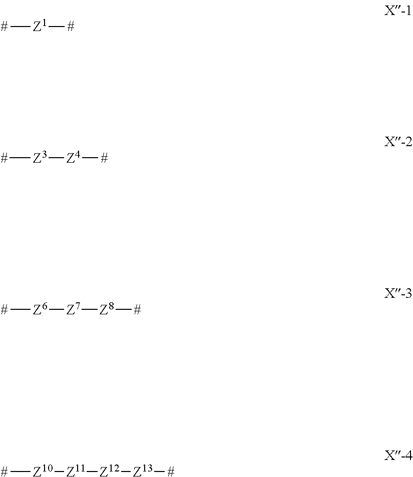

wherein A, Z¹, Z³, Z⁴, Z⁶, Z⁷, Z⁸, Z¹⁰, Z¹¹, Z¹² and Z¹³ are as defined herein for compounds of formula (I);
Examples for such transformations can be found in Angewandte Chemie, International Edition, 43(25), 3333-3336; 2004; Organic Letters, 6(26), 4905-4907; 2004; Journal of the American Chemical Society, 130(38), 12592-12593; 2008 or in Organic Letters, 11(20), 4540-4543; 2009

Compounds of formula (IIIe) are especially useful as intermediates to a number of other compounds, wherein the hydroxy group formed is transformed into other functional groups, for example acid halides. Such transformations can be effected using a number of conditions well known to the person skilled in the art.

(31) Compounds of formula (XXXIII) may be prepared by oxidation from compounds of formula (XXXII). Such oxidations can be affected using a number of conditions well known to the person skilled in the art. Specific reaction conditions may be found in Organic & Biomolecular Chemistry, 6(21), 4036-4040; 2008; Bioorganic & Medicinal Chemistry Letters, 19(13), 3627-3631; 2009; Chemical Communications (Cambridge, United Kingdom), (37), 5618-5620; 2009; or in Synthesis, (1), 91-97; 2010.

(32) Compounds of formula (XXXII) may be prepared from compound of formula (XXVI) and compounds of formula (XXXI) wherein X″ represents

X″-1, X″-2, X″-3 or X″-4

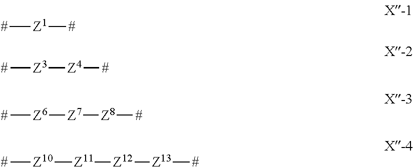

wherein Z¹, Z³, Z⁴, Z⁶, Z⁷, Z⁸, Z¹⁰, Z¹¹, Z¹² and Z¹³ are as defined herein for compounds of formula (I);

and R²⁵ is a halogen, in particular chlorine, bromine or iodine, or a sulfonic acid ester group, such as mesylate, tosylate, triflate, phenylsulfonic acid ester, nitro-phenylsulfonic acid ester, or nonafluorobutylsulfonic acid ester. Many of such compounds are known in the literature and are commercially available or can be prepared by methods well known to the person skilled in the art. The alkylation reaction can be carried out analogously to procedure 3 as shown in Scheme 2.

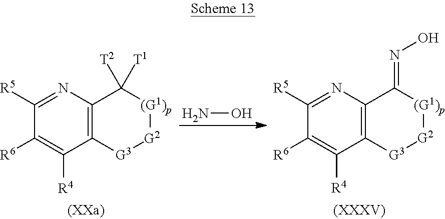

33) Oximes of formula (XXXV) may be obtained by a condensation reaction, whereby a compound of formula (XXa), that is a compound of formula XX (wherein R²⁷ represents A-9 and T¹ and T² together with the carbon they are attached to form a carbonyl group is reacted with hydroxylamine, or, alternatively, with a salt of hydroxylamine. A more detailed description of condensation processes is given below.

Related references include the following: Journal of Heterocyclic Chemistry, 46(1), 116-118; 2009; Journal of Medicinal Chemistry, 20(5), 718-21; 1977; Journal of Organic Chemistry, 73(11), 4017-4026; 2008; EJEAFChe, Electronic Journal of Environmental, Agricultural and Food Chemistry, 5(5), 1515-1521; 2006; Advanced Synthesis & Catalysis, 346(13-15), 1798-1811; 2004.

Some compounds of formula (XXa) are known and their preparation has been published or they are available commercially. A few typical examples are given in Table 35 together with the corresponding CAS numbers. Analogous protocols to those used to prepare the following compounds can be used to prepare other compounds of formula (XXa).

TABLE 35

| | |
|---|---|
| 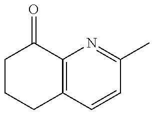 | 849643-01-2 |
| 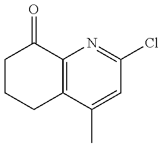 | 904915-35-1 |
| 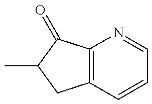 | 31170-79-3 |
| 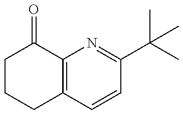 | 263566-88-7 |
| 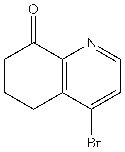 [SMILES: O=C1CCCc2c(Br)ccnc21] | 1196155-16-4 |
| 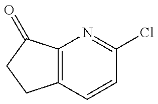 [SMILES: O=C1CCc2ccc(Cl)nc21] | 1150617-92-7 |
| 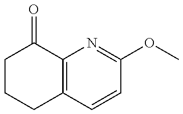 | 209741-58-2 |
| 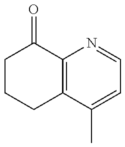 | 73123-86-1 |
| 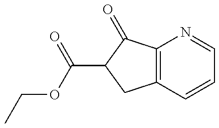 | 52402-29-6 |
| 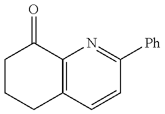 [SMILES: O=C1CCCc2ccc(-c3ccccc3)nc21] | 78590-01-9 |
| 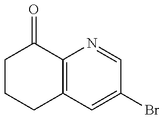 [SMILES: O=C1CCCc2cc(Br)cnc21] | 904929-24-4 |
| 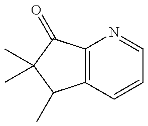 | 76474-76-5 |
| 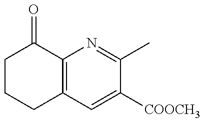 [SMILES: COC(=O)c1cc2c(nc1C)C(=O)CCC2] | 212762-37-3 |
| 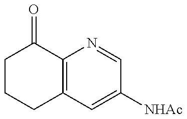 [SMILES: CC(=O)Nc1cnc2c(c1)CCCC2=O] | 331759-68-3 |
| 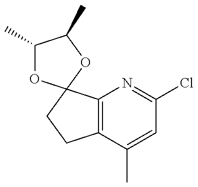 [SMILES: Cc1cc(Cl)nc2c1CCC21O[C@H](C)[C@@H](C)O1] | 745075-86-9 |
| 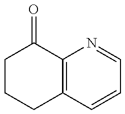 [SMILES: O=C1CCCc2cccnc21] | 56826-69-8 |
| 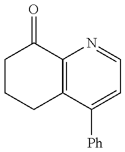 [SMILES: O=C1CCCc2c(-c3ccccc3)ccnc21] | 135761-75-0 |
| 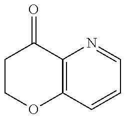 [SMILES: O=C1CCOc2cccnc21] | 405174-48-3 |
| 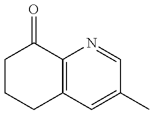 | 62230-65-3 |
| 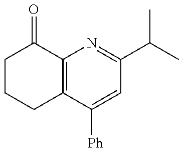 [SMILES: CC(C)c1cc(-c2ccccc2)c2c(n1)C(=O)CCC2] | 906668-73-3 |
| 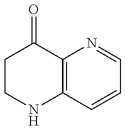 [SMILES: O=C1CCNc2cccnc21] | 1211528-89-0 |
| 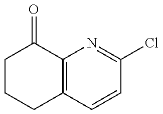 [SMILES: O=C1CCCc2ccc(Cl)nc21] | 129337-86-6 |
| 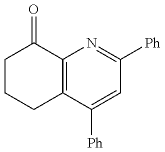 [SMILES: O=C1CCCc2c(-c3ccccc3)cc(-c3ccccc3)nc21] | 1033623-16-3 |
| 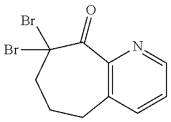 [SMILES: O=C1c2ncccc2CCCC1(Br)Br] | 41043-16-7 |
| 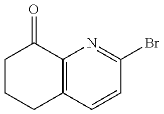 [SMILES: O=C1CCCc2ccc(Br)nc21] | 130861-70-010 |
| 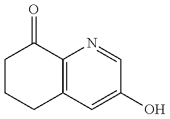 [SMILES: O=C1CCCc2cc(O)cnc21] | 1196153-30-6 |
| 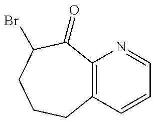 [SMILES: O=C1c2ncccc2CCCC1Br] | 41043-14-5 |
| 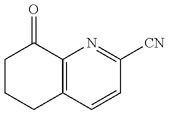 [SMILES: N#Cc1ccc2c(n1)C(=O)CCC2] | 399042-43-4 |
| 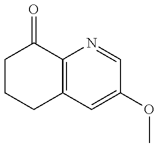 | 558444-62-5 |
| 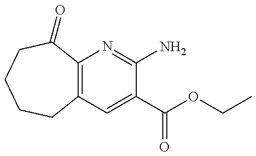 [SMILES: CCOC(=O)c1cc2c(nc1N)C(=O)CCCC2] | 908231-09-4 |
| 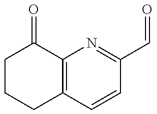 [SMILES: O=Cc1ccc2c(n1)C(=O)CCC2] | 238755-38-9 |
| 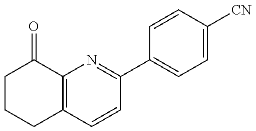 [SMILES: N#Cc1ccc(-c2ccc3c(n2)C(=O)CCC3)cc1] | 4231162-28-3 |
| 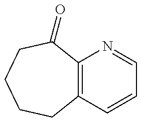 [SMILES: O=C1CCCCc2cccnc21] | 41043-13-4 |
| 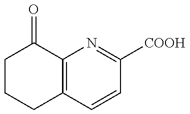 [SMILES: O=C(O)c1ccc2c(n1)C(=O)CCC2] | 238755-39-0 |
| 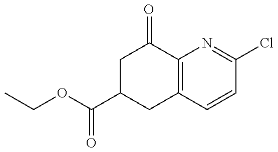 [SMILES: CCOC(=O)C1CC(=O)c2nc(Cl)ccc2C1] | 864830-54-6 |
| 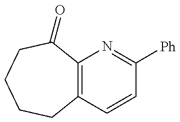 [SMILES: O=C1CCCCc2ccc(-c3ccccc3)nc21] | 78509-53-2 |
| 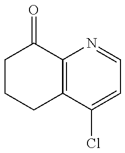 [SMILES: O=C1CCCc2c(Cl)ccnc21] | 1196156-61-2 |
| 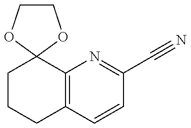 [SMILES: N#Cc1ccc2c(n1)C1(CCC2)OCCO1] | 399042-44-5 |
| 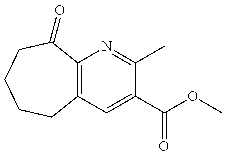 [SMILES: COC(=O)c1cc2c(nc1C)C(=O)CCCC2] | 212762-38-4 |
| 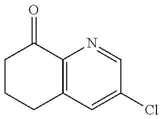 [SMILES: O=C1CCCc2cc(Cl)cnc21] | 1196151-83-3 |
| 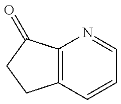 | 31170-78-2 |

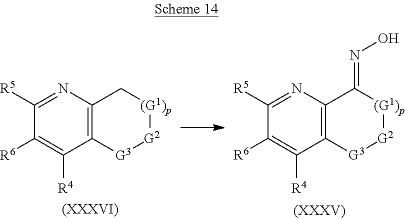

34) Alternatively, oximes of formula (XXXV) can be obtained by a nitrosation reaction of compounds of formula (XXXVI), wherein G¹, G², G³, p, R⁴, R⁵ and R⁶ are as defined herein for compounds of formula (I), with base and an alkyl nitrite, as seen in scheme 14. Typical bases include lithium diisopropyl amide (LDA), lithium hexamethyldisilazane, n-butyl lithium, s-butyl lithium, tert-butyl lithium, sodium tert-butylate or potassium tert-butylate. Typical alkyl nitrites include isopentyl nitrite and tert-butyl nitrite. The compound of formula (XI), the alkyl nitrite or the base can be used in different stoichiometric amounts, with each reagent possibly being in excess with respect to the others. Preferentially, such reactions are carried out under non-aqueous conditions in an inert solvent such as hexane, heptanes, cyclohexane, toluene or ethers such as THF or tert-butyl methyl ether. The reaction may be performed at temperatures ranging from −80 to 250° C., preferably between −50 and 120° C.

Such reactions can lead to a mixture of the E- and the Z-oxime (ether) product, or the product may also be exclusively either the E- or the Z-oxime (ether).

A large number of these types of transformations are known in the art. Typical reaction conditions for this type of reaction may be found in Crawford, Jason B.; Chen, Gang; Gauthier, David; Wilson, Trevor; Carpenter, Bryon; Baird, Ian R.; McEachern, Ernie; Kaller, Alan; Harwig, Curtis; Atsma, Bem; Skerlj, Renato T.; Bridger, Gary J., Organic Process Research & Development (2008), 12(5), 823-830, McEachern, E. J.; Yang, W.; Chen, G.; Skerlj, R. T.; Bridger, G. J., Synthetic Communications (2003), 33(20), 3497-350; and Bark, Thomas; Thummel, Randolph P., Inorganic Chemistry (2005), 44(24), 8733-8739.

Ketone intermediates of formula XXb, that is a compound of formula XX (wherein R²⁷ is A-10 and T¹ and T² together with the carbon they are attached to form a carbonyl group; XXc, that is a compound of formula XX wherein R²⁷ is A-7 and T¹ and T² together with the carbon they are attached to form a carbonyl group; XXd, that is a compound of formula XX wherein R²⁷ is A and T¹ and T² together with the carbon they are attached to form a carbonyl group -8 may be prepared by a variety of methods, illustrated in schemes 15-17.

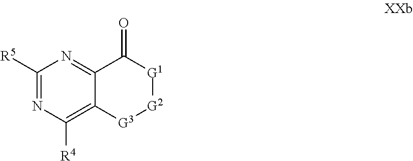

Some compounds of formula (XXb) are known and their preparation has been published or they are available commercially. A few typical examples are given in Table 36 together with the corresponding CAS numbers.

TABLE 36

| | |
|---|---|
| 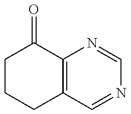 [SMILES: O=C1CCCc2cncnc21] | 89967-17-9 |
| 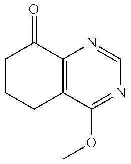 | 64571-29-5 |
| 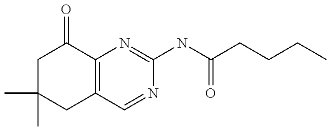 [SMILES: CCCCC(=O)Nc1ncc2c(n1)C(=O)CC(C)(C)C2] | 420824-47-1 |
| 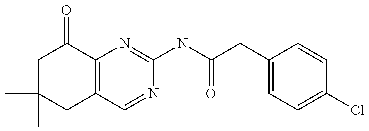 [SMILES: CC1(C)CC(=O)c2nc(NC(=O)Cc3ccc(Cl)cc3)ncc2C1] | 420824-53-9 |
| 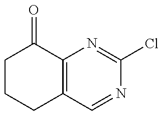 [SMILES: O=C1CCCc2cnc(Cl)nc21] | 1105664- 58-1 |
| 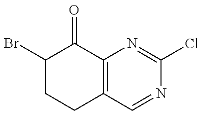 [SMILES: O=C1c2nc(Cl)ncc2CCC1Br] | 1105664- 60-5 |
| 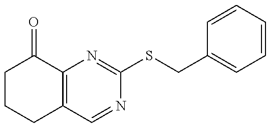 [SMILES: O=C1CCCc2cnc(SCc3ccccc3)nc21] | 802541-55-5 |

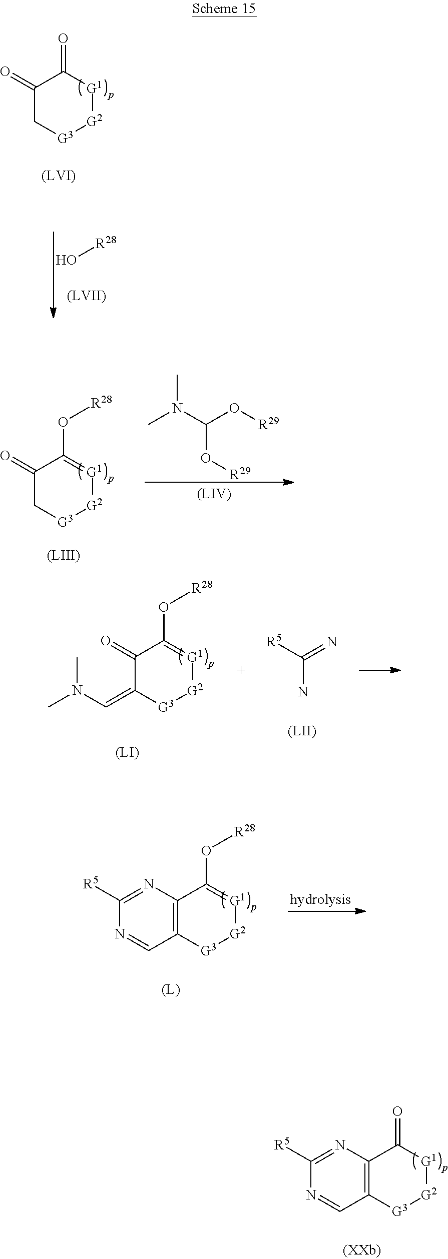

35) Compounds of formula (XXb) can be obtained by acidic hydrolysis methods, well known to the person skilled in the art of compounds of formula (L), wherein G¹, G², G³, p, R⁴ and R⁵ are as defined herein for compounds of formula (I) and R²⁸ is alkyl.

37) Enolethers of formula (L) can be obtained by reacting enaminone of formula (LI) wherein G¹, G², G³, p, R⁴ and R⁵ are as defined herein for compounds of formula (I) and R²⁸ is alkyl with amidines or guanidines of formula (LII) wherein R⁵ is a defined for compounds of formula (I). Such condensation reactions can be performed using a number of conditions well known to the person skilled in the art. Such reactions are carried out in the presence of a base preferentially sodium or potassium alcoholate in ethanol or methanol. Specific reaction conditions may be found in Synthesis, 1012-1018, 1996; J. Heterocycl. Chem. 20, 649-653, 1983 or in WO2009010488.

38) Enaminone of formula (LI) can be obtained by reacting ketone of formula (LIII) wherein G¹, G², G³ and p are as defined herein for compounds of formula (I) and R²⁸ is alkyl with N,N-dimethylformamide dialkyl acetal of formula (LIV) wherein R²⁹ is alkyl. Such condensation reactions are well known to the person skilled in the art. The reaction is carried out in an inert solvent or without solvent at temperatures ranging from 0° C. to 250° C., preferably between 50 and 160° C. Specific reaction conditions may be found in Synthesis, (97), 3397, 1964; Synthesis, (97), 3407, 1964; Journal of Med. Chem., Vol. 52, No. 16, 5152-5163; Tetrahedron Lett, (27), 2567, 1986; Tetrahedron Lett, (50), 2255-2264, 1994; Synthetic Commun., (28), 10, 1743-1753, 1998 or in Chem. Ber., (104), 2975, 1971.

39) Enol ether of formula (LIII) can be obtained by reacting ketones of formula (LVI) wherein G¹, G², G³ and p are as defined herein for compounds of formula (I) with an alcohol of formula (LVII) wherein R²⁸ is alkyl. Such enol reactions can be affected using a number of conditions well known to the person skilled in the art. Specific reaction conditions may be found in WO2004104007.

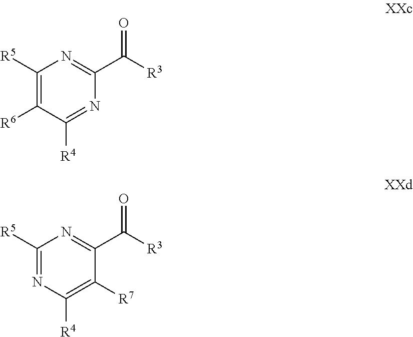

Some compounds of formula (XXc) or (XXd) are known and their preparation has been published or they are available commercially. A few typical examples are given in Table 37 together with the corresponding CAS numbers.

TABLE 37

| | |
|---|---|
| 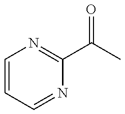 | 53342-27-1 |
| 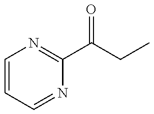 | 54643-09-3 |
| 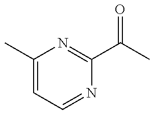 | 71850-85-6 |
| 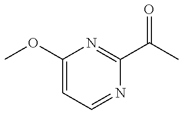 | 463337-53-3 |
| 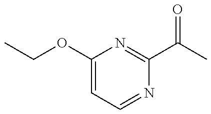 | 145947-97-3 |
| 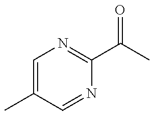 | 122372-22-9 |
| 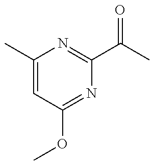 | 64571-49-9 |
| 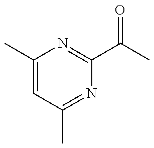 | 64571-50-2 |
| 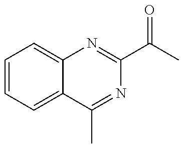 | 126994-78-3 |
| 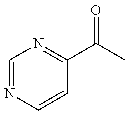 | 39870-05-8 |
| 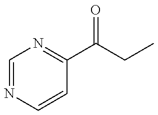 | 54643-10-6 |
| 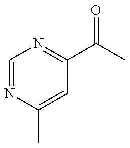 | 67073-96-5 |
| 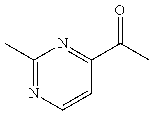 | 67860-38-2 |
| 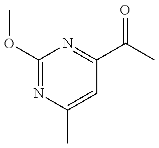 | 64571-47-7 |
| 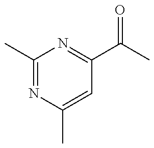 | 73937-21-0 |
| 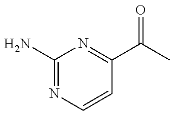 | 106157-82-8 |
| 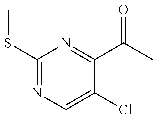 | 122372-21-8 |
| 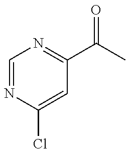 | 210295-81-1 |

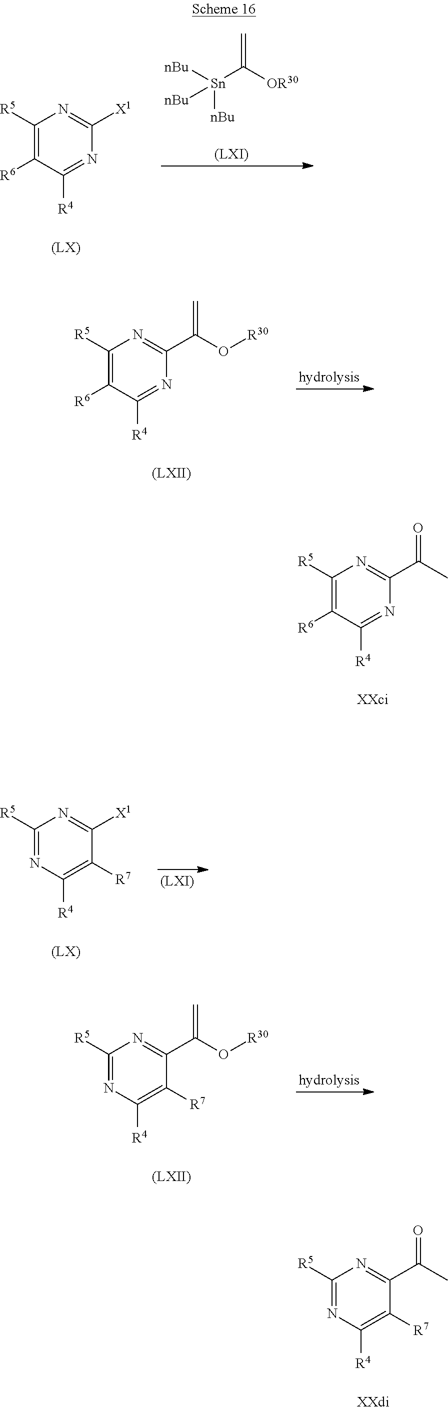

40) Ketone intermediates of formula (XXci) or (XXdi), that is compounds of formula) XXc and XXd wherein R³ is methyl can be obtained by a Stille cross-coupling reaction of the halo pyrimidine derivative of formula (LX) wherein X¹ is a halogen, preferably chlorine or bromine and R⁴, R⁵ and R⁶ are as defined for compounds of formula (I) with tri-n-butyl(1-ethoxyvinyl)tin (LXI) wherein R³⁰ is alkyl to give the vinyl ether of formula (LXII), wherein R⁴, R⁵ and R⁶ are as defined for compounds of formula (I) and R³⁰ is alkyl which by acidic hydrolysis methods give the desired ketone intermediate of formula (XXc) or (XXd). Examples for such Stille cross-coupling reaction can be found in Angew. Chem. Int. Ed. Engl., 25, 508-524 (1986); Bull. Chem. Soc. Jpn. 60, 767, 1987; Tetrahedron, 45, 993-1006 (1989); Acta Chem. Scand., 43, 62-68 (1989); Tetrahedron (1996), 52(15), 5625-38 or Angewandte Chemie, International Edition (2002), 41(7), 1195-1198.

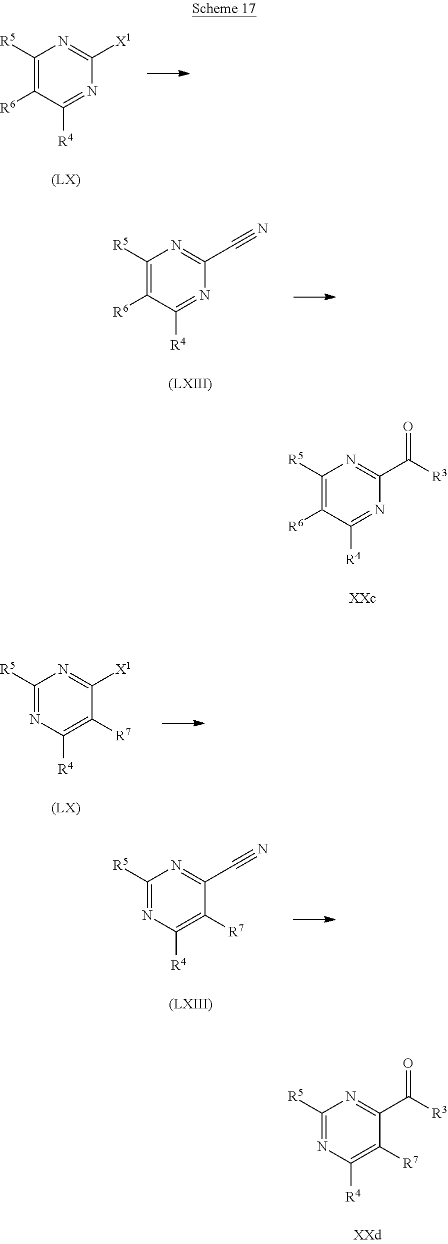

41) Alternatively compounds of formula (LX) can be converted to the corresponding nitrile of formula (LXIII) wherein R⁴, R⁵, R⁶ and R⁷ are as defined for compounds of formula (I) by well known standard procedures. A subsequent reaction of nitrile derivative of formula (LXII) with a Grignard reagent of the formula R₃—MgBr, wherein R₃ is as defined under formula IIA, yields the ketone intermediate of formula (XX A-2) or (XX A-3) as described in scheme 17.

Typical Conditions for Condensation Reactions:

This applies to procedures 1, 2, 4, 6, 7, 10, 11, 13.

Different stoichiometric set-ups may be used for these reactions, depending on the properties of reactants and product. An excess of the electrophile, the nucleophile, or equimolar amounts may be chosen. Preferentially equimolar amounts of electrophilic and nucleophilic compounds are used.

The reaction may be performed in the presence or absence of an inert organic or inorganic solvent, or in the presence of a mixture of such solvents. Preferentially, it is performed in the presence of one or more solvents. Preferred solvents include the following aliphatic or aromatic hydrocarbons, which may optionally be substituted by one or more halogen atoms, such as pentane, hexanes, heptanes, cyclohexane, petroleum ether, benzene, toluene, xylene, chlorobenzene, dichlorobenzenes, dichloromethane, chloroform, 1,2-dichloroethane or carbon tetrachloride, ethers such as diethylether, diisopropyl ether, tert-butyl methyl ether, tetrahydrofuran, 1,4-dioxane, dimethoxyethane or diglycol dimethyl ether, ketones such as acetone, methyl ethyl ketone, methyl isopropyl ketone or methyl isobutyl ketone, acids and ester such as acetic acid, ethyl acetate or methyl acetate, aprotic polar solvents such as acetonitrile, pripionitril, dimethyl formamide, dimethyl acetamide, N-methyl-pyrrolidone, dimethyl sulfoxide, sulfolane, DMPU, or pyridine and picolines. The selection of solvents includes water and alcohols such as methanol, ethanol, propanol, isopropanol, butanol, isobutanol, tert-butanol, pentanol, isopentanol, hexanol, trifluorethanol, ethylene glycol or methoxyethanol.

The reaction may be performed between −20° C. and 250° C., preferentially between 0° C. and 100° C. In some cases the reaction mixture may be heated to reflux.

Where appropriate, compounds can be used in the form of the free compound, or, alternatively, they can be used in the form of a salt such as the acetate, trifluoroacetate, propionate, benzoate, oxalate, methylsolfonate, phenylsulfonate, p-tolylsulfonate, trifluormethylsulfonate, fluoride, chloride, bromide, iodide, sulphate, hydrogensulphate or nitrate, including bis-salts if appropriate.

The reaction can be carried out in the absence of an acid using the free compounds. Alternatively, the reaction may be performed in the presence of an acid in catalytic, stoichiometric or excess amounts. Acids that could be used include acetic acid, propionic acid, oxalic acid, trifluoroacetic acid, hydrochloric acid, hydrobromic acid, hydroiodic acid, methansulfonic acid, para-toluenesulfonic acid, sulphuric acid, sodium hydrogensulphate and phosphoric acid. The reaction can optionally be carried out in a water-free solvent system in the presence of a drying agent, such as sodium or magnesium sulphate, potassium carbonate or molecular sieves.

If the two substituents at the carbon atom of the oxime or oxime ether function are different from each other, the condensation reaction can lead to a mixture of the E- and the Z-oxime (ether) product. The condensation product may also be exclusively either the E- or the Z-oxime (ether).

Condensations can be performed under reduced pressure, normal pressure or increased pressure. Preferentially the reaction is performed under normal pressure.

Typical Conditions for Alkylation Reactions:

This applies to procedure 3, 18, 20, 25, 32.

Different stoichiometric set-ups may be used for these reactions, depending on the properties of reactants and product. An excess of the electrophile, the nucleophile, or neither may be chosen. Usually, it is preferable that equimolar amounts of electrophilic and nucleophilic compounds are used.

The reaction may be performed in the absence or presence of a solvent or a mixture of solvents. Preferential solvents include the following aliphatic or aromatic hydrocarbons that may optionally be substituted by one or more halogen atoms such as pentane, hexanes, heptanes, cyclohexane, petroleum ether, benzene, toluene, xylene, chlorobenzene, dichlorobenzenes, dichloromethane, chloroform, 1,2-dichloroethanev or carbon tetrachloride, ethers such as diethyl ether, diisopropyl ether, tert-butyl-methyl ether, tetrahydrofuran, 1,4-dioxane, dimethoxyethane or diglycol dimethyl ether, ketones such as acetone, methyl ethyl ketone, methyl isopropyl ketone or methyl isobutyl ketone, acids and ester such as acetic acid, ethyl acetate or methyl acetate, aprotic polar solvents such as acetonitrile, pripionitrile, dimethyl formamide, dimethyl acetamide, N-methyl-pyrrolidone, dimethyl sulfoxide, sulfolane, DMPU, or pyridine and picolines. The selection of solvents includes also water and alcohols such as methanol, ethanol, propanol, isopropanol, butanol, isobutanol, tert-butanol, pentanol, isopentanol, hexanol, trifluorethanol, ethylene glycol or methoxyethanol.

The reaction may be performed in a biphasic system comprising an organic solvent that is not miscible with water, such as toluene, dichloromethane, dichloro-ethylene, and an aqueous solvent, such as water. Such a reaction would be performed in the presence of a phase-transfer catalyst, such as tetra-n-butylammonium bromide (TBAB), Tetradecyldimethylbenzylammonium chloride (TDMBAC), N-Benzyltrimethylammonium hydroxide, along with aqueous sodium or potassium hydroxide in stoichiometric amounts. The biphasic reaction may be performed with or without ultrasonication.

The reaction may be carried out at temperatures varying from −100° C. and 250° C. Preferentially, the temperature range is between 0° C. and 100° C.

Optionally, an organic or inorganic base may be present such as alkali- and earth alkali acetates, amides, carbonates, hydrogencarbonates, hydrides, hydroxides or alcoholates such as sodium, potassium, caesium or calcium acetate, sodium, potassium, caesium or calcium carbonate, sodium, potassium, caesium or calcium hydrogencarbonate, sodium, potassium, caesium or calcium hydride, sodium, potassium, caesium or calcium amide, sodium, potassium, caesium or calcium hydroxide, sodium, potassium, caesium or calcium methanolate, sodium, potassium, caesium or calcium ethanolate, sodium, potassium, caesium or calcium n-, i-, s- or t-butanolate, triethylamine, tripropylamine, tributylamine, di-isopropyl-ethylamine, N,N-dimethyl-cyclohexylamine, N-methyl-dicyclohexylamine, N,N-dimethyl-aniline, N,N-diethyl-aniline, N,N-dimethyl-benzylamine, N,N-diethyl-benzylamine, pyridine, 2-methyl-pyridine, 3-methyl-pyridine, 4-methyl-pyridine, 2,6-dimethyl-pyridine, 2,4,6-trimethyl-pyridine, 4-dimethylamino-pyridine, N-methyl-piperidine, N-ethyl-piperidine, N-methyl-morpholine, N-ethyl-morpholine, N,N′-dimethyl-piperazine, 1,4-Diazabicyclo[2.2.2]octane (DABCO), 1,8-Diaza-7-bicyclo[5.4.0]undecene (DBU), 1,5-Diazabicyclo[4.3.0]non-5-ene (DBN), 1-tert-Butyl-2,2,2-tri(1-pyrrolidinyl)phosphazene (BTPP), 1-tert-Butyl-2,2,2-tris(dimethylamino)phosphazene, sodium hexamethyldisilazane, potassium hexamethyldisilazane, lithium diisopropylamide, ethyl magnesium chloride, isopropylmagnesium chloride.

The alkylation can be performed under reduced pressure, normal pressure or increased pressure. Preferentially the reaction is performed under normal pressure.

The products of steps 1) to 31) may be required to be purified using, for example, chromatography, crystallisation or other purification techniques well known to the person skilled in the art.

The compounds of formula (I) to formula (XXXIV) and, where appropriate, the tautomers thereof, can, if appropriate, also be obtained in the form of hydrates and/or include other solvents, for example those which may have been used for the crystallization of compounds which are present in solid form.

It has now been found that the compounds of formula (I) according to the invention have, for practical purposes, a very advantageous spectrum of activities for protecting useful plants against diseases that are caused by phytopathogenic microorganisms, such as fungi, bacteria or viruses.

The invention therefore also relates to a method of controlling or preventing infestation of useful plants by phytopathogenic microorganisms, wherein a compound of formula (I) is applied as active ingredient to the plants, to parts thereof or the locus thereof. The compounds of formula (I) according to the invention are distinguished by excellent activity at low rates of application, by being well tolerated by plants and by being environmentally safe. They have very useful curative, preventive and systemic properties and are used for protecting numerous useful plants. The compounds of formula (I) can be used to inhibit or destroy the diseases that occur on plants or parts of plants (fruit, blossoms, leaves, stems, tubers, roots) of different crops of useful plants, while at the same time protecting also those parts of the plants that grow later e.g. from phytopathogenic microorganisms.

It is also possible to use compounds of formula (I) as dressing agents for the treatment of plant propagation material, in particular of seeds (fruit, tubers, grains) and plant cuttings (e.g. rice), for the protection against fungal infections as well as against phytopathogenic fungi occurring in the soil.

Furthermore the compounds of formula (I) according to the invention may be used for controlling fungi in related areas, for example in the protection of technical materials, including wood and wood related technical products, in food storage or in hygiene management.

The compounds of formula (I) are, for example, effective against the phytopathogenic fungi of the following classes: Fungi imperfecti (e.g. Botrytis, Pyricularia, Helminthosporium, Fusarium, Septoria, Cercospora and Alternaria) and Basidiomycetes (e.g. Rhizoctonia, Hemileia, Puccinia). Additionally, they are also effective against the Ascomycetes classes (e.g. Venturia and Erysiphe, Podosphaera, Monilinia, Uncinula) and of the Oomycetes classes (e.g. Phytophthora, Pythium, Plasmopara). Within the scope of the invention, useful plants to be protected typically comprise the following species of plants: cereal (wheat, barley, rye, oat, rice, maize, sorghum and related species); beet (sugar beet and fodder beet); pomes, drupes and soft fruit (apples, pears, plums, peaches, almonds, cherries, strawberries, raspberries and blackberries); leguminous plants (beans, lentils, peas, soybeans); oil plants (rape, mustard, poppy, olives, sunflowers, coconut, castor oil plants, cocoa beans, groundnuts); cucumber plants (pumpkins, cucumbers, melons); fibre plants (cotton, flax, hemp, jute); citrus fruit (oranges, lemons, grapefruit, mandarins); vegetables (spinach, lettuce, asparagus, cabbages, carrots, onions, tomatoes, potatoes, paprika); lauraceae (avocado, cinnamomum, camphor) or plants such as tobacco, nuts, coffee, eggplants, sugar cane, tea, pepper, vines, hops, bananas and natural rubber plants, as well as ornamentals.

The term “useful plants” is to be understood as including also useful plants that have been rendered tolerant to herbicides like bromoxynil or classes of herbicides (such as, for example, HPPD inhibitors, ALS inhibitors, for example primisulfuron, prosulfuron and trifloxysulfuron, EPSPS (5-enol-pyrovyl-shikimate-3-phosphate-synthase) inhibitors, GS (glutamine synthetase) inhibitors or PPO (protoporphyrinogen-oxidase) inhibitors) as a result of conventional methods of breeding or genetic engineering. An example of a crop that has been rendered tolerant to imidazolinones, e.g. imazamox, by conventional methods of breeding (mutagenesis) is Clearfield® summer rape (Canola). Examples of crops that have been rendered tolerant to herbicides or classes of herbicides by genetic engineering methods include glyphosate- and glufosinate-resistant maize varieties commercially available under the trade names RoundupReady®, Herculex I® and LibertyLink®.

The term “useful plants” is to be understood as including also useful plants which have been so transformed by the use of recombinant DNA techniques that they are capable of synthesising one or more selectively acting toxins, such as are known, for example, from toxin-producing bacteria, especially those of the genus Bacillus.

Examples of such plants are: YieldGard® (maize variety that expresses a CryIA(b) toxin); YieldGard Rootworm® (maize variety that expresses a CryIIIB(b1) toxin); YieldGard Plus® (maize variety that expresses a CryIA(b) and a CryIIIB(b1) toxin); Starlink® (maize variety that expresses a Cry9(c) toxin); Herculex I® (maize variety that expresses a CryIF(a2) toxin and the enzyme phosphinothricine N-acetyltransferase (PAT) to achieve tolerance to the herbicide glufosinate ammonium); NuCOTN 33B® (cotton variety that expresses a CryIA(c) toxin); Bollgard I® (cotton variety that expresses a CryIA(c) toxin); Bollgard II® (cotton variety that expresses a CryIA(c) and a CryIIA(b) toxin); VIPCOT® (cotton variety that expresses a VIP toxin); NewLeaf® (potato variety that expresses a CryIIIA toxin); Nature-Gard® Agrisure® GT Advantage (GA21 glyphosate-tolerant trait), Agrisure® CB Advantage (Bt11 corn borer (CB) trait), Agrisure® RW (corn rootworm trait) and Protecta®.

The term “useful plants” is to be understood as including also useful plants which have been so transformed by the use of recombinant DNA techniques that they are capable of synthesising antipathogenic substances having a selective action, such as, for example, the so-called “pathogenesis-related proteins” (PRPs, see e.g. EP-A-0 392 225). Examples of such antipathogenic substances and transgenic plants capable of synthesising such antipathogenic substances are known, for example, from EP-A-0 392 225, WO 95/33818, and EP-A-0 353 191. The methods of producing such transgenic plants are generally known to the person skilled in the art and are described, for example, in the publications mentioned above.

The term “locus” of a useful plant as used herein is intended to embrace the place on which the useful plants are growing, where the plant propagation materials of the useful plants are sown or where the plant propagation materials of the useful plants will be placed into the soil. An example for such a locus is a field, on which crop plants are growing.

The term “plant propagation material” is understood to denote generative parts of the plant, such as seeds, which can be used for the multiplication of the latter, and vegetative material, such as cuttings or tubers, for example potatoes. There may be mentioned for example seeds (in the strict sense), roots, fruits, tubers, bulbs, rhizomes and parts of plants. Germinated plants and young plants which are to be transplanted after germination or after emergence from the soil, may also be mentioned. These young plants may be protected before transplantation by a total or partial treatment by immersion. Preferably “plant propagation material” is understood to denote seeds.

The compounds of formula (I) can be used in unmodified form or, preferably, together with carriers and adjuvants conventionally employed in the art of formulation.

Therefore the invention also relates to compositions for controlling and protecting against phytopathogenic microorganisms, comprising a compound of formula (I) and an inert carrier, and to a method of controlling or preventing infestation of useful plants by phytopathogenic microorganisms, wherein a composition, comprising a compound of formula (I) as active ingredient and an inert carrier, is applied to the plants, to parts thereof or the locus thereof.

To this end compounds of formula (I) and inert carriers are conveniently formulated in known manner to emulsifiable concentrates, coatable pastes, directly sprayable or dilutable solutions, dilute emulsions, wettable powders, soluble powders, dusts, granulates, and also encapsulations e.g. in polymeric substances. As with the type of the compositions, the methods of application, such as spraying, atomising, dusting, scattering, coating or pouring, are chosen in accordance with the intended objectives and the prevailing circumstances. The compositions may also contain further adjuvants such as stabilizers, antifoams, viscosity regulators, binders or tackifiers as well as fertilizers, micronutrient donors or other formulations for obtaining special effects.

Suitable carriers and adjuvants (auxiliaries) can be solid or liquid and are substances useful in formulation technology, e.g. natural or regenerated mineral substances, solvents, dispersants, wetting agents, tackifiers, thickeners, binders or fertilizers. Such carriers are for example described in WO 97/33890.

The compounds of formula (I) or compositions, comprising a compound of formula (I) as active ingredient and an inert carrier, can be applied to the locus of the plant or plant to be treated, simultaneously or in succession with further compounds. These further compounds can be e.g. fertilizers or micronutrient donors or other preparations which influence the growth of plants. They can also be selective herbicides as well as insecticides, fungicides, bactericides, nematicides, molluscicides or mixtures of several of these preparations, if desired together with further carriers, surfactants or application promoting adjuvants customarily employed in the art of formulation.

A preferred method of applying a compound of formula (I), or a composition, comprising a compound of formula (I) as active ingredient and an inert carrier, is foliar application. The frequency of application and the rate of application will depend on the risk of infestation by the corresponding pathogen. However, the compounds of formula (I) may also penetrate the plant through the roots via the soil (systemic action) by drenching the locus of the plant with a liquid formulation, or by applying the compounds in solid form to the soil, e.g. in granular form (soil application). In crops of water rice such granulates can be applied to the flooded rice field. The compounds of formula (I) may also be applied to seeds (coating) by impregnating the seeds or tubers either with a liquid formulation of the fungicide or coating them with a solid formulation.

A formulation, i.e. a composition comprising the compound of formula (I) and, if desired, a solid or liquid adjuvant, is prepared in a known manner, typically by intimately mixing and/or grinding the compound with extenders, for example solvents, solid carriers and, optionally, surface-active compounds (surfactants).

The agrochemical formulations will usually contain from 0.1 to 99% by weight, preferably from 0.1 to 95% by weight, of the compound of formula (I), 99.9 to 1% by weight, preferably 99.8 to 5% by weight, of a solid or liquid adjuvant, and from 0 to 25% by weight, preferably from 0.1 to 25% by weight, of a surfactant.

Whereas it is preferred to formulate commercial products as concentrates, the end user will normally use dilute formulations.

Advantageous rates of application are normally from 5 g to 2 kg of active ingredient (a.i.) per hectare (ha), preferably from 10 g to 1 kg a.i./ha, most preferably from 20 g to 600 g a.i./ha. When used as seed drenching agent, convenient rates of application are from 10 mg to 1 g of active substance per kg of seeds. The rate of application for the desired action can be determined by experiments. It depends for example on the type of action, the developmental stage of the useful plant, and on the application (location, timing, application method) and can, owing to these parameters, vary within wide limits.

The compounds of formula (I), or a pharmaceutical salt thereof, described above may also have an advantageous spectrum of activity for the treatment and/or prevention of microbial infection in an animal. “Animal” can be any animal, for example, insect, mammal, reptile, fish, amphibian, preferably mammal, most preferably human. “Treatment” means the use on an animal which has microbial infection in order to reduce or slow or stop the increase or spread of the infection, or to reduce the infection or to cure the infection. “Prevention” means the use on an animal which has no apparent signs of microbial infection in order to prevent any future infection, or to reduce or slow the increase or spread of any future infection.

According to the present invention there is provided the use of a compound of formula (I) in the manufacture of a medicament for use in the treatment and/or prevention of microbial infection in an animal. There is also provided the use of a compound of formula (I) as a pharmaceutical agent. There is also provided the use of a compound of formula (I) as an antimicrobial agent in the treatment of an animal. According to the present invention there is also provided a pharmaceutical composition comprising as an active ingredient a compound of formula (I), or a pharmaceutically acceptable salt thereof, and a pharmaceutically acceptable diluent or carrier. This composition can be used for the treatment and/or prevention of antimicrobial infection in an animal. This pharmaceutical composition can be in a form suitable for oral administration, such as tablet, lozenges, hard capsules, aqueous suspensions, oily suspensions, emulsions dispersible powders, dispersible granules, syrups and elixirs. Alternatively this pharmaceutical composition can be in a form suitable for topical application, such as a spray, a cream or lotion. Alternatively this pharmaceutical composition can be in a form suitable for parenteral administration, for example injection. Alternatively this pharmaceutical composition can be in inhalable form, such as an aerosol spray.

The compounds of formula (I) may be effective against various microbial species able to cause a microbial infection in an animal. Examples of such microbial species are those causing Aspergillosis such as Aspergillus fumigatus, A. flavus, A. terrus, A. nidulans and A. niger, those causing Blastomycosis such as Blastomyces dermatitidis; those causing Candidiasis such as Candida albicans, C. glabrata, C. tropicalis, C. parapsilosis, C. krusei and C. lusitaniae, those causing Coccidioidomycosis such as Coccidioides immitis; those causing Cryptococcosis such as Cryptococcus neoformans, those causing Histoplasmosis such as Histoplasma capsulatum and those causing Zygomycosis such as Absidia corymbifera, Rhizomucor pusillus and Rhizopus arrhizus. Further examples are Fusarium Spp such as Fusarium oxysporum and Fusarium solani and Scedosporium Spp such as Scedosporium apiospermum and Scedosporium prolificans. Still further examples are Microsporum Spp, Trichophyton Spp, Epidermophyton Spp, Mucor Spp, Sporothorix Spp, Phialophora Spp, Cladosporium Spp, Petriellidium spp, Paracoccidioides Spp and Histoplasma Spp.

In addition, further, other biocidally active ingredients or compositions may be combined with the compound of formula (I) and used in the methods of the invention and applied simultaneously or sequentially with the compound of formula (I). When applied simultaneously, these further active ingredients may be formulated together with the compound of formula (I) or mixed in, for example, the spray tank. These further biocidally active ingredients may be fungicides, herbicides, insecticides, bactericides, acaricides, nematicides and/or plant growth regulators.

Accordingly, in one aspect, the present invention provides a composition comprising a compound of formula (I), which is selected from the Tables 1 to 34, and (i) a further fungicide, (ii) a herbicide, (iii) an insecticide, (iv) a bactericide, (v) an acaricide, (vi) a nematicide and/or (vii) a plant growth regulator.

Additionally, the present invention provides for the use of a composition in the methods of the present invention, said composition comprising a compound of formula (I), which is selected from Tables 1 to 35, and (i) a further fungicide, (ii) a herbicide, (iii) an insecticide, (iv) a bactericide, (v) an acaricide, (vi) a nematicide and/or (vii) a plant growth regulator.

In addition, the compounds of the invention may also be applied with one or more systemically acquired resistance inducers (“SAR” inducer). SAR inducers are known and described in, for example, U.S. Pat. No. 6,919,298 and include, for example, salicylates and the commercial SAR inducer acibenzolar-S-methyl.

The present invention relates additionally to mixtures comprising at least a compound of formula I and at least a further, other biocidally active ingredient and optionally further ingredients. The further, other biocidally active ingredient are known for example from “The Pesticide Manual” [The Pesticide Manual—A World Compendium; Thirteenth Edition (New edition (2 Nov. 2003)); Editor: C. D. S. Tomlin; The British Crop Protection Council, ISBN-10: 1901396134; ISBN-13: 978-1901396133] or its electronic version “e-Pesticide Manual V4.2” or from the website http://www.alanwood.net/pesticides/or preferably one of the further pesticides listed below.

The following mixtures of the compounds of TX with a further active ingredient (B) are preferred (the abbreviation “TX” means a compound encompassed by the compounds of formula I, or preferably the term “TX” refers to a compound selected from the Tables 1-34 and Tables 38-39:

an adjuvant selected from the group of substances consisting of petroleum oils (alternative name) (628)+TX,

an acaricide selected from the group of substances consisting of 1,1-bis(4-chloro-phenyl)-2-ethoxyethanol (IUPAC name) (910)+TX, 2,4-dichlorophenyl benzenesulfonate (IUPAC/Chemical Abstracts name) (1059)+TX, 2-fluoro-N-methyl-N-1-naphthylacetamide (IUPAC name) (1295)+TX, 4-chlorophenyl phenyl sulfone (IUPAC name) (981)+TX, abamectin (1)+TX, acequinocyl (3)+TX, acetoprole [CCN]+TX, acrinathrin (9)+TX, aldicarb (16)+TX, aldoxycarb (863)+TX, alpha-cypermethrin (202)+TX, amidithion (870)+TX, amidoflumet [CCN]+TX, amidothioate (872)+TX, amiton (875)+TX, amiton hydrogen oxalate (875)+TX, amitraz (24)+TX, aramite (881)+TX, arsenous oxide (882)+TX, AVI 382 (compound code)+TX, AZ 60541 (compound code)+TX, azinphos-ethyl (44)+TX, azinphos-methyl (45)+TX, azobenzene (IUPAC name) (888)+TX, azocyclotin (46)+TX, azothoate (889)+TX, benomyl (62)+TX, benoxafos (alternative name) [CCN]+TX, benzoximate (71)+TX, benzyl benzoate (IUPAC name) [CCN]+TX, bifenazate (74)+TX, bifenthrin (76)+TX, binapacryl (907)+TX, brofenvalerate (alternative name)+TX, bromocyclen (918)+TX, bromophos (920)+TX, bromophos-ethyl (921)+TX, bromopropylate (94)+TX, buprofezin (99)+TX, butocarboxim (103)+TX, butoxycarboxim (104)+TX, butylpyridaben (alternative name)+TX, calcium polysulfide (IUPAC name) (111)+TX, camphechlor (941)+TX, carbanolate (943)+TX, carbaryl (115)+TX, carbofuran (118)+TX, carbophenothion (947)+TX, CGA 50′439 (development code) (125)+TX, chinomethionat (126)+TX, chlorbenside (959)+TX, chlordimeform (964)+TX, chlordimeform hydrochloride (964)+TX, chlorfenapyr (130)+TX, chlorfenethol (968)+TX, chlorfenson (970)+TX, chlorfensulphide (971)+TX, chlorfenvinphos (131)+TX, chlorobenzilate (975)+TX, chloromebuform (977)+TX, chloromethiuron (978)+TX, chloropropylate (983)+TX, chlorpyrifos (145)+TX, chlorpyrifos-methyl (146)+TX, chlorthiophos (994)+TX, cinerin I (696)+TX, cinerin II (696)+TX, cinerins (696)+TX, clofentezine (158)+TX, closantel (alternative name) [CCN]+TX, coumaphos (174)+TX, crotamiton (alternative name) [CCN]+TX, crotoxyphos (1010)+TX, cufraneb (1013)+TX, cyanthoate (1020)+TX, cyflumetofen (CAS Reg. No.: 400882-07-7)+TX, cyhalothrin (196)+TX, cyhexatin (199)+TX, cypermethrin (201)+TX, DCPM (1032)+TX, DDT (219)+TX, demephion (1037)+TX, demephion-O (1037)+TX, demephion-S (1037)+TX, demeton (1038)+TX, demeton-methyl (224)+TX, demeton-O (1038)+TX, demeton-O-methyl (224)+TX, demeton-S (1038)+TX, demeton-5-methyl (224)+TX, demeton-S-methylsulphon (1039)+TX, diafenthiuron (226)+TX, dialifos (1042)+TX, diazinon (227)+TX, dichlofluanid (230)+TX, dichlorvos (236)+TX, dicliphos (alternative name)+TX, dicofol (242)+TX, dicrotophos (243)+TX, dienochlor (1071)+TX, dimefox (1081)+TX, dimethoate (262)+TX, dinactin (alternative name) (653)+TX, dinex (1089)+TX, dinex-diclexine (1089)+TX, dinobuton (269)+TX, dinocap (270)+TX, dinocap-4 [CCN]+TX, dinocap-6 [CCN]+TX, dinocton (1090)+TX, dinopenton (1092)+TX, dinosulfon (1097)+TX, dinoterbon (1098)+TX, dioxathion (1102)+TX, diphenyl sulfone (IUPAC name) (1103)+TX, disulfuram (alternative name) [CCN]+TX, disulfoton (278)+TX, DNOC (282)+TX, dofenapyn (1113)+TX, doramectin (alternative name) [CCN]+TX, endosulfan (294)+TX, endothion (1121)+TX, EPN (297)+TX, eprinomectin (alternative name) [CCN]+TX, ethion (309)+TX, ethoate-methyl (1134)+TX, etoxazole (320)+TX, etrimfos (1142)+TX, fenazaflor (1147)+TX, fenazaquin (328)+TX, fenbutatin oxide (330)+TX, fenothiocarb (337)+TX, fenpropathrin (342)+TX, fenpyrad (alternative name)+TX, fenpyroximate (345)+TX, fenson (1157)+TX, fentrifanil (1161)+TX, fenvalerate (349)+TX, fipronil (354)+TX, fluacrypyrim (360)+TX, fluazuron (1166)+TX, flubenzimine (1167)+TX, flucycloxuron (366)+TX, flucythrinate (367)+TX, fluenetil (1169)+TX, flufenoxuron (370)+TX, flumethrin (372)+TX, fluorbenside (1174)+TX, fluvalinate (1184)+TX, FMC 1137 (development code) (1185)+TX, formetanate (405)+TX, formetanate hydrochloride (405)+TX, formothion (1192)+TX, formparanate (1193)+TX, gamma-HCH (430)+TX, glyodin (1205)+TX, halfenprox (424)+TX, heptenophos (432)+TX, hexadecyl cyclopropanecarboxylate (IUPAC/Chemical Abstracts name) (1216)+TX, hexythiazox (441)+TX, iodomethane (IUPAC name) (542)+TX, isocarbophos (alternative name) (473)+TX, isopropyl O-(methoxyaminothiophosphoryl)salicylate (IUPAC name) (473)+TX, ivermectin (alternative name) [CCN]+TX, jasmolin I (696)+TX, jasmolin II (696)+TX, jodfenphos (1248)+TX, lindane (430)+TX, lufenuron (490)+TX, malathion (492)+TX, malonoben (1254)+TX, mecarbam (502)+TX, mephosfolan (1261)+TX, mesulfen (alternative name) [CCN]+TX, methacrifos (1266)+TX, methamidophos (527)+TX, methidathion (529)+TX, methiocarb (530)+TX, methomyl (531)+TX, methyl bromide (537)+TX, metolcarb (550)+TX, mevinphos (556)+TX, mexacarbate (1290)+TX, milbemectin (557)+TX, milbemycin oxime (alternative name) [CCN]+TX, mipafox (1293)+TX, monocrotophos (561)+TX, morphothion (1300)+TX, moxidectin (alternative name) [CCN]+TX, naled (567)+TX, NC-184 (compound code)+TX, NC-512 (compound code)+TX, nifluridide (1309)+TX, nikkomycins (alternative name) [CCN]+TX, nitrilacarb (1313)+TX, nitrilacarb 1:1 zinc chloride complex (1313)+TX, NNI-0101 (compound code)+TX, NNI-0250 (compound code)+TX, omethoate (594)+TX, oxamyl (602)+TX, oxydeprofos (1324)+TX, oxydisulfoton (1325)+TX, pp′-DDT (219)+TX, parathion (615)+TX, permethrin (626)+TX, petroleum oils (alternative name) (628)+TX, phenkapton (1330)+TX, phenthoate (631)+TX, phorate (636)+TX, phosalone (637)+TX, phosfolan (1338)+TX, phosmet (638)+TX, phosphamidon (639)+TX, phoxim (642)+TX, pirimiphos-methyl (652)+TX, polychloroterpenes (traditional name) (1347)+TX, polynactins (alternative name) (653)+TX, proclonol (1350)+TX, profenofos (662)+TX, promacyl (1354)+TX, propargite (671)+TX, propetamphos (673)+TX, propoxur (678)+TX, prothidathion (1360)+TX, prothoate (1362)+TX, pyrethrin I (696)+TX, pyrethrin II (696)+TX, pyrethrins (696)+TX, pyridaben (699)+TX, pyridaphenthion (701)+TX, pyrimidifen (706)+TX, pyrimitate (1370)+TX, quinalphos (711)+TX, quintiofos (1381)+TX, R-1492 (development code) (1382)+TX, RA-17 (development code) (1383)+TX, rotenone (722)+TX, schradan (1389)+TX, sebufos (alternative name)+TX, selamectin (alternative name) [CCN]+TX, SI-0009 (compound code)+TX, sophamide (1402)+TX, spirodiclofen (738)+TX, spiromesifen (739)+TX, SSI-121 (development code) (1404)+TX, sulfuram (alternative name) [CCN]+TX, sulfluramid (750)+TX, sulfotep (753)+TX, sulphur (754)+TX, SZI-121 (development code) (757)+TX, tau-fluvalinate (398)+TX, tebufenpyrad (763)+TX, TEPP (1417)+TX, terbam (alternative name)+TX, tetrachlorvinphos (777)+TX, tetradifon (786)+TX, tetranactin (alternative name) (653)+TX, tetrasul (1425)+TX, thiafenox (alternative name)+TX, thiocarboxime (1431)+TX, thiofanox (800)+TX, thiometon (801)+TX, thioquinox (1436)+TX, thuringiensin (alternative name) [CCN]+TX, triamiphos (1441)+TX, triarathene (1443)+TX, triazophos (820)+TX, triazuron (alternative name)+TX, trichlorfon (824)+TX, trifenofos (1455)+TX, trinactin (alternative name) (653)+TX, vamidothion (847)+TX, vaniliprole [CCN] and YI-5302 (compound code)+TX,

an algicide selected from the group of substances consisting of bethoxazin [CCN]+TX, copper dioctanoate (IUPAC name) (170)+TX, copper sulfate (172)+TX, cybutryne [CCN]+TX, dichlone (1052)+TX, dichlorophen (232)+TX, endothal (295)+TX, fentin (347)+TX, hydrated lime [CCN]+TX, nabam (566)+TX, quinoclamine (714)+TX, quinonamid (1379)+TX, simazine (730)+TX, triphenyltin acetate (IUPAC name) (347) and triphenyltin hydroxide (IUPAC name) (347)+TX,

an anthelmintic selected from the group of substances consisting of abamectin (1)+TX, crufomate (1011)+TX, doramectin (alternative name) [CCN]+TX, emamectin (291)+TX, emamectin benzoate (291)+TX, eprinomectin (alternative name) [CCN]+TX, ivermectin (alternative name) [CCN]+TX, milbemycin oxime (alternative name) [CCN]+TX, moxidectin (alternative name) [CCN]+TX, piperazine [CCN]+TX, selamectin (alternative name) [CCN]+TX, spinosad (737) and thiophanate (1435)+TX,

an avicide selected from the group of substances consisting of chloralose (127)+TX, endrin (1122)+TX, fenthion (346)+TX, pyridin-4-amine (IUPAC name) (23) and strychnine (745)+TX,

a bactericide selected from the group of substances consisting of 1-hydroxy-1H-pyridine-2-thione (IUPAC name) (1222)+TX, 4-(quinoxalin-2-ylamino)benzenesulfonamide (IUPAC name) (748)+TX, 8-hydroxyquinoline sulfate (446)+TX, bronopol (97)+TX, copper dioctanoate (IUPAC name) (170)+TX, copper hydroxide (IUPAC name) (169)+TX, cresol [CCN]+TX, dichlorophen (232)+TX, dipyrithione (1105)+TX, dodicin (1112)+TX, fenaminosulf (1144)+TX, formaldehyde (404)+TX, hydrargaphen (alternative name) [CCN]+TX, kasugamycin (483)+TX, kasugamycin hydrochloride hydrate (483)+TX, nickel bis(dimethyldithiocarbamate) (IUPAC name) (1308)+TX, nitrapyrin (580)+TX, octhilinone (590)+TX, oxolinic acid (606)+TX, oxytetracycline (611)+TX, potassium hydroxyquinoline sulfate (446)+TX, probenazole (658)+TX, streptomycin (744)+TX, streptomycin sesquisulfate (744)+TX, tecloftalam (766)+TX, and thiomersal (alternative name) [CCN]+TX,

a biological agent selected from the group of substances consisting of Adoxophyes orana GV (alternative name) (12)+TX, Agrobacterium radiobacter (alternative name) (13)+TX, Amblyseius spp. (alternative name) (19)+TX, Anagrapha falcifera NPV (alternative name) (28)+TX, Anagrus atomus (alternative name) (29)+TX, Aphelinus abdominalis (alternative name) (33)+TX, Aphidius colemani (alternative name) (34)+TX, Aphidoletes aphidimyza (alternative name) (35)+TX, Autographa californica NPV (alternative name) (38)+TX, Bacillus firmus (alternative name) (48)+TX, Bacillus sphaericus Neide (scientific name) (49)+TX, Bacillus thuringiensis Berliner (scientific name) (51)+TX, Bacillus thuringiensis subsp. aizawai (scientific name) (51)+TX, Bacillus thuringiensis subsp. israelensis (scientific name) (51)+TX, Bacillus thuringiensis subsp. japonensis (scientific name) (51)+TX, Bacillus thuringiensis subsp. kurstaki (scientific name) (51)+TX, Bacillus thuringiensis subsp. tenebrionis (scientific name) (51)+TX, Beauveria bassiana (alternative name) (53)+TX, Beauveria brongniartii (alternative name) (54)+TX, Chrysoperla carnea (alternative name) (151)+TX, Cryptolaemus montrouzieri (alternative name) (178)+TX, Cydia pomonella GV (alternative name) (191)+TX, Dacnusa sibirica (alternative name) (212)+TX, Diglyphus isaea (alternative name) (254)+TX, Encarsia formosa (scientific name) (293)+TX, Eretmocerus eremicus (alternative name) (300)+TX, Helicoverpa zea NPV (alternative name) (431)+TX, Heterorhabditis bacteriophora and H. megidis (alternative name) (433)+TX, Hippodamia convergens (alternative name) (442)+TX, Leptomastix dactylopii (alternative name) (488)+TX, Macrolophus caliginosus (alternative name) (491)+TX, Mamestra brassicae NPV (alternative name) (494)+TX, Metaphycus helvolus (alternative name) (522)+TX, Metarhizium anisopliae var. acridum (scientific name) (523)+TX, Metarhizium anisopliae var. anisopliae (scientific name) (523)+TX, Neodiprion sertifer NPV and N. lecontei NPV (alternative name) (575)+TX, Orius spp. (alternative name) (596)+TX, Paecilomyces fumosoroseus (alternative name) (613)+TX, Phytoseiulus persimilis (alternative name) (644)+TX, Spodoptera exigua multicapsid nuclear polyhedrosis virus (scientific name) (741)+TX, Steinernema bibionis (alternative name) (742)+TX, Steinernema carpocapsae (alternative name) (742)+TX, Steinernema feltiae (alternative name) (742)+TX, Steinernema glaseri (alternative name) (742)+TX, Steinernema riobrave (alternative name) (742)+TX, Steinernema riobravis (alternative name) (742)+TX, Steinernema scapterisci (alternative name) (742)+TX, Steinernema spp. (alternative name) (742)+TX, Trichogramma spp. (alternative name) (826)+TX, Typhlodromus occidentalis (alternative name) (844) and Verticillium lecanii (alternative name) (848)+TX,

a soil sterilant selected from the group of substances consisting of iodomethane (IUPAC name) (542) and methyl bromide (537)+TX,

a chemosterilant selected from the group of substances consisting of apholate [CCN]+TX, bisazir (alternative name) [CCN]+TX, busulfan (alternative name) [CCN]+TX, diflubenzuron (250)+TX, dimatif (alternative name) [CCN]+TX, hemel [CCN]+TX, hempa [CCN]+TX, metepa [CCN]+TX, methiotepa [CCN]+TX, methyl apholate [CCN]+TX, morzid [CCN]+TX, penfluoron (alternative name) [CCN]+TX, tepa [CCN]+TX, thiohempa (alternative name) [CCN]+TX, thiotepa (alternative name) [CCN]+TX, tretamine (alternative name) [CCN] and uredepa (alternative name) [CCN]+TX,

an insect pheromone selected from the group of substances consisting of (E)-dec-5-en-1-yl acetate with (E)-dec-5-en-1-ol (IUPAC name) (222)+TX, (E)-tridec-4-en-1-yl acetate (IUPAC name) (829)+TX, (E)-6-methylhept-2-en-4-ol (IUPAC name) (541)+TX, (E,Z)-tetradeca-4,10-dien-1-yl acetate (IUPAC name) (779)+TX, (Z)-dodec-7-en-1-yl acetate (IUPAC name) (285)+TX, (Z)-hexadec-11-enal (IUPAC name) (436)+TX, (Z)-hexadec-11-en-1-yl acetate (IUPAC name) (437)+TX, (Z)-hexadec-13-en-11-yn-1-yl acetate (IUPAC name) (438)+TX, (Z)-icos-13-en-10-one (IUPAC name) (448)+TX, (Z)-tetradec-7-en-1-al (IUPAC name) (782)+TX, (Z)-tetradec-9-en-1-ol (IUPAC name) (783)+TX, (Z)-tetradec-9-en-1-yl acetate (IUPAC name) (784)+TX, (7E,9Z)-dodeca-7,9-dien-1-yl acetate (IUPAC name) (283)+TX, (9Z,11E)-tetradeca-9,11-dien-1-yl acetate (IUPAC name) (780)+TX, (9Z,12E)-tetradeca-9,12-dien-1-yl acetate (IUPAC name) (781)+TX, 14-methyloctadec-1-ene (IUPAC name) (545)+TX, 4-methylnonan-5-ol with 4-methylnonan-5-one (IUPAC name) (544)+TX, alpha-multistriatin (alternative name) [CCN]+TX, brevicomin (alternative name) [CCN]+TX, codlelure (alternative name) [CCN]+TX, codlemone (alternative name) (167)+TX, cuelure (alternative name) (179)+TX, disparlure (277)+TX, dodec-8-en-1-yl acetate (IUPAC name) (286)+TX, dodec-9-en-1-yl acetate (IUPAC name) (287)+TX, dodeca-8+TX, 10-dien-1-yl acetate (IUPAC name) (284)+TX, dominicalure (alternative name) [CCN]+TX, ethyl 4-methyloctanoate (IUPAC name) (317)+TX, eugenol (alternative name) [CCN]+TX, frontalin (alternative name) [CCN]+TX, gossyplure (alternative name) (420)+TX, grandlure (421)+TX, grandlure I (alternative name) (421)+TX, grandlure II (alternative name) (421)+TX, grandlure III (alternative name) (421)+TX, grandlure IV (alternative name) (421)+TX, hexylure [CCN]+TX, ipsdienol (alternative name) [CCN]+TX, ipsenol (alternative name) [CCN]+TX, japonilure (alternative name) (481)+TX, lineatin (alternative name) [CCN]+TX, litlure (alternative name) [CCN]+TX, looplure (alternative name) [CCN]+TX, medlure [CCN]+TX, megatomoic acid (alternative name) [CCN]+TX, methyl eugenol (alternative name) (540)+TX, muscalure (563)+TX, octadeca-2,13-dien-1-yl acetate (IUPAC name) (588)+TX, octadeca-3,13-dien-1-yl acetate (IUPAC name) (589)+TX, orfralure (alternative name) [CCN]+TX, oryctalure (alternative name) (317)+TX, ostramone (alternative name) [CCN]+TX, siglure [CCN]+TX, sordidin (alternative name) (736)+TX, sulcatol (alternative name) [CCN]+TX, tetradec-11-en-1-yl acetate (IUPAC name) (785)+TX, trimedlure (839)+TX, trimedlure A (alternative name) (839)+TX, trimedlure B1 (alternative name) (839)+TX, trimedlure B2 (alternative name) (839)+TX, trimedlure C (alternative name) (839) and trunc-call (alternative name) [CCN]+TX,

an insect repellent selected from the group of substances consisting of 2-(octylthio)-ethanol (IUPAC name) (591)+TX, butopyronoxyl (933)+TX, butoxy(polypropylene glycol) (936)+TX, dibutyl adipate (IUPAC name) (1046)+TX, dibutyl phthalate (1047)+TX, dibutyl succinate (IUPAC name) (1048)+TX, diethyltoluamide [CCN]+TX, dimethyl carbate [CCN]+TX, dimethyl phthalate [CCN]+TX, ethyl hexanediol (1137)+TX, hexamide [CCN]+TX, methoquin-butyl (1276)+TX, methylneodecanamide [CCN]+TX, oxamate [CCN] and picaridin [CCN]+TX,

an insecticide selected from the group of substances consisting of 1-dichloro-1-nitroethane (IUPAC/Chemical Abstracts name) (1058)+TX, 1,1-dichloro-2,2-bis(4-ethylphenyl)ethane (IUPAC name) (1056), +TX, 1,2-dichloropropane (IUPAC/Chemical Abstracts name) (1062)+TX, 1,2-dichloropropane with 1,3-dichloropropene (IUPAC name) (1063)+TX, 1-bromo-2-chloroethane (IUPAC/Chemical Abstracts name) (916)+TX, 2,2,2-trichloro-1-(3,4-dichlorophenyl)ethyl acetate (IUPAC name) (1451)+TX, 2,2-dichlorovinyl 2-ethylsulphinylethyl methyl phosphate (IUPAC name) (1066)+TX, 2-(1,3-dithiolan-2-yl)phenyl dimethylcarbamate (IUPAC/Chemical Abstracts name) (1109)+TX, 2-(2-butoxyethoxy)ethyl thiocyanate (IUPAC/Chemical Abstracts name) (935)+TX, 2-(4,5-dimethyl-1,3-dioxolan-2-yl)phenyl methylcarbamate (IUPAC/Chemical Abstracts name) (1084)+TX, 2-(4-chloro-3,5-xylyloxy)ethanol (IUPAC name) (986)+TX, 2-chlorovinyl diethyl phosphate (IUPAC name) (984)+TX, 2-imidazolidone (IUPAC name) (1225)+TX, 2-isovalerylindan-1,3-dione (IUPAC name) (1246)+TX, 2-methyl(prop-2-ynyl)aminophenyl methylcarbamate (IUPAC name) (1284)+TX, 2-thiocyanatoethyl laurate (IUPAC name) (1433)+TX, 3-bromo-1-chloroprop-1-ene (IUPAC name) (917)+TX, 3-methyl-1-phenylpyrazol-5-yl dimethylcarbamate (IUPAC name) (1283)+TX, 4-methyl(prop-2-ynyl)amino-3,5-xylyl methylcarbamate (IUPAC name) (1285)+TX, 5,5-dimethyl-3-oxocyclohex-1-enyl dimethylcarbamate (IUPAC name) (1085)+TX, abamectin (1)+TX, acephate (2)+TX, acetamiprid (4)+TX, acethion (alternative name) [CCN]+TX, acetoprole [CCN]+TX, acrinathrin (9)+TX, acrylonitrile (IUPAC name) (861)+TX, alanycarb (15)+TX, aldicarb (16)+TX, aldoxycarb (863)+TX, aldrin (864)+TX, allethrin (17)+TX, allosamidin (alternative name) [CCN]+TX, allyxycarb (866)+TX, alpha-cypermethrin (202)+TX, alpha-ecdysone (alternative name) [CCN]+TX, aluminium phosphide (640)+TX, amidithion (870)+TX, amidothioate (872)+TX, aminocarb (873)+TX, amiton (875)+TX, amiton hydrogen oxalate (875)+TX, amitraz (24)+TX, anabasine (877)+TX, athidathion (883)+TX, AVI 382 (compound code)+TX, AZ 60541 (compound code)+TX, azadirachtin (alternative name) (41)+TX, azamethiphos (42)+TX, azinphos-ethyl (44)+TX, azinphos-methyl (45)+TX, azothoate (889)+TX, Bacillus thuringiensis delta endotoxins (alternative name) (52)+TX, barium hexafluorosilicate (alternative name) [CCN]+TX, barium polysulfide (IUPAC/Chemical Abstracts name) (892)+TX, barthrin [CCN]+TX, Bayer 22/190 (development code) (893)+TX, Bayer 22408 (development code) (894)+TX, bendiocarb (58)+TX, benfuracarb (60)+TX, bensultap (66)+TX, beta-cyfluthrin (194)+TX, beta-cypermethrin (203)+TX, bifenthrin (76)+TX, bioallethrin (78)+TX, bioallethrin S-cyclopentenyl isomer (alternative name) (79)+TX, bioethanomethrin [CCN]+TX, biopermethrin (908)+TX, bioresmethrin (80)+TX, bis(2-chloroethyl)ether (IUPAC name) (909)+TX, bistrifluoron (83)+TX, borax (86)+TX, brofenvalerate (alternative name)+TX, bromfenvinfos (914)+TX, bromocyclen (918)+TX, bromo-DDT (alternative name) [CCN]+TX, bromophos (920)+TX, bromophos-ethyl (921)+TX, bufencarb (924)+TX, buprofezin (99)+TX, butacarb (926)+TX, butathiofos (927)+TX, butocarboxim (103)+TX, butonate (932)+TX, butoxycarboxim (104)+TX, butylpyridaben (alternative name)+TX, cadusafos (109)+TX, calcium arsenate [CCN]+TX, calcium cyanide (444)+TX, calcium polysulfide (IUPAC name) (111)+TX, camphechlor (941)+TX, carbanolate (943)+TX, carbaryl (115)+TX, carbofuran (118)+TX, carbon disulfide (IUPAC/Chemical Abstracts name) (945)+TX, carbon tetrachloride (IUPAC name) (946)+TX, carbophenothion (947)+TX, carbosulfan (119)+TX, cartap (123)+TX, cartap hydrochloride (123)+TX, cevadine (alternative name) (725)+TX, chlorbicyclen (960)+TX, chlordane (128)+TX, chlordecone (963)+TX, chlordimeform (964)+TX, chlordimeform hydrochloride (964)+TX, chlorethoxyfos (129)+TX, chlorfenapyr (130)+TX, chlorfenvinphos (131)+TX, chlorfluazuron (132)+TX, chlormephos (136)+TX, chloroform [CCN]+TX, chloropicrin (141)+TX, chlorphoxim (989)+TX, chlorprazophos (990)+TX, chlorpyrifos (145)+TX, chlorpyrifos-methyl (146)+TX, chlorthiophos (994)+TX, chromafenozide (150)+TX, cinerin I (696)+TX, cinerin II (696)+TX, cinerins (696)+TX, cis-resmethrin (alternative name)+TX, cismethrin (80)+TX, clocythrin (alternative name)+TX, cloethocarb (999)+TX, closantel (alternative name) [CCN]+TX, clothianidin (165)+TX, copper acetoarsenite [CCN]+TX, copper arsenate [CCN]+TX, copper oleate [CCN]+TX, coumaphos (174)+TX, coumithoate (1006)+TX, crotamiton (alternative name) [CCN]+TX, crotoxyphos (1010)+TX, crufomate (1011)+TX, cryolite (alternative name) (177)+TX, CS 708 (development code) (1012)+TX, cyanofenphos (1019)+TX, cyanophos (184)+TX, cyanthoate (1020)+TX, cyclethrin [CCN]+TX, cycloprothrin (188)+TX, cyfluthrin (193)+TX, cyhalothrin (196)+TX, cypermethrin (201)+TX, cyphenothrin (206)+TX, cyromazine (209)+TX, cythioate (alternative name) [CCN]+TX, d-limonene (alternative name) [CCN]+TX, d-tetramethrin (alternative name) (788)+TX, DAEP (1031)+TX, dazomet (216)+TX, DDT (219)+TX, decarbofuran (1034)+TX, deltamethrin (223)+TX, demephion (1037)+TX, demephion-O (1037)+TX, demephion-S (1037)+TX, demeton (1038)+TX, demeton-methyl (224)+TX, demeton-O (1038)+TX, demeton-O-methyl (224)+TX, demeton-S (1038)+TX, demeton-5-methyl (224)+TX, demeton-S-methylsulphon (1039)+TX, diafenthiuron (226)+TX, dialifos (1042)+TX, diamidafos (1044)+TX, diazinon (227)+TX, dicapthon (1050)+TX, dichlofenthion (1051)+TX, dichlorvos (236)+TX, dicliphos (alternative name)+TX, dicresyl (alternative name) [CCN]+TX, dicrotophos (243)+TX, dicyclanil (244)+TX, dieldrin (1070)+TX, diethyl 5-methylpyrazol-3-yl phosphate (IUPAC name) (1076)+TX, diflubenzuron (250)+TX, dilor (alternative name) [CCN]+TX, dimefluthrin [CCN]+TX, dimefox (1081)+TX, dimetan (1085)+TX, dimethoate (262)+TX, dimethrin (1083)+TX, dimethylvinphos (265)+TX, dimetilan (1086)+TX, dinex (1089)+TX, dinex-diclexine (1089)+TX, dinoprop (1093)+TX, dinosam (1094)+TX, dinoseb (1095)+TX, dinotefuran (271)+TX, diofenolan (1099)+TX, dioxabenzofos (1100)+TX, dioxacarb (1101)+TX, dioxathion (1102)+TX, disulfoton (278)+TX, dithicrofos (1108)+TX, DNOC (282)+TX, doramectin (alternative name) [CCN]+TX, DSP (1115)+TX, ecdysterone (alternative name) [CCN]+TX, EI 1642 (development code) (1118)+TX, emamectin (291)+TX, emamectin benzoate (291)+TX, EMPC (1120)+TX, empenthrin (292)+TX, endosulfan (294)+TX, endothion (1121)+TX, endrin (1122)+TX, EPBP (1123)+TX, EPN (297)+TX, epofenonane (1124)+TX, eprinomectin (alternative name) [CCN]+TX, esfenvalerate (302)+TX, etaphos (alternative name) [CCN]+TX, ethiofencarb (308)+TX, ethion (309)+TX, ethiprole (310)+TX, ethoate-methyl (1134)+TX, ethoprophos (312)+TX, ethyl formate (IUPAC name) [CCN]+TX, ethyl-DDD (alternative name) (1056)+TX, ethylene dibromide (316)+TX, ethylene dichloride (chemical name) (1136)+TX, ethylene oxide [CCN]+TX, etofenprox (319)+TX, etrimfos (1142)+TX, EXD (1143)+TX, famphur (323)+TX, fenamiphos (326)+TX, fenazaflor (1147)+TX, fenchlorphos (1148)+TX, fenethacarb (1149)+TX, fenfluthrin (1150)+TX, fenitrothion (335)+TX, fenobucarb (336)+TX, fenoxacrim (1153)+TX, fenoxycarb (340)+TX, fenpirithrin (1155)+TX, fenpropathrin (342)+TX, fenpyrad (alternative name)+TX, fensulfothion (1158)+TX, fenthion (346)+TX, fenthion-ethyl [CCN]+TX, fenvalerate (349)+TX, fipronil (354)+TX, flonicamid (358)+TX, flubendiamide (CAS. Reg. No.: 272451-65-7)+TX, flucofuron (1168)+TX, flucycloxuron (366)+TX, flucythrinate (367)+TX, fluenetil (1169)+TX, flufenerim [CCN]+TX, flufenoxuron (370)+TX, flufenprox (1171)+TX, flumethrin (372)+TX, fluvalinate (1184)+TX, FMC 1137 (development code) (1185)+TX, fonofos (1191)+TX, formetanate (405)+TX, formetanate hydrochloride (405)+TX, formothion (1192)+TX, formparanate (1193)+TX, fosmethilan (1194)+TX, fospirate (1195)+TX, fosthiazate (408)+TX, fosthietan (1196)+TX, furathiocarb (412)+TX, furethrin (1200)+TX, gamma-cyhalothrin (197)+TX, gamma-HCH (430)+TX, guazatine (422)+TX, guazatine acetates (422)+TX, GY-81 (development code) (423)+TX, halfenprox (424)+TX, halofenozide (425)+TX, HCH (430)+TX, HEOD (1070)+TX, heptachlor (1211)+TX, heptenophos (432)+TX, heterophos [CCN]+TX, hexaflumuron (439)+TX, HHDN (864)+TX, hydramethylnon (443)+TX, hydrogen cyanide (444)+TX, hydroprene (445)+TX, hyquincarb (1223)+TX, imidacloprid (458)+TX, imiprothrin (460)+TX, indoxacarb (465)+TX, iodomethane (IUPAC name) (542)+TX, IPSP (1229)+TX, isazofos (1231)+TX, isobenzan (1232)+TX, isocarbophos (alternative name) (473)+TX, isodrin (1235)+TX, isofenphos (1236)+TX, isolane (1237)+TX, isoprocarb (472)+TX, isopropyl O-(methoxy-aminothiophosphoryl)salicylate (IUPAC name) (473)+TX, isoprothiolane (474)+TX, isothioate (1244)+TX, isoxathion (480)+TX, ivermectin (alternative name) [CCN]+TX, jasmolin I (696)+TX, jasmolin II (696)+TX, jodfenphos (1248)+TX, juvenile hormone I (alternative name) [CCN]+TX, juvenile hormone II (alternative name) [CCN]+TX, juvenile hormone III (alternative name) [CCN]+TX, kelevan (1249)+TX, kinoprene (484)+TX, lambda-cyhalothrin (198)+TX, lead arsenate [CCN]+TX, lepimectin (CCN)+TX, leptophos (1250)+TX, lindane (430)+TX, lirimfos (1251)+TX, lufenuron (490)+TX, lythidathion (1253)+TX, m-cumenyl methylcarbamate (IUPAC name) (1014)+TX, magnesium phosphide (IUPAC name) (640)+TX, malathion (492)+TX, malonoben (1254)+TX, mazidox (1255)+TX, mecarbam (502)+TX, mecarphon (1258)+TX, menazon (1260)+TX, mephosfolan (1261)+TX, mercurous chloride (513)+TX, mesulfenfos (1263)+TX, metaflumizone (CCN)+TX, metam (519)+TX, metam-potassium (alternative name) (519)+TX, metam-sodium (519)+TX, methacrifos (1266)+TX, methamidophos (527)+TX, methanesulphonyl fluoride (IUPAC/Chemical Abstracts name) (1268)+TX, methidathion (529)+TX, methiocarb (530)+TX, methocrotophos (1273)+TX, methomyl (531)+TX, methoprene (532)+TX, methoquin-butyl (1276)+TX, methothrin (alternative name) (533)+TX, methoxychlor (534)+TX, methoxyfenozide (535)+TX, methyl bromide (537)+TX, methyl isothiocyanate (543)+TX, methylchloroform (alternative name) [CCN]+TX, methylene chloride [CCN]+TX, metofluthrin [CCN]+TX, metolcarb (550)+TX, metoxadiazone (1288)+TX, mevinphos (556)+TX, mexacarbate (1290)+TX, milbemectin (557)+TX, milbemycin oxime (alternative name) [CCN]+TX, mipafox (1293)+TX, mirex (1294)+TX, monocrotophos (561)+TX, morphothion (1300)+TX, moxidectin (alternative name) [CCN]+TX, naftalofos (alternative name) [CCN]+TX, naled (567)+TX, naphthalene (IUPAC/Chemical Abstracts name) (1303)+TX, NC-170 (development code) (1306)+TX, NC-184 (compound code)+TX, nicotine (578)+TX, nicotine sulfate (578)+TX, nifluridide (1309)+TX, nitenpyram (579)+TX, nithiazine (1311)+TX, nitrilacarb (1313)+TX, nitrilacarb 1:1 zinc chloride complex (1313)+TX, NNI-0101 (compound code)+TX, NNI-0250 (compound code)+TX, nornicotine (traditional name) (1319)+TX, novaluron (585)+TX, noviflumuron (586)+TX, O-5-dichloro-4-iodophenyl O-ethyl ethylphosphonothioate (IUPAC name) (1057)+TX, O,O-diethyl O-4-methyl-2-oxo-2H-chromen-7-yl phosphorothioate (IUPAC name) (1074)+TX, O,O-diethyl O-6-methyl-2-propylpyrimidin-4-yl phosphorothioate (IUPAC name) (1075)+TX, O,O,O′,O′-tetrapropyl dithiopyrophosphate (IUPAC name) (1424)+TX, oleic acid (IUPAC name) (593)+TX, omethoate (594)+TX, oxamyl (602)+TX, oxydemeton-methyl (609)+TX, oxydeprofos (1324)+TX, oxydisulfoton (1325)+TX, pp′-DDT (219)+TX, para-dichlorobenzene [CCN]+TX, parathion (615)+TX, parathion-methyl (616)+TX, penfluoron (alternative name) [CCN]+TX, pentachlorophenol (623)+TX, pentachlorophenyl laurate (IUPAC name) (623)+TX, permethrin (626)+TX, petroleum oils (alternative name) (628)+TX, PH 60-38 (development code) (1328)+TX, phenkapton (1330)+TX, phenothrin (630)+TX, phenthoate (631)+TX, phorate (636)+TX, phosalone (637)+TX, phosfolan (1338)+TX, phosmet (638)+TX, phosnichlor (1339)+TX, phosphamidon (639)+TX, phosphine (IUPAC name) (640)+TX, phoxim (642)+TX, phoxim-methyl (1340)+TX, pirimetaphos (1344)+TX, pirimicarb (651)+TX, pirimiphos-ethyl (1345)+TX, pirimiphos-methyl (652)+TX, polychlorodicyclopentadiene isomers (IUPAC name) (1346)+TX, polychloroterpenes (traditional name) (1347)+TX, potassium arsenite [CCN]+TX, potassium thiocyanate [CCN]+TX, prallethrin (655)+TX, precocene I (alternative name) [CCN]+TX, precocene II (alternative name) [CCN]+TX, precocene III (alternative name) [CCN]+TX, primidophos (1349)+TX, profenofos (662)+TX, profluthrin [CCN]+TX, promacyl (1354)+TX, promecarb (1355)+TX, propaphos (1356)+TX, propetamphos (673)+TX, propoxur (678)+TX, prothidathion (1360)+TX, prothiofos (686)+TX, prothoate (1362)+TX, protrifenbute [CCN]+TX, pymetrozine (688)+TX, pyraclofos (689)+TX, pyrazophos (693)+TX, pyresmethrin (1367)+TX, pyrethrin I (696)+TX, pyrethrin II (696)+TX, pyrethrins (696)+TX, pyridaben (699)+TX, pyridalyl (700)+TX, pyridaphenthion (701)+TX, pyrimidifen (706)+TX, pyrimitate (1370)+TX, pyriproxyfen (708)+TX, quassia (alternative name) [CCN]+TX, quinalphos (711)+TX, quinalphos-methyl (1376)+TX, quinothion (1380)+TX, quintiofos (1381)+TX, R-1492 (development code) (1382)+TX, rafoxanide (alternative name) [CCN]+TX, resmethrin (719)+TX, rotenone (722)+TX, RU 15525 (development code) (723)+TX, RU 25475 (development code) (1386)+TX, ryania (alternative name) (1387)+TX, ryanodine (traditional name) (1387)+TX, sabadilla (alternative name) (725)+TX, schradan (1389)+TX, sebufos (alternative name)+TX, selamectin (alternative name) [CCN]+TX, SI-0009 (compound code)+TX, SI-0205 (compound code)+TX, SI-0404 (compound code)+TX, SI-0405 (compound code)+TX, silafluofen (728)+TX, SN 72129 (development code) (1397)+TX, sodium arsenite [CCN]+TX, sodium cyanide (444)+TX, sodium fluoride (IUPAC/Chemical Abstracts name) (1399)+TX, sodium hexafluorosilicate (1400)+TX, sodium pentachlorophenoxide (623)+TX, sodium selenate (IUPAC name) (1401)+TX, sodium thiocyanate [CCN]+TX, sophamide (1402)+TX, spinosad (737)+TX, spiromesifen (739)+TX, spirotetrmat (CCN)+TX, sulcofuron (746)+TX, sulcofuron-sodium (746)+TX, sulfluramid (750)+TX, sulfotep (753)+TX, sulphuryl fluoride (756)+TX, sulprofos (1408)+TX, tar oils (alternative name) (758)+TX, tau-fluvalinate (398)+TX, tazimcarb (1412)+TX, TDE (1414)+TX, tebufenozide (762)+TX, tebufenpyrad (763)+TX, tebupirimfos (764)+TX, teflubenzuron (768)+TX, tefluthrin (769)+TX, temephos (770)+TX, TEPP (1417)+TX, terallethrin (1418)+TX, terbam (alternative name)+TX, terbufos (773)+TX, tetrachloroethane [CCN]+TX, tetrachlorvinphos (777)+TX, tetramethrin (787)+TX, theta-cypermethrin (204)+TX, thiacloprid (791)+TX, thiafenox (alternative name)+TX, thiamethoxam (792)+TX, thicrofos (1428)+TX, thiocarboxime (1431)+TX, thiocyclam (798)+TX, thiocyclam hydrogen oxalate (798)+TX, thiodicarb (799)+TX, thiofanox (800)+TX, thiometon (801)+TX, thionazin (1434)+TX, thiosultap (803)+TX, thiosultap-sodium (803)+TX, thuringiensin (alternative name) [CCN]+TX, tolfenpyrad (809)+TX, tralomethrin (812)+TX, transfluthrin (813)+TX, transpermethrin (1440)+TX, triamiphos (1441)+TX, triazamate (818)+TX, triazophos (820)+TX, triazuron (alternative name)+TX, trichlorfon (824)+TX, trichlormetaphos-3 (alternative name) [CCN]+TX, trichloronat (1452)+TX, trifenofos (1455)+TX, triflumuron (835)+TX, trimethacarb (840)+TX, triprene (1459)+TX, vamidothion (847)+TX, vaniliprole [CCN]+TX, veratridine (alternative name) (725)+TX, veratrine (alternative name) (725)+TX, XMC (853)+TX, xylylcarb (854)+TX, Y¹-5302 (compound code)+TX, zeta-cypermethrin (205)+TX, zetamethrin (alternative name)+TX, zinc phosphide (640)+TX, zolaprofos (1469) and ZXI 8901 (development code) (858)+TX, cyantraniliprole [736994-63-19]+TX, chlorantraniliprole [500008-45-7]+TX, cyenopyrafen [560121-52-0]+TX, cyflumetofen [400882-07-7]+TX, pyrifluquinazon [337458-27-2]+TX, spinetoram [187166-40-1+187166-15-0]+TX, spirotetramat [203313-25-1]+TX, sulfoxaflor [946578-00-3]+TX, flufiprole [704886-18-0]+TX, meperfluthrin [915288-13-0]+TX, tetramethylfluthrin [84937-88-2]+TX,

a molluscicide selected from the group of substances consisting of bis(tributyltin) oxide (IUPAC name) (913)+TX, bromoacetamide [CCN]+TX, calcium arsenate [CCN]+TX, cloethocarb (999)+TX, copper acetoarsenite [CCN]+TX, copper sulfate (172)+TX, fentin (347)+TX, ferric phosphate (IUPAC name) (352)+TX, metaldehyde (518)+TX, methiocarb (530)+TX, niclosamide (576)+TX, niclosamide-olamine (576)+TX, pentachlorophenol (623)+TX, sodium pentachlorophenoxide (623)+TX, tazimcarb (1412)+TX, thiodicarb (799)+TX, tributyltin oxide (913)+TX, trifenmorph (1454)+TX, trimethacarb (840)+TX, triphenyltin acetate (IUPAC name) (347) and triphenyltin hydroxide (IUPAC name) (347)+TX, pyriprole [394730-71-3]+TX,

a nematicide selected from the group of substances consisting of AKD-3088 (compound code)+TX, 1,2-dibromo-3-chloropropane (IUPAC/Chemical Abstracts name) (1045)+TX, 1,2-dichloropropane (IUPAC/Chemical Abstracts name) (1062)+TX, 1,2-dichloropropane with 1,3-dichloropropene (IUPAC name) (1063)+TX, 1,3-dichloropropene (233)+TX, 3,4-dichlorotetrahydrothiophene 1,1-dioxide (IUPAC/Chemical Abstracts name) (1065)+TX, 3-(4-chlorophenyl)-5-methylrhodanine (IUPAC name) (980)+TX, 5-methyl-6-thioxo-1,3,5-thiadiazinan-3-ylacetic acid (IUPAC name) (1286)+TX, 6-isopentenylaminopurine (alternative name) (210)+TX, abamectin (1)+TX, acetoprole [CCN]+TX, alanycarb (15)+TX, aldicarb (16)+TX, aldoxycarb (863)+TX, AZ 60541 (compound code)+TX, benclothiaz [CCN]+TX, benomyl (62)+TX, butylpyridaben (alternative name)+TX, cadusafos (109)+TX, carbofuran (118)+TX, carbon disulfide (945)+TX, carbosulfan (119)+TX, chloropicrin (141)+TX, chlorpyrifos (145)+TX, cloethocarb (999)+TX, cytokinins (alternative name) (210)+TX, dazomet (216)+TX, DBCP (1045)+TX, DCIP (218)+TX, diamidafos (1044)+TX, dichlofenthion (1051)+TX, dicliphos (alternative name)+TX, dimethoate (262)+TX, doramectin (alternative name) [CCN]+TX, emamectin (291)+TX, emamectin benzoate (291)+TX, eprinomectin (alternative name) [CCN]+TX, ethoprophos (312)+TX, ethylene dibromide (316)+TX, fenamiphos (326)+TX, fenpyrad (alternative name)+TX, fensulfothion (1158)+TX, fosthiazate (408)+TX, fosthietan (1196)+TX, furfural (alternative name) [CCN]+TX, GY-81 (development code) (423)+TX, heterophos [CCN]+TX, iodomethane (IUPAC name) (542)+TX, isamidofos (1230)+TX, isazofos (1231)+TX, ivermectin (alternative name) [CCN]+TX, kinetin (alternative name) (210)+TX, mecarphon (1258)+TX, metam (519)+TX, metam-potassium (alternative name) (519)+TX, metam-sodium (519)+TX, methyl bromide (537)+TX, methyl isothiocyanate (543)+TX, milbemycin oxime (alternative name) [CCN]+TX, moxidectin (alternative name) [CCN]+TX, Myrothecium verrucaria composition (alternative name) (565)+TX, NC-184 (compound code)+TX, oxamyl (602)+TX, phorate (636)+TX, phosphamidon (639)+TX, phosphocarb [CCN]+TX, sebufos (alternative name)+TX, selamectin (alternative name) [CCN]+TX, spinosad (737)+TX, terbam (alternative name)+TX, terbufos (773)+TX, tetrachlorothiophene (IUPAC/Chemical Abstracts name) (1422)+TX, thiafenox (alternative name)+TX, thionazin (1434)+TX, triazophos (820)+TX, triazuron (alternative name)+TX, xylenols [CCN]+TX, Y¹-5302 (compound code) and zeatin (alternative name) (210)+TX, fluensulfone [318290-98-1]+TX,

a nitrification inhibitor selected from the group of substances consisting of potassium ethylxanthate [CCN] and nitrapyrin (580)+TX,

a plant activator selected from the group of substances consisting of acibenzolar (6)+TX, acibenzolar-5-methyl (6)+TX, probenazole (658) and Reynoutria sachalinensis extract (alternative name) (720)+TX,

a rodenticide selected from the group of substances consisting of 2-isovalerylindan-1,3-dione (IUPAC name) (1246)+TX, 4-(quinoxalin-2-ylamino)benzenesulfonamide (IUPAC name) (748)+TX, alpha-chlorohydrin [CCN]+TX, aluminium phosphide (640)+TX, antu (880)+TX, arsenous oxide (882)+TX, barium carbonate (891)+TX, bisthiosemi (912)+TX, brodifacoum (89)+TX, bromadiolone (91)+TX, bromethalin (92)+TX, calcium cyanide (444)+TX, chloralose (127)+TX, chlorophacinone (140)+TX, cholecalciferol (alternative name) (850)+TX, coumachlor (1004)+TX, coumafuryl (1005)+TX, coumatetralyl (175)+TX, crimidine (1009)+TX, difenacoum (246)+TX, difethialone (249) 35+TX, diphacinone (273)+TX, ergocalciferol (301)+TX, flocoumafen (357)+TX, fluoroacetamide (379)+TX, flupropadine (1183)+TX, flupropadine hydrochloride (1183)+TX, gamma-HCH (430)+TX, HCH (430)+TX, hydrogen cyanide (444)+TX, iodomethane (IUPAC name) (542)+TX, lindane (430)+TX, magnesium phosphide (IUPAC name) (640)+TX, methyl bromide (537)+TX, norbormide (1318)+TX, phosacetim (1336)+TX, phosphine (IUPAC name) (640)+TX, phosphorus [CCN]+TX, pindone (1341)+TX, potassium arsenite [CCN]+TX, pyrinuron (1371)+TX, scilliroside (1390)+TX, sodium arsenite [CCN]+TX, sodium cyanide (444)+TX, sodium fluoroacetate (735)+TX, strychnine (745)+TX, thallium sulfate [CCN]+TX, warfarin (851) and zinc phosphide (640)+TX,

a synergist selected from the group of substances consisting of 2-(2-butoxyethoxy)ethyl piperonylate (IUPAC name) (934)+TX, 5-(1,3-benzodioxol-5-yl)-3-hexylcyclohex-2-enone (IUPAC name) (903)+TX, farnesol with nerolidol (alternative name) (324)+TX, MB-599 (development code) (498)+TX, MGK 264 (development code) (296)+TX, piperonyl butoxide (649)+TX, piprotal (1343)+TX, propyl isomer (1358)+TX, S421 (development code) (724)+TX, sesamex (1393)+TX, sesasmolin (1394) and sulfoxide (1406)+TX,

an animal repellent selected from the group of substances consisting of anthraquinone (32)+TX, chloralose (127)+TX, copper naphthenate [CCN]+TX, copper oxychloride (171)+TX, diazinon (227)+TX, dicyclopentadiene (chemical name) (1069)+TX, guazatine (422)+TX, guazatine acetates (422)+TX, methiocarb (530)+TX, pyridin-4-amine (IUPAC name) (23)+TX, thiram (804)+TX, trimethacarb (840)+TX, zinc naphthenate [CCN] and ziram (856)+TX,

a virucide selected from the group of substances consisting of imanin (alternative name) [CCN] and ribavirin (alternative name) [CCN]+TX,

a wound protectant selected from the group of substances consisting of mercuric oxide (512)+TX, octhilinone (590) and thiophanate-methyl (802)+TX,

and biologically active compounds selected from the group consisting of azaconazole (60207-31-0]+TX, bitertanol [70585-36-3]+TX, bromuconazole [116255-48-2]+TX, cyproconazole [94361-06-5]+TX, difenoconazole [119446-68-3]+TX, diniconazole [83657-24-3]+TX, epoxiconazole [106325-08-0]+TX, fenbuconazole [114369-43-6]+TX, fluquinconazole [136426-54-5]+TX, flusilazole [85509-19-9]+TX, flutriafol [76674-21-0]+TX, hexaconazole [79983-71-4]+TX, imazalil [35554-44-0]+TX, imibenconazole [86598-92-7]+TX, ipconazole [125225-28-7]+TX, metconazole [125116-23-6]+TX, myclobutanil [88671-89-0]+TX, pefurazoate [101903-30-4]+TX, penconazole [66246-88-6]+TX, prothioconazole [178928-70-6]+TX, pyrifenox [88283-41-4]+TX, prochloraz [67747-09-5]+TX, propiconazole [60207-90-1]+TX, simeconazole [149508-90-7]+TX, tebuconazole [107534-96-3]+TX, tetraconazole [112281-77-3]+TX, triadimefon [43121-43-3]+TX, triadimenol [55219-65-3]+TX, triflumizole [99387-89-0]+TX, triticonazole [131983-72-7]+TX, ancymidol [12771-68-5]+TX, fenarimol [60168-88-9]+TX, nuarimol [63284-71-9]+TX, bupirimate [41483-43-6]+TX, dimethirimol [5221-53-4]+TX, ethirimol [23947-60-6]+TX, dodemorph [1593-77-7]+TX, fenpropidine [67306-00-7]+TX, fenpropimorph [67564-91-4]+TX, spiroxamine [118134-30-8]+TX, tridemorph [81412-43-3]+TX, cyprodinil [121552-61-2]+TX, mepanipyrim [110235-47-7]+TX, pyrimethanil [53112-28-0]+TX, fenpiclonil [74738-17-3]+TX, fludioxonil [131341-86-1]+TX, benalaxyl [71626-11-4]+TX, furalaxyl [57646-30-7]+TX, metalaxyl [57837-19-1]+TX, R-metalaxyl [70630-17-0]+TX, ofurace [58810-48-3]+TX, oxadixyl [77732-09-3]+TX, benomyl [17804-35-2]+TX, carbendazim [10605-21-7]+TX, debacarb [62732-91-6]+TX, fuberidazole [3878-19-1]+TX, thiabendazole [148-79-8]+TX, chlozolinate [84332-86-5]+TX, dichlozoline [24201-58-9]+TX, iprodione [36734-19-7]+TX, myclozoline [54864-61-8]+TX, procymidone [32809-16-8]+TX, vinclozoline [50471-44-8]+TX, boscalid [188425-85-6]+TX, carboxin [5234-68-4]+TX, fenfuram [24691-80-3]+TX, flutolanil [66332-96-5]+TX, mepronil [55814-41-0]+TX, oxycarboxin [5259-88-1]+TX, penthiopyrad [183675-82-3]+TX, thifluzamide [130000-40-7]+TX, guazatine [108173-90-6]+TX, dodine [2439-10-3] [112-65-2] (free base)+TX, iminoctadine [13516-27-3]+TX, azoxystrobin [131860-33-8]+TX, dimoxystrobin [149961-52-4]+TX, enestroburin {Proc. BCPC, Int. Congr., Glasgow, 2003, 1, 93}+TX, fluoxastrobin [361377-29-9]+TX, kresoxim-methyl [143390-89-0]+TX, metominostrobin [133408-50-1]+TX, trifloxystrobin [141517-21-7]+TX, orysastrobin [248593-16-0]+TX, picoxystrobin [117428-22-5]+TX, pyraclostrobin [175013-18-0]+TX, ferbam [14484-64-1]+TX, mancozeb [8018-01-7]+TX, maneb [12427-38-2]+TX, metiram [9006-42-2]+TX, propineb [12071-83-9]+TX, thiram [137-26-8]+TX, zineb [12122-67-7]+TX, ziram [137-30-4]+TX, captafol [2425-06-1]+TX, captan [133-06-2]+TX, dichlofluanid [1085-98-9]+TX, fluoroimide [41205-21-4]+TX, folpet [133-07-3]+TX, tolylfluanid [731-27-1]+TX, bordeaux mixture [8011-63-0]+TX, copperhydroxid [20427-59-2]+TX, copperoxychlorid [1332-40-7]+TX, coppersulfat [7758-98-7]+TX, copperoxid [1317-39-1]+TX, mancopper [53988-93-5]+TX, oxine-copper [10380-28-6]+TX, dinocap [131-72-6]+TX, nitrothal-isopropyl [10552-74-6]+TX, edifenphos [17109-49-8]+TX, iprobenphos [26087-47-8]+TX, isoprothiolane [50512-35-1]+TX, phosdiphen [36519-00-3]+TX, pyrazophos [13457-18-6]+TX, tolclofos-methyl [57018-04-9]+TX, acibenzolar-S-methyl [135158-54-2]+TX, anilazine [101-05-3]+TX, benthiavalicarb [413615-35-7]+TX, blasticidin-S [2079-00-7]+TX, chinomethionat [2439-01-2]+TX, chloroneb [2675-77-6]+TX, chlorothalonil [1897-45-6]+TX, cyflufenamid [180409-60-3]+TX, cymoxanil [57966-95-7]+TX, dichlone [117-80-6]+TX, diclocymet [139920-32-4]+TX, diclomezine [62865-36-5]+TX, dicloran [99-30-9]+TX, diethofencarb [87130-20-9]+TX, dimethomorph [110488-70-5]+TX, SYP-LI90 (Flumorph) [211867-47-9]+TX, dithianon [3347-22-6]+TX, ethaboxam [162650-77-3]+TX, etridiazole [2593-15-9]+TX, famoxadone [131807-57-3]+TX, fenamidone [161326-34-7]+TX, fenoxanil [115852-48-7]+TX, fentin [668-34-8]+TX, ferimzone [89269-64-7]+TX, fluazinam [79622-59-6]+TX, fluopicolide [239110-15-7]+TX, flusulfamide [106917-52-6]+TX, fenhexamid [126833-17-8]+TX, fosetyl-aluminium [39148-24-8]+TX, hymexazol [10004-44-1]+TX, iprovalicarb [140923-17-7]+TX, IKF-916 (Cyazofamid) [120116-88-3]+TX, kasugamycin [6980-18-3]+TX, methasulfocarb [66952-49-6]+TX, metrafenone [220899-03-6]+TX, pencycuron [66063-05-6]+TX, phthalide [27355-22-2]+TX, polyoxins [11113-80-7]+TX, probenazole [27605-76-1]+TX, propamocarb [25606-41-1]+TX, proquinazid [189278-12-4]+TX, pyroquilon [57369-32-1]+TX, quinoxyfen [124495-18-7]+TX, quintozene [82-68-8]+TX, sulphur [7704-34-9]+TX, tiadinil [223580-51-6]+TX, triazoxide [72459-58-6]+TX, tricyclazole [41814-78-2]+TX, triforine [26644-46-2]+TX, validamycin [37248-47-8]+TX, zoxamide (RH7281) [156052-68-5]+TX, mandipropamid [374726-62-2]+TX, isopyrazam [881685-58-1]+TX, sedaxane [874967-67-6]+TX, 3-difluoromethyl-1-methyl-1H-pyrazole-4-carboxylic acid (9-dichloromethylene-1,2,3,4-tetrahydro-1,4-methano-naphthalen-5-yl)-amide (disclosed in WO 2007/048556)+TX, 3-difluoromethyl-1-methyl-1H-pyrazole-4-carboxylic acid [2-(2,4-dichlorophenyl)-2-methoxy-1-methyl-ethyl]-amide (disclosed in WO 2008/148570)+TX, 1-[4-[4-[(55)-5-(2,6-difluorophenyl)-4,5-dihydro-1,2-oxazol-3-yl]-1,3-thiazol-2-yl]piperidin-1-yl]-2-[5-methyl-3-(trifluoromethyl)-1H-pyrazol-1-yl]ethanone+TX, 1-[4-[4-[5-(2,6-difluorophenyl)-4,5-dihydro-1,2-oxazol-3-yl]-1,3-thiazol-2-yl]piperidin-1-yl]-2-[5-methyl-3-(trifluoromethyl)-1H-pyrazol-1-yl]ethanone [1003318-67-9], both disclosed in WO 2010/123791, WO 2008/013925, WO 2008/013622 and WO 2011/051243 page 20)+TX, and 3-difluoromethyl-1-methyl-1H-pyrazole-4-carboxylic acid (3′,4′,5′-trifluoro-biphenyl-2-yl)-amide (disclosed in WO 2006/087343)+TX.

Throughout this document the expression “composition” stands for the various mixtures or combinations of components TX and (B), for example in a single “ready-mix” form, in a combined spray mixture composed from separate formulations of the single active ingredient components, such as a “tank-mix”, and in a combined use of the single active ingredients when applied in a sequential manner, i.e. one after the other with a reasonably short period, such as a few hours or days. The order of applying the components TX and (B) is not essential for working the present invention.

The compositions according to the invention may also comprise more than one of the active components (B), if, for example, a broadening of the spectrum of disease control is desired. For instance, it may be advantageous in the agricultural practice to combine two or three components (B) with component TX. An example is a composition comprising a compound of formula (I), azoxystrobin and cyproconazole.

In the above different lists of active ingredients to be mixed with a TX, the compound of the formula I is preferably a compound of Tables 1-34 and Tables 38-39, and more preferably, a compound selected from P.01, P.02, P.03, P.04, P.05, P.08, P.09, P.10, P.11, P.12, P.13, P.14, P.15, P.16, P.17, P.18, P.19, P.20, P.21, P.22, P.23A, P.24, P.29, P.33, P.34, P. 35, P.37, P.38, P.39, P.45, P.46, P.47, P.49, P.50, P.51, P.53, P.54, P.55, P.56, P.57, P.58, P.60, P.61, P.62, P.63A, P.64, P.65, P.66, P.67, P.68, P.69, P.71, P.72, P.74, P.75, P.76, P.77, P.78, P.79, P.80, P.82, P.83, P.84, P.85, P.86, P.87, P.88, P.89, P.90, P.91, P.92, P.94, P.95, P.96, P.97, P.98, P.99, P.100, P.102, P.103, P.101, P.104, P.105, P.107, P.108.

In the above-mentioned mixtures of compounds of formula I, in particular a compound selected from said Tables 1-34 and Tables 38-39, with other insecticides, fungicides, herbicides, safeners, adjuvants and the like, the mixing ratios can vary over a large range and are, preferably 100:1 to 1:6000, especially 50:1 to 1:50, more especially 20:1 to 1:20, even more especially 10:1 to 1:10. Those mixing ratios are understood to include, on the one hand, ratios by weight and also, on other hand, molar ratios.

The mixtures can advantageously be used in the above-mentioned formulations (in which case “active ingredient” relates to the respective mixture of TX with the mixing partner).

Some mixtures may comprise active ingredients which have significantly different physical, chemical or biological properties such that they do not easily lend themselves to the same conventional formulation type. In these circumstances other formulation types may be prepared. For example, where one active ingredient is a water insoluble solid and the other a water insoluble liquid, it may nevertheless be possible to disperse each active ingredient in the same continuous aqueous phase by dispersing the solid active ingredient as a suspension (using a preparation analogous to that of an SC) but dispersing the liquid active ingredient as an emulsion (using a preparation analogous to that of an EW). The resultant composition is a suspoemulsion (SE) formulation.

It has been found, surprisingly, that certain weight ratios of component TX to component (B) are able to give rise to synergistic activity. Therefore, a further aspect of the invention are compositions, wherein component TX and component (B) are present in the composition in amounts producing a synergistic effect. This synergistic activity is apparent from the fact that the fungicidal activity of the composition comprising component TX and component (B) is greater than the sum of the fungicidal activities of component TX and of component (B). This synergistic activity extends the range of action of component TX and component (B) in two ways. Firstly, the rates of application of component TX and component (B) are lowered whilst the action remains equally good, meaning that the active ingredient mixture still achieves a high degree of phytopathogen control even where the two individual components have become totally ineffective in such a low application rate range. Secondly, there is a substantial broadening of the spectrum of phytopathogens that can be controlled.

A synergistic effect exists whenever the action of an active ingredient combination is greater than the sum of the actions of the individual components. The action to be expected E for a given active ingredient combination obeys the so-called COLBY formula and can be calculated as follows (COLBY, S. R. “Calculating synergistic and antagonistic responses of herbicide combination”. Weeds, Vol. 15, pages 20-22; 1967):

ppm=milligrams of active ingredient (=a.i.) per liter of spray mixture

X=% action by active ingredient A) using p ppm of active ingredient

Y=% action by active ingredient B) using q ppm of active ingredient.

According to COLBY, the expected (additive) action of active ingredients A)+B) using p+q ppm of active ingredient is

$$E = X + Y - \frac{X \cdot Y}{100}$$

If the action actually observed (O) is greater than the expected action (E), then the action of the combination is super-additive, i.e. there is a synergistic effect. In mathematical terms, synergism corresponds to a positive value for the difference of (O-E). In the case of purely complementary addition of activities (expected activity), said difference (O-E) is zero. A negative value of said difference (O-E) signals a loss of activity compared to the expected activity.

However, besides the actual synergistic action with respect to fungicidal activity, the compositions according to the invention can also have further surprising advantageous properties. Examples of such advantageous properties that may be mentioned are: more advantageuos degradability; improved toxicological and/or ecotoxicological behaviour; or improved characteristics of the useful plants including: emergence, crop yields, more developed root system, tillering increase, increase in plant height, bigger leaf blade, less dead basal leaves, stronger tillers, greener leaf colour, less fertilizers needed, less seeds needed, more productive tillers, earlier flowering, early grain maturity, less plant verse (lodging), increased shoot growth, improved plant vigor, and early germination.

Some compositions according to the invention have a systemic action and can be used as foliar, soil and seed treatment fungicides.

With the compositions according to the invention it is possible to inhibit or destroy the phytopathogenic microorganisms which occur in plants or in parts of plants (fruit, blossoms, leaves, stems, tubers, roots) in different useful plants, while at the same time the parts of plants which grow later are also protected from attack by phytopathogenic microorganisms.

The compositions according to the invention can be applied to the phytopathogenic microorganisms, the useful plants, the locus thereof, the propagation material thereof, storage goods or technical materials threatened by microorganism attack.

The compositions according to the invention may be applied before or after infection of the useful plants, the propagation material thereof, storage goods or technical materials by the microorganisms.

A further aspect of the present invention is a method of controlling diseases on useful plants or on propagation material thereof caused by phytopathogens, which comprises applying to the useful plants, the locus thereof or propagation material thereof a composition according to the invention. Preferred is a method, which comprises applying to the useful plants or to the locus thereof a composition according to the invention, more preferably to the useful plants. Further preferred is a method, which comprises applying to the propagation material of the useful plants a composition according to the invention.

The compositions according to the invention may also comprise more than one of the active components (B), if, for example, a broadening of the spectrum of disease control is desired. For instance, it may be advantageous in the agricultural practice to combine two or three components (B) with component TX. An example is a composition comprising a compound of formula (I), azoxystrobin and cyproconazole.

The following non-limiting Examples illustrate the above-described invention in greater detail without limiting it. Those skilled in the art will promptly recognise appropriate variations from the procedures both as to reactants and as to reaction conditions and techniques. All references mentioned herein are incorporated by reference in their entirety.

### PREPARATORY EXAMPLES

Throughout these examples, the isomer drawn is in excess in the reaction mixture and/or product

### Example 1

### Preparation of Compound P.12

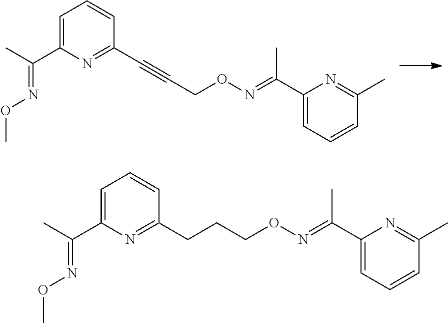

(E)-1-(6-{3-[1-(6-Methyl-pyridin-2-yl)-eth-(E)-ylideneaminooxy]-prop-1-ynyl}-pyridin-2-yl)-ethanone O-methyl-oxime (85 mg) was dissolved in ethanol (10 mL). Palladium on carbon (5% on charcoal; 5 mg) was added and the reaction mixture was stirred for 16 h under an atmosphere of hydrogen. The reaction mixture was filtered, evaporated and purified over silica to give a yellow oil (13 mg). 1H-NMR (CDCl3, 400 MHz): 7.70 (d, 1H), 7.68 (d, 1H), 7.69-7.50 (m, 2H), 7.12 (d, 1H), 7.10 (d, 1H), 4.39 (t, 2H), 4.01 (s, 3H), 2.92 (t, 2H), 2.32 (s, 6H), 2.21 (m, 2H)

### Preparation of (E)-1-(6-{3-[1-(6-methyl-pyridin-2-yl)-eth-(E)-ylideneaminooxy]-prop-1-ynyl}-pyridin-2-yl)-ethanone O-methyl-oxime

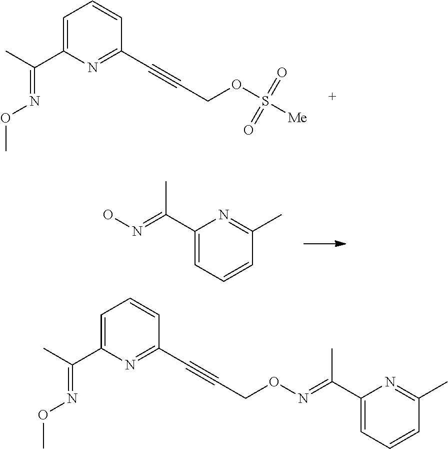 [SMILES: CO/N=C(\C)c1cccc(C#CCOS(C)(=O)=O)n1 ; C/C(=N\O)c1cccc(C)n1 ; CO/N=C(\C)c1cccc(C#CCO/N=C(\C)c2cccc(C)n2)n1]

Sodium hydride (55% w/w in mineral oil; 22 mg) was added at 0-5° C. to a solution of (E)-1-(6-methyl-pyridin-2-yl)-ethanone oxime (50 mg) in dimethylformamide (3.5 mL). After stirring for 20 min at 0-5° C. a solution of methanesulfonic acid 3-(6-{1-[(E)-methoxyimino]-ethyl}-pyridin-2-yl)-prop-2-ynyl ester (94 mg) in dimethylformamide (0.5 mL) was added. The reaction mixture was the stirred for 3 h at ambient temperature, then diluted with ethyl acetate and washed with water. The organic phase was separated, dried over sodium sulphate and concentrated to give brown material (85 mg) which was used without further purification in the next step.

### Preparation of methanesulfonic acid 3-(6-{1-[(E)-methoxyimino]-ethyl}-pyridin-2-yl)-prop-2-ynyl ester

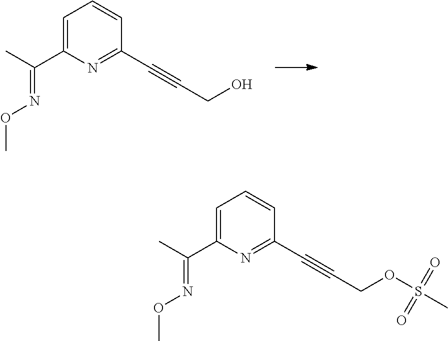 [SMILES: CO/N=C(\C)c1cccc(C#CCO)n1 ; CO/N=C(\C)c1cccc(C#CCOS(C)(=O)=O)n1]

Methane sulfonyl chloride (118 mg) was added at 0-5° C. to a solution of triethylamine (0.21 mL) and (E)-1-[6-(3-hydroxy-prop-1-ynyl)-pyridin-2-yl]-ethanone O-methyl-oxime (150 mg) in dichloromethane (3.0 mL). After stirring for 10 min at 5° C. and 90 min at ambient temperature sodium bicarbonate (10% w/w aqueous solution; 1 mL) was added and the reaction mixture was diluted with dichloromethane, washed with water and brine and dried over sodium sulfate. Filtration and concentration gave a yellow residue (211 mg) which was used directly in the next step.

### Preparation of (E)-1-[6-(3-hydroxy-prop-1-ynyl)-pyridin-2-yl]-ethanone O-methyl-oxime

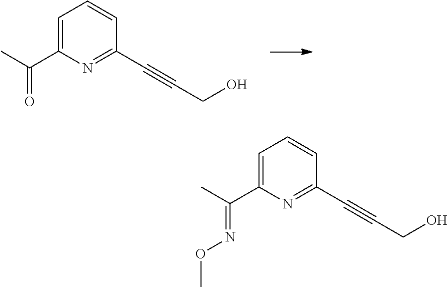

Sodium-acetate (490 mg) and O-methyl-hydroxylamine hydrochloride (396 mg) were added to a solution of 1-[6-(3-hydroxy-prop-1-ynyl)-pyridin-2-yl]-ethanone (700 mg) in methanol (7 mL). After stirring for 16 h at ambient temperature the reaction mixture was diluted with ethyl acetate, washed with water and dried over sodium sulphate. Filtration and concentration gave a beige solid (729 mg). ¹H-NMR (CDCl3, 400 MHz): 7.99 (d, 1H), 7.64 (t, 1H), 7.49 (d, 1H), 4.53 (s, 2H), 4.3 (s, 3H), 2.31 (s, 3H), 1.88 (s broad, 1H)

### Preparation of 1-[6-(3-hydroxy-prop-1-ynyl)-pyridin-2-yl]-ethanone

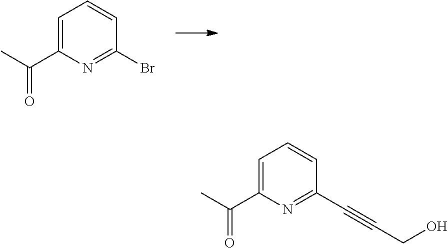

2-Acetyl-6-bromopyridine (10 g) and propargyl alcohol (3.64 g) were dissolved in THF (150 mL). Diisopropylamine (14.1 mL), dichlorobis (triphenylphospine) palladium(II) (1.4 g) and copper(I) iodide (0.99 g) were added. After stirring for 16 h at 70° C. the reaction mixture was concentrated to ⅓ of the volume, diluted with ethyl acetate, washed with sodium bicarbonate (10% w/w aqueous solution) and brine. The organic phase was dried over sodium sulphate, concentrated and purified by chromatography over silica to give a beige solid (6.8 g). ¹H-NMR (CDCl3, 400 MHz): 7.99 (d, 1H), 7.80 (t, 1H), 7.60 (d, 1H), 4.60 (d, 2H), 2.74 (d, 3H), 2.26 (t, 1H)

### Example 2

### Preparation of Compound P.09

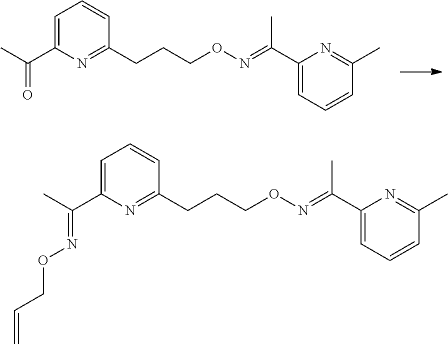 [SMILES: CC(=O)c1cccc(CCCO/N=C(\C)c2cccc(C)n2)n1 ; C=CCO/N=C(\C)c1cccc(CCCO/N=C(\C)c2cccc(C)n2)n1]

Sodium acetate (10 mg) and O-allyl-hydroxylamine hydrochloride (13 mg) were added to a solution of 1-(6-{3-[1-(6-methyl-pyridin-2-yl)-eth-(E)-ylideneaminooxy]-propyl}-pyridin-2-yl)-ethanone (30 mg) in methanol (4 mL) After stirring for 16 h at ambient temperature the reaction mixture was diluted with ethyl acetate, washed with water and dried over sodium sulphate. Filtration and concentration gave 31 mg of light yellow oil. ¹H-NMR (CDCl3, 400 MHz): 7.70 (d, 1H), 7.68 (d, 1H), 7.58-7.50 (m, 2H), 7.12-7.05 (m, 2H), 6.12-6.02 (m, 1H), 5.49-5.20 (m, 2H) 4.72 (d, 2H), 4.39 (t, 2H), 2.92 (t, 2H), 2.57 (s, 3H), 2.37 (s, 3H), 2.32 (s, 3H), 2.22 (m, 2H)

### Preparation of 1-(6-{3-[1-(6-methyl-pyridin-2-yl)-eth-(E)-ylideneaminooxy]-propyl}-pyridin-2-yl)-ethanone

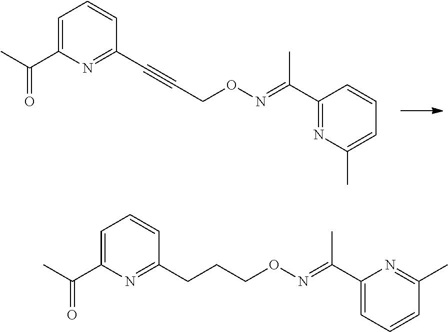 [SMILES: CC(=O)c1cccc(C#CCO/N=C(\C)c2cccc(C)n2)n1 ; CC(=O)c1cccc(CCCO/N=C(\C)c2cccc(C)n2)n1]

1-(6-{3-[1-(6-Methyl-pyridin-2-yl)-eth-(E)-ylideneaminooxy]-prop-1-ynyl}-pyridin-2-yl)-ethanone (290 mg) was dissolved in ethanol (10 mL). Palladium (5% on charcoal; 20 mg) was added and the reaction mixture was stirred for 16 h under an atmosphere of hydrogen. The reaction mixture was filtered, evaporated and purified over silica to give a yellow oil (239 mg). ¹H-NMR (CDCl3, 400 MHz): 7.85 (d, 1H), 7.72 (t, 1H), 7.68 (d, 1H), 7.53 (t, 1H), 7.33 (d, 1H), 7.10 (d, 1H), 4.31 (t, 2H), 3.00 (t, 2H), 2.71 (s, 3H), 2.56 (s, 3H), 2.31 (s, 3H), 2.25 (m, 2H)

### Preparation of 1-(6-{3-[1-(6-methyl-pyridin-2-yl)-eth-(E)-ylideneaminooxy]-prop-1-ynyl}-pyridin-2-yl)-ethanone

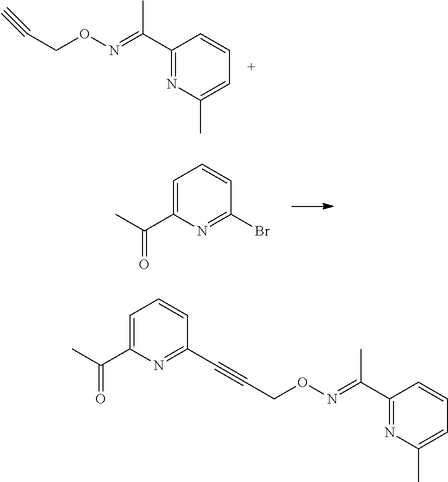

2-Acetyl-6-bromopyridine (500 mg) and (E)-1-(6-methyl-pyridin-2-yl)-ethanone O-prop-2-ynyl-oxime (470 mg) were dissolved in THF (10 mL). Diisopropylamine (0.72 mL), dichlorobis (triphenylphospine) palladium (II) (53 mg) and copper (I) iodide (38 mg) were added. After stirring for 16 h at 70° C. the reaction mixture was diluted with ethyl acetate, washed with sodium bicarbonate (10% w/w aqueous solution) and brine. The organic phase was dried over sodium sulphate, concentrated and purified by chromatography over silica to give a beige solid (430 mg). ¹H-NMR (CDCl3, 400 MHz): 7.98 (d, 1H), 7.79 (t, 1H), 7.73 (d, 1H), 7.63 (d, 1H), 7.58 (t, 1H), 7.12 (d, 1H), 5.10 (s, 2H), 2.73 (s, 3H), 2.48 (s, 3H), 2.40 (s, 3H)

### Preparation of (E)-1-(6-methyl-pyridin-2-yl)-ethanone O-prop-2-ynyl-oxime

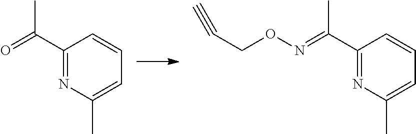

2-Acetyl-6-methyl-pyridine (1.5 g) was dissolved in ethanol (10 mL). Sodium acetate (1.37 g) and O-propargyl-hydroxylamine hydrochloride (1.45 g) were added. After stirring for 16 h at ambient temperature the reaction mixture was diluted with ethyl acetate, washed with water, dried over sodium sulphate, filtrated and evaporated to give a brown oil (1.9 g). ¹H-NMR (CDCl3, 400 MHz): 7.70 (d, 1H), 7.54 (t, 1H), 7.10 (d, 1H), 4.81 (s, 2H), 2.58 (s, 3H), 2.49 (s, 1H), 2.37 (s, 3H)

### Example 3

### Preparation of Compound P.03

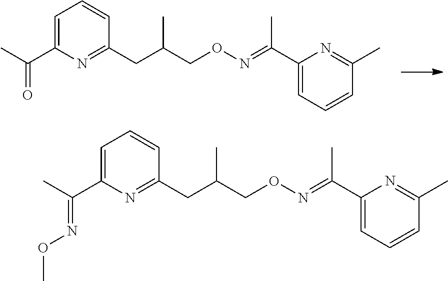

Sodium acetate (10 mg) and O-methyl-hydroxylamine hydrochloride (8 mg) were added to a solution of 1-(6-{2-methyl-3-[1-(6-methyl-pyridin-2-yl)-eth-(E)-ylideneaminooxy]-propyl}-pyridin-2-yl)-ethanone (25 mg) in methanol (5 mL). After stirring for 16 h at ambient temperature the reaction mixture was diluted with ethyl acetate, washed with water and dried over sodium sulphate. Filtration and concentration gave a light yellow oil (27 mg). ¹H-NMR (CDCl3, 400 MHz): 7.63 (d, 1H), 7.59 (d, 1H), 7.50-7.41 (m, 2H), 7.05-6.97 (2d, 2H), 4.13-4.00 (m, 2H), 3.94 (s, 3H), 2.90 (dd, 1H), 2.60 (dd, 1H), 2.50 (m, 4H), 2.74 (2s, 6H), 0.92 (d, 3H).

### Preparation of 1-(6-{2-methyl-3-[1-(6-methyl-pyridin-2-yl)-eth-(E)-ylideneaminooxy]-propyl}-pyridin-2-yl)-ethanone

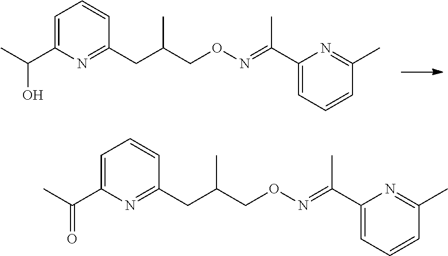

1,1,1-Tris(acetyloxy)-1,1-dihydro-1,2-benziodoxol-3-(1H)-one (55 mg) was added to a solution of (E)-1-(6-methyl-pyridin-2-yl)-ethanone O-{3-[6-(1-hydroxy-ethyl)-pyridin-2-yl]-2-methyl-propyl}-oxime (34 mg) in dichloromethane (3 mL). After stirring for 16 h at ambient temperature, sodium hydrogen carbonate (2 mL; 20% aqueous solution) and sodium thiosulphate (2 mL; 30% aqueous solution) were added. After stirring for further 40 min the organic phase was separated, washed with water, dried over sodium sulphate, filtered and purified by chromatography over silica to give a colorless oil (25 mg) ¹H-NMR (CDCl3, 400 MHz): 7.85 (d, 1H), 7.70 (t, 1H), 7.65 (d, 1H), 7.54 (t, 1H), 7.30 (d, 1H), 7.10 (d, 1H), 4.15 (m, 2H), 3.04 (dd, 1H), 2.78-2.68 (m, 4H), 2.65-2.54 (m, 4H), 2.30 (s, 3H), 1.00 (d, 3H)

### Preparation of (E)-1-(6-methyl-pyridin-2-yl)-ethanone O-{3-[6-(1-hydroxy-ethyl)-pyridin-2-yl]-2-methyl-propyl}-oxime

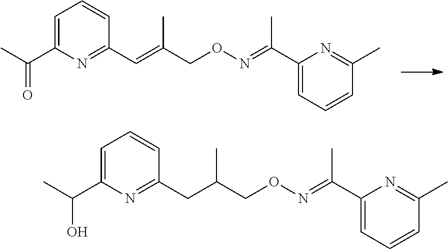

1-(6-{(E)-2-Methyl-3-[1-(6-methyl-pyridin-2-yl)-eth-(E)-ylideneaminooxy]-propenyl}-pyridin-2-yl)-ethanone (149 mg) was dissolved in ethanol (8 mL). Palladium (5% on charcoal; 10 mg) was added and the reaction mixture was stirred for 16 h under an atmosphere of hydrogen. The reaction mixture was filtered, evaporated and purified over silica to give a yellow oil (32 mg). ¹H-NMR (CDCl3, 400 MHz): 7.65 (d, 1H), 7.6-7.5 (m, 2H), 7.10-7.03 (m, 3H), 4.89-4.79 (m, 2H), 4.18-4.05 (m, 2H), 2.98 (dd, 1H), 2.68 (m, 1H), 2.55 (m, 4H), 2.30 (d, 3H), 1.49 (dd, 2H), 1.00 (dd, 3H)

### Preparation of 1-(6-{(E)-2-methyl-3-[1-(6-methyl-pyridin-2-yl)-ethylideneaminooxy]-propenyl}-pyridin-2-yl)-ethanone

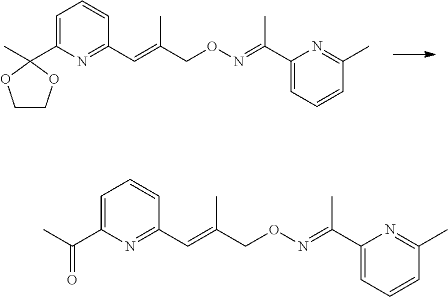

(E)-1-(6-Methyl-pyridin-2-yl)-ethanone O-{(E/Z)-2-methyl-3-[6-(2-methyl-[1,3]dioxolan-2-yl)-pyridin-2-yl]-allyl}-oxime (540 mg; containing some (E)-1-(6-methyl-pyridin-2-yl)-ethanone oxime) was dissolved in acetone (20 mL). Hydrochloric acid (3 mL; 30% aqueous solution) was added and the reaction mixture was stirred at ambient temperature for 72 h. The reaction mixture was concentrated, neutralised with sodium bicarbonate (20% aqueous solution) and extracted with dichloromethane. The organic phase was dried over sodium sulphate, concentrated and purified by chromatography over silica to give a yellow oil (189 mg). According to ¹H-NMR a mixture of E/Z isomers was obtained. ¹H-NMR (CDCl3, 400 MHz) signals for E/E isomer: 7.86 (d, 1H), 7.77 (t, 1H), 7.69 (d, 1H), 7.55 (t, 1H), 7.38 (d, 1H), 6.68 (s, 1H), 7.10 (d, 1H), 6.60 (s, 1H), 4.85 (s, 2H), 2.74 (s, 3H), 2.57 (s, 3H), 2.42 (s, 3H), 2.32 (s, 3H).

### Preparation of (E)-1-(6-methyl-pyridin-2-yl-ethanone O-{2-methyl-3-[6-(2-methyl-[1,3]dioxolan-2-yl)-pyridin-2-yl]-allyl}-oxime

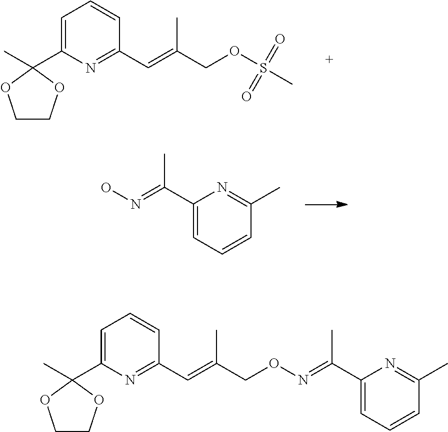

Sodium hydride (0.17 g; 55% w/w in mineral oil) was added at 0-5° C. to a solution of (E)-1-(6-methyl-pyridin-2-yl)-ethanone oxime (0.59 g) in dimethylformamide (12 mL). After stirring for 30 min at 0-5° C. a solution of methanesulfonic acid 2-methyl-3-[6-(2-methyl-[1,3]dioxolan-2-yl)-pyridin-2-yl]-allyl ester (0.456 g) in dimethylformamide (4 mL) was added. The cooling bath was removed and the reaction mixture was stirre for 16 h at ambient temperature. The reaction mixture was diluted with ethyl acetate and washed with water. The organic phase was dried over sodium sulphate, concentrated and purified by chromatography over silica to give a yellow oil (672 mg), which still contained some (E)-1-(6-methyl-pyridin-2-yl)-ethanone oxime. This material was used in the next step without further purification.

### Preparation of methanesulfonic acid 2-methyl-3-[6-(2-methyl-[1,3]-dioxolan-2-yl)-pyridin-2-yl]-allyl ester

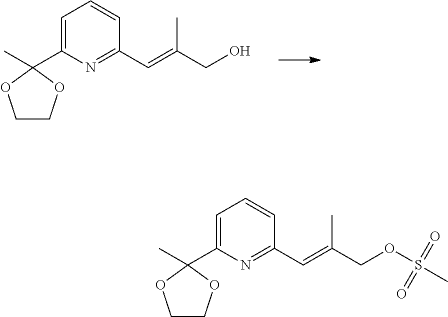

Methane sulfonyl chloride (0.498 g) was added at 0-5° C. to a solution of (E)-2-methyl-3-[6-(2-methyl-[1,3]dioxolan-2-yl)-pyridin-2-yl]-prop-2-en-1-ol (0.93 g) and triethylamine (1.09 g) in dichloromethane (15 mL). After stirring for 2 h at 0-5° C. sodium bicarbonate (2 mL, 20% aqueous solution) was added. The reaction mixture was diluted with dichloromethane, washed with water, dried over magnesium sulfate, filtrated and concentrated to give a yellow oil (0.45 g) which was used in the next step without further purification. ¹H-NMR (CDCl3, 400 MHz) signals for E isomer: 7.68 (t, 1H), 7.41 (d, 1H), 7.19 (d, 1H), 6.68 (s, 1H), 4.79 (s, 2H), 4.10 (m, 2H), 3.93 (m, 2H), 3.07 (s, 3H), 2.23 (s, 3H), 1.78 (s, 3H).

### Preparation of (E)-2-methyl-3-[6-(2-methyl-[1,3]dioxolan-2-yl)-pyridin-2-yl]-prop-2-en-1-ol

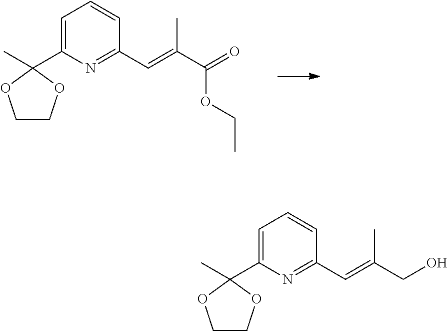 [SMILES: CCOC(=O)/C(C)=C/c1cccc(C2(C)OCCO2)n1 ; C/C(=C\c1cccc(C2(C)OCCO2)n1)CO]

Diisobutyl aluminium hydride (1M in dichloromethane; 12.4 mL) was added within 30 min at −60° C. to a solution of 2-methyl-3-[6-(2-methyl-[1,3]dioxolan-2-yl)-pyridin-2-yl]-acrylic acid ethyl ester (1.69 g) in dichloromethane (30 mL). After stirring for 3 h at −60° C. the cooling bath was removed and water (0.5 mL), NaOH (2M aqueous solution; 0.5 mL) and again water (1 mL) were added. During these additions the temperature raised to 10° C. The reaction mixture was stirred for 30 min at 0-10° C., and then magnesium sulphate was added. After further stirring for 30 min the reaction mixture was filtered, evaporated and purified over silica to give a yellow oil (910 mg). ¹H-NMR (CDCl3, 400 MHz): 7.64 (t, 1H), 7.48 (d, 1H), 7.17 (d, 1H), 6.63 (s, 1H), 4.22 (d, 2H), 4.10 (m, 2H), 3.92 (m, 2H), 2.14 (s, 3H), 1.78 (s, 3H).

### Preparation of 2-methyl-3-[6-(2-methyl-[1,3]dioxolan-2-yl)-pyridin-2-yl]-acrylic acid ethyl ester

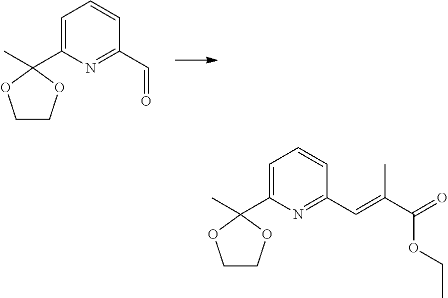 [SMILES: CC1(c2cccc(C=O)n2)OCCO1 ; CCOC(=O)/C(C)=C/c1cccc(C2(C)OCCO2)n1]

2-(Diethoxy-phosphoryl)-propionic acid ethyl ester (2.52 g) and diisopropylethylamine (1.74 g) were added at ambient temperature to a solution of lithium chloride (0.54 g) in acetonitrile (30 mL). After stirring for 5 min a solution of 6-(2-methyl-[1,3]dioxolan-2-yl)-pyridine-2-carbaldehyde (1.2 g; prepared according to Bioorganic & Medicinal Chemistry (2005), 13(24), 6763-6770) in acetonitrile (5 mL) was added and the reaction mixture was stirrer for 72 h at ambient temperature. The reaction mixture was diluted with ethyl acetate and washed with water. The organic phase was dried over sodium sulphate, concentrated and purified by chromatography over silica to give a yellow oil (1.69 g). ¹H-NMR (CDCl3, 400 MHz): 7.71 (t, 1H), 7.67 (s, 1H), 7.47 (d, 1H), 7.31 (d, 1H), 4.28 (q, 2H), 4.13 (m, 2H), 3.95 (m, 2H), 2.46 (s, 3H), 1.79 (s, 3H), 1.35 (t, 3H)

### Preparation of (E)-1-(6-methyl-pyridin-2-yl)-ethanone oxime

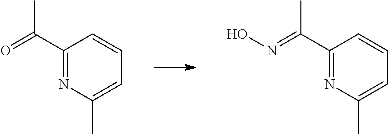

2-Acetyl-6-methyl-pyridine (12 g) was dissolved in methanol (70 mL). Sodium acetate (10.9) and hydroxylamine hydrochloride (7.4 g) were added. After stirring for 3 h at ambient temperature the reaction mixture was diluted with ethyl acetate washed with water, dried over sodium sulphate, filtered, evaporated and crystallised from hexane to give a white solid (11.2 g). ¹H-NMR (CDCl3, 400 MHz): 9.95 (s broad, 1H), 7.57 (m, 2H), 7.10 (d, 1H), 2.59 (s, 3H), 2.40 (s, 3H).

### Example 4

### Preparation of Compounds P.07 and P.08

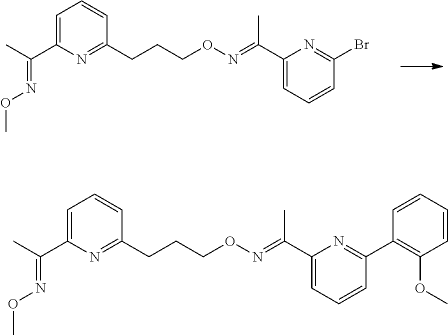 [SMILES: CO/N=C(\C)c1cccc(CCCO/N=C(\C)c2cccc(Br)n2)n1 ; CO/N=C(\C)c1cccc(CCCO/N=C(\C)c2cccc(-c3ccccc3OC)n2)n1]

2-Methoxy-phenyl boronic-acid (56 mg), palladium (II) acetate (2 mg), 2-dicyclohexylphosphino-2′,6′-dimethoxybiphenyl (sPhos; 8 mg), potassium phosphate (236 mg) and (E)-1-(6-{3-[1-(6-bromo-pyridin-2-yl)-eth-(E)-ylideneaminooxy]-propyl}-pyridin-2-yl)-ethanone O-methyl-oxime (100 mg) were suspended in toluene (5 mL) and stirred under an argon atmosphere at 100° C. for 16 h. The reaction mixture was diluted with ethyl acetate and washed with water. The organic phase was separated dried over sodium sulphate and concentrated. The crude was purified by chromatography over silica to give a colorless oil (59 mg). ¹H-NMR (CDCl3, 400 MHz): 7.95 (d, 1H), 7.85 (m, 2H), 7.68 (m, 2H), 7.76 (t, 1H), 7.48 (t, 1H), 7.10 (m, 2H), 7.00 (d, 1H), 4.30 (t, 2H), 4.02 (s, 3H), 3.89 (s, 3H), 2.93 (t, 2H), 2.40 (s, 3H), 2.33 (s, 3H), 2.24 (m, 2H).

### Preparation of (E)-1-(6-{3-[1-(6-bromo-pyridin-2-yl-eth-(E)-ylideneaminooxy]-propyl}-pyridin-2-yl)-ethanone O-methyl-oxime

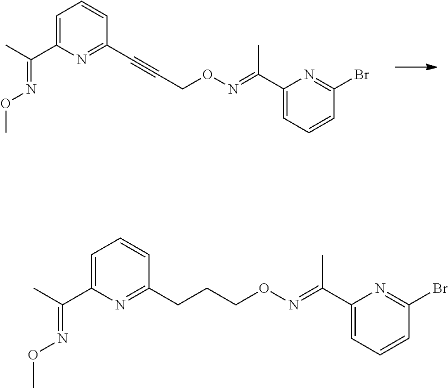 [SMILES: CO/N=C(\C)c1cccc(C#CCO/N=C(\C)c2cccc(Br)n2)n1 ; CO/N=C(\C)c1cccc(CCCO/N=C(\C)c2cccc(Br)n2)n1]

(E)-1-(6-Bromo-pyridin-2-yl)-ethanone O-[3-(6-{1-[(E)-methoxyimino]-ethyl}-pyridin-2-yl)-prop-2-ynyl]-oxime (883 mg) was dissolved in ethanol (20 mL). Platinum (IV) oxide hydrate (73 mg) was added and the reaction mixture was stirred for 30 min under an atmosphere of hydrogen. The reaction mixture was filtered, evaporated and purified over silica to give a yellow oil (871 mg). ¹H-NMR (CDCl3, 400 MHz): 7.87 (d, 1H), 7.70 (d, 1H), 7.56 (t, 1H), 7.50 (t, 1H), 7.41 (d, 1H), 7.11 (d, 1H), 4.30 (t, 2H), 4.01 (s, 3H), 2.92 (t, 2H), δ 2.32 (s, 3H), 2.29 (s, 3H), 2.22 (m, 2H)

### Preparation of (E)-1-(6-bromo-pyridin-2-yl)-ethanone O-[3-(6-{1-[(E)-methoxyimino]-ethyl}-pyridin-2-yl)-prop-2-ynyl]-oxime

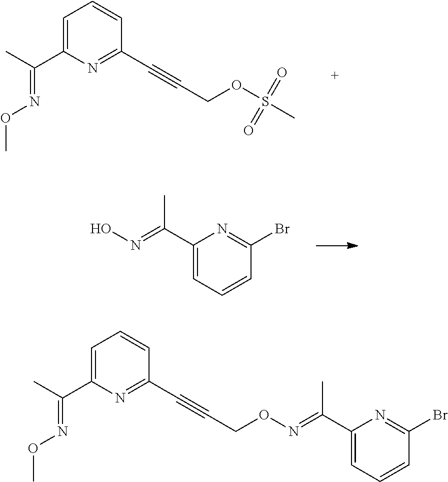

Sodium bis-trimethylsilyl amide 2M in tetrahydrofuran (3.63 mL) was added at 0-5° C. to a solution of (E)-1-(6-bromo-pyridin-2-yl)-ethanone oxime (1.3 g) in acetonitrile (35 mL) and dimethylformamide (5 mL). After stirring for 20 min at ambient temperature a solution of methanesulfonic acid 3-(6-{1-[(E)-methoxyimino]-ethyl}-pyridin-2-yl)-prop-2-ynyl ester (1.7 g) in dimethylformamide (5 mL) was added. The reaction mixture was the stirred for 16 h at ambient temperature diluted with ethyl acetate and washed with water. The organic phase was separated dried over sodium sulphate and concentrated. The crude was purified by chromatography over silica to give a yellow solid (1.0 g). ¹H-NMR (CDCl3, 400 MHz): 7.93 (d, 1H), 7.88 (d, 1H), 7.62 (t, 1H), 7.53 (t, 1H), 7.44 (t, 1H), 5.18 (s, 2H), 4.02 (s, 3H), 2.35 (s, 3H), 2.32 (s, 3H).

### Preparation of (E)-1-(6-bromo-pyridin-2-yl)-ethanone oxime

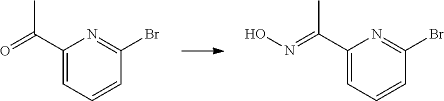

2-Bromo-6-methyl-pyridine (2.5 g) was dissolved in methanol (40 mL). Sodium acetate (1.54 g) and hydroxylamine hydrochloride (1.04 g) were added. After stirring for 24 h at ambient temperature the reaction mixture was diluted with ethyl acetate, washed with water, dried over sodium sulphate, filtered and the solvent evaporated to give a white solid (2.5 g). ¹H-NMR (DMSO, d6, 400 MHz): 11.75 (s, 1H), 7.88 (d, 1H), 7.76 (t, 1H), 7.63.

### Example 5

### Preparation of Compound P.23

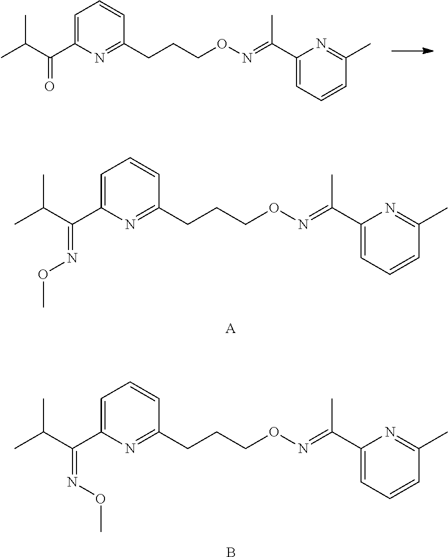

Sodium acetate (65 mg) and O-methyl-hydroxylamine hydrochloride (65 mg) were added to a solution of 2-methyl-1-(6-{3-[1-(6-methyl-pyridin-2-yl)-eth-(E)-ylideneaminooxy]-propyl}-pyridin-2-yl)-propan-1-one (40 mg) in methanol (4 mL). After stirring for 72 h at ambient temperature the reaction mixture was diluted with ethylacetate washed with water and dried over sodium sulfate. Filtration, concentration and purification by chromatography over silica gave a 1:3 mixture of A:B (17 mg) and A (8 mg). ¹H-NMR (Compound A; CDCl3, 400 MHz): 7.66 (d, 1H), 7.55 (m, 2H), 7.42 (d, 1H), 7.09 (m, 2H), 4.28 (t, 2H), 3.97 (s, 3H), 3.69 (m, 1H), 2.91 (t, 2H), 2.58 (s, 3H), 2.32 (s, 3H), 2.20 (m, 2H), 1.28 (d, 6H).

### Preparation of 2-methyl-1-(6-{3-[1-(6-methyl-pyridin-2-yl)-eth-(E)-ylideneaminooxy]-propyl}-pyridin-2-yl)-propan-1-one

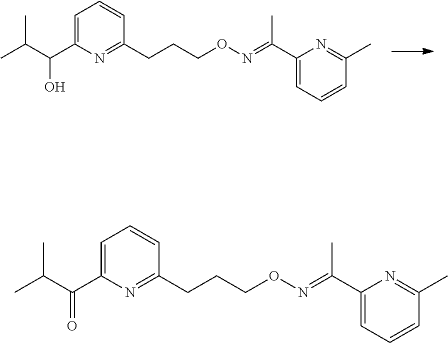

1,1,1-Tris(acetyloxy)-1,1-dihydro-1,2-benziodoxol-3-(1H)-one (89 mg) was added to a solution of (E)-1-(6-methyl-pyridin-2-yl)-ethanone O-{3-[6-(1-hydroxy-2-methyl-propyl)-pyridin-2-yl]-propyl}-oxime (60 mg) in dichloromethane (5 mL). After stirring for 4 h at ambient temperature sodium hydrogen carbonate (2 mL; 20% aqueous solution) and sodium thiosulphate (2 mL; 30% aqueous solution) were added. After stirring for further 40 min the organic phase was separated, washed with water, dried over sodium sulphate, filtered and purified by chromatography over silica to give a colorless oil (40 mg). ¹H-NMR (CDCl3, 400 MHz): 7.85 (d, 1H), 7.70 (m, 2H), 7.55 (t, 1H), 7.32 (d, 1H), 7.10 (d, 1H), 4.30 (t, 2H), 4.16 (m, 1H), 3.00 (t, 2H), 2.56 (s, 3H), 2.32 (s, 3H), 2.25 (m, 2H), 1.20 (d, 6H).

### Preparation of (E)-1-(6-methyl-pyridin-2-yl)-ethanone O-{3-[6-(1-hydroxy-2-methyl-propyl)-pyridin-2-yl]-propyl}-oxime

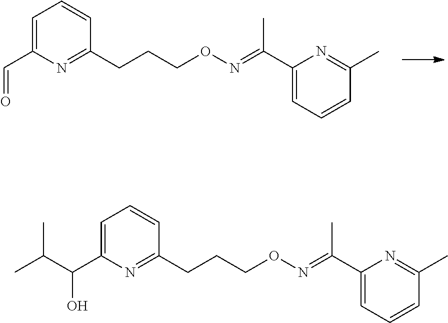

Isopropyl magnesium chloride (2M in tetrahydrofuran; 0.355 mL) was added at −70° C. to a solution of 6-{3-[1-(6-methyl-pyridin-2-yl)-eth-(E)-ylideneaminooxy]-propyl}-pyridine-2-carbaldehyde (190 mg) in tetrahydrofuran (10 mL). After stirring for 90 min at −70° C. ammonium chloride (10% aqueous solution; 1 mL) was added. The reaction mixture was the stirred for 10 min diluted with ethyl acetate and washed with water. The organic phase was separated, dried over sodium sulphate and concentrated. The crude was purified by chromatography over silica to give a yellow oil (60 mg). ¹H-NMR (CDCl3, 400 MHz): 7.67 (d, 1H), 7.55 (m, 2H), 7.18 (m, 2H), 7.00 (d, 1H), 4.62 (d, broad, 1H), 4.53 (m, 1H), 4.76 (t, 2H), 2.92 (t, 2H), 2.56 (s, 3H), 2.32 (s, 3H), 2.20 (m, 2H), 2.00 (m, 1H), 1.02 (d, 3H), 0.75 (d, 3H).

### Preparation of 6-{3-[1-(6-methyl-pyridin-2-yl)-eth-(E)-ylideneaminooxy]-propyl}-pyridine-2-carbaldehyde

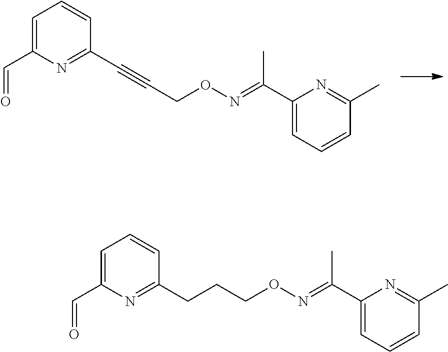 [SMILES: C/C(=N\OCC#Cc1cccc(C=O)n1)c1cccc(C)n1 ; C/C(=N\OCCCc1cccc(C=O)n1)c1cccc(C)n1]

6-{3-[1-(6-Methyl-pyridin-2-yl)-eth-(E)-ylideneaminooxy]-prop-1-ynyl}-pyridine-2-carbaldehyde (1.13 g) was dissolved in ethanol (40 mL). Platinum (IV) oxide hydrate (80 mg) was added and the reaction mixture was stirred for 3 h under an atmosphere of hydrogen. The reaction mixture was filtered, evaporated and purified over silica to give a yellow oil (235 mg). ¹H-NMR (CDCl3, 400 MHz): 10.05 (s, 1H), 7.79 (m, 2H), 7.67 (d, 1H), 7.54 (t, 1H), 7.42 (d, 1H), 7.10 (d, 1H), 4.30 (t, 2H), 3.03 (t, 2H), 2.47 (s, 3H), 2.31 (s, 3H), 2.25 (m, 2H).

### Preparation of 6-{3-[1-(6-methyl-pyridin-2-yl)-eth-(E)-ylideneaminooxy]-prop-1-ynyl}-pyridine-2-carbaldehyde

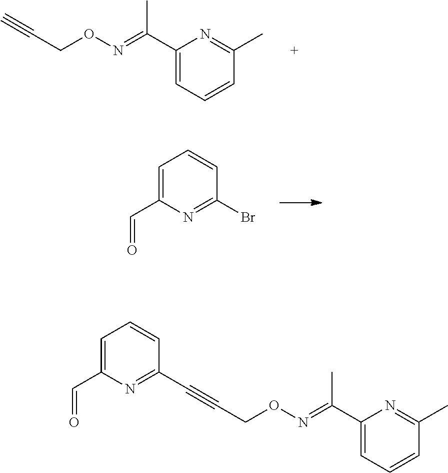 [SMILES: C#CCO/N=C(\C)c1cccc(C)n1 ; O=Cc1cccc(Br)n1 ; C/C(=N\OCC#Cc1cccc(C=O)n1)c1cccc(C)n1]

6-Bromo-pyridine-2-carbaldehyde (2.5 g) and (E)-1-(6-methyl-pyridin-2-yl)-ethanone O-prop-2-ynyl-oxime (2.53 g) were dissolved in THF (80 mL). Diisopropylamine (3.79 mL), dichlorobis (triphenylphospine) palladium (II) (283 mg) and copper (I) iodide (205 mg) were added. After stirring for 6 h at ambient temperature the reaction mixture was diluted with ethyl acetate washed with sodium bicarbonate (10% aqueous solution), water and brine. The organic phase was dried over sodium sulphate, concentrated and purified by chromatography over silica to give a beige solid (3.0 g). ¹H-NMR (CDCl3, 400 MHz): 10.05 (s, 1H), 7.90 (d, 1H), 7.85 (t, 1H), 7.70 (m, 2H), 7.55 (t, 1H), 7.12 (d, 1H), 5.10 (s, 2H), 2.68 (s, 3H), 2.40 (s, 3H).

### Example 6

### Preparation of Compound P.06

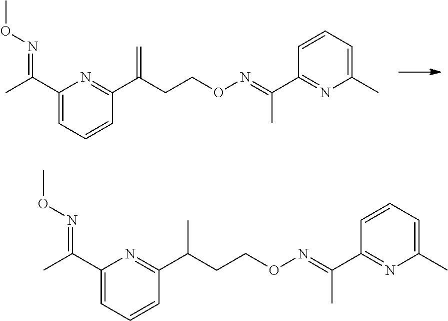

(E)-1-(6-{1-Methylene-3-[1-(6-methyl-pyridin-2-yl)-eth-(E)-ylideneaminooxy]-propyl}-pyridin-2-yl)-ethanone O-methyl-oxime (76 mg) was dissolved in ethanol (10 mL). Palladium (5% on charcoal; 10 mg) was added and the reaction mixture was stirred for 2 h under an atmosphere of hydrogen. The reaction mixture was filtered, evaporated and purified over silica to give a colorless oil (75 mg).

### Preparation of (E)-1-(6-{1-methylene-3-[1-(6-methyl-pyridin-2-yl)-eth-(E)-ylideneaminooxy]-propyl}-pyridin-2-yl)-ethanone O-methyl-oxime

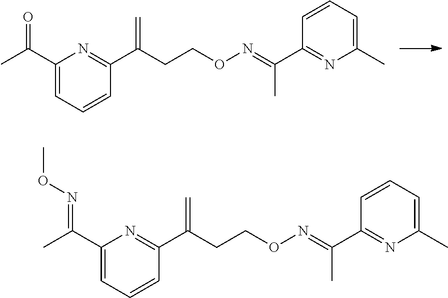

Sodium acetate (26 mg) and O-methyl-hydroxylamine hydrochloride (24 mg) were added to a solution of 1-(6-{1-methylene-3-[1-(6-methyl-pyridin-2-yl)-eth-(E)-ylideneaminooxy]-propyl}-pyridin-2-yl)-ethanone (78 mg) in methanol (4 mL). After stirring for 16 h at ambient temperature the reaction mixture was diluted with ethyl acetate, washed with water and dried over sodium sulphate. Filtration and concentration gave a colorless oil (80 mg). 1H-NMR (CDCl3, 400 MHz): 7.80 (d, 1H) 7.70-7.60 (m, 2H), 7.53 (m, 2H), 7.09 (d, 1H), 5.89 (s, 1H), 4.90 (s, 1H), 4.44 (t, 2H), 4.03 (s, 3H), 3.10 (t, 2H), 2.55 (s, 3H), 2.45 (s, 3H), 2.28 (s, 3H).

### Preparation of 1-(6-{1-methylene-3-[1-(6-methyl-pyridin-2-yl)-eth-(E)-ylideneaminooxy]-propyl}-pyridin-2-yl)-ethanone

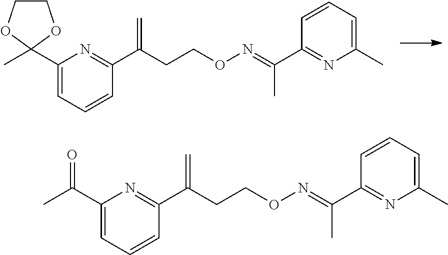

(E)-1-(6-Methyl-pyridin-2-yl)-ethanone O-{3-[6-(2-methyl-[1,3]dioxolan-2-yl)-pyridin-2-yl]-but-3-enyl}-oxime (230 mg; 70% purity) was dissolved in acetone (15 mL). Hydrochloric acid (2.5 mL; 10% aqueous solution) was added and the reaction mixture was stirred at ambient temperature for 16 h. The reaction mixture was concentrated, neutralised with sodium bicarbonate (20% in water) and extracted with dichloromethane. The organic phase was dried over sodium sulphate, concentrated and purified by chromatography over silica to give a yellow oil (86 mg). 1H-NMR (CDCl3, 400 MHz): 7.91 (d, 1H) 7.75 (m, 2H), 7.66 (d, 1H), 7.54 (t, 1H), 7.09 (d, 1H), 5.92 (s, 1H), 4.98 (s, 1H), 4.47 (t, 2H), 3.15 (t, 2H), 2.64 (s, 3H), 2.56 (s, 3H), 2.27 (s, 3H).

### Preparation of (E)-1-(6-methyl-pyridin-2-yl)-ethanone O-{3-[6-(2-methyl-[1,3]dioxolan-2-yl)-pyridin-2-yl]-but-3-enyl}-oxime

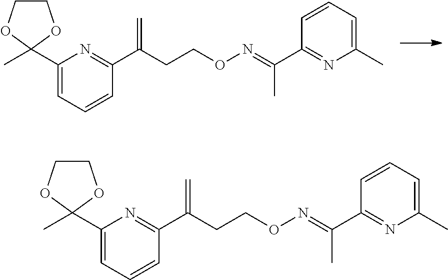

Butyl lithium (1.6M in hexane; 1.27 mL) was added at −70° C. to a solution of methyltriphenyl phosphonium bromide in tetrahydrofuran (8 mL). The reaction mixture was stirred for 30 min at −70° C., heated up to ambient temperature, and cooled again to −70° C. A solution of 1-[6-(2-methyl-[1,3]dioxolan-2-yl)-pyridin-2-yl]-3-[1-(6-methyl-pyridin-2-yl)-eth-(E)-lideneaminooxy]-propan-1-one (300 mg; 80% purity) in tetrahydrofuran (5 mL) was added. The reaction mixture was stirred for 1 h at −70° C. and 2 h at ambient temperature. The reaction mixture was quenched with water and diluted with ethyl acetate. The organic phase was washed with water, separated, dried over sodium sulphate and concentrated. The residue was purified by chromatography over silica to give a yellow oil (230 mg; 70% purity). This material was used in the next step without further purification.

### Preparation of 1-[6-(2-methyl-[1,3]dioxolan-2-yl)-pyridin-2-yl]-3-[1-(6-methyl-pyridin-2-yl)-eth-(E)-lideneaminooxy]-propan-1-one

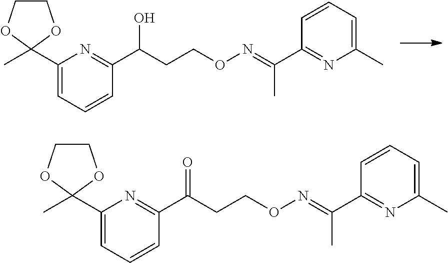

Manganese dioxide (5.2 g) was added to a solution of (E)-1-(6-methyl-pyridin-2-yl)-ethanone O-{3-hydroxy-3-[6-(2-methyl-[1,3]dioxolan-2-yl)-pyridin-2-yl]-propyl}-oxime (1.46 g) in dichloromethane (30 mL). After stirring for 16 h at ambient temperature the reaction mixture was filtered over hyflo, concentrated and the residue was purified by chromatography over silica to give a yellow oil (470 mg; 80% purity). This material was used in the next step without further purification.

### Preparation of (E)-1-(6-methyl-pyridin-2-yl)-ethanone O-{3-hydroxy-3-[6-(2-methyl-[1,3]dioxolan-2-yl)-pyridin-2-yl]-propyl}-oxime

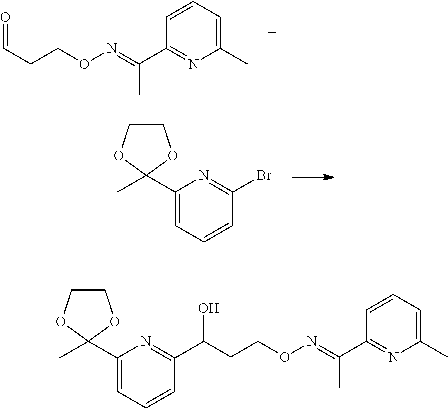

Butyllithium (1.6M in hexane; 4.18 mL) was added within 10 min at −60° C. to a solution of 2-bromo-6-(2-methyl-[1,3]dioxolan-2-yl)-pyridine (1.6 g) in tetrahydrofuran (24 mL). After stirring for 1 h at −60° C. 3-[1-(6-methyl-pyridin-2-yl)-eth-(E)-ylideneaminooxy]-propionaldehyde (1.35 g) was added. The reaction mixture was stirred for 1 h at −60° C. Then ammonium chloride (6 mL; 10% aqueous solution) was added, the cooling bath was removed and the reaction mixture was diluted with ethyl acetate. The organic phase was washed with water, separated and dried over sodium sulphate and concentrated. The residue was purified by chromatography over silica to give a yellow oil (1.46 g). ¹H-NMR (CDCl3, 400 MHz): 7.70 (m, 2H), 7.56 (t, 1H), 7.48 (d, 1H), 7.28 (d, 1H), 7.10 (d, 1H), 5.00 (m, 1H), 4.55-4.38 (m, 3H), 4.12 (m, 2H), 3.90 (m, 2H), 2.59 (s, 3H), 2.47 (m, 1H), 2.30 (s, 3H), 2.12 (m, 1H), 1.78 (s, 3H).

### Preparation of 3-[1-(6-methyl-pyridin-2-yl)-eth-(E)-ylideneaminooxy]-propionaldehyde

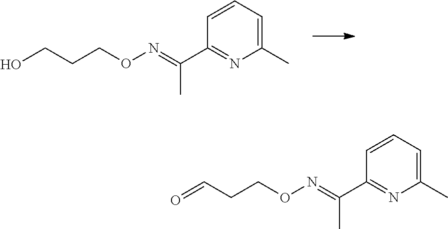

A solution of 1,1,1-tris(acetyloxy)-1,1-dihydro-1,2-benziodoxol-3-(1H)-one (4.21 g) and (E)-1-(6-methyl-pyridin-2-yl)-ethanone O-(3-hydroxy-propyl)-oxime (1.88 g) in dichloromethane (55 mL) was added dropwise to dichloromethane (180 mL) and water (0.3 mL). After stirring for 1 h at ambient temperature, sodium hydrogen carbonate (2 mL; 20% aqueous solution) and sodium thiosulphate (2 mL; 30% aqueous solution) were added. After stirring for further 40 min the organic phase was separated, washed with water, dried over sodium sulphate, filtered, concentrated and purified by chromatography over silica to give a yellow oil (1.38 g). 1H-NMR (CDCl3, 400 MHz): 9.90 (s, 1H), 7.63 (d, 1H), 7.58 (t, 1H), 7.12 (d, 1H), 4.59 (t, 2H), 2.84 (m, 2H), 2.58 (s, 3H), 2.33 (s, 3H).

### Preparation of (E)-1-(6-methyl-pyridin-2-yl)-ethanone O-(3-hydroxy-propyl)-oxime

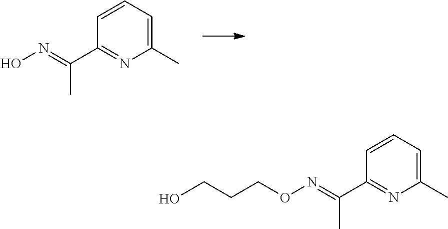

Sodium hydride (55% in mineral oil; 640 mg) was added at 0-5° C. to a solution of (E)-1-(6-methyl-pyridin-2-yl)-ethanone oxime (2.0 g) in dimethylformamide (35 mL). After stirring for 20 min at 0-5° C. 3-bromo propanol (2.78 g) was added. The reaction mixture was the stirred for 3 h at ambient temperature diluted with ethyl acetate and washed with water. The organic phase was separated, dried over sodium sulphate and concentrated. The residue was purified by chromatography over silica to give a colorless oil (1.8 g). 1H-NMR (CDCl3, 400 MHz): 7.65 (d, 1H), 7.58 (t, 1H), 7.12 (d, 1H), 4.40 (t, 2H), 3.84 (m, 2H), 2.60 (s, 3H), 2.34 (s, 3H), 2.16 (s, broad, 1H), 2.03 (m, 2H).

### Example 7

### Preparation of Compound P.10

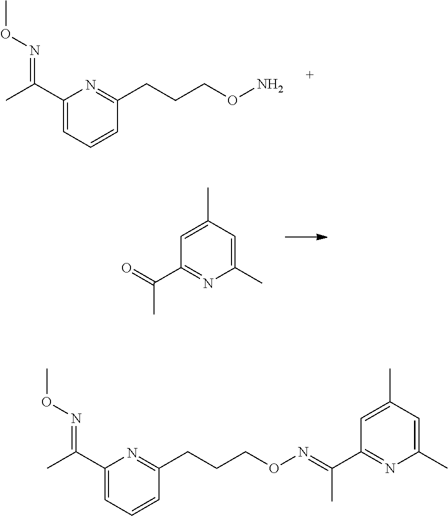 [SMILES: CO/N=C(\C)c1cccc(CCCON)n1 ; CC(=O)c1cc(C)cc(C)n1 ; CO/N=C(\C)c1cccc(CCCO/N=C(\C)c2cc(C)cc(C)n2)n1]

1-(4,6-Dimethyl-pyridin-2-yl)-ethanone (400 mg) was dissolved in methanol (15 mL) and (E)-1-[6-(3-aminooxy-propyl)-pyridin-2-yl]-ethanone O-methyl-oxime (600 mg) was added. After stirring for 70 h at ambient temperature, the reaction mixture was concentrated and the residue was purified by chromatography over silica to give colorless oil (740 mg). ¹H-NMR (CDCl3, 400 MHz): 7.70 (d, 1H), 7.55 (t, 1H), 7.47 (s, 2H), 7.11 (d, 1H), 6.93 (s, 1H), 4.28 (t, 2H), 4.01 (s, 3H), 2.92 (t, 2H), 2.51 (s, 3H), 2.32 (s+s+s, 9H), 2.21 (m, 2H)

### Preparation of (E)-1-[6-(3-aminooxy-propyl)-pyridin-2-yl]-ethanone O-methyl-oxime

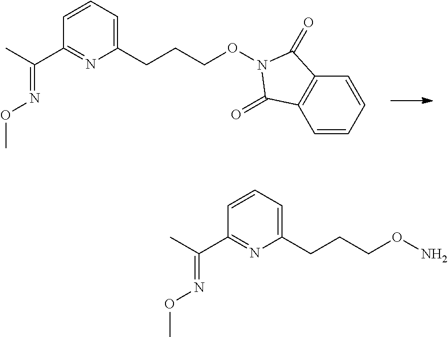 [SMILES: CO/N=C(\C)c1cccc(CCCON2C(=O)c3ccccc3C2=O)n1 ; CO/N=C(\C)c1cccc(CCCON)n1]

Hydrazine monohydrate (1.65 mL) was added dropwise to a suspension of 2-[3-(6-{1-[(E)-methoxyimino]-ethyl}-pyridin-2-yl)-propoxy]-isoindole-1,3-dione (6 g) in ethanol (40 mL). After stirring for 2 h at ambient temperature The reaction mixture was poured on water and then NaOH (4M aqueous solution) was added till the pH was 14. The basic solution was extracted twice with ethyl acetate. The combined organic layers were washed with water, brine and then dried over sodium sulphate, filtrated and evaporated. The residue was purified by chromatography over silica (Eluent: cyclohexane:ethyl acetate 1:1) to give a colorless oil (3.2 g). 1H-NMR (CDCl3, 400 MHz): 7.70 (d, 1H), 7.55 (t, 1H), 7.09 (d, 1H), 5.37 (s, broad, 2H), 4.03 (s, 3H), 3.73 (t, 2H), 2.85 (t, 2H), 2.32 (s, 3H), 2.06 (m, 2H).

### Preparation of 2-[3-(6-{1-[(E)-methoxyimino]-ethyl}-pyridin-2-yl)-propoxy]-isoindole-1,3-dione

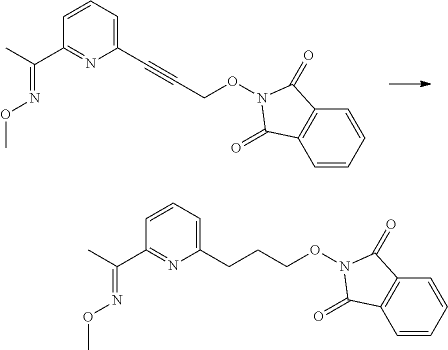 [SMILES: CO/N=C(\C)c1cccc(C#CCON2C(=O)c3ccccc3C2=O)n1 ; CO/N=C(\C)c1cccc(CCCON2C(=O)c3ccccc3C2=O)n1]

Palladium on carbon (5% on charcoal; 800 mg) was added to a solution of 2-[3-(6-{1-[(E)-methoxyimino]-ethyl}-pyridin-2-yl)-prop-2-ynyloxy]-isoindole-1,3-dione(8 g) in tetrahydrofuran. After stirring for 3.5 h under an atmosphere of hydrogen the reaction mixture was filtered, the filtrate was concentrated and the residue was purified by chromatography over silica (Eluent: cyclohexane:ethyl acetate) to give a white solid (6.4 g). mp. 65-68° C.; 1H-NMR (CDCl3, 400 MHz): 7.85 (m, 2H), 7.75 (m, 3H), 7.59 (t, 1H), 7.20 (d, 1H), 4.28 (t, 2H), 4.01 (s, 3H), 3.05 (t, 2H), 2.29 (s, 3H), 2.25 (m, 2H).

### Preparation of 2-[3-(6-{1-[(E)-methoxyimino]-ethyl}-pyridin-2-yl)-prop-2-ynyloxy]-isoindole-1,3-dione

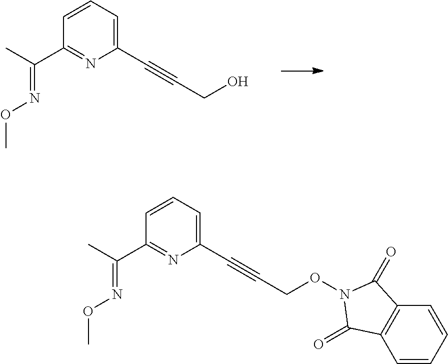 [SMILES: CO/N=C(\C)c1cccc(C#CCO)n1 ; CO/N=C(\C)c1cccc(C#CCON2C(=O)c3ccccc3C2=O)n1]

N-hydroxyphthalimide (6.4 g) and triphenylphosphine (11.3 g) were added portion wise at 5° C. to a solution of (E)-1-[6-(3-Hydroxy-prop-1-ynyl)-pyridin-2-yl]-ethanone O-methyl-oxime (8.0 g) in tetrahydrofuran (60 mL). To this suspension a solution of diisopropylazodicarboxylate (8.8 mL) in tetrahydrofuran (10 mL) was added at 5-10° C. within 70 min. The reaction mixture was diluted with tetrahydrofuran (100 mL). After stirring for a further 2.5 h at 5-10° C. the reaction mixture was concentrated. The beige residue was suspended in methanol:water (5:1; 250 mL) and stirred for 10 min. The precipitate was filtered, washed with methanol:water (5:1; 200 mL) and dried to give a white solid (12.3 g; mp. 185-188° C.)

1H-NMR (CDCl3, 400 MHz): 7.86 (m, 3H), 7.78 (m, 2H), 7.62 (t, 1H), 7.42 (d, 1H), 5.13 (s, 2H), 4.01 (s, 3H), 2.24 (s, 3H).

### Example 9

### Preparation of Compound P.55

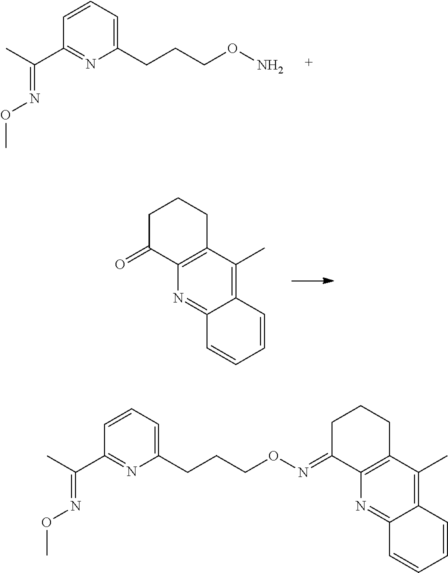 [SMILES: CO/N=C(\C)c1cccc(CCCON)n1 ; Cc1c2c(nc3ccccc13)C(=O)CCC2 ; CO/N=C(\C)c1cccc(CCCO/N=C2\CCCc3c2nc2ccccc2c3C)n1]

To a stirred solution of (E)-1-[6-(3-aminooxy-propyl)-pyridin-2-yl]-ethanone O-methyl-oxime (160 mg; 0.71 mmol) in methanol (15 mL) was added 9-methyl-2,3-dihydro-1H-acridin-4-one (150 mg; 0.71 mmol). After being stirred for 3 hours at room temperature methanol was removed in vacuo to give a colourless oil (320 mg). The crude material was purified by chromatography (Supelco 25 g silica gel; eluent: 40% cyclohexane in ethylacetate), to yield 250 mg (84% of theory) of the title compound as a colourless oil.

LC-MS (ZCQ): UV Detection: 220 nm; Rₜ=1.69 min. MS: (M⁺+1)=417, (M⁺+23)=439.

### Example 10

### Preparation of Compound P.56

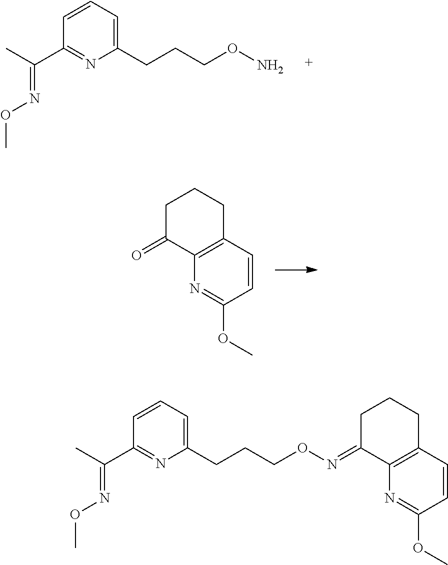 [SMILES: CO/N=C(\C)c1cccc(CCCON)n1 ; COc1ccc2c(n1)C(=O)CCC2 ; CO/N=C(\C)c1cccc(CCCO/N=C2\CCCc3ccc(OC)nc32)n1]

A solution of (E)-1-[6-(3-aminooxy-propyl)-pyridin-2-yl]-ethanone O-methyl-oxime (80.0 mg) in absolute ethanol (0.50 mL) was charged to a 5 mL Supelco vial. Under magnetic stirring, p-toluenesulphonic acid mono-hydrate (4.0 mg) was added, followed by the addition of 6,7-dihydro-2-methoxy-8(5H)-quinolinone (63 mg). The Supelco vial is then sealed with a septum cap. The resulting light-yellow solution was stirred at room temperature for 3 hours. TLC indicated that no starting materials were remaining after this time. The ethanol was removed in vacuo. A saturated aqueous solution of NaHCO₃ (2.00 mL) was added to the resulting residue, and extraction was carried out using ethyl acetate (2×5 mL). The combined organic layers were washed with brine, dried over sodium sulphate and filtered. The solvent was removed in vacuo to give an orange oil (139 mg). No further purification was required.

LC-MS (ZCQ): UV Detection: 220 nm; Rₜ=1.52 min. MS: (M⁺+1)=383, (M⁺+23)=405. TLC: Plates: Merck DC-Plates, silica gel F₂₅₄, saturated atmosphere in developing tank, UV detection, eluent: heptane/ethyl acetate 1:2 (v:v); R_{f} of title compound=0.54, R_{f} of ketone starting material=0.33, R_{f} of oxyamine starting material=0.26.

### Example 11

### Preparation of Compound P.57

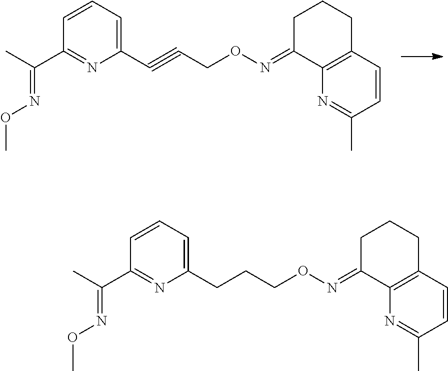 [SMILES: CO/N=C(\C)c1cccc(C#CCO/N=C2\CCCc3ccc(C)nc32)n1 ; CO/N=C(\C)c1cccc(CCCO/N=C2\CCCc3ccc(C)nc32)n1]

In a 25 mL single-necked round-bottomed flask, Palladium on carbon (10% on charcoal; 13 mg) was added to a solution of 2-methyl-6,7-dihydro-5H-quinolin-8-one O-[3-(6-{1-[(E)-methoxyimino]-ethyl}-pyridin-2-yl)-prop-2-ynyl]-oxime (130 mg) in ethanol. After stirring for 3.5 h under an atmosphere of hydrogen (normal pressure) the reaction mixture was filtered, the filtrate was concentrated and the residue was purified by chromatography over silica (Eluent: heptane:ethyl acetate 9:1 (v/v)) to give a colourless oil (80 mg).

LC-MS (ZCQ): UV Detection: 220 nm; Rₜ=1.42 min. MS: (M⁺+1)=367, (M⁺+23)=389.

TLC: Plates: Merck DC-Plates, silica gel F₂₅₄, saturated atmosphere in developing tank, UV detection, eluent: heptane/ethyl acetate 1:1 (v:v); R_{f} of title compound=0.37, R_{f} of oxyamine starting material=0.27.

### Preparation of 2-methyl-6,7-dihydro-5H-quinolin-8-one O-[3-(6-{1-[(E)-methoxyimino]-ethyl}-pyridin-2-yl)-prop-2-ynyl]-oxime

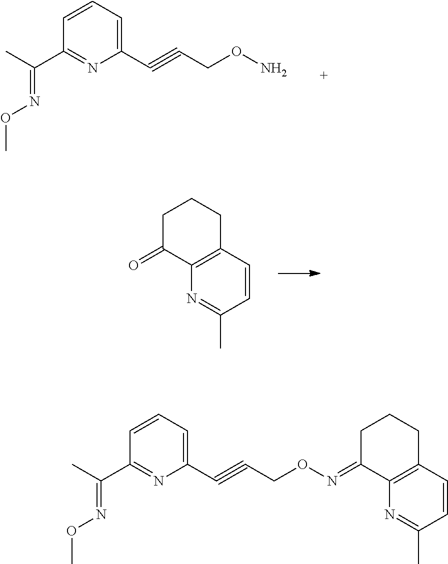 [SMILES: CO/N=C(\C)c1cccc(C#CCON)n1 ; Cc1ccc2c(n1)C(=O)CCC2 ; CO/N=C(\C)c1cccc(C#CCO/N=C2\CCCc3ccc(C)nc32)n1]

A solution of (E)-1-[6-(3-aminooxy-prop-1-ynyl)-pyridin-2-yl]-ethanone O-methyl-oxime (131 mg) in absolute ethanol (5.0 mL) was charged to a 25 single-necked round-bottomed flask. Under stirring, p-toluenesulphonic acid mono-hydrate (7.0 mg) was added, followed by the addition of 2-methyl-6,7-dihydro-5H-quinolin-8-one (97 mg). The resulting light-yellow solution was stirred at room temperature for 2 hours. TLC indicated that no starting materials were remaining after this time. The ethanol was removed in vacuo. A saturated aqueous solution of NaHCO₃ (20 mL) was added to the resulting residue, and extraction was carried out using dichloromethane (2×20 mL). The combined organic layers were washed with brine, dried over sodium sulphate and filtered. The solvent was removed in vacuo to give a beige oil (200 mg). The residue was purified by chromatography over silica (Eluent: heptane:ethyl acetate 9:1) to give a yellow oil (160 mg).

LC-MS (ZCQ): UV Detection: 220 nm; Rₜ=1.55 min. MS: (M⁺+1)=363.

TLC: Plates: Merck DC-Plates, silica gel F₂₅₄, saturated atmosphere in developing tank, UV detection, eluent: heptane/ethyl acetate 1:1 (v:v); R_{f} of title compound=0.48, R_{f} of ketone starting material=0.11, R_{f} of oxyamine starting material=0.33.

### Preparation of (E)-1-[6-(3-aminooxy-prop-1-ynyl)-pyridin-2-yl]-ethanone O-methyl-oxime

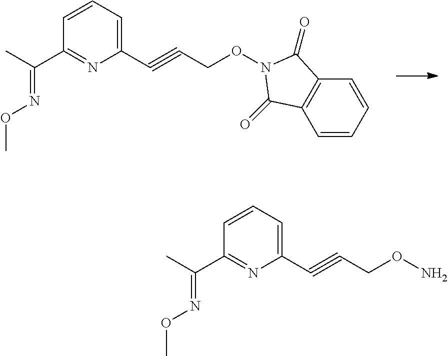 [SMILES: CO/N=C(\C)c1cccc(C#CCON2C(=O)c3ccccc3C2=O)n1 ; CO/N=C(\C)c1cccc(C#CCON)n1]

In a 25 mL single-necked round-bottomed flask, hydrazine monohydrate (0.23 mL) was added dropwise to a suspension of 2-[3-(6-{1-[(E)-methoxyimino]-ethyl}-pyridin-2-yl)-prop-2-ynyloxy]-isoindole-1,3-dione (810 mg) in ethanol (5 mL). After stirring for 4 h at ambient temperature the reaction mixture was poured on water and then NaOH (4M aqueous solution) was added until the pH was 14. The basic solution was extracted twice with ethyl acetate. The combined organic layers were washed with water, brine and then dried over sodium sulphate, filtrated and concentrated in vacuo. The residue was purified by chromatography over silica (Eluent: heptane:ethyl acetate 4:1) to give a beige solid (330 mg; m.p. 60 to 63° C.).

LC-MS (ZCQ): UV Detection: 220 nm; Rₜ=1.33 min. MS: (M⁺+1)=220, (M⁺+23)=242.

TLC: Plates: Merck DC-Plates, silica gel F₂₅₄, saturated atmosphere in developing tank, UV detection, eluent: heptane/ethyl acetate 1:1 (v:v); R_{f} of title compound=0.49, R_{f} of phthalimide starting material=0.19.

### Example 12

### Preparation of Compound P.60

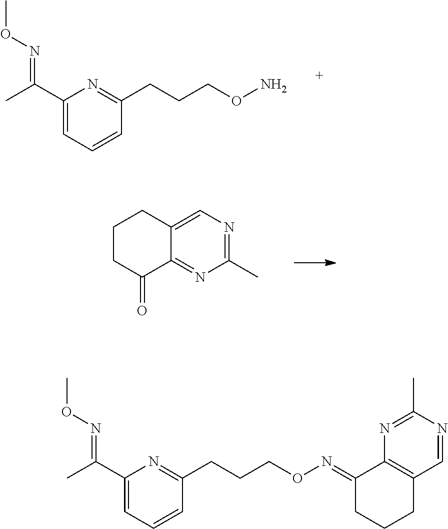 [SMILES: CO/N=C(\C)c1cccc(CCCON)n1 ; Cc1ncc2c(n1)C(=O)CCC2 ; CO/N=C(\C)c1cccc(CCCO/N=C2\CCCc3cnc(C)nc32)n1]

2-Methyl-6,7-dihydro-5H-quinazolin-8-one (100 mg; 0.6 mmol)) was dissolved in methanol (13 mL) and (E)-1-[6-(3-aminooxy-propyl)-pyridin-2-yl]-ethanone O-methyl-oxime (138 mg; 0.6 mmol) was added. After stirring for 18 h at ambient temperature, the reaction mixture was concentrated and the residue was purified by chromatography over silica (combiflash RF, 0-80% ethylacetate in cyclohexane) to give 2-Methyl-6,7-dihydro-5H-quinazolin-8-one O-[3-(6-(1-((E)-methoxyimino)-ethyl)-pyridin-2-yl)-propyl]-oxime as a light yellow oil (115 mg; 51% of theory). LC-MS (Method ZCQ) Rₜ=1.70 min., MS: (M⁺+1)=368. ¹H-NMR (CDCl₃, 400 MHz): 1.85 (m, 2H); 2.23 (m, 2H); 2.30 (s, 3H); 2.68 (t, 2H); 2.78 (s, 3H); 2.81 (t, 2H); 2.92 (m, 2H); 4.01 (s, 3H), 4.45 (t, 2H); 7.13 (d, 1H); 7.56 (t, 1H); 7.71 (d, 1H); 8.49 (s, 1H).

### Preparation of 2-methyl-6,7-dihydro-5H-quinazolin-8-one

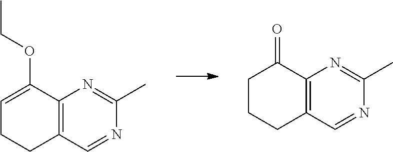

In a 25 mL single-necked round-bottomed flask, equipped with a condenser 8-Ethoxy-2-methyl-5,6-dihydro-quinazoline (1.30 g; 6.80 mmol) is dissolved in a mixture of acetic acid (31 mL) and water (3.1 mL). Stirring was continued under heating to reflux over night for 20 hours. TLC indicated that starting materials were consumed by this time. The mixture was cooled to room temperature, water and saturated NaHCO3 was added. Extraction was carried out using dichloromethane (3×100 mL). The combined organic phases were washed with brine and then dried over sodium sulphate, filtered and the solvent was removed in vacuo. The crude is purified via chromatography (combiflash RF, 0-10% methanol in dichloromethane) to give 2-Methyl-6,7-dihydro-5H-quinazolin-8-one (764 mg; 69% of theory) as a brown oil. LC-MS (Method ZCQ) Rₜ=0.91 min., MS: (M⁺+1)=163. ¹H-NMR (CDCl₃, 400 MHz): 2.24 (m, 2H); 2.83 (m, 2H); 2.84 (s, 3H); 3.01 (m, 2H); 8.85 (s, 1H).

### Preparation of 8-Ethoxy-2-methyl-5,6-dihydro-quinazoline

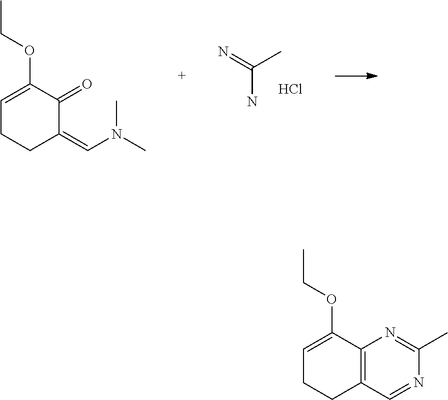

In a 25 mL single-necked round-bottomed flask, equipped with a condenser a mixture of 6-[1-Dimethylamino-meth-(E)-ylidene]-2-ethoxy-cyclohex-2-enone (WO 2004/104007) (2.80 g; 14.3 mmol), Acetamidine hydrochloride (1.70 g; 17.9 mmol) and potassium carbonate (2.73 g; 19.7 mmol), in absolute ethanol (50 mL) is stirred at reflux temperature over night for 16 hours. The reaction mixture was cooled to room temperature, poured onto water (400 ml) and extracted with dichloromethane (3×100 mL). The crude reaction mixture is purified via chromatography (combiflash RF, 70-100% ethylacetate in cyclohexane) to give 8-ethoxy-2-methyl-5,6-dihydro-quinazoline (1.47 g, 54% of theory) as brown oil. LC-MS (Method ZCQ) Rₜ=1.21 min., MS: (M⁺+1)=191. ¹H-NMR (CDCl₃, 400 MHz): 1.49 (t, 3H); 2.41 (m, 2H); 2.74 (t, 2H); 2.75 (s, 3H); 3.99 (q, 2H); 5.46 (t, 1H); 8.47 (s, 1H).

### Example 13

### Preparation of Compound P.61

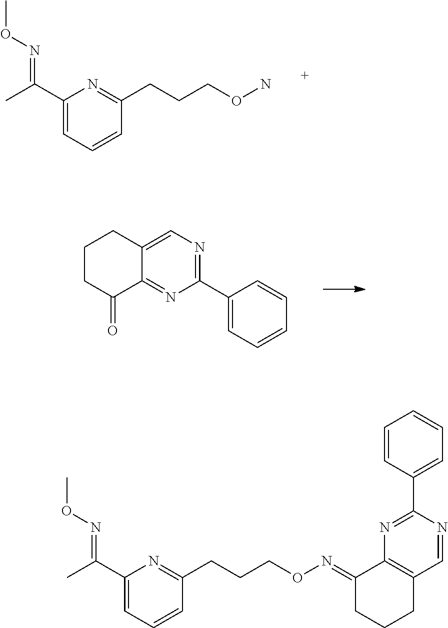 [SMILES: CO/N=C(\C)c1cccc(CCCON)n1 ; O=C1CCCc2cnc(-c3ccccc3)nc21 ; CO/N=C(\C)c1cccc(CCCO/N=C2\CCCc3cnc(-c4ccccc4)nc32)n1]

2-Phenyl-6,7-dihydro-5H-quinazolin-8-one (100 mg; 0.45 mmol) was dissolved in methanol (10 mL) and (E)-1-[6-(3-aminooxy-propyl)-pyridin-2-yl]-ethanone O-methyl-oxime (100 mg; 0.45 mmol) was added. After stirring for 3 hours at ambient temperature, the reaction mixture was concentrated and the residue was purified by chromatography over silicagel (20 g) eluted with (ethylacetate, cyclohexane 2:8) to give 2-Phenyl-6,7-dihydro-5H-quinazolin-8-one O-[3-(6-(1-((E)-methoxyimino)-ethyl)-pyridin-2-yl)-propyl]-oxime as a colorless oil (130 mg; 68% of theory). LC-MS (Method ZMD) Rₜ=2.05 min., MS: (M⁺+1)=430. ¹H-NMR (CDCl_{3, 400} MHz): 1.90 (m, 2H); 2.23 (m, 2H); 2.31 (s, 3H); 2.83 (t, 2H); 2.92 (m, 2H); 4.03 (s, 3H), 4.48 (t, 2H); 7.14 (d, 1H); 7.48 (m, 3H); 7.56 (m, 1H); 7.70 (d, 1H); 8.45 (m, 2H); 8.64 (s, 1H).

### Preparation of 2-Phenyl-6,7-dihydro-5H-quinazolin-8-one

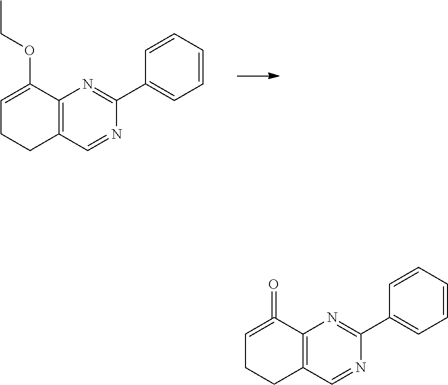

In a 25 mL single-necked round-bottomed flask, equipped with a condenser 8-Ethoxy-2-phenyl-5,6-dihydro-quinazoline (0.45 g; 1.18 mmol) was dissolved in a mixture of acetic acid (9.5 mL) and water (0.95 mL). Stirring was continued under heating to reflux for 15 minutes. TLC indicated that starting materials were consumed by this time. The mixture was cooled to room temperature, water and saturated NaHCO₃ was added. Extraction was carried out using dichloromethane (3×20 mL). The combined organic phases were washed with brine and then dried over sodium sulphate, filtered and the solvent was removed in vacuo to give 2-Phenyl-6,7-dihydro-5H-quinazolin-8-one (380 mg; 95% of theory) as a beige solid. MP: 154-156° C. LC-MS (Method ZCQ) Rₜ=1.49 min., MS: (M⁺+1)=225. ¹H-NMR (CDCl₃, 400 MHz): 2.25 (m, 2H); 2.86 (m, 2H); 3.03 (m, 2H); 7.51 (m, 3H); 8.52 (m, 2H); 8.94 (s, 1H).

### Preparation of 8-Ethoxy-2-phenyl-5,6-dihydro-quinazoline

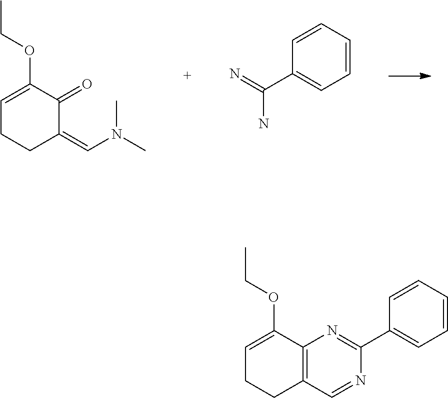 [SMILES: CCOC1=CCC/C(=C/N(C)C)C1=O ; N=C(N)c1ccccc1 ; CCOC1=CCCc2cnc(-c3ccccc3)nc21]

In a 25 mL single-necked round-bottomed flask, equipped with a condenser a mixture of 6-[1-Dimethylamino-meth-(E)-ylidene]-2-ethoxy-cyclohex-2-enone (WO 2004/104007) (0.51 g; 2.6 mmol) and Benzamidine (0.38 g; 3.2 mmol) in absolute ethanol (9 mL) was stirred at reflux temperature over night for 17 hours. The reaction mixture was evaporated to dryness, taken up in dichloromethane and purified via chromatography (combiflash RF, 0-40% ethylacetate in cyclohexane) to give 8-ethoxy-2-phenyl-5,6-dihydro-quinazoline (0.50 g, 63% of theory) as a white solid. MP: 101-103° C. LC-MS (Method ZCQ) Rₜ=1.84 min, MS: (M⁺+1)=253. ¹H-NMR (CDCl₃, 400 MHz): 1.48 (t, 3H); 2.45 (m, 2H); 2.81 (t, 2H); 4.02 (q, 2H); 5.52 (t, 1H); 7.47 (m, 3H); 8.46 (m, 2H); 8.51 (s, 1H).

### Example 14

### Preparation of Compound P.62

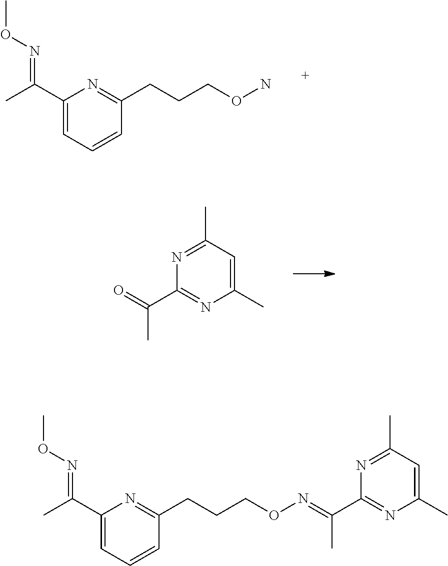 [SMILES: CO/N=C(\C)c1cccc(CCCON)n1 ; CC(=O)c1nc(C)cc(C)n1 ; CO/N=C(\C)c1cccc(CCCO/N=C(\C)c2nc(C)cc(C)n2)n1]

To a stirred mixture of (E)-1-[6-(3-aminooxy-propyl)-pyridin-2-yl]-ethanone O-methyl-oxime (150 mg; 0.67 mmol) and p-TsOH monohydrate (7.6 mg; 0.04 mmol) in ethanol (10 mL) was added 1-(4,6-dimethyl-pyrimidin-2-yl)-ethanone CAS: 64571-50-2 (100 mg; 0.67 mmol) in ethanol (5 mL). After stirring for 2 hours at ambient temperature, the reaction mixture was poured onto water (150 mL) and neutralized by adding triethylamine (a few drops). Extraction was carried out using dichloromethane (2×50 mL). The combined organic phases were washed with brine and then dried over sodium sulphate, filtered and the solvent was removed in vacuo. The crude (0.26 g oil) is purified via chromatography over silicagel (24 g) (combiflash RF, 0-80% ethylacetate in heptane) to give 1-(6-(3-[1-(4,6-dimethyl-pyrimidin-2-yl)-eth-(E)-ylideneaminooxy]-propyl)-pyridin-2-yl)-ethanone O-methyl oxime as a colorless resinl (80 mg). LC-MS (Method ZCQ) Rₜ=1.83 min., MS: (M⁺+1)=356. ¹H-NMR (CDCl₃, 400 MHz): 2.25 (m, 2H); 2.32 (s, 3H); 2.36 (s, 3H); 2.53 (s, 3H); 2.96 (t, 2H); 2.92 (m, 2H); 4.03 (s, 3H), 4.47 (t, 2H); 7.00 (s, 1H); 7.14 (d, 1H); 7.48 (t, 1H); 7.72 (d, 1H).

### Example 15

### Preparation of 2-Methyl-6,7-dihydro-5H-quinolin-8-one-(E)-oxime

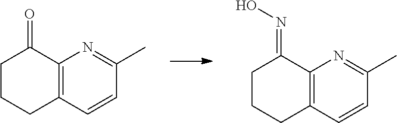

A 250 mL single-necked round-bottomed flask, equipped with a condenser, was charged with a solution of 2-methyl-6,7-dihydro-5H-quinolin-8-one (7.00 g) (CA Registry Number: 849643-01-2) in absolute ethanol (70 mL). Under stirring, first hydroxylamine-hydrochloride (4.50 g) was added and then a solution of NaOH (8.70 g) dissolved in water (14.00 mL) was added in portions. Stirring was continued under heating to reflux for 6.0 hours. Following the course of the reaction by TLC indicated that starting materials were consumed by this time. The suspension was cooled to room temperature. Under stirring and cooling with an ice-water cooling bath, 10 mL of water was added and the pH was adjusted to 6 by the addition of 6 M aqueous HCl. Extraction was carried out using ethyl acetate (2×100 mL). The combined organic phases were washed with brine and then dried over sodium sulphate, filtered and the solvent was removed in vacuo to give a yellow solid (7.65 g).

LC-MS (Method ZMD) UV Detection: 220 nm; Rₜ=0.20, MS: (M⁺+1)=177, (M⁺+23)=179; melting point=177-181° C.

TLC: Plates: Merck DC-Plates, silica gel F₂₅₄, saturated atmosphere in developing tank, UV detection, eluent: ethyl acetate/triethylamine 10:1 (V: V); R_{f} of title compound=0.26, R_{f} of the ketone starting material=0.46.

The preparation of the following starting materials are described in the literature:

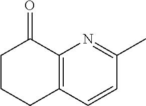

### CA Registry Number: 849643-01-2

U.S. Pat. Appl. Publ. (2005), 75 pp., Cont.-in-part of U.S. Ser. No. 437,807. CODEN: USXXCO US 2005075366 A1 20050407

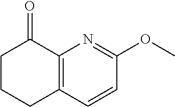

### Registry Number: 209741-58-2

### WO 199828281 A1 (19980702)

### Application: WO 97-GB3509 19971222. Priority: GB 96-26742 19961223; GB 97-8115 19970422. CAN 129:95505 AN 1998:479514

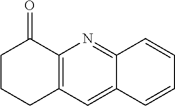 [SMILES: O=C1CCCc2cc3ccccc3nc21]

### Registry Number: 49568-10-7

Hayashi, Eisaku; Suzuki, Senji. Shizuoka Coll. Pharm., Shizuoka, Japan. Yakugaku Zasshi (1975), 95(12), 1439-42. CODEN: YKKZAJ ISSN: 0031-6903

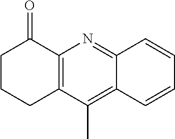 [SMILES: Cc1c2c(nc3ccccc13)C(=O)CCC2]

### Registry Number: 14428-47-8

Senechal-David, Katell; Hemeryck, Anne; Tancrez, Nicolas; Toupet, Loiec; Williams, J. A. Gareth; Ledoux, Isabelle; Zyss, Joseph; Boucekkine, Abdou; Guegan, Jean-Paul; Le Bozec, Hubert; Maury, Olivier. Laboratoire de Chimie de Coordination et Catalyze, UMR 6509, Institut de Chimie, CNRS-Universite Rennes 1, Rennes, Fr. Journal of the American Chemical Society (2006), 128(37), 12243-12255.

TABLE 38
¹H-NMR data of compounds of formula (I):

| | Structure | ¹H-NMR |
|---|---|---|
| P.01 | 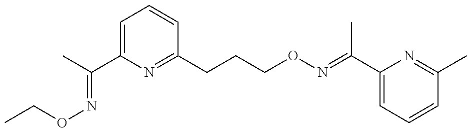 [SMILES: CCO/N=C(\C)c1cccc(CCCO/N=C(\C)c2cccc(C)n2)n1] | ¹H-NMR (CDCl3, 400 MHz): 7.70 (d, 1H), 7.68 (d, 1H), 7.58-7.50 (m, 2H), 7.12-7.06 (m, 2H), 4.31- 4.20 (m, 4H), 2.92 (t, 2H), 2.57 (s, 3H), 2.31 (s + s, 6H), 2.21 (m, 2H), 1.34 (t, 3H) |
| P.02 | 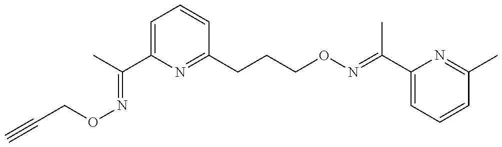 [SMILES: C#CCO/N=C(\C)c1cccc(CCCO/N=C(\C)c2cccc(C)n2)n1] | ¹H-NMR (CDCl3, 400 MHz): 7.72 (d, 1H), 7.68 (d, 1H), 7.58-7.50 (m, 2H), 7.15-7.05 (m, 2H), 4.80 (d, 2H), 4.28 (t, 2H), 2.92 (t, 2H), 2.57 (s, 3H), 2.50 (t, 1H), 2.37 (s, 3H), 2.32 (s, 3H), 2.22 (m, 2H) |
| P.03 | 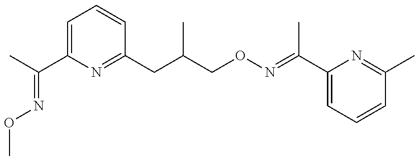 [SMILES: CO/N=C(\C)c1cccc(CC(C)CO/N=C(\C)c2cccc(C)n2)n1] | ¹H-NMR (CDCl3, 400 MHz): 7.63 (d, 1H), 7.59 (d, 1H), 7.50-7.41 (m, 2H), 7.05-6.97 (2d, 2H), 4.13-4.00 (m, 2H), 3.94 (s, 3H), 2.90 (dd, 1H), 2.60 (dd, 1H), 2.50 (m, 4H), 2.74 (2s, 6H), 0.92 (d, 3H) |
| P.04 | 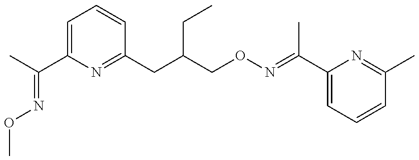 [SMILES: CCC(CO/N=C(\C)c1cccc(C)n1)Cc1cccc(/C(C)=N/OC)n1] | ¹H-NMR (CDCl3, 400 MHz): 7.72 (d, 1H), 7.69 (d, 1H), 7.58 (m, 2H), 7.10 (m, 2H), 4.20 (d, 2H), 4.03 (s, 3H), 3.00-2.80 (m, 2H), 2.60 (s, 3H), 2.45-2.28 (m, 7H), 1.55-1.42 (m, 2H), 1.00 (t, 3H). |
| P.05 | 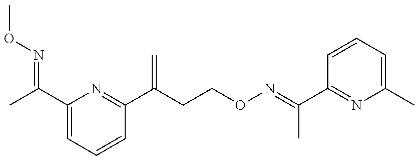 | 1H-NMR (CDCl3, 400 MHz): 7.80 (d, 1H), 7.70-7.60 (m, 2H), 7.53 (m, 2H), 7.09 (d, 1H), 5.89 (s, 1H), 4.90 (s, 1H), 4.44 (t, 2H), 4.03 (s, 3H), 3.10 (t, 2H), 2.55 (s, 3H), 2.45 (s, 3H), 2.28 (s, 3H) |
| P.06 | 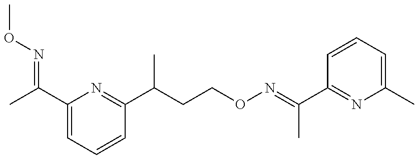 | 1H-NMR (CDCl3, 400 MHz): 7.70 (d, 1H), 7.63 (d, 1H), 7.58-7.49 (m, 2H), 7.11-7.04 (m, 2H), 4.23-4.09 (m, 2H), 4.01 (s, 3H), 3.13-3.02 (m, 1H), 2.54 (s, 3H), 2.32 (s, 3H), 2.28 (s, 3H), 2.38-2.19 (m, 1H), 2.10-2.00 (m, 1H), 1.33 (d, 3H) |
| P.07 | 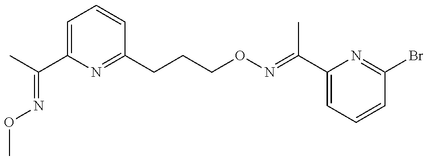 [SMILES: CO/N=C(\C)c1cccc(CCCO/N=C(\C)c2cccc(Br)n2)n1] | ¹H-NMR (CDCl3, 400 MHz): 7.87 (d, 1H), 7.70 (d, 1H), 7.56 (t, 1H), 7.50 (t, 1H), 7.41 (d, 1H), 7.11 (d, 1H), 4.30 (t, 2H), 4.01 (s, 3H), 2.92 (t, 2H), 2.32 (s, 3H), 2.29 (s, 3H), 2.22 (m, 2H) |
| P.08 | 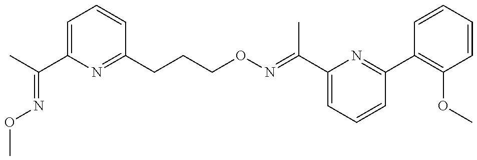 | ¹H-NMR (CDCl3, 400 MHz): 7.95 (d, 1H), 7.85 (m, 2H), 7.68 (m, 2H), 7.76 (t, 1H), 7.48 (t, 1H), 7.10 (m, 2H), 7.00 (d, 1H), 4.30 (t, 2H), 4.02 (s, 3H), 3.89 (s, 3H), 2.93 (t, 2H), 2.40 (s, 3H), 2.33 (s, 3H), 2.24 (m, 2H). |
| P.09 | 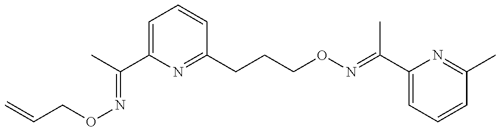 [SMILES: C=CCO/N=C(\C)c1cccc(CCCO/N=C(\C)c2cccc(C)n2)n1] | ¹H-NMR (CDCl3, 400 MHz): 7.70 (d, 1H), 7.68 (d, 1H), 7.58-7.50 (m, 2H), 7.12-7.05 (m, 2H), 6.12-6.02 (m, 1H), 5.49-5.20 (m, 2H), 4.72 (d, 2H), 4.39 (t, 2H), 2.92 (t, 2H), 2.57 (s, 3H), 2.37 (s, 3H), 2.32 (s, 3H), 2.22 (m, 2H) |
| P.10 | 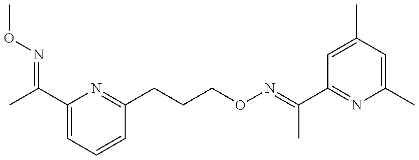 | ¹H-NMR (CDCl3, 400 MHz): 7.70 (d, 1H), 7.55 (t, 1H), 7.47 (s, 2H), 7.11 (d, 1H), 6.93 (s, 1H), 4.28 (t, 2H), 4.01 (s, 3H), 2.92 (t, 2H), 2.51 (s, 3H), 2.32 (s + s + s, 9H), 2.21 (m, 2H) |
| P.11 | 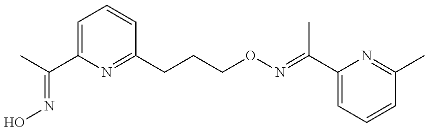 [SMILES: C/C(=N\OCCCc1cccc(/C(C)=N/O)n1)c1cccc(C)n1] | ¹H-NMR (CDCl3, 400 MHz): 7.67 (d, 1H), 7.61 (d, 1H), 7.60-7.50 (m, 2H), 7.13 (d, 1H), 7.10 (d, 1H), 4.39 (t, 2H), 2.94 (t, 2H), 2.58 (s, 3H), 2.39 (s, 3H), 2.33 (s, 3H), 2.22 (m, 2H) |
| P.12 | 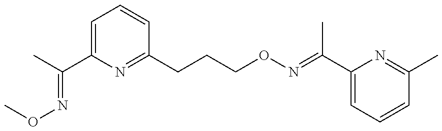 | ¹H-NMR (CDCl3, 400 MHz): 7.70 (d, 1H), 7.68 (d, 1H), 7.69-7.50 (m, 2H), 7.12 (d, 1H), 7.10 (d, 1H), 4.39 (t, 2H), 4.01 (s, 3H), 2.92 (t, 2H), 2.32 (s, 6H), 2.21 (m, 2H) |
| P.63A | 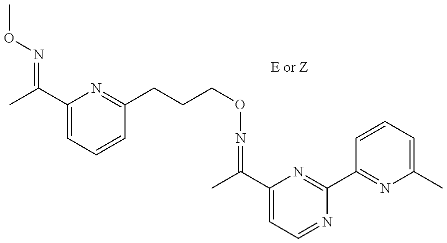 | ¹H-NMR (CDCl3, 400 MHz): Isomer A: 2.25 (m, 2H); 2.32 (s, 3H); 2.39 (s, 3H); 2.73 (s, 3H); 2.94 (t, 2H); 4.01 (s, 3H); 4.36 (t, 2H); 7.12 (d, 1H); 7.29 (d, 1H); 7.56 (t, 1H); 7.70 (d, 1H); 7.74 (t, 1H); 7.84 (d, 1H); 8.36 (d, 1H); 8.88 (d, 1H). |
| P.63B | 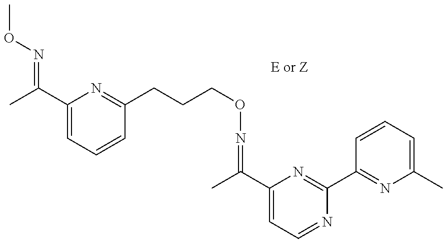 | ¹H-NMR (CDCl3, 400 MHz): Isomer B: 2.01 (s, 3H); 2.03 (s, 3H); 2.25 (m, 2H); 2.73 (s, 3H); 2.98 (t, 2H); 3.94 (s, 3H); 4.28 (t, 2H); 7.29 (d, 2H); 7.80 (m, 2H); 8.40 (d, 1H); 8.50 (m, 2H); 9.06 (d, 1H) |
| P.64 | 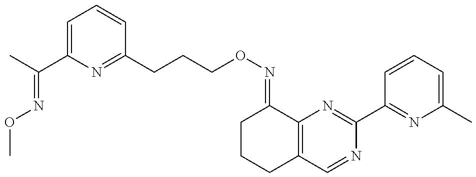 | ¹H-NMR (CDCl3, 400 MHz): 1.94 (m, 2H); 2.28 (m, 2H); 2.31 (s, 3H); 2.72 (s, 3H); 2.88 (m, 4H); 2.97 (t, 2H); 4.03 (s, 3H), 4.49 (t, 2H); 7.14 (d, 1H); 7.23 (d, 1H); 7.56 (t, 1H); 7.72 (m, 2H); 8.38 (d, 1H); 8.77 (s, 1H). |
| P.65 | 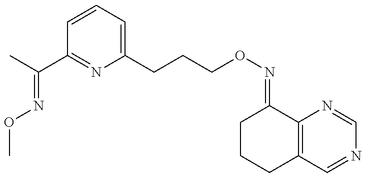 [SMILES: CO/N=C(\C)c1cccc(CCCO/N=C2\CCCc3cncnc32)n1] | ¹H-NMR (CDCl3, 400 MHz): 1.90 (m, 2H); 2.23 (m, 2H); 2.31 (s, 3H); 2.76 (t, 2H); 2.82 (t, 2H); 2.94 (t, 2H); 4.01 (s, 3H); 4.46 (t, 2H); 7.11 (d, 1H); 7.54 (t, 1H); 7.71 (d, 1H); 8.57 (s, 1H); 9.13 (s, 1H). |
| P.60 | 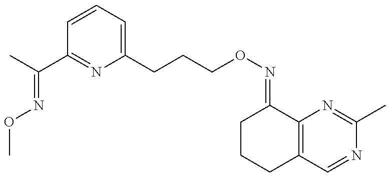 | ¹H-NMR (CDCl3, 400 MHz): 1.85 (m, 2H); 2.23 (m, 2H); 2.30 (s, 3H); 2.68 (t, 2H); 2.78 (s, 3H); 2.81 (t, 2H); 2.92 (m, 2H); 4.01 (s, 3H), 4.45 (t, 2H); 7.13 (d, 1H); 7.56 (t, 1H); 7.71 (d, 1H); 8.49 (s, 1H). |
| P.61 | 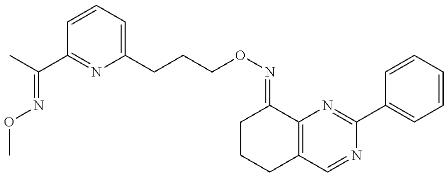 [SMILES: CO/N=C(\C)c1cccc(CCCO/N=C2\CCCc3cnc(-c4ccccc4)nc32)n1] | ¹H-NMR (CDCl3, 400 MHz): 1.90 (m, 2H); 2.23 (m, 2H); 2.31 (s, 3H); 2.83 (t, 2H); 2.92 (m, 2H); 4.03 (s, 3H), 4.48 (t, 2H); 7.14 (d, 1H); 7.48 (m, 3H); 7.56 (m, 1H); 7.70 (d, 1H); 8.45 (m, 2H); 8.64 (s, 1H). |
| P.62 | 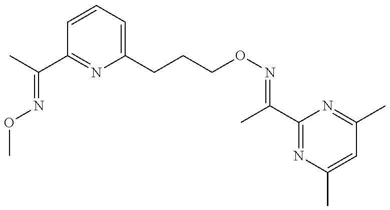 | ¹H-NMR (CDCl3, 400 MHz): 2.25 (m, 2H); 2.32 (s, 3H); 2.36 (s, 3H); 2.53 (s, 3H); 2.96 (t, 2H); 2.92 (m, 2H); 4.03 (s, 3H), 4.47 (t, 2H); 7.00 (s, 1H); 7.14 (d, 1H); 7.48 (t, 1H); 7.72 (d, 1H). |

TABLE 39
LC-MS and mp data for compounds of formula (I)

| | | RT | | |
|---|---|---|---|---|
| | | (mins) | Molecular | mp |
| | Structure | (method) | ion | (° C.) |
| P.13 | 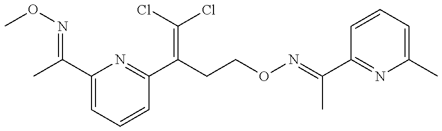 | 2.15 (ZDQ) | 421 ([M + 1]⁺) | |
| P.14 | 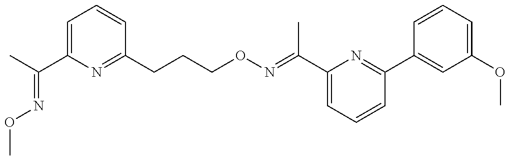 | 2.29 (ZDQ) | 433 ([M + 1]⁺) | |
| P.15 | 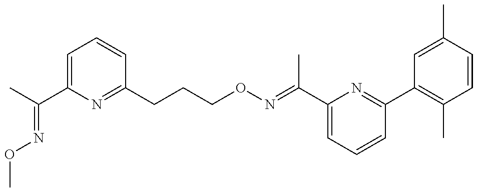 [SMILES: CO/N=C(\C)c1cccc(CCCO/N=C(\C)c2cccc(-c3cc(C)ccc3C)n2)n1] | 2.36 (ZDQ) | 431 ([M + 1]⁺) | |
| P.16 | 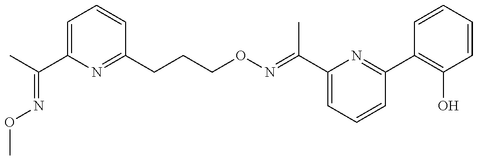 [SMILES: CO/N=C(\C)c1cccc(CCCO/N=C(\C)c2cccc(-c3ccccc3O)n2)n1] | 2.26 (ZDQ) | 419 ([M + 1]⁺) | |
| P.17 | 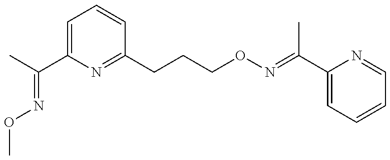 [SMILES: CO/N=C(\C)c1cccc(CCCO/N=C(\C)c2ccccn2)n1] | 1.91 (ZCQ) | 327 ([M + 1]⁺) | |
| P.18 | 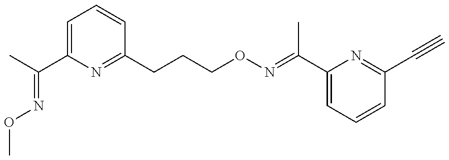 [SMILES: C#Cc1cccc(/C(C)=N/OCCCc2cccc(/C(C)=N/OC)n2)n1] | 2.05 (ZDQ) | 351 ([M + 1]⁺) | |
| P.19 | 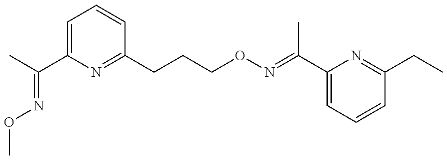 [SMILES: CCc1cccc(/C(C)=N/OCCCc2cccc(/C(C)=N/OC)n2)n1] | 2.14 (ZDQ) | 355 ([M + 1]⁺) | |
| P.20 | 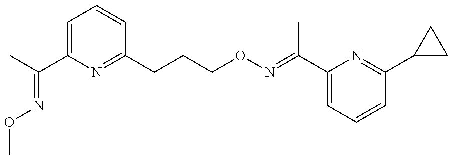 [SMILES: CO/N=C(\C)c1cccc(CCCO/N=C(\C)c2cccc(C3CC3)n2)n1] | 2.23 (ZDQ) | 367 ([M + 1]⁺) | |
| P.21 | 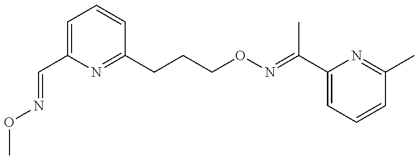 | 1.72 (ZDQ) | 327 ([M + 1]⁺) | |
| P.22 | 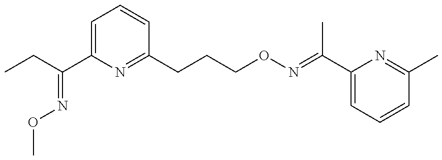 [SMILES: CC/C(=N\OC)c1cccc(CCCO/N=C(\C)c2cccc(C)n2)n1] | 2.07 (ZDQ) | 355 ([M + 1]⁺) | |
| P.23A | 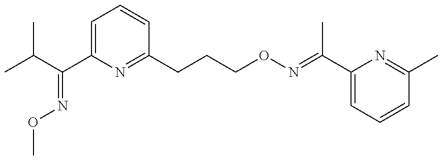 [SMILES: CO/N=C(/c1cccc(CCCO/N=C(\C)c2cccc(C)n2)n1)C(C)C] | Isomer A 2.29 (ZMD) | Isomer A 369 ([M + 1]⁺) | |
| P.24 | 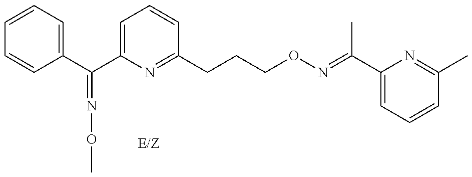 [SMILES: CON=C(c1ccccc1)c1cccc(CCCO/N=C(\C)c2cccc(C)n2)n1] | 1.98 (ZDQ) | 403 ([M + 1]⁺) | |
| P.25 | 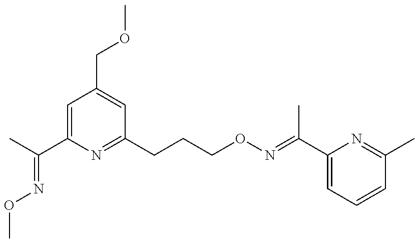 | 2.02 (ZDQ) | 385 ([M + 1]⁺) | |
| P.26 | 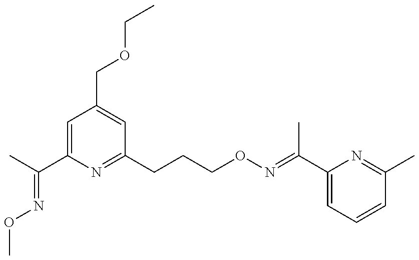 | 2.12 (ZDQ) | 389 ([M + 1]⁺) | |
| P.27 | 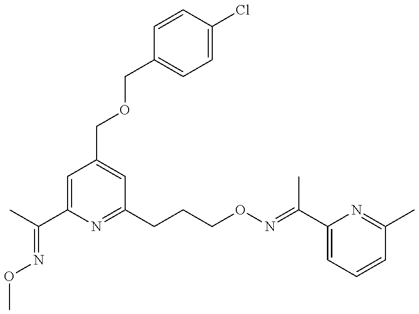 | 2.35 (ZDQ) | 495 ([M + 1]⁺) | |
| P.28 | 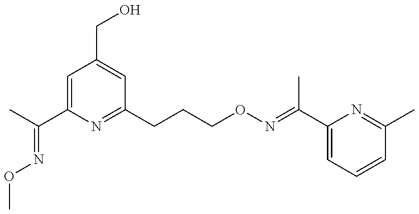 | 1.41 (ZDQ) | 371 ([M + 1]⁺) | |
| P.29 | 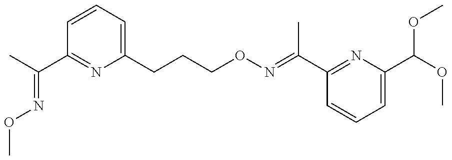 | 2.11 (ZDQ) | 401 ([M + 1]⁺) | |
| P.30 | 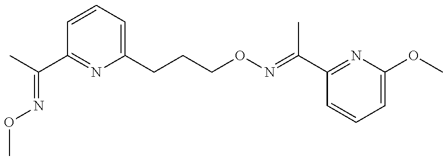 | 2.22 (ZMD) | 357 ([M + 1]⁺) | |
| P.31 | 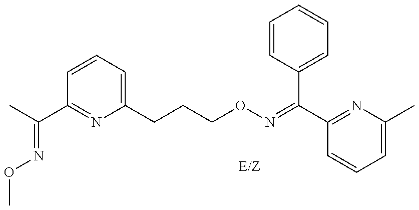 | 2.10 + 2.14 (ZCQ) | 403 ([M + 1]⁺) | |
| P.32 | 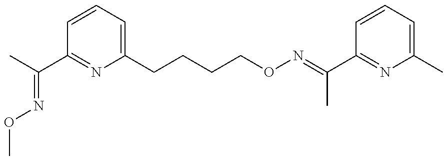 | 2.12 (ZMD) | 355 ([M + 1]⁺) | |
| P.33 | 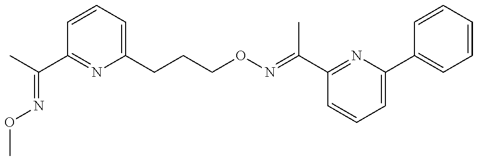 [SMILES: CO/N=C(\C)c1cccc(CCCO/N=C(\C)c2cccc(-c3ccccc3)n2)n1] | 2.38 (ZMD) | 403 ([M + 1]⁺) | |
| P.34 | 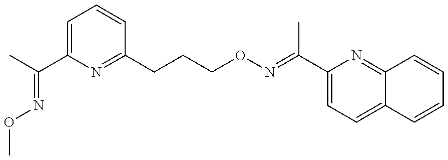 [SMILES: CO/N=C(\C)c1cccc(CCCO/N=C(\C)c2ccc3ccccc3n2)n1] | 2.31 (ZMD) | 377 ([M + 1]⁺) | |
| P.35 | 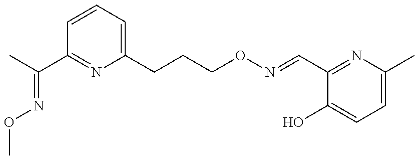 | 1.68 (U) | 343.33 | |
| P.36 | 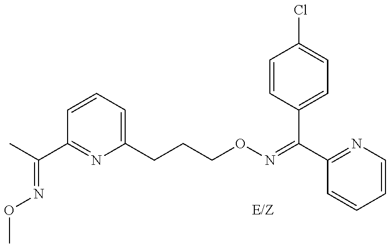 [SMILES: CO/N=C(\C)c1cccc(CCCO/N=C(\c2ccc(Cl)cc2)c2ccccn2)n1] | 2.06 (U) | 423.33 | |
| P.37 | 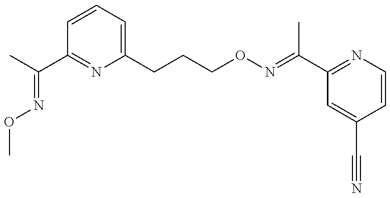 [SMILES: CO/N=C(\C)c1cccc(CCCO/N=C(\C)c2cc(C#N)ccn2)n1] | 1.92 (U) | 352.33 | |
| P.38 | 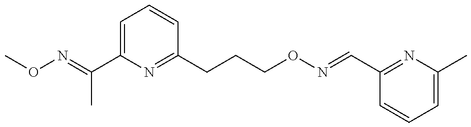 | 1.59 (U) | 327.35 | |
| P.39 | 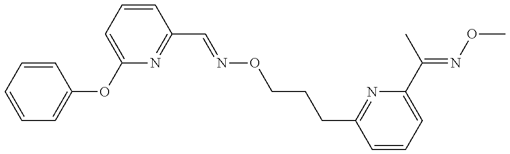 [SMILES: CO/N=C(\C)c1cccc(CCCO/N=C/c2cccc(Oc3ccccc3)n2)n1] | 2.13 (U) | 405.39 | |
| P.40 | 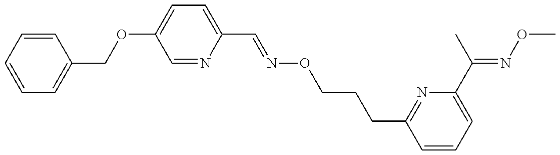 [SMILES: CO/N=C(\C)c1cccc(CCCO/N=C/c2ccc(OCc3ccccc3)cn2)n1] | 2.04 (U) | 419.38 | |
| P.41 | 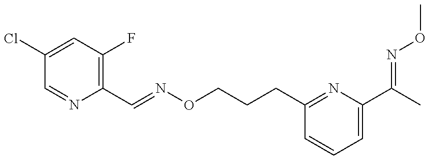 [SMILES: CO/N=C(\C)c1cccc(CCCO/N=C/c2ncc(Cl)cc2F)n1] | 1.89 (U) | 365.27 | |
| P.42 | 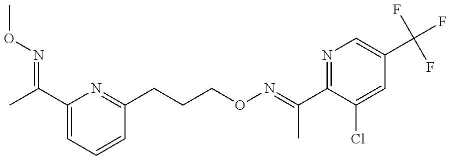 [SMILES: CO/N=C(\C)c1cccc(CCCO/N=C(\C)c2ncc(C(F)(F)F)cc2Cl)n1] | 2.22 (U) | 429.29 | |
| P.43 | 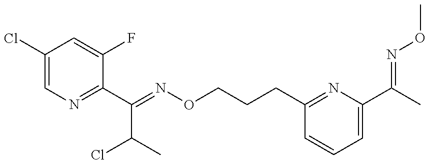 [SMILES: CO/N=C(\C)c1cccc(CCCO/N=C(/c2ncc(Cl)cc2F)C(C)Cl)n1] | 2.23 (U) | 427.29 | |
| P.44 | 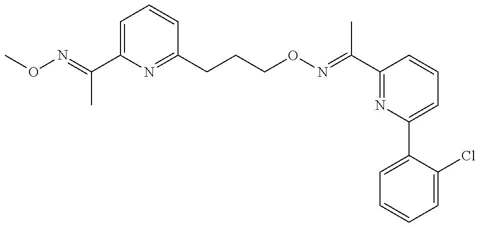 [SMILES: CO/N=C(\C)c1cccc(CCCO/N=C(\C)c2cccc(-c3ccccc3Cl)n2)n1] | 2.42 (U) | 437.36 | |
| P.45 | 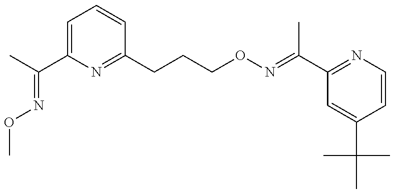 [SMILES: CO/N=C(\C)c1cccc(CCCO/N=C(\C)c2cc(C(C)(C)C)ccn2)n1] | 2.15 (U) | 383.41 | |
| P.46 | 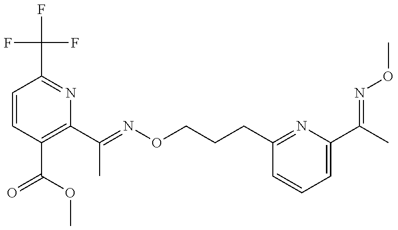 [SMILES: CO/N=C(\C)c1cccc(CCCO/N=C(\C)c2nc(C(F)(F)F)ccc2C(=O)OC)n1] | 2.10 (U) | 453.35 | |
| P.47 | 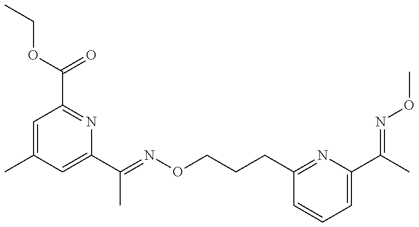 | 2.11 (U) | 413.37 | |
| P.48 | 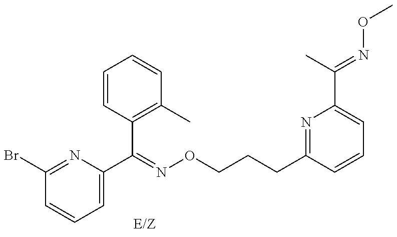 [SMILES: CO/N=C(\C)c1cccc(CCCO/N=C(/c2cccc(Br)n2)c2ccccc2C)n1] | 2.25 (U) | 481.3 | |
| P.49 | 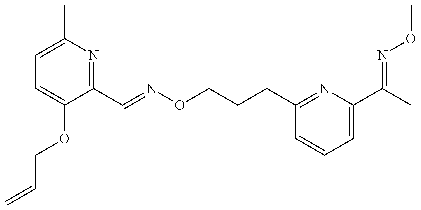 [SMILES: C=CCOc1ccc(C)nc1/C=N/OCCCc1cccc(/C(C)=N/OC)n1] | 1.68 (U) | 383.05 | |
| P.50 | 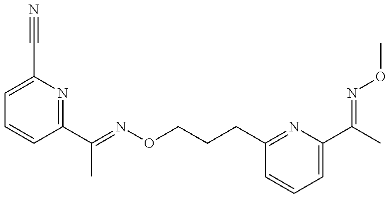 [SMILES: CO/N=C(\C)c1cccc(CCCO/N=C(\C)c2cccc(C#N)n2)n1] | 1.95 (U) | 352.33 | |
| P.51 | 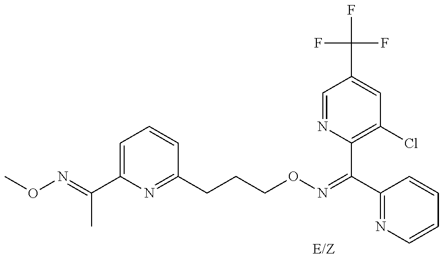 [SMILES: CO/N=C(\C)c1cccc(CCCO/N=C(/c2ccccn2)c2ncc(C(F)(F)F)cc2Cl)n1] | 2.10 (U) | 492.41 | |
| P.52 | 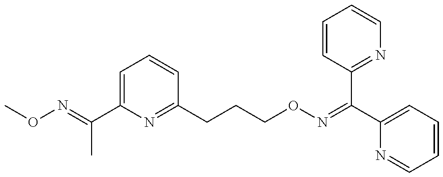 [SMILES: CO/N=C(\C)c1cccc(CCCON=C(c2ccccn2)c2ccccn2)n1] | 1.42 (U) | 390.43 | |
| P.53 | 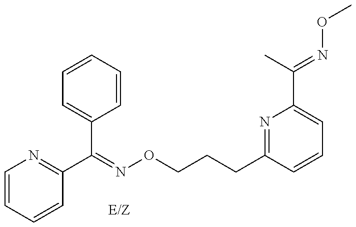 [SMILES: CO/N=C(\C)c1cccc(CCCO/N=C(\c2ccccc2)c2ccccn2)n1] | 1.84 (U) | 389.5 | |
| P.54 | 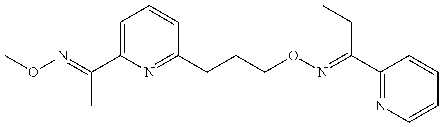 [SMILES: CC/C(=N\OCCCc1cccc(/C(C)=N/OC)n1)c1ccccn1] | 1.94 (U) | 341.4 | |
| P.55 | 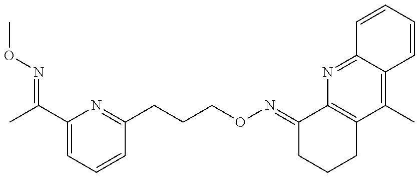 [SMILES: CO/N=C(\C)c1cccc(CCCO/N=C2\CCCc3c2nc2ccccc2c3C)n1] | 1.69 (ZMD) | 417 ([M + 1]⁺); 439 ([M + 23]⁺) | |
| P.56 | 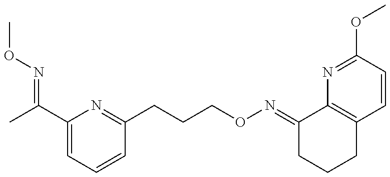 [SMILES: CO/N=C(\C)c1cccc(CCCO/N=C2\CCCc3ccc(OC)nc32)n1] | 2.03 (ZMD) | 383 ([M + 1]⁺); 405 ([M + 23]⁺) | |
| P.57 | 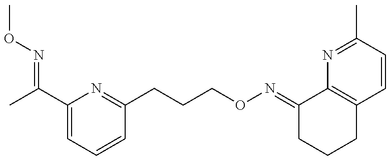 [SMILES: CO/N=C(\C)c1cccc(CCCO/N=C2\CCCc3ccc(C)nc32)n1] | 1.42 (ZCQ) | 367 ([M + 1]⁺); 389 ([M + 23]⁺); | |
| P.58 | 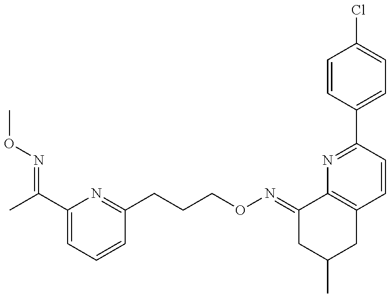 [SMILES: CO/N=C(\C)c1cccc(CCCO/N=C2\CC(C)Cc3ccc(-c4ccc(Cl)cc4)nc32)n1] | 2.60 (UPLC1) | 511 ([M + 1]⁺) | |
| P.59 | 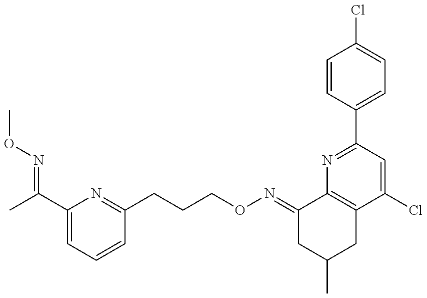 | 2.34 (UPLC1) | 477 ([M + 1]⁺) | |
| P.60 | 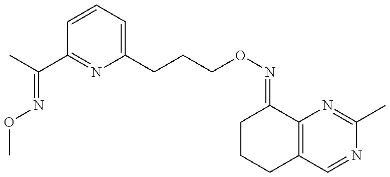 | 1.70 (ZCQ) | 368 ([M + 1]+) | |
| P.61 | 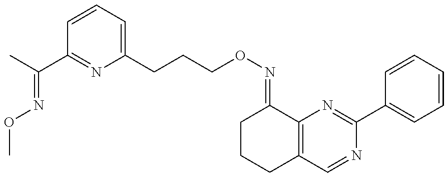 [SMILES: CO/N=C(\C)c1cccc(CCCO/N=C2\CCCc3cnc(-c4ccccc4)nc32)n1] | 2.05 (ZMD) | 430 ([M + 1]⁺) | |
| P.62 | 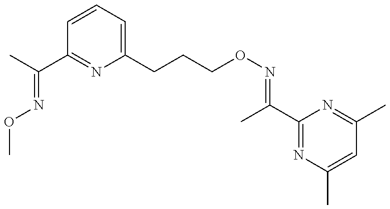 | 1.83 (ZCQ) | 356 ([M + 1]⁺) | |
| P.63A | 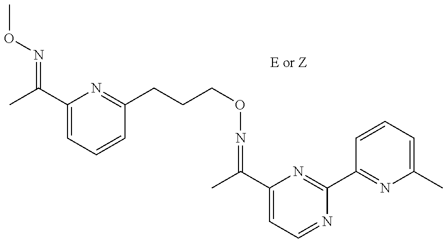 | Isomer A 1.75 (ZMD) | Isomer A 419 ([M + 1]⁺) | |
| P.63B | 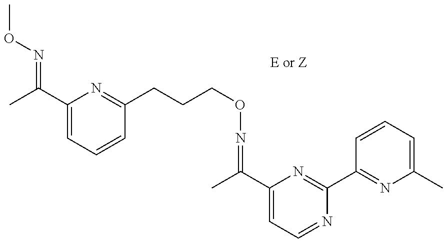 | Isomer B 1.78 (ZMD) | Isomer B 419 ([M + 1]⁺) | |
| P.64 | 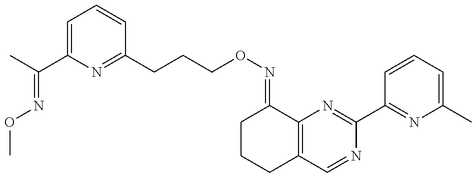 [SMILES: CO/N=C(\C)c1cccc(CCCO/N=C2\CCCc3cnc(-c4cccc(C)n4)nc32)n1] | 1.54 (ZMD) | 445 ([M + 1]⁺) | |
| P.65 | 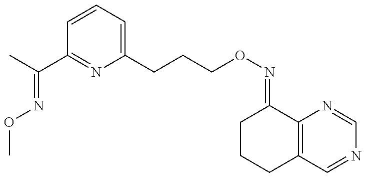 [SMILES: CO/N=C(\C)c1cccc(CCCO/N=C2\CCCc3cncnc32)n1] | 1.68 (ZMD) | 354 ([M + 1]⁺) | |
| P.66 | 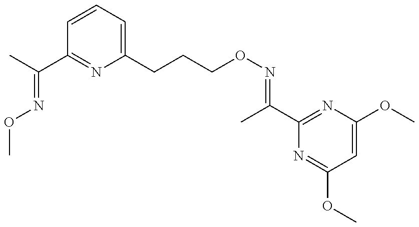 [SMILES: CO/N=C(\C)c1cccc(CCCO/N=C(\C)c2nc(OC)cc(OC)n2)n1] | 1.88 (UPLC1) | 388 ([M + 1]⁺) | |
| P.67 | 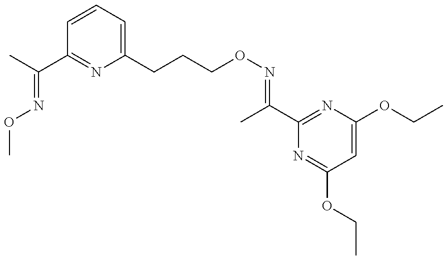 [SMILES: CCOc1cc(OCC)nc(/C(C)=N/OCCCc2cccc(/C(C)=N/OC)n2)n1] | 2.18 (UPLC1) | 416 ([M + 1]⁺) | |
| P.68 | 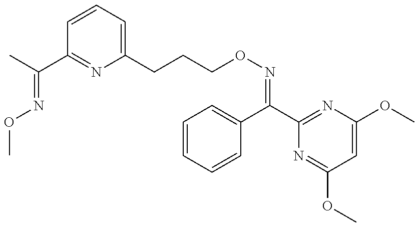 [SMILES: CO/N=C(\C)c1cccc(CCCO/N=C(\c2ccccc2)c2nc(OC)cc(OC)n2)n1] | 2.10 (UPLC1) | 450 ([M + 1]⁺) | |
| P.69 | 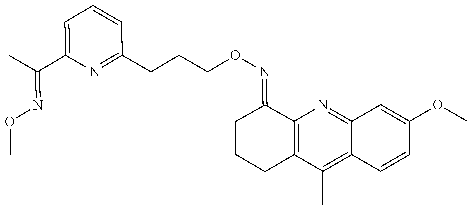 [SMILES: CO/N=C(\C)c1cccc(CCCO/N=C2\CCCc3c2nc2cc(OC)ccc2c3C)n1] | 1.48 (ZMD) | 447 ([M + 1]+) | |
| P.70 | 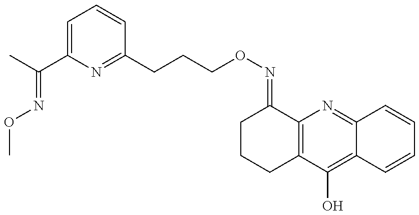 [SMILES: CO/N=C(\C)c1cccc(CCCO/N=C2\CCCc3c2nc2ccccc2c3O)n1] | 2.00 (ZMD) | 419 ([M + 1]+) | |
| P.71 | 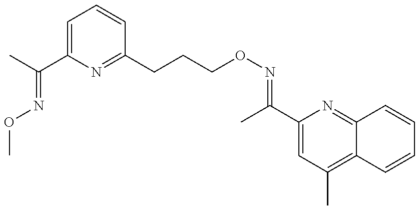 [SMILES: CO/N=C(\C)c1cccc(CCCO/N=C(\C)c2cc(C)c3ccccc3n2)n1] | 2.23 (ZMD) | 391 ([M + 1]+) | |
| P.72 | 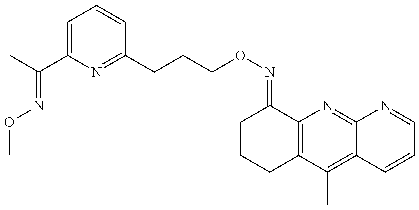 [SMILES: CO/N=C(\C)c1cccc(CCCO/N=C2\CCCc3c2nc2ncccc2c3C)n1] | 1.61 (ZMD) | 418 ([M + 1]+) | |
| P.73 | 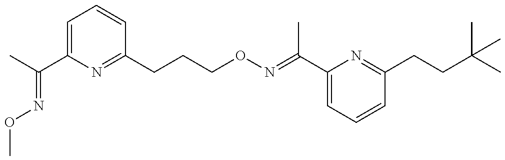 [SMILES: CO/N=C(\C)c1cccc(CCCO/N=C(\C)c2cccc(CCC(C)(C)C)n2)n1] | 2.38 (OA_3min_30V) | 411 ([M + 1]⁺) | |
| P.74 | 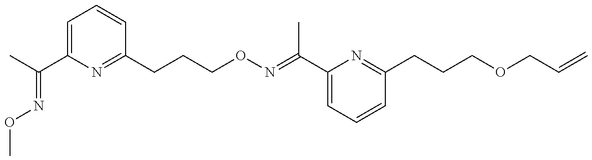 [SMILES: C=CCOCCCc1cccc(/C(C)=N/OCCCc2cccc(/C(C)=N/OC)n2)n1] | 2.62 (OA_5min_30V) | 425 ([M + 1]⁺) | |
| P.75 | 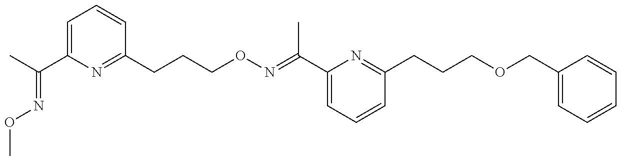 [SMILES: CO/N=C(\C)c1cccc(CCCO/N=C(\C)c2cccc(CCCOCc3ccccc3)n2)n1] | 2.27 (OA_3min_30V) | 475 ([M + 1]⁺) | |
| P.76 | 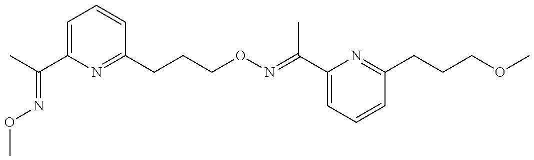 [SMILES: COCCCc1cccc(/C(C)=N/OCCCc2cccc(/C(C)=N/OC)n2)n1] | 1.19 (OA_2min_30V) | 399 ([M + 1]⁺) | |
| P.77 | 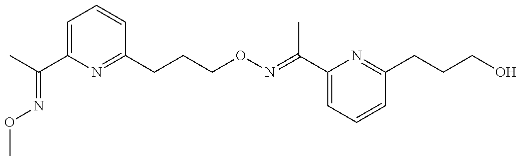 [SMILES: CO/N=C(\C)c1cccc(CCCO/N=C(\C)c2cccc(CCCO)n2)n1] | 1.73 (OA_3min_30V) | 385 ([M + 1]⁺) | |
| P.78 | 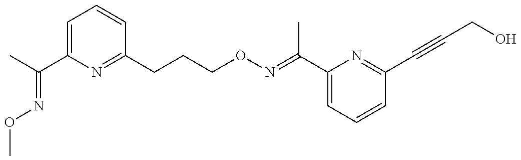 [SMILES: CO/N=C(\C)c1cccc(CCCO/N=C(\C)c2cccc(C#CCO)n2)n1] | 1.81 (OA_3min_30V) | 381 ([M + 1]⁺) | |
| P.79 | 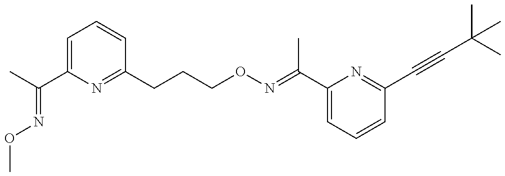 [SMILES: CO/N=C(\C)c1cccc(CCCO/N=C(\C)c2cccc(C#CC(C)(C)C)n2)n1] | 2.28 (OA_3min_30V) | 407 ([M + 1]⁺) | |
| P.80 | 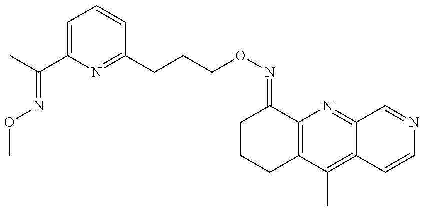 [SMILES: CO/N=C(\C)c1cccc(CCCO/N=C2\CCCc3c2nc2cnccc2c3C)n1] | 1.73 (ZMD) | 418 ([M + 1]⁺) | |
| P.81 | 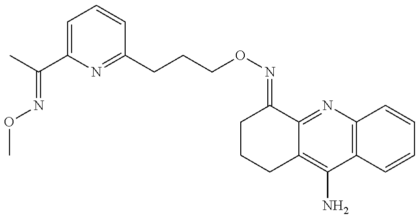 [SMILES: CO/N=C(\C)c1cccc(CCCO/N=C2\CCCc3c2nc2ccccc2c3N)n1] | 2.17 (ZMD) | 418 ([M + 1]⁺) | |
| P.82 | 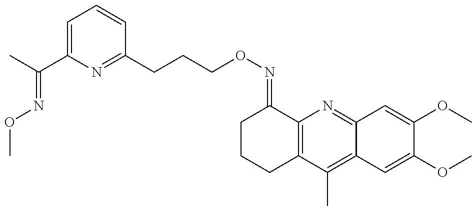 [SMILES: CO/N=C(\C)c1cccc(CCCO/N=C2\CCCc3c2nc2cc(OC)c(OC)cc2c3C)n1] | 1.44 (ZMD) | 477 ([M + 1]⁺) | |
| P.83 | 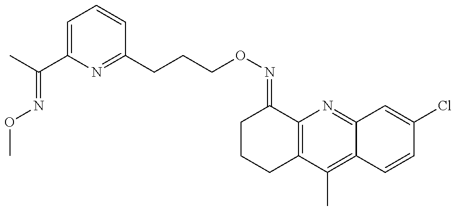 [SMILES: CO/N=C(\C)c1cccc(CCCO/N=C2\CCCc3c2nc2cc(Cl)ccc2c3C)n1] | 2.01 (ZMD) | 451 ([M + 1]⁺) | |
| P.84 | 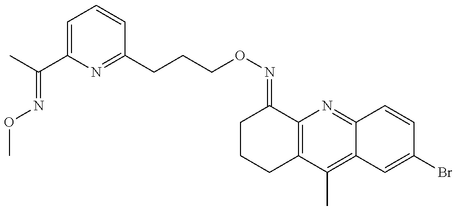 [SMILES: CO/N=C(\C)c1cccc(CCCO/N=C2\CCCc3c2nc2ccc(Br)cc2c3C)n1] | 2.04 (ZMD) | 496 ([M + 1]⁺) | |
| P.85 | 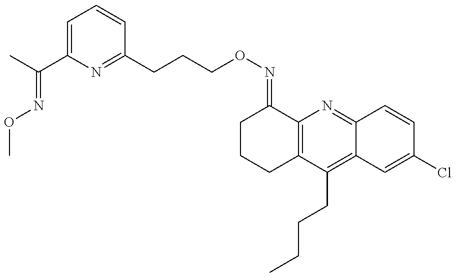 [SMILES: CCCCc1c2c(nc3ccc(Cl)cc13)/C(=N/OCCCc1cccc(/C(C)=N/OC)n1)CCC2] | 2.25 (ZMD) | 494 ([M + 1]⁺) | |
| P.86 | 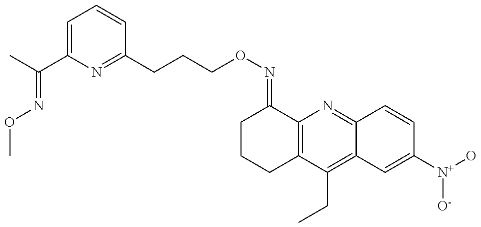 [SMILES: CCc1c2c(nc3ccc([NH+]([O-])O)cc13)/C(=N/OCCCc1cccc(/C(C)=N/OC)n1)CCC2] | 2.08 (ZMD) | 476 ([M + 1]⁺) | |
| P.87 | 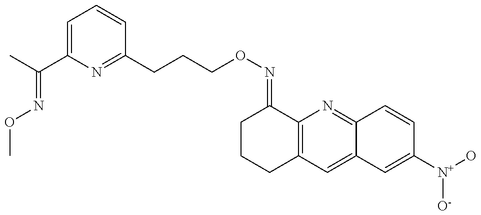 [SMILES: CO/N=C(\C)c1cccc(CCCO/N=C2\CCCc3cc4cc([NH+]([O-])O)ccc4nc32)n1] | 1.98 (ZMD) | 448 ([M + 1]⁺) | |
| P.88 | 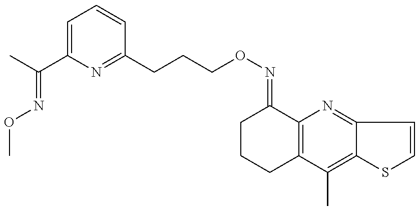 [SMILES: CO/N=C(\C)c1cccc(CCCO/N=C2\CCCc3c2nc2ccsc2c3C)n1] | 1.72 (ZMD) | 423 ([M + 1]⁺) | |
| P.89 | 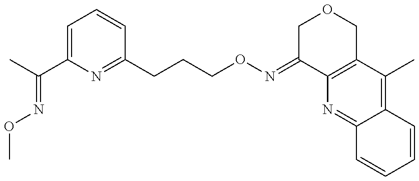 | 1.81 (ZMD) | 419 ([M + 1]⁺) | |
| P.90 | 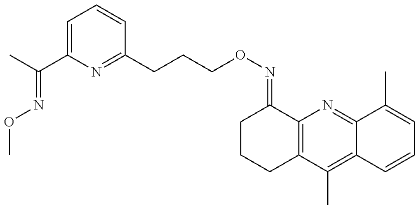 [SMILES: CO/N=C(\C)c1cccc(CCCO/N=C2\CCCc3c2nc2c(C)cccc2c3C)n1] | 1.84 (ZMD) | 431 ([M + 1]⁺) | |
| P.91 | 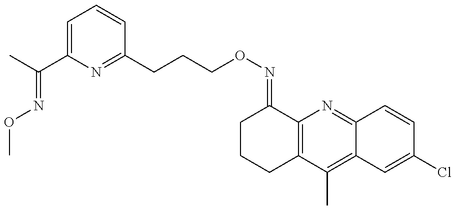 [SMILES: CO/N=C(\C)c1cccc(CCCO/N=C2\CCCc3c2nc2ccc(Cl)cc2c3C)n1] | 2.00 (ZMD) | 451 ([M + 1]⁺) | |
| P.92 | 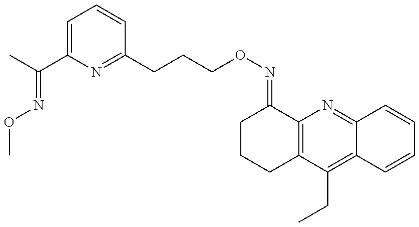 [SMILES: CCc1c2c(nc3ccccc13)/C(=N/OCCCc1cccc(/C(C)=N/OC)n1)CCC2] | 1.66 (ZMD) | 431 ([M + 1]⁺) | |
| P.93 | 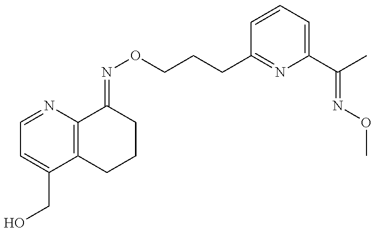 [SMILES: CO/N=C(\C)c1cccc(CCCO/N=C2\CCCc3c(CO)ccnc32)n1] | 1.18 (ZMD) | 383 ([M + 1]⁺) | |
| P.94 | 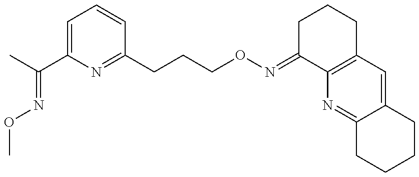 [SMILES: CO/N=C(\C)c1cccc(CCCO/N=C2\CCCc3cc4c(nc32)CCCC4)n1] | 1.37 (ZMD) | 407 ([M + 1]⁺) | |
| P.95 | 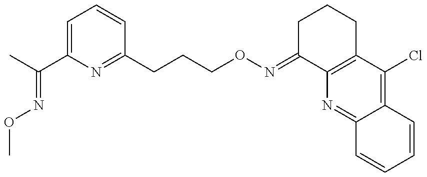 [SMILES: CO/N=C(\C)c1cccc(CCCO/N=C2\CCCc3c2nc2ccccc2c3Cl)n1] | 2.12 (ZMD) | 437 ([M + 1]⁺) | |
| P.96 | 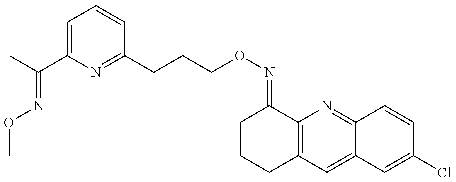 [SMILES: CO/N=C(\C)c1cccc(CCCO/N=C2\CCCc3cc4cc(Cl)ccc4nc32)n1] | 2.05 (ZMD) | 437 ([M + 1]⁺) | |
| P.97 | 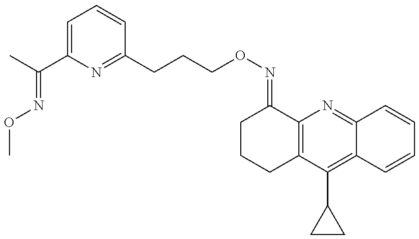 [SMILES: CO/N=C(\C)c1cccc(CCCO/N=C2\CCCc3c2nc2ccccc2c3C2CC2)n1] | 1.77 (ZMD) | 443 ([M + 1]⁺) | |
| P.98 | 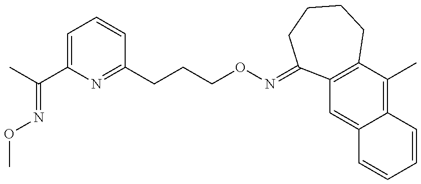 | 2.03 (ZMD) | 431 ([M + 1]⁺) | |
| P.99 | 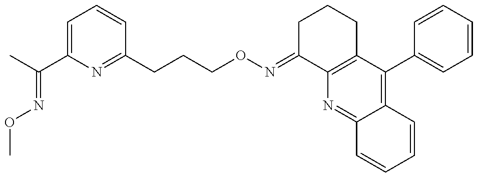 [SMILES: CO/N=C(\C)c1cccc(CCCO/N=C2\CCCc3c2nc2ccccc2c3-c2ccccc2)n1] | 2.20 (ZMD) | 479 ([M + 1]⁺) | |
| P.100 | 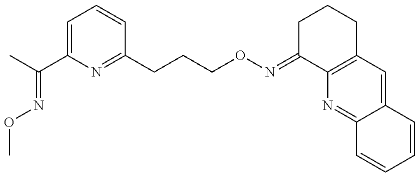 [SMILES: CO/N=C(\C)c1cccc(CCCO/N=C2\CCCc3cc4ccccc4nc32)n1] | 1.58 (ZMD) | 403 ([M + 1]⁺) | |
| P.101 | 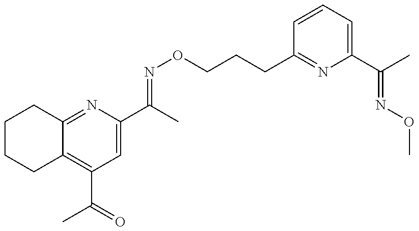 | 2.12 (ZMD) | 381 ([M + 1]⁺) | |
| P.102 | 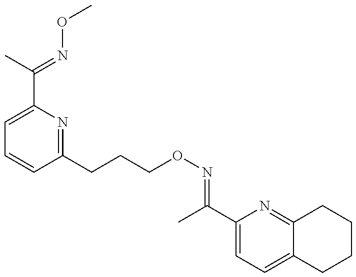 | 2.27 (ZMD) | 423 ([M + 1]⁺) | |
| P.103 | 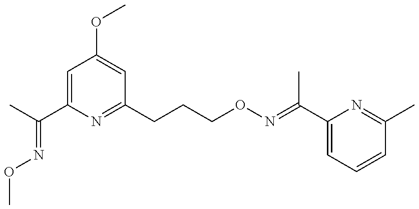 | 1.56 (ZMD) | 371 ([M + 1]⁺) | |
| P.104 | 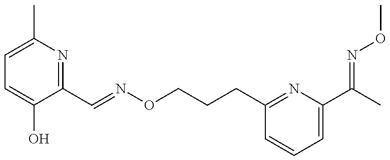 [SMILES: CO/N=C(\C)c1cccc(CCCO/N=C/c2nc(C)ccc2O)n1] | 1.68 (UPLC1) | 343 ([M + 1]⁺) | |
| P.105 | 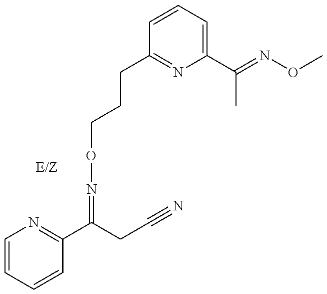 [SMILES: CO/N=C(\C)c1cccc(CCCON=C(CC#N)c2ccccn2)n1] | 1.75 (UPLC1) | 352 ([M + 1]⁺) | |
| P.106 B | 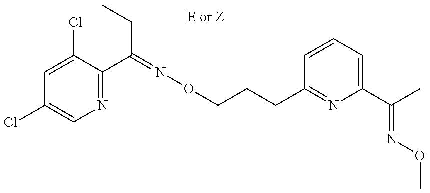 | Isomer B 2.09 (UPLC1) | Isomer B 429 ([M + 1]⁺) | |
| P.107 | 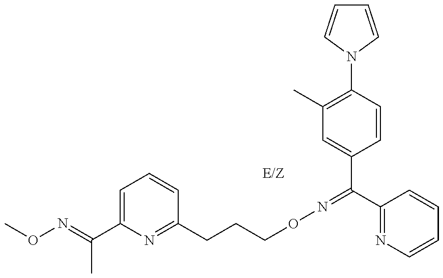 [SMILES: CO/N=C(\C)c1cccc(CCCON=C(c2ccc(-n3cccc3)c(C)c2)c2ccccn2)n1] | 2.17 (UPLC1) | 468 ([M + 1]⁺) | |
| P.108 | 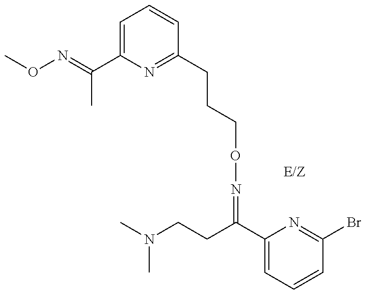 [SMILES: CO/N=C(\C)c1cccc(CCCON=C(CCN(C)C)c2cccc(Br)n2)n1] | 1.25 (UPLC1) | 462 ([M + 1]⁺) | |
| P.109 | 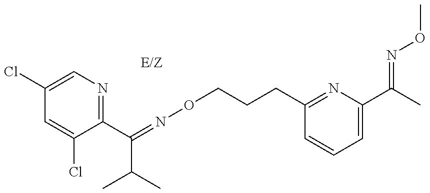 [SMILES: CO/N=C(\C)c1cccc(CCCON=C(c2ncc(Cl)cc2Cl)C(C)C)n1] | 2.35 (UPLC1) | 423 ([M + 1]⁺) | |
| P.110 | 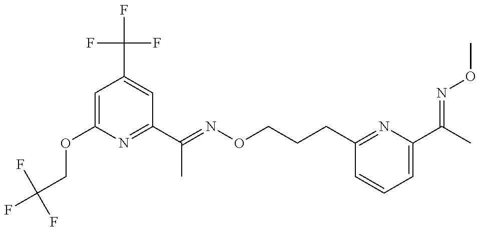 [SMILES: CO/N=C(\C)c1cccc(CCCO/N=C(\C)c2cc(C(F)(F)F)cc(OCC(F)(F)F)n2)n1] | 2.48 (UPLC1) | 494 ([M + 1]⁺) | |
| P.111 | 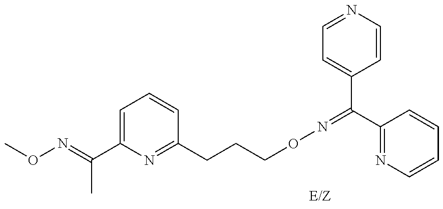 [SMILES: CO/N=C(\C)c1cccc(CCCON=C(c2ccncc2)c2ccccn2)n1] | 1.40 (UPLC1) | 390 ([M + 1]⁺) | |
| P.112 | 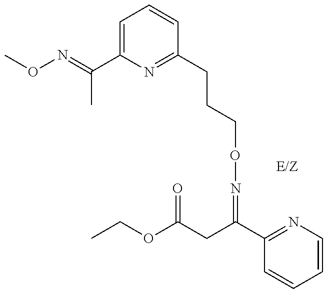 [SMILES: CCOC(=O)CC(=NOCCCc1cccc(/C(C)=N/OC)n1)c1ccccn1] | 1.91 (UPLC1) | 399 ([M + 1]⁺) | |

LC Method Used

Method A
Autopurification System from Waters: 2767 sample Manager, 2489 UV/Visible Detector, 2545 Quaternary Gradient Module.
Column: Phenomenex Synergi C18 Reversed Phase, 4 μm particle size, 80 Å, 75×30.00 mm,
100 mg of product dissolve in DMF injected
DAD Wavelength (nm): 220 and 254
Solvent Gradient:
A=water (Fluka Analytical)
B=Acetonitrile for prep. HPLC (Fluka Analytical)

| Time | A % | B % | Flow (mL/min) |
|---|---|---|---|
| 0.00 | 90.0 | 10.0 | 50.00 |
| 0.01 | 90.0 | 10.0 | 50.00 |
| 6.00 | 60.0 | 40.0 | 50.00 |
| 7.90 | 60.0 | 40.0 | 50.00 |
| 8.00 | 0.0 | 100.0 | 50.00 |
| 8.90 | 0.0 | 100.0 | 50.00 |
| 9.00 | 90.0 | 10.0 | 50.00 |
| 9.50 | 90.0 | 10.0 | 50.00 |
| 9.55 | 90.0 | 10.0 | 50.00 |

LC-MS Methods Used

Method ZMD
ZMD Mass Spectrometer from Waters (Single quadrupole mass spectrometer)
Instrument Parameter:
Ionisation method: Electrospray
Polarity: positive ions
Capillary (kV) 3.80, Cone (V), Extractor (V) 3.00, Source Temperature (° C.) 150,
Desolvation Temperature (° C.) 350, Cone Gas Flow (L/Hr) OFF, Desolvation Gas Flow (L/Hr) 600
Mass range: 100 to 900 Da
HP 1100 HPLC from Agilent: solvent degasser, binary pump, heated column compartment and diode-array detector.
Column: Phenomenex Gemini C18, 3 mm particle size, 110 Å 30×3 mm,
Temp: 60° C.
DAD Wavelength range (nm): 200 to 500
Solvent Gradient:
A=water+0.05% HCOOH
B=Acetonitrile/Methanol (4:1, v:v)+0.04% HCOOH

| Time | A % | B % | Flow (mL/min) |
|---|---|---|---|
| 0.00 | 95.0 | 5.0 | 1.700 |
| 2.00 | 0.0 | 100.0 | 1.700 |
| 2.80 | 0.0 | 100.0 | 1.700 |
| 2.90 | 95.0 | 5.0 | 1.700 |
| 3.00 | 95.0 | 5.0 | 1.700 |

Method ZCQ
ZQ Mass Spectrometer from Waters (Single quadrupole mass spectrometer)
Instrument Parameter:
Ionisation method: Electrospray
Polarity: positive ions
Capillary (kV) 3.00, Cone (V) 30.00, Extractor (V) 2.00, Source Temperature (° C.) 100,
Desolvation Temperature (° C.) 250, Cone Gas Flow (L/Hr) 50, Desolvation Gas Flow (L/Hr) 400
Mass range: 100 to 900 Da
HP 1100 HPLC from Agilent: solvent degasser, quaternary pump (ZCQ)/binary pump (ZDQ), heated column compartment and diode-array detector.
Column: Phenomenex Gemini C18, 3 mm particle size, 110 Å, 30×3 mm,
Temp: 60° C.
DAD Wavelength range (nm): 200 to 500
Solvent Gradient:
A=water+0.05% HCOOH
B=Acetonitrile/Methanol (4:1, v:v)+0.04% HCOOH

| Time | A % | B % | Flow (mL/min) |
|---|---|---|---|
| 0.00 | 95.0 | 5.0 | 1.700 |
| 2.00 | 0.0 | 100.0 | 1.700 |
| 2.80 | 0.0 | 100.0 | 1.700 |
| 2.90 | 95.0 | 5.0 | 1.700 |
| 3.00 | 95.0 | 5.0 | 1.700 |

Method UPLC
ACQUITY SQD Mass Spectrometer from Waters (Single quadrupole mass spectrometer)
Ionisation method: Electrospray
Polarity: positive ions
Capillary (kV) 3.80, Cone (V) 20.00, Extractor (V) 3.00, Source Temperature (° C.) 150,
Desolvation Temperature (° C.) 400, Cone Gas Flow (L/Hr) 60, Desolvation Gas Flow (L/Hr) 700
Mass range: 100 to 800 Da
Column: Waters ACQUITY UPLC HSS T3; Column length: 30 mm; Internal diameter of column: 2.1 mm; Particle Size: 1.8 micron; Temperature: 60° C.
DAD Wavelength range (nm): 210 to 400
Solvent Gradient:
A=water/methanol 9:1, 0.1% HCOOH
B=Acetonitrile+0.1% HCOOH

| Time | A % | B % | Flow (mL/min) |
|---|---|---|---|
| 0.00 | 100.0 | 0.0 | 0.75 |
| 2.50 | 0.0 | 100.0 | 0.75 |
| 2.80 | 0.0 | 100.0 | 0.75 |
| 3.00 | 100.0 | 0.0 | 0.75 |

UPLC1
ACQUITY SQD Mass Spectrometer from Waters (Single quadrupole mass spectrometer)
Instrument Parameters:
Ionisation method: Electrospray
Polarity: positive ions
Capillary (kV) 3.00, Cone (V) 20.00, Extractor (V) 3.00, Source Temperature (° C.) 150, Desolvation Temperature (° C.) 400, Cone Gas Flow (L/Hr) 60, Desolvation Gas Flow (L/Hr) 700
Mass range: 100 to 800 Da
Type of column: Waters ACQUITY UPLC HSS T3; 1.8 micron particle size, 30 mm×2.1 mm;
Temperature: 60° C.
DAD Wavelength range (nm): 210 to 400
Solvent Gradient:
A: Water/Methanol 9:1+0.1% formic acid
B: Acetonitrile+0.1% formic acid

| Time | A % | B % | Flow (mL/min) |
|---|---|---|---|
| 0.00 | 100.0 | 0.0 | 1.700 |
| 2.50 | 0.0 | 100.0 | 1.700 |
| 2.80 | 0.0 | 100.0 | 1.700 |
| 3.00 | 100.0 | 0.0 | 1.700 |

OA_{—}2min_{—}30V
SQD Mass Spectrometer from Waters (Single quadrupole mass spectrometer):
Ionization method: Electrospray; Polarity: positive and negative ions; Capillary (kV): 3.00; Cone (V): 30.00; Extractor (V): 2.00; Source Temperature (° C.): 150; Desolvation Temperature (° C.): 250; Cone Gas Flow (L/Hr): 0; Desolvation Gas Flow (L/Hr): 650; Mass range: 100 to 900 Da
Acquity UPLC from Waters:
Binary pump, heated column compartment and diode-array detector; Solvent degasser, binary pump, heated column compartment and diode-array detector; Column: Phenomenex Gemini C18, 3 •m, 30×2 mm; Temp: 60° C.; DAD Wavelength range (nm): 210 to 500
Solvent Gradient:
A=H2O+5% MeOH+0.05% HCOOH
B=Acetonitril+0.05% HCOOH

| Time | A % | B % | Flow (mL/min) |
|---|---|---|---|
| 0.00 | 100 | 0 | 0.850 |
| 1.20 | 0 | 100 | 0.850 |
| 1.50 | 0 | 100 | 0.850 |

OA_{—}2min_{—}45V
SQD Mass Spectrometer from Waters (Single quadrupole mass spectrometer):
Ionization method: Electrospray; Polarity: positive and negative ions; Capillary (kV): 3.00; Cone (V): 45.00; Extractor (V): 2.00; Source Temperature (° C.): 150; Desolvation Temperature (° C.): 250; Cone Gas Flow (L/Hr): 0; Desolvation Gas Flow (L/Hr): 650; Mass range: 100 to 900 Da
Acquity UPLC from Waters:
Binary pump, heated column compartment and diode-array detector; Solvent degasser, binary pump, heated column compartment and diode-array detector; Column: Phenomenex Gemini C18, 3 •m, 30×2 mm; Temp: 60° C.; DAD Wavelength range (nm): 210 to 500
Solvent Gradient:
A=H2O+5% MeOH+0.05% HCOOH
B=Acetonitril+0.05% HCOOH

| Time | A % | B % | Flow (mL/min) |
|---|---|---|---|
| 0.00 | 100 | 0 | 0.850 |
| 1.20 | 0 | 100 | 0.850 |
| 1.50 | 0 | 100 | 0.850 |

OA_{—}3min_{—}30V
ZQ Mass Spectrometer from Waters (Single quadrupole mass spectrometer):
Ionization method: Electrospray; Polarity: positive and negative ions; Capillary (kV): 3.00; Cone (V): 30.00; Extractor (V): 2.00; Source Temperature (° C.): 100; Desolvation Temperature (° C.): 250; Cone Gas Flow (L/Hr): 50; Desolvation Gas Flow (L/Hr): 400; Mass range: 100 to 900 Da
HP 1100 HPLC from Agilent:
Solvent degasser, binary pump, heated column compartment and diode-array detector; Column: Phenomenex Gemini C18, 3 •m, 30×3 mm; Temp: 60° C.; DAD Wavelength range (nm): 210 to 500;
Solvent Gradient:
A=water+5% MeOH+0.05% HCOOH
B=Acetonitrile+0.05% HCOOH

| Time | A % | B % | Flow (mL/min) |
|---|---|---|---|
| 0.00 | 100 | 0 | 1.700 |
| 2.00 | 0 | 100 | 1.700 |
| 2.80 | 0 | 100 | 1.700 |
| 2.90 | 100 | 0 | 1.700 |
| 3.00 | 100 | 0 | 1.700 |

OA_{—}5min_{—}45V
SQD Mass Spectrometer from Waters (Single quadrupole mass spectrometer)
Ionization method: Electrospray; Polarity: positive and negative ions; Capillary (kV): 3.00; Cone (V): 45.00; Extractor (V): 2.00; Source Temperature (° C.): 150; Desolvation Temperature (° C.): 250; Cone Gas Flow (L/Hr): 0; Desolvation Gas Flow (L/Hr): 650; Mass range: 100 to 900 Da
Acquity UPLC from Waters:
Binary pump, heated column compartment and diode-array detector; Solvent degasser, binary pump, heated column compartment and diode-array detector; Column: Phenomenex Gemini C18, 3 •m, 30×2 mm; Temp: 60° C.; DAD Wavelength range (nm): 210 to 500
Solvent Gradient:
A=water+5% MeOH+0.05% HCOOH
B=Acetonitrile+0.05% HCOOH

| Time | A % | B % | Flow (mL/min) |
|---|---|---|---|
| 0.00 | 100 | 0 | 0.850 |
| 3.40 | 0 | 100 | 0.850 |
| 4.10 | 0 | 100 | 0.850 |
| 4.20 | 100 | 0 | 0.850 |
| 4.60 | 100 | 0 | 0.850 |

OA_{—}8min_Pol_{—}30V
ZQ Mass Spectrometer from Waters (Single quadrupole mass spectrometer)
Ionization method: Electrospray; Polarity: positive and negative ions; Capillary (kV): 3.00; Cone (V): 30.00; Extractor (V): 2.00; Source Temperature (° C.): 100; Desolvation Temperature (° C.): 250; Cone Gas Flow (L/Hr): 50; Desolvation Gas Flow (L/Hr): 400; Mass range: 100 to 900 Da
HP 1100 HPLC from Agilent:
Solvent degasser, binary pump, heated column compartment and diode-array detector; Column: HyperCarb, 3 •m, 30×3 mm; Temp: 60° C.; DAD Wavelength range (nm): 210 to 500
Solvent Gradient:
A=water+5% MeOH+0.05% HCOOH
B=Acetonitrile+0.05% HCOOH

| Time | A % | B % | Flow (mL/min) |
|---|---|---|---|
| 0.00 | 100 | 0 | 1.700 |
| 6.00 | 0 | 100 | 1.700 |
| 7.70 | 0 | 100 | 1.700 |
| 7.80 | 100 | 0 | 1.700 |
| 8.00 | 100 | 0 | 1.700 |

Method U
ACQUITY SQD Mass Spectrometer from Waters (Single quadrupole mass spectrometer)
Ionisation method: Electrospray
Polarity: positive ions
Capillary (kV) 3.80, Cone (V) 20.00, Extractor (V) 3.00, Source Temperature (° C.) 150, Desolvation Temperature (° C.) 400, Cone Gas Flow (L/Hr) 60, Desolvation Gas Flow (L/Hr) 700
Mass range: 100 to 800 Da
Column: Waters ACQUITY UPLC HSS T3; Column length: 30 mm; Internal diameter of column: 2.1 mm; Particle Size: 1.8 micron; Temperature: 60° C.
DAD Wavelength range (nm): 210 to 400
Solvent Gradient:
A=water/methanol 9:1, 0.1% HCOOH
B=Acetonitrile+0.1% HCOOH

| Time | A % | B % | Flow (mL/min) |
|---|---|---|---|
| 0 | 100.0 | 0.0 | 0.75 |
| 2.5 | 0.0 | 100.0 | 0.75 |
| 2.8 | 0.0 | 100.0 | 0.75 |
| 3.00 | 100.0 | 0.0 | 0.75 |

### Biological Examples

### Puccinia recondita f. sp. tritici/Wheat/Leaf Disc Preventative (Brown Rust)

Wheat leaf segments cultivated variety (cv) Kanzler were placed on agar in 24-well plates and sprayed with formulated test compound diluted in water at an application rate of 200 ppm. The leaf disks were inoculated with a spore suspension of the fungus 1 day after application. The inoculated leaf segments were incubated at 19° C. and 75% relative humidity under a light regime of 12/12 h (light/dark) in a climate cabinet and the activity of a compound was assessed as percent disease control compared to untreated when an appropriate level of disease damage appears in untreated check leaf segments (7-9 days after application). The following compounds gave at least 80% control of Puccinia recondita f. sp. tritici: P.12, P.01, P.09, P.24, P.03, P.04, P.14, P.22, P.08, P.10, P.55, P.58, P.69, P.72, P.88, P.91, P.92, P.94, P.97, P.100, P.102, P.103

Puccinia recondita f. sp. tritici/Wheat/Leaf Disc Curative (Brown Rust):

Wheat leaf segments cv Kanzler were placed on agar in 24-well plates. The leaf segments were inoculated with a spore suspension of the fungus. The plates were stored in darkness at 19° C. and 75% relative humidity. The formulated test compound diluted in water was applied at an application rate of 200 ppm 1 day after inoculation. The leaf segments were incubated at 19° C. and 75% relative humidity under a light regime of 12/12 h (light/dark) in a climate cabinet and the activity of a compound is assessed as percent disease control compared to untreated when an appropriate level of disease damage appears in untreated check leaf segments (6-8 days after application). The following compounds gave at least 80% control of Puccinia recondita f. sp. tritici:P.12, P.01, P.09, P.02, P.24, P.03, P.04, P.22, P.08, P.19, P.10, P.12, P.55, P.56, P.58, P.62, P.69, P.72, P.88, P.92, P.94, P.97, P.100, P.102, P.103

Phaeosphaeria nodorum (Septoria nodorum)/Wheat/Leaf Disc Preventative (Glume Blotch):

Wheat leaf segments cv Kanzler were placed on agar in a 24-well plate and sprayed with formulated test compound diluted in water at an application rate of 200 ppm. The leaf disks are inoculated with a spore suspension of the fungus 2 days after application. The inoculated test leaf disks are incubated at 20° C. and 75% relative humidity under a light regime of 12/12 h (light/dark) in a climate cabinet and the activity of a compound is assessed as percent disease control compared to untreated when an appropriate level of disease damage appears in untreated check leaf disks (5-7 days after application). The following compounds gave at least 80% control of Phaeosphaeria nodorum: P.12, P.01, P.09, P.02, P.24, P.03, P.04, P.13, P.14, P.20, P.22, P.08, P.19, P.10, P.24, P.51, P.12, P.10, P.46, P.55, P.56, P.57, P.58, P.61, P.63A, P.69, P.72, P.74, P.76, P.82, P.84, P.88, P.91, P.92, P.94, P.95, P.96, P.97, P.98, P.100, P.102, P.103

Pyrenophora teres/Barley/Leaf Disc Preventative (Net Blotch):

Barley leaf segments cv Hasso are placed on agar in a 24-well plate and sprayed with formulated test compound diluted in water at an application rate of 200 ppm. The leaf segments are inoculated with a spore suspension of the fungus two days after application of the test solution. The inoculated leaf segments are incubated at 20° C. and 65% relative humidity under a light regime of 12/12 h (light/dark) in a climate cabinet and the activity of a compound is assessed as disease control compared to untreated when an appropriate level of disease damage appears in untreated check leaf segments (5-7 days after application). The following compounds gave at least 80% control of Pyrenophora teres P.12, P.01, P.09, P.24, P.03, P.04, P.13, P.14, P.20, P.22, P.15, P.08, P.19, P.23A, P.10, P.55, P.58, P.72, P.74, P.76, P.82, P.83, P.84, P.88, P.92, P.94, P.95, P.96, P.97, P.98, P.100, P.103

Botryotinia fuckeliana (Botrytis cinerea)/Liquid Culture (Gray Mould):

Conidia of the fungus from cryogenic storage were directly mixed into nutrient broth (Vogels broth). After placing a DMSO solution of test compound into a 96-well microtiter plate at an application rate of 200 ppm, the nutrient broth containing the fungal spores was added. The test plates were incubated at 24° C. and the inhibition of growth was determined photometrically 3-4 days after application. The following compounds gave at least 80% control of Botryotinia fuckeliana: P.12, P.11, P.01, P.09, P.02, P.24, P.03, P.04, P.20, P.17, P.18, P.22, P.15, P.08, P.19, P.21, P.23A, P.10, P.34, P.33, P.24, P.56, P.51, P.50, P.12, P.47, P.46, P.45, P.39, P.38, P. 35, P.29, P.55, P.56, P.57, P.58, P.61, P.62, P.63B, P.64, P.65, P.66, P.67, P.69, P.71, P.72, P.74, P.75, P.76, P.77, P.79, P.80, P.82, P.83, P.84, P.85, P.86, P.87, P.88, P.89, P.90; P.91, P.92, P.94, P.95, P.96, P.97, P.98, P.99, P.100, P.101, P.102, P.103, P.104

Glomerella lagenarium (Colletotrichum lagenarium)/Liquid Culture (Anthracnose):

Conidia of the fungus from cryogenic storage were directly mixed into nutrient broth (PDB potato dextrose broth). After placing a DMSO solution of test compound into a 96-well microtiter plate at an application rate of 200 ppm, the nutrient broth containing the fungal spores was added. The test plates were incubated at 24° C. and the inhibition of growth is measured photometrically 3-4 days after application. The following compounds gave at least 80% control of Glomerella lagenarium: P.12, P.01, P.09, P.24, P.03, P.04, P.22, P.10, P.24, P.51, P.12, P.55, P.56, P.57, P.58, P.63A, P.63B, P.69, P.72, P.76, P.82, P.83, P.84, P.88, P.90; P.91, P.92, P.94, P.95, P.96, P.97, P.98, P.99, P.100, P.102, P.103

Mycosphaerella arachidis (Cercospora arachidicola)/Liquid Culture (Early Leaf Spot):

Conidia of the fungus from cryogenic storage were directly mixed into nutrient broth (PDB potato dextrose broth). After placing a DMSO solution of test compound into a 96-well microtiter plate at an application rate of 200 ppm, the nutrient broth containing the fungal spores was added. The test plates are incubated at 24° C. and the inhibition of growth was determined photometrically 4-5 days after application. The following compounds gave at least 80% control of Mycosphaerella arachidis P.12, P.01, P.09, P.02, P.24, P.03, P.04, P.13, P.14, P.20, P.18, P.22, P.15, P.08, P.19, P.23A, P.10, P.33, P.24, P.56, P.55, P.51, P.50, P.49, P.12, P.47, P.46, P.45, P.39, P.38, P.35, P.29, P.55, P.56, P.57, P.58, P.60, P.61, P.62, P.66, P.67, P.68, P.69, P.74, P.75, P.76, P.77, P.78, P.79, P.80, P.82, P.83, P.84, P.86, P.87, P.88, P.89, P.90; P.91, P.92, P.94, P.95, P.96, P.97, P.98, P.99, P.100, P.101, P.102, P.103, P.104, P.107, P.108

Mycosphaerella graminicola (Septoria tritici)/Liquid Culture (Septoria Blotch):

Conidia of the fungus from cryogenic storage were directly mixed into nutrient broth (PDB potato dextrose broth). After placing a DMSO solution of test compound into a 96-well microtiter plate at an application rate of 200 ppm, the nutrient broth containing the fungal spores was added. The test plates were incubated at 24° C. and the inhibition of growth was determined photometrically 4-5 days after application. The following compounds gave at least 80% control of Mycosphaerella graminicola: P.12, P.11, P.01, P.09, P.02, P.24, P.03, P.04, P.05, P.13, P.14, P.20, P.16, P.22, P.15, P.08, P.19, P.23A, P.10, P.34, P.33, P.56, P.51, P.50, P.12, P.47, P.46, P.45, P.39, P.38, P.35, P.29, P.55, P.56, P.57, P.58, P.61, P.62, P.63A, P.67, P.68, P.69, P.72, P.74, P.75, P.76, P.77, P.78, P.80, P.82, P.83, P.84, P.85, P.87, P.88, P.89, P.90; P.91, P.92, P.94, P.95, P.96, P.97, P.98, P.99, P.100, P.101, P.102, P.103, P.104

Gaeumannomyces graminis/Liquid Culture (Take-all of Cereals):

Mycelial fragments of the fungus from cryogenic storage were directly mixed into nutrient broth (PDB potato dextrose broth). After placing a DMSO solution of test compound into a 96-well microtiter plate at an application rate of 200 ppm, the nutrient broth Cp.33, containing the fungal spores is added. The test plates were incubated at 24° C. and the inhibition of growth was determined photometrically 4-5 days after application. The following compounds gave at least 80% control of Gaeumannomyces graminis: P.12, P.02, P.04, P.13, P.14, P.22, P.23A, P.10, P.24, P.56, P.55, P.54, P.53, P.51, P.12, P.46, P.37, P.35, P.55, P.57, P.58, P.61, P.69, P.74, P.76, P.83, P.84, P.94, P.95, P.96, P.100, P.102, P.103, P.105

Thanatephorus cucumeris (Rhizoctonia solani)/Liquid Culture (Foot Rot, Damping-Off):

Mycelia fragments of a newly grown liquid culture of the fungus are directly mixed into nutrient broth (PDB potato dextrose broth). After placing a DMSO solution of the test compounds into a 96-well microtiter plate at an application rate of 200 ppm, the nutrient broth containing the fungal material was added. The test plates were incubated at 24° C. and the inhibition of growth was determined photometrically 3-4 days after application. The following compounds gave at least 80% control of Thanatephorus cucumeris P.12, P.24, P.03, P.04, P.19, P.10, P.51, P.56, P.58, P.62, P.69, P.82, P.88, P.91, P.92, P.94, P.95, P.96, P.100

Monographella nivalis (Microdochium nivale)/Liquid Culture (Foot Rot Cereals):

Conidia of the fungus from cryogenic storage were directly mixed into nutrient broth (PDB potato dextrose broth). After placing a DMSO solution of test compound into a 96-well microtiter plate at an application rate of 200 ppm, the nutrient broth containing the fungal spores was added. The test plates were incubated at 24° C. and the inhibition of growth was determined photometrically 4-5 days after application. The following compounds gave at least 80% control of Monographella nivalis: P.12, P.09, P.02, P.24, P.03, P.04, P.05, P.22, P.08, P.10, P.24, P.51, P.38, P.35, P.55, P.56, P.57, P.58, P.69, P.74, P.76, P.78, P.80, P.82, P.88, P.91, P.92, P.94, P.95, P.96, P.97, P.98, P.99, P.100, P.103

Blumeria graminis f. sp. tritici (Erysiphe graminis f. sp. tritici)/Wheat/Leaf Disc Preventative (Powdery Mildew on Wheat):

Wheat leaf segments cv. Kanzler were placed on agar in a 24-well plate and sprayed with the formulated test compound diluted in water at an application rate of 200 ppm. The leaf disks were inoculated by shaking powdery mildew infected plants above the test plates 1 day after application. The inoculated leaf disks were incubated at 20° C. and 60% relative humidity under a light regime of 24 h darkness followed by 12 h/12 h (dark/light) in a climate chamber and the activity of a compound was assessed as percent disease control compared to untreated when an appropriate level of disease damage appears on untreated check leaf segments (6-8 days after application). The following compounds gave at least 80% control of Blumeria graminis: P.12, P.01, P.09, P.24, P.03, P.04, P.22, P.08, P.23A, P.10, P.12, P.55, P.56, P.58, P.69, P.72, P.74, P.82, P.83, P.84, P.88, P.91, P.92, P.94, P.96, P.97, P.100, P.102, P.103

Alternaria solani/Tomato/Leaf Disc (Early Blight):

Tomato leaf disks cultivated variety (cv.) Baby were placed on agar in multiwell plates (24-well format) and sprayed with the formulated test compound diluted in water at an application rate of 200 ppm. The leaf disks were inoculated with a spore suspension of the fungus 2 days after application. The inoculated leaf disks were incubated at 23° C./21° C. (day/night) and 80% relative humidity under a light regime of 12/12 h (light/dark) in a climate cabinet and the activity of a compound was assessed as percent disease control compared to untreated when an appropriate level of disease damage appears on untreated check disk leaf disks (5-7 days after application). The following compounds gave at least 80% control of Alternaria solani: P.58, P.94

Magnaporthe grisea (Pyricularia oryzae)/Rice/Leaf Disc Preventative (Rice Blast):

Rice leaf segments cv. Ballila were placed on agar in multiwell plate (24-well format) and sprayed with the formulated test compound diluted in water at an application rate of 200 ppm. The leaf segments were inoculated with a spore suspension of the fungus 2 days after application. The inoculated leaf segments were incubated at 22° C. and 80% rh under a light regime of 24 h darkness followed by 12/12 h (light/dark) in a climate cabinet and the activity of a compound was assessed as percent disease control compared to untreated when an appropriate level of disease damage appears in untreated check leaf segments (5-7 days after application). The following compounds gave at least 80% control of Magnaporthe grisea: P.62, P.72, P.74, P.76, P.82, P.88, P.91, P.92, P.94, P.96, P.97, P.100, P.101

1. A compound of formula (I): 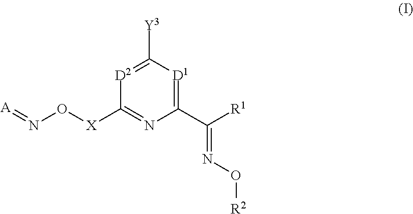
wherein
R¹ represents hydrogen, halogen, CN, SH, C₁-C₈ alkylthio, C₁-C₈ alkylsulphinyl, C₁-C₈ alkylsulphonyl, NH₂, C₁-C₁₀ alkyl, C₃-C₈ cycloalkyl, C₂-C₈ alkenyl, C₂-C₈ alkynyl, (R⁸O)carbonyl(C₁-C₄ alkyl), phenyl or pyridyl, wherein the alkyl, cycloalkyl, alkenyl, alkynyl, phenyl and pyridyl are optionally substituted by one or more groups independently selected from halogen, CN, NH₂, NH—C₁-C₈ alkyl, N(C₁-C₈ alkyl)₂, NO₂, OR⁸, C₁-C₄ alkyl, C₁-C₄ haloalkyl, C₃-C₆ cycloalkyl and a 5- or 6-membered heterocycle containing one to three heteroatoms independently selected from O, S and N, providing that the heterocycle does not contain adjacent oxygen atoms, adjacent sulphur atoms, or adjacent sulphur and oxygen atoms;
R² represents hydrogen, C₁-C₈ alkyl, C₃-C₈ cycloalkyl, C₃-C₈ alkenyl, C₃-C₈ alkynyl, benzyl, phenyl or pyridyl, wherein the alkyl, cycloalkyl, alkenyl, alkynyl, phenyl, benzyl and pyridyl are optionally substituted by one or more groups independently selected from halogen, CN, NH₂, NO₂, OH, C₁-C₄ alkyl, C₁-C₄ haloalkyl, C₁-C₄ alkoxy and C₁-C₄ haloalkoxy;
D¹ represents N or C—Y¹;
D² represents N or C—Y²;
wherein both D¹ and D² cannot be N;
A represents group A-1, A-2, or A-3: 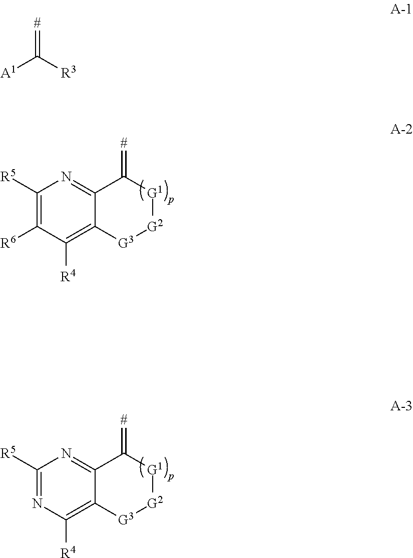
Wherein A¹ represents the cycle A^{1a}, A^{1b}, or A^{1c}: 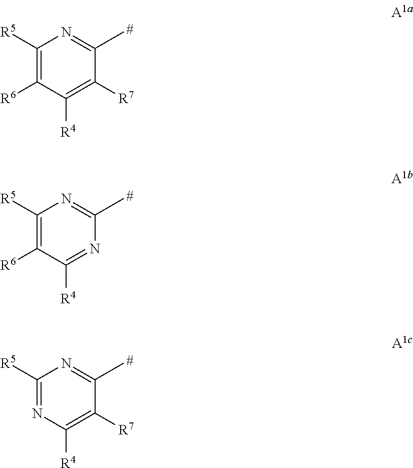
R³ represents hydrogen, halogen, CN, SH, C₁-C₈ alkylthio, C₁-C₈ alkylsulphinyl, C₁-C₈ alkylsulphonyl, NH₂, C₁-C₁₀ alkyl, C₃-C₈ cycloalkyl, C₂-C₈ alkenyl, C₂-C₈ alkynyl, (R⁸O)carbonyl(C₁-C₄ alkyl), phenyl or pyridyl, wherein the alkyl, cycloalkyl, alkenyl, alkynyl, phenyl and pyridyl are optionally substituted by one or more groups independently selected from halogen, CN, NH₂, NH—C₁-C₈ alkyl, N(C₁-C₈ alkyl)₂, NO₂, OR⁸, C₁-C₄ alkyl, C₁-C₄ haloalkyl, C₃-C₆ cycloalkyl and a 5- or 6-membered heterocycle containing one to three heteroatoms independently selected from O, S and N, providing that the heterocycle does not contain adjacent oxygen atoms, adjacent sulphur atoms, or adjacent sulphur and oxygen atoms;
R⁴, R⁵, R⁶ and R⁷ independently of one another represent hydrogen, halogen, CN, NO₂, C₁-C₈ alkyl, C₃-C₈ cycloalkyl, C₂-C₈ alkenyl, C₂-C₈ alkynyl, phenyl, a 5- or 6-membered heterocycle containing one to three heteroatoms independently selected from O, S and N, providing that the heterocycle does not contain adjacent oxygen atoms, adjacent sulphur atoms, or adjacent sulphur and oxygen atoms, COR⁹, OR⁸, SH, C₁-C₈-alkylthio, C₁-C₈-alkylsulphinyl, C₁-C₈-alkylsulphonyl, phenylthio, phenylsulphinyl, phenylsulphonyl, N(R¹⁰)₂, CO₂R⁸, O(CO)R⁹, CON(R¹⁰)₂, NR¹⁰COR⁹ or CR⁹N—OR⁸, wherein the alkyl, cycloalkyl, alkenyl, alkynyl, phenyl and heterocycle are optionally substituted by one or more groups independently selected from halogen, CN, NH₂, NO₂, OR⁸, C₁-C₄ alkyl and C₁-C₄ haloalkyl;
or, when A is A-1, wherein A¹ is A^{1a} or A^{1b}, or when A is A-2, R⁵ and R⁶, R⁶ and R⁴, or R⁷ and R⁴ together with the fragment of the ring to which they are attached may form a partially or fully unsaturated 5- to 7-membered carbocyclic ring or a partially or fully unsaturated 5- to 7-membered heterocyclic ring containing one to three heteroatoms independently selected from O, S, N and N(R¹⁰), providing that the heterocycle does not contain adjacent oxygen atoms, adjacent sulphur atoms, or adjacent sulphur and oxygen atoms, and wherein the ring formed by R⁵ and R⁶, R⁶ and R⁴, or R⁷ and R⁴ is optionally substituted by one or more groups independently selected from halogen, CN, NH₂, NO₂, OH, C₁-C₄ alkyl, C₁-C₄ haloalkyl, C₁-C₄ alkoxy and C₁-C₄ haloalkoxy;
G¹ and G² independently of one another represent —C(R¹²R¹³)—;
G³ represents —C(R¹²R¹³)—, O, N(R¹⁴) or S;
or G¹ and G², or G² and G³, or G¹ and G¹ together represent —CR¹²═CR¹³—;
each R¹² and R¹³ independently of one another represent hydrogen, halogen, C₁-C₄ alkyl, C₁-C₄ haloalkyl, C₁-C₄ alkoxy or C₁-C₄ haloalkoxy;
R¹⁴ represents hydrogen, OH, C₁-C₄ alkyl, C₁-C₄ alkoxy, C₃-C₆ cycloalkyl, C₁-C₈ alkylcarbonyl or C₁-C₈ haloalkylcarbonyl;
p represents 0, 1 or 2;
X represents X-2, X-3, X-4 or X-5: 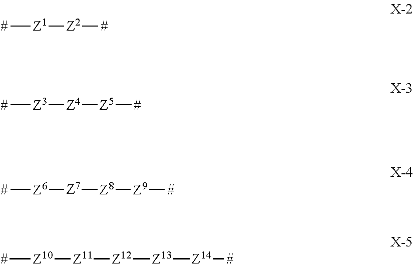
Z¹, Z², Z³, Z⁵, Z⁶, Z⁷, Z⁸, Z⁹, Z¹⁰, Z¹¹, Z¹³ and Z¹⁴ independently of one another represent CR¹⁵CR¹⁶, C═O or C═CR¹⁷R¹⁸;
Z⁴ and Z¹² represent CR¹⁹R²⁰, SiR²¹R²², C═O or C═CR¹⁷R¹⁸;
each R¹⁵ and R¹⁶ independently of one another represent hydrogen, halogen, CN, OH, C₁-C₄ alkyl, C₁-C₄ haloalkyl or phenyl, wherein the phenyl is optionally substituted by one or more groups independently selected from halogen, CN, C₁-C₄ alkyl, C₁-C₄ haloalkyl, C₁-C₄ alkoxy and C₁-C₄ haloalkoxy;
or R¹⁵ and R¹⁶ together with the carbon atom to which they are attached may form a C₃-C₆ cycloalkyl group or a C₃-C₆ halocycloalkyl group;
each R¹⁷ and R¹⁸ independently of one another represent hydrogen, halogen, C₁-C₄ alkyl or C₁-C₄ haloalkyl;
each R¹⁹, R²⁰, R²¹ and R²² independently of one another represent hydrogen, halogen, CN, OH, C₁-C₄ alkyl, C₁-C₄ haloalkyl or phenyl, wherein phenyl is optionally substituted by one or more groups independently selected from halogen, CN, C₁-C₄ alkyl, C₁-C₄ haloalkyl, C₁-C₄ alkoxy and C₁-C₄ haloalkoxy;
or R¹⁹ and R²⁹ together with the carbon atom to which they are attached may form a C₃-C₆ cycloalkyl group or a C₃-C₆ halocycloalkyl group;
wherein the groupings X-2, X-3, X-4 and X-5 contain at most one ring which contains either only one of the radicals Z¹ to Z¹⁴ or two radicals Z¹ to Z¹⁴ or three radicals Z¹ to Z¹⁴ or four radicals Z¹ to Z¹⁴ as ring members; wherein radicals Z¹, Z³, Z⁶ and Z¹⁰ are not substituted by OH; and wherein none of Z¹, Z², Z³, Z⁴, Z⁵, Z⁶, Z⁷, Z⁸, Z⁹, Z¹⁰, Z¹¹, Z¹², Z¹³ and Z¹⁴ represent a carbon atom substituted by two OH;
Y¹, Y² and Y³ independently of one another represent hydrogen, halogen, CN, NO₂, C₁-C₈ alkyl, C₃-C₈ cycloalkyl, C₂-C₈ alkenyl, C₂-C₈ alkynyl, phenyl, a 5- or 6-membered heterocycle containing one to three heteroatoms independently selected from O, S and N, providing that the heterocycle does not contain adjacent oxygen atoms, adjacent sulphur atoms, or adjacent sulphur and oxygen atoms, COR⁹, OR⁸, SH, C₁-C₈-alkylthio, C₁-C₈-alkylsulphinyl, C₁-C₈-alkylsulphonyl, phenylthio, phenylsulphinyl, phenylsulphonyl, N(R¹⁰)₂, CO₂R⁸, O(CO)R⁹, CON(R¹⁰)₂, NR¹⁰COR⁹ or CR⁹N—OR⁸, wherein the alkyl, cycloalkyl, alkenyl, alkynyl, phenyl, and heterocycle are optionally substituted by one or more groups independently selected from halogen, CN, NH₂, NO₂, OR⁸, C₁-C₄ alkyl and C₁-C₄ haloalkyl;
or Y¹ and Y³, or Y² and Y³ together with the fragment of the pyridyl ring to which they are attached may form a partially or fully unsaturated 5- to 7-membered carbocyclic ring or a partially or fully unsaturated 5- to 7-membered heterocyclic ring containing one to three heteroatoms independently selected from O, S, N and N(R¹⁰), providing that the heterocycle does not contain adjacent oxygen atoms, adjacent sulphur atoms, or adjacent sulphur and oxygen atoms, and wherein the ring formed by Y¹ and Y³, or Y² and Y³ is optionally substituted by one or more groups independently selected from halogen, CN, NH₂, NO₂, OH, C₁-C₄ alkyl, C₁-C₄ haloalkyl, C₁-C₄ alkoxy and C₁-C₄ haloalkoxy;
each R⁸ independently of one another represents hydrogen, C₁-C₈ alkyl, C₃-C₈ cycloalkyl, C₃-C₈ alkenyl, C₃-C₈ alkynyl, phenyl, benzyl or a 5- or 6-membered heterocycle containing one to three heteroatoms independently selected from O, S and N, providing that the heterocycle does not contain adjacent oxygen atoms, adjacent sulphur atoms, or adjacent sulphur and oxygen atoms, wherein the alkyl, cycloalkyl, alkenyl, alkynyl, phenyl, benzyl and heterocycle are optionally substituted by one or more groups independently selected from halogen, CN, NH₂, NO₂, OH, C₁-C₄ alkyl, C₁-C₄-haloalkyl, C₁-C₄ alkoxy, C₁-C₄ haloalkoxy and C₁-C₄-alkoxy-C₁-C₄-alkyl;
each R⁹ independently of one another represents hydrogen, C₁-C₈ alkyl, C₃-C₈ cycloalkyl, C₂-C₈ alkenyl, C₂-C₈ alkynyl, phenyl, benzyl or pyridyl, wherein the alkyl, cycloalkyl, alkenyl, alkynyl, phenyl, benzyl and pyridyl are optionally substituted by one or more groups independently selected from halogen, CN, NH₂, NO₂, OH, C₁-C₄ alkyl, C₁-C₄ haloalkyl, C₁-C₄ alkoxy and C₁-C₄ haloalkoxy;
each R¹⁰ independently of one another represents hydrogen, OH, C₁-C₈ alkyl, C₁-C₈ alkoxy, C₁-C₈-alkoxy-C₁-C₄-alkyl, C₃-C₈ alkenyl, C₃-C₈ alkynyl, or COR⁹, wherein the alkyl, alkoxy, alkenyl and alkynyl are optionally substituted by one or more halogen;
wherein when two radicals R¹⁰ are attached to the same nitrogen atom, these radicals can be identical or different;
wherein when two radicals R¹⁰ are attached to the same nitrogen atom, both of these radicals cannot be OH, C₁-C₄ alkoxy or C₁-C₄ haloalkoxy;
and wherein when two radicals R¹⁰ are attached to the same nitrogen atom, these two radicals together with the nitrogen atom to which they are attached may form a cycle B-1, B-2, B-3, B-4, B-5, B-6, B-7 or B-8: 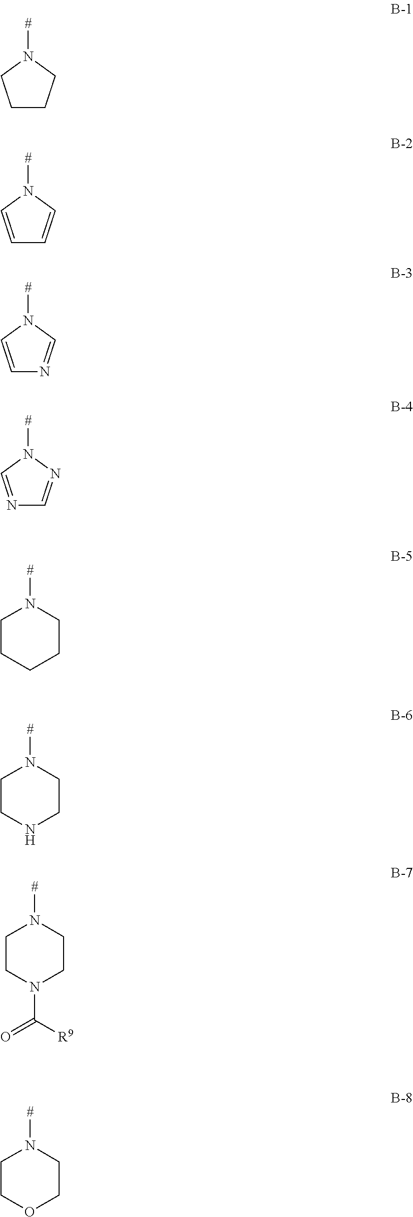
wherein the cycle formed is optionally substituted by one or more groups independently selected from halogen, CN, NH₂, NO₂, OH, C₁-C₄ alkyl, C₁-C₄ haloalkyl, C₁-C₄ alkoxy and C₁-C₄ haloalkoxy;
or a salt or an N-oxide thereof.

2. A compound according to claim 1, wherein
R¹ represents hydrogen, C₁-C₈ alkyl, C₂-C₈ alkenyl, C₂-C₈ alkynyl, C₃-C₈ cycloalkyl, phenyl, pyridyl or (R⁸O)carbonyl(C₁-C₄ alkyl), wherein the alkyl, alkenyl, alkynyl, cycloalkyl, phenyl and pyridyl are optionally substituted by one or more groups independently selected from halogen, CN, OR⁸, NH₂, NH—C₁-C₈ alkyl, N(C₁-C₈ alkyl)₂, C₁-C₄ alkyl, C₁-C₄ haloalkyl, C₃-C₆ cycloalkyl and pyridyl;
R² represents hydrogen, C₁-C₈ alkyl, C₁-C₈ haloalkyl, C₃-C₈ cycloalkyl, C₃-C₈ halocycloalkyl, C₃-C₈ alkenyl, C₃-C₈ haloalkenyl, C₃-C₈ alkynyl, C₃-C₈ haloalkynyl, benzyl or pyridyl, wherein the benzyl and pyridyl are optionally substituted by one or more groups independently selected from halogen, CN, C₁-C₄ alkyl, C₁-C₄ haloalkyl, C₁-C₄ alkoxy and C₁-C₄ haloalkoxy;
R³ represents hydrogen, C₁-C₈ alkyl, C₂-C₈ alkenyl, C₂-C₈ alkynyl, C₃-C₈ cycloalkyl, phenyl, pyridyl or (R⁸O)carbonyl(C₁-C₄ alkyl), wherein the alkyl, alkenyl, alkynyl, cycloalkyl, phenyl and pyridyl are optionally substituted by one or more groups independently selected from halogen, CN, OR⁸, NH₂, NH—C₁-C₈ alkyl, N(C₁-C₈ alkyl)₂, C₁-C₄ alkyl, C₁-C₄ haloalkyl, C₃-C₆ cycloalkyl and pyridyl;
A represents group A-1, A-2 or A-3;
R⁴, R⁵, R⁶ and R⁷ independently of one another represent hydrogen, halogen, CN, OR⁸, C₁-C₈ alkyl, C₂-C₈ alkenyl, C₃-C₈ cycloalkyl, phenyl, pyridyl, N(R¹⁰)₂, CO₂R⁸, NR¹⁰COR⁹, SH, C₁-C₈-alkylthio, C₁-C₈-alkylsulphinyl, C₁-C₈-alkylsulphonyl, phenylthio, phenylsulphinyl or phenylsulphonyl, wherein the alkyl, alkenyl, cycloalkyl, phenyl and pyridyl are optionally substituted by one or more groups independently selected from halogen, CN, OR⁸, C₁-C₄ alkyl and C₁-C₄ haloalkyl;
or, when A is A-1, wherein A¹ is A^{1a} or A^{1b}, or when A is A-2, R⁵ and R⁶, R⁶ and R⁴, or R⁴ and R⁷, together with the fragment of the ring to which they are attached may form a partially or fully unsaturated 5- to 7-membered carbocyclic ring or a partially or fully unsaturated 5- to 7-membered heterocyclic ring containing one to three heteroatoms independently selected from O, S, N and N(R¹⁰), providing that the heterocycle does not contain adjacent oxygen atoms, adjacent sulphur atoms, or adjacent sulphur and oxygen atoms, wherein the ring formed by R⁵ and R⁶, R⁶ and R⁴, or R⁴ and R⁷ is optionally substituted by one or more groups independently selected from halogen, CN, C₁-C₄ alkyl, C₁-C₄ haloalkyl, C₁-C₄ alkoxy and C₁-C₄ haloalkoxy;
X represents X-3 or X-5;
Z³, Z⁵, Z¹⁰, Z¹¹, Z¹³ and Z¹⁴ independently of one another represent CR¹⁵R¹⁶ or C═CR¹⁷R¹⁸;
Z⁴ and Z¹² represent CR¹⁹R²⁰ or C═CR¹⁷R¹⁸;
each R¹⁵ and R¹⁶ independently of one another represent hydrogen, halogen, CN, OH, C₁-C₄ alkyl or C₁-C₄ haloalkyl;
each R¹⁷ and R¹⁸ independently of one another represent hydrogen, halogen, C₁-C₄ alkyl or C₁-C₄ haloalkyl;
each R¹⁹ and R²⁰ independently of one another represent hydrogen, halogen, CN, OH, C₁-C₄ alkyl, C₁-C₄ haloalkyl or phenyl, wherein the phenyl is optionally substituted by one or more groups independently selected from halogen, CN, methyl, halomethyl, methoxy and halomethoxy;
or R¹⁹ and R²⁰ together with the carbon atom to which they are attached may form a C₃-C₆ cycloalkyl group or a C₃-C₆ halocycloalkyl group;
Y¹, Y² and Y³ independently of one another represent hydrogen, halogen, CN, OR⁸, C₁-C₈ alkyl, C₂-C₈ alkenyl, C₃-C₈ cycloalkyl, phenyl, pyridyl, N(R¹⁰)₂, CO₂R⁸, NR¹⁰COR⁹, SH, C₁-C₈-alkylthio, C₁-C₈-alkylsulphinyl, C₁-C₈-alkylsulphonyl, phenylthio, phenylsulphinyl or phenylsulphonyl, wherein the alkyl, alkenyl, cycloalkyl, phenyl and pyridyl are optionally substituted by one or more groups independently selected from halogen, CN, OR⁸, C₁-C₄ alkyl and C₁-C₄ haloalkyl;
each R⁸ independently of one another represents hydrogen, C₁-C₈ alkyl, C₁-C₈ haloalkyl, C₃-C₈ alkenyl, C₃-C₈ haloalkenyl, C₃-C₈ haloalkynyl, phenyl, benzyl or pyridyl, wherein the phenyl, benzyl and pyridyl are optionally substituted by one or more groups independently selected from halogen, CN, NH₂, NO₂, OH, C₁-C₄ alkyl, C₁-C₄-haloalkyl, C₁-C₄ alkoxy and C₁-C₄ haloalkoxy;
each R⁹ independently of one another represents hydrogen, C₁-C₈ alkyl or C₁-C₈ haloalkyl;
each R¹⁰ independently of one another represents hydrogen, C₁-C₈ alkyl or COR⁹;
wherein when two radicals R¹⁰ are attached to the same nitrogen atom, these radicals can be identical or different;
and wherein when two radicals R¹⁰ are attached to the same nitrogen atom, these two radicals together with the nitrogen atom to which they are attached may form a cycle B-1, B-2, B-3, B-4 or B-5 wherein the cycle formed is optionally substituted by one or more groups independently selected from halogen, methyl and halomethyl.

3. A compound according to claim 1, wherein
R¹ represents hydrogen, C₁-C₄ alkyl, C₂-C₄ alkenyl, phenyl or pyridyl, wherein the alkyl, alkenyl, phenyl and pyridyl are optionally substituted by one or more groups independently selected from halogen, CN, OH, NH₂, NH—C₁-C₄ alkyl, N(C₁-C₄ alkyl)₂, C₁-C₄ alkyl, C₁-C₄ haloalkyl, C₁-C₄ alkoxy, C₁-C₄ haloalkoxy and C₃-C₆ cycloalkyl;
R² represents C₁-C₄ alkyl, C₃-C₆ alkenyl, C₃-C₆ alkynyl or benzyl, wherein the alkyl, alkenyl, alkynyl and benzyl are optionally substituted by one or more groups independently selected from halogen, CN, C₁-C₄ alkoxy and C₁-C₄ haloalkoxy;
R³ represents hydrogen, C₁-C₄ alkyl, C₂-C₄ alkenyl, phenyl or pyridyl, wherein the alkyl, alkenyl, phenyl and pyridyl are optionally substituted by one or more groups independently selected from halogen, CN, OH, NH₂, NH—C₁-C₄ alkyl, N(C₁-C₄ alkyl)₂, C₁-C₄ alkyl, C₁-C₄ haloalkyl, C₁-C₄ alkoxy, C₁-C₄ haloalkoxy and C₃-C₆ cycloalkyl;
A represents group A-1, A-2 or A-3;
R⁴, R⁵, R⁶ and R⁷ independently of one another represent hydrogen, halogen, OR⁸, CN, C₁-C₄ alkyl, C₃-C₆ cycloalkyl, N(R¹⁰)₂, phenyl, CO₂R⁸ or NR¹⁰COR⁹, wherein the alkyl, cycloalkyl and phenyl are optionally substituted by one or more groups independently selected from halogen, CN, C₁-C₄ alkyl, C₁-C₄-haloalkyl, C₁-C₄ alkoxy and C₁-C₄ haloalkoxy;
or, when A is A-1, wherein A¹ is A^{1a} or A^{1b}, or when A is A-2, R⁵ and R⁶, R⁶ and R⁴, or R⁴ and R⁷, together with the fragment of the pyridyl ring to which they are attached may form a fully or partially unsaturated 5- or 6-membered carbocyclic ring, optionally substituted by one or more groups independently selected from halogen, methyl and halomethyl;
X represents X-3;
Z³ and Z⁵ independently of one another represent CR¹⁵R¹⁶ or C═CR¹⁷R¹⁸;
Z⁴ represents CR¹⁹R²⁰ or C═CR¹⁷R¹⁸;
each R¹⁵ and R¹⁶ independently of one another represent hydrogen, halogen, CN, OH, C₁-C₄ alkyl or C₁-C₄ haloalkyl;
each R¹⁷ and R¹⁸ independently of one another represent hydrogen, halogen, C₁-C₄ alkyl or C₁-C₄ haloalkyl;
each R¹⁹ and R²⁰ independently of one another represent hydrogen, halogen, CN, OH, C₁-C₄ alkyl, C₁-C₄ haloalkyl or phenyl, wherein the phenyl is optionally substituted by one or more groups independently selected from halogen, CN, methyl, halomethyl, methoxy and halomethoxy;
or R¹⁹ and R²⁰ together with the carbon atom to which they are attached may form a C₃-C₆ cycloalkyl group or a C₃-C₆ halocycloalkyl group;
wherein at least two of Z³, Z⁴ and Z⁵ are methylene;
Y¹, Y² and Y³ independently of one another represent hydrogen, halogen, OR⁸, CN, C₁-C₄ alkyl, C₃-C₆ cycloalkyl, N(R¹⁰)₂, phenyl, CO₂R⁸ or NR¹⁰COR⁹ wherein the alkyl, cycloalkyl and phenyl are optionally substituted by one or more groups independently selected from halogen, CN, C₁-C₄ alkyl, C₁-C₄-haloalkyl, C₁-C₄ alkoxy and C₁-C₄ haloalkoxy;
each R⁸ independently of one another represents hydrogen, C₁-C₈ alkyl, C₁-C₈ haloalkyl, C₃-C₈ alkenyl, C₃-C₈ haloalkenyl, C₃-C₈ alkynyl, C₃-C₈ haloalkynyl, phenyl, benzyl, or pyridyl, wherein the phenyl, benzyl and pyridyl are optionally substituted by one or more groups independently selected from halogen, CN, C₁-C₄ alkyl, C₁-C₄-haloalkyl, C₁-C₄ alkoxy and C₁-C₄ haloalkoxy;
each R⁹ independently of one another represents hydrogen, C₁-C₄ alkyl or C₁-C₄ haloalkyl;
each R¹⁰ independently of one another represents hydrogen or C₁-C₄ alkyl;
wherein when two radicals R¹⁰ are attached to the same nitrogen atom, these radicals can be identical or different;
and wherein when two radicals R¹⁰ are attached to the same nitrogen atom, these two radicals together with the nitrogen atom to which they are attached may form a cycle B-1, B-2, B-3, B-4 or B-5 wherein the cycle formed is optionally substituted by one or more groups independently selected from halogen, methyl and halomethyl.

4. A compound according to claim 1, wherein
R¹ represents hydrogen, C₁-C₄ alkyl, C₁-C₄ haloalkyl, phenyl or pyridin-2-yl, wherein the phenyl and pyridin-2-yl are optionally substituted by one or more groups independently selected from halogen, CN, methyl, halomethyl, methoxy and halomethoxy;
R² represents hydrogen, C₁-C₈ alkyl, or C₁-C₈ haloalkyl;
R³ represents hydrogen, C₁-C₄ alkyl, C₁-C₄ haloalkyl, phenyl or pyridin-2-yl, wherein the phenyl and pyridin-2-yl are optionally substituted by one or more groups independently selected from halogen, CN, methyl, halomethyl, methoxy and halomethoxy;
A represents group A-1, A-2, or A-3;
R⁴, R⁵, R⁶ and R⁷ independently of one another represent hydrogen, halogen, OH, CN, C₁-C₄ alkyl, C₁-C₄ alkoxy, C₃-C₆ alkenyloxy, C₃-C₆ cycloalkyl, N(R¹⁰)₂, phenyl or CO₂R⁸, wherein the alkyl, alkoxy, alkenyloxy, cycloalkyl and phenyl are optionally substituted by one or more groups independently selected from halogen, CN, C₁-C₄ alkyl, C₁-C₄-haloalkyl, C₁-C₄ alkoxy and C₁-C₄ haloalkoxy;
X represents X-3;
Z³ and Z⁵ independently of one another represent CR¹⁵R¹⁶ or C═CR¹⁷R¹⁸;
Z⁴ represents CR¹⁹R²⁰ or C═CR¹⁷R¹⁸;
each R¹⁵ and R¹⁶ independently of one another represent hydrogen, halogen, CN, OH, C₁-C₄ alkyl or C₁-C₄ haloalkyl;
each R¹⁷ and R¹⁸ independently of one another represent hydrogen, halogen, methyl or halomethyl;
each R¹⁹ and R²⁰ independently of one another represent hydrogen, halogen, CN, OH, C₁-C₄ alkyl, C₁-C₄ haloalkyl or phenyl, wherein the phenyl is optionally substituted by one or more groups independently selected from halogen, CN, methyl, halomethyl, methoxy and halomethoxy;
or R¹⁹ and R²⁰ together with the carbon atom to which they are attached may form a C₃-C₆ cycloalkyl group or a C₃-C₆ halocycloalkyl group;
wherein at least two of Z³, Z⁴ and Z⁵ are methylene;
Y¹, Y², and Y³ independently of one another represent hydrogen, halogen, OH, CN, C₁-C₄ alkyl, C₁-C₄ alkoxy, C₃-C₆ alkenyloxy, C₃-C₆ cycloalkyl, N(R¹⁰)₂, phenyl or CO₂R⁸, wherein the alkyl, alkoxy, alkenyloxy, cycloalkyl and phenyl are optionally substituted by one or more groups independently selected from halogen, CN, C₁-C₄ alkyl, C₁-C₄-haloalkyl, C₁-C₄ alkoxy and C₁-C₄ haloalkoxy;
each R⁸ independently or one another represents hydrogen, C₁-C₄ alkyl or C₁-C₄ haloalkyl;
each R¹⁰ independently of one another represents hydrogen or C₁-C₄ alkyl;
wherein when two radicals R¹⁰ are attached to the same nitrogen atom, these radicals can be identical or different;
and wherein when two radicals R¹¹ are attached to the same nitrogen atom, these two radicals together with the nitrogen atom to which they are attached may form a cycle B-1, B-2, B-3, B-4 or B-5, wherein the cycle formed is optionally substituted by one or more groups independently selected from halogen, methyl and halomethyl.

5. A compound according to claim 1,
wherein R³ represents C₁-C₄ alkyl, C₂-C₄ alkenyl, phenyl or pyridyl, wherein the alkyl, alkenyl, phenyl and pyridyl are optionally substituted by one or more groups independently selected from halogen, CN, C₁-C₄ alkoxy and C₁-C₄ haloalkoxy.

6. A compound according to claim 1, wherein A represents A-1 wherein A¹ is A^{1a} or wherein A represents A-2.

7. A compound according to claim 1, wherein R⁴, R⁵, R⁶ and R⁷ independently of one another represent hydrogen, C₁-C₄ alkyl, CN or C₁-C₄ alkoxy, wherein the alkyl and alkoxy are optionally substituted by one or more groups independently selected from halogen, CN, C₁-C₄ alkoxy and C₁-C₄ haloalkoxy.

8. A compound according to claim 1, wherein X represents X-3 or X-5.

9. A compound according to claim 1, wherein X represents X-3.

10. A compound according to claim 1, wherein
X represents X-3;
Z³ and Z⁵ represent methylene;
Z⁴ represents CR¹⁹R²⁰ or C═CR¹⁷R¹⁸;
each R¹⁷ and R¹⁸ independently of one another represent hydrogen, halogen, methyl or halomethyl;
each R¹⁹ and R²⁰ independently of one another represent hydrogen, halogen, CN, OH, C₁-C₄ alkyl, C₁-C₄ haloalkyl or phenyl, wherein the phenyl is optionally substituted by one or more groups independently selected from halogen, CN, methyl, halomethyl, methoxy and halomethoxy;
or R¹⁹ and R²⁰ together with the carbon atom to which they are attached may form a C₃-C₆ cycloalkyl group optionally substituted by halogen.

11. A compound according to claim 1, wherein R¹ represents C₁-C₄ alkyl, C₂-C₄ alkenyl, phenyl or pyridyl, wherein the alkyl, alkenyl, phenyl and pyridyl are optionally substituted by one or more groups independently selected from halogen, CN, C₁-C₄ alkoxy and C₁-C₄ haloalkoxy.

12. A compound according to claim 1, wherein G¹, G² and G³ represent C(R³⁴)₂, wherein each R³⁴ independently of one another represents hydrogen or C₁-C₄ alkyl.

13. A compound according to claim 1, wherein p is 1.

14. A compound according to claim 1, wherein R⁵ and R⁶, R⁶ and R⁴, or R⁴ and R⁷ together with the fragment of the pyridyl ring to which they are attached may form a partially or fully unsaturated 5- to 7-membered carbocyclic ring or a 5- to 7-membered heterocyclic ring containing one to three heteroatoms independently selected from O, S, N and N(R⁵), providing that the heterocycle does not contain adjacent oxygen atoms, adjacent sulphur atoms, or adjacent sulphur and oxygen atoms, and wherein the ring formed by R⁵ and R⁶, R⁶ and R⁴, or R⁴ and R⁷ is optionally substituted by one or more groups independently selected from halogen, CN, NH₂, NO₂, OH, C₁-C₄ alkyl, C₁-C₄ haloalkyl, C₁-C₄ alkoxy and C₁-C₄ haloalkoxy.

15. A compound according to claim 1, wherein R⁵ and R⁶, R⁶ and R⁴, or R⁴ and R⁷, together with the fragment of the pyridyl ring to which they are attached may form a fully or partially unsaturated 6-membered carbocyclic ring optionally substituted by one or more groups independently selected from halogen, methyl and halomethyl.

16. A compound according to claim 1 wherein
R¹ represents hydrogen, C₁-C₄ alkyl, C₁-C₄ haloalkyl and phenyl, wherein the phenyl is optionally substituted by one or more groups independently selected from halogen, CN, methyl, halomethyl, methoxy and halomethoxy;
R² represents hydrogen, C₁-C₄ alkyl, C₃-C₆ alkenyl or C₃-C₆ alkynyl, wherein the alkyl, alkenyl, or alkynyl are optionally substituted by one or more groups independently selected from halogen, CN, C₁-C₄ alkoxy and C₁-C₄ haloalkoxy;
D¹ represents C—Y¹;
D² represents C—Y²;
A represents group A-1, A-2, or A-3;
A¹ represents the cycle A^{1a}, A^{1b}, or A^{1c};
R³ represents hydrogen, CN, C₁-C₄ alkyl, C₃-C₆ cycloalkyl, C₂-C₄ alkenyl, C₂-C₄ alkynyl, (C₁-C₄alkoxy)carbonyl(C₁-C₄ alkyl), phenyl or pyridyl, wherein the alkyl, cycloalkyl, alkenyl, alkynyl, phenyl and pyridyl are optionally substituted by one or more groups independently selected from halogen, CN, NH₂, NH—C₁-C₈ alkyl, N(C₁-C₈ alkyl)₂, NO₂, OH, C₁-C₄ alkyl, C₁-C₄ haloalkyl, C₃-C₆ cycloalkyl and pyridyl or pyrroline;
R⁴ represents hydrogen, halogen, CN, C₁-C₆ alkyl, C₃-C₆ cycloalkyl, C₂-C₆ alkenyl, C₂-C₆ alkynyl, phenyl, OH, C₁-C₄ alkoxy, NH₂, NH(C₁-C₄ alkyl), N(C₁-C₄ alkyl)₂, CO(C₁-C₄ alkyl), wherein the alkyl, cycloalkyl, alkenyl, alkynyl and phenyl are optionally substituted by one or more groups independently selected from halogen, CN, methyl, halomethyl, methoxy and halomethoxy;
R⁵ represents hydrogen, halogen, CN, C₁-C₈ alkyl, C₃-C₆ cycloalkyl, C₂-C₈ alkenyl, C₂-C₈ alkynyl, phenyl, pyridyl, CO(C₁-C₄ alkyl), OH, C₁-C₄ alkoxy, NH₂, NH(C₁-C₄ alkyl), N(C₁-C₄ alkyl)₂ or CO₂(C₁-C₄ alkyl), wherein the alkyl, cycloalkyl, alkenyl, alkynyl, phenyl and pyridyl are optionally substituted by one or more groups independently selected from halogen, CN, NH₂, OR⁸, C₁-C₄ alkyl, C₁-C₄ haloalkyl;
R⁶ represents hydrogen, halogen, CN, C₁-C₄ alkyl, C₃-C₆ cycloalkyl, C₂-C₆ alkenyl, C₂-C₆ alkynyl, phenyl, C₁-C₄ alkoxy or benzyloxy, wherein the alkyl, cycloalkyl, alkenyl, alkynyl and phenyl are optionally substituted by one or more groups independently selected from halogen, CN, methyl, halomethyl, methoxy and halomethoxy;
or R⁵ and R⁶ together with the fragment of the ring to which they are attached may form a partially or fully unsaturated 5- to 7-membered carbocyclic ring or a partially or fully unsaturated 5- to 7-membered heterocyclic ring containing one heteroatom independently selected from O, S, N NH and N(C₁-C₄ alkyl), wherein the ring formed is optionally substituted by one or more groups independently selected from halogen, CN, methyl, halomethyl, methoxy and halomethoxy;
R⁷ represents hydrogen, halogen, CN, C₁-C4 alkyl, C₃-C₆ cycloalkyl, C₂-C₄ alkenyl, C₂-C₄ alkynyl, OH, C₁-C₄ alkoxy, NH₂, NH(C₁-C₄ alkyl), N(C₁-C₄ alkyl)₂, CO₂(C₁-C₄ alkyl) and CO₂(C₁-C₄ alkyl), wherein the alkyl, cycloalkyl, alkenyl and alkynyl are optionally substituted by one or more groups independently selected from halogen, CN, methyl, halomethyl, methoxy and halomethoxy;
G¹ and G² independently of one another represent —C(R¹²R¹³)—;
G³ represents —C(R¹²R¹³)—, O, N(R¹⁴) or S;
each R¹² and R¹³ independently of one another represent hydrogen, halogen, C₁-C₄ alkyl, C₁-C₄ haloalkyl, C₁-C₄ alkoxy or C₁-C₄ haloalkoxy;
R¹⁴ represents hydrogen, OH, C₁-C₄ alkyl, C₁-C₄ alkoxy, C₃-C₆ cycloalkyl, C₁-C₈ alkylcarbonyl or C₁-C₈ haloalkylcarbonyl;
p represents 1 or 2;
X represents X-3;
Z³ and Z⁵ independently of one another represent CR¹⁵R¹⁶ or C═CR¹⁷R¹⁸;
Z⁴ represent CR¹⁹R²⁰;
each R¹⁵ and R¹⁶ independently of one another represent hydrogen, halogen, C₁-C₄ alkyl or C₁-C₄ haloalkyl;
each R¹⁷ and R¹⁸ independently of one another represent hydrogen, halogen, methyl or halomethyl;
each R¹⁹, R²⁰ independently of one another represent hydrogen, halogen, CN, OH, C₁-C₄ alkyl or C₁-C₄ haloalkyl;
or R¹⁹ and R²⁰ together with the carbon atom to which they are attached may form a C₃-C₆ cycloalkyl group or a C₃-C₆ halocycloalkyl group;
Y¹ and Y² each represent H;
Y³ represents hydrogen, halogen, CN, C₁-C₄ alkyl, C₃-C₆ cycloalkyl, C₂-C₆ alkenyl, C₂-C₆ alkynyl or C₁-C₄ alkoxy wherein the alkyl, cycloalkyl, alkenyl and alkynyl are optionally substituted by one or more groups independently selected from halogen, CN, NH₂, NO₂, OH, C₁-C₄ alkyl and C₁-C₄ haloalkyl;
each R⁸ independently of one another represents hydrogen, C₁-C₈ alkyl, C₃-C₈ cycloalkyl, C₃-C₈ alkenyl, C₃-C₈ alkynyl, phenyl, benzyl or pyridyl, wherein the alkyl, cycloalkyl, alkenyl, alkynyl, phenyl, benzyl and pyridyl are optionally substituted by one or more groups independently selected from halogen, CN, NH₂, NO₂, OH, C₁-C₄ alkyl, C₁-C₄-haloalkyl, C₁-C₄ alkoxy, C₁-C₄ haloalkoxy and C₁-C₄-alkoxy-C₁-C₄-alkyl.

17. A compound according to claim 16 wherein
R¹ represents hydrogen, C₁-C₄ alkyl, C₁-C₄ haloalkyl and phenyl, wherein the phenyl is optionally substituted by one or more groups independently selected from halogen, CN, methyl, halomethyl, methoxy and halomethoxy;
R² represents hydrogen, C₁-C₄ alkyl, C₃-C₆ alkenyl or C₃-C₆ alkynyl, wherein the alkyl, alkenyl, or alkynyl are optionally substituted by one or more groups independently selected from halogen, CN, methyl, halomethyl, methoxy and halomethoxy;
D¹ represents C—Y¹;
D² represents C—Y²;
A represents group A-1, A-2, or A-3;
A¹ represents the cycle A^{1a}, A^{1b}, or A^{1c};
R³ represents hydrogen, CN, C₁-C₄ alkyl, C₂-C₄ alkenyl, C₂-C₄ alkynyl or phenyl, wherein the alkyl, cycloalkyl, alkenyl, alkynyl and phenyl are optionally substituted by one or more groups independently selected from halogen, CN, NH₂, NH—C₁-C₄ alkyl, N(C₁-C₄ alkyl)₂, OH, C₁-C₄ alkyl, C₁-C₄ haloalkyl, C₃-C₆ cycloalkyl, pyridyl or pyrroline;
R⁴ represents hydrogen, halogen, CN, C₁-C₆ alkyl, C₃-C₆ cycloalkyl, C₂-C₄ alkenyl, C₂-C₄ alkynyl, phenyl, C₁-C₄ alkoxy or CO(C₁-C₄ alkyl), wherein the alkyl, cycloalkyl, alkenyl, alkynyl and phenyl are optionally substituted by one or more groups independently selected from halogen, CN, methyl, halomethyl, methoxy and halomethoxy;
R⁵ represents hydrogen, halogen, CN, C₁-C₈ alkyl, C₃-C₆ cycloalkyl, C₂-C₈ alkenyl, C₂-C₈ alkynyl, phenyl, pyridyl, CO(C₁-C₄ alkyl), OH, C₁-C₄ alkoxy, NH₂, NH(C₁-C₄ alkyl), N(C₁-C₄ alkyl)₂ or CO₂(C₁-C₄ alkyl), wherein the alkyl, cycloalkyl, alkenyl, alkynyl, phenyl and pyridyl are optionally substituted by one or more groups independently selected from halogen, CN, NH₂, OR⁸, C₁-C₄ alkyl, C₁-C₄ haloalkyl;
R⁶ represents hydrogen, halogen, CN, C₁-C₄ alkyl, C₁-C₄ alkoxy or benzyloxy, wherein the alkyl and phenyl are optionally substituted by one or more groups independently selected from halogen, CN, methyl, halomethyl, methoxy and halomethoxy;
or R⁵ and R⁶ together with the fragment of the ring to which they are attached may form a partially or fully unsaturated 5- to 7-membered carbocyclic ring or a partially or fully unsaturated 5- to 7-membered heterocyclic ring containing one heteroatom independently selected from O or S, wherein the ring formed is optionally substituted by one or more groups independently selected from halogen, CN, methyl, halomethyl, methoxy and halomethoxy;
R⁷ represents hydrogen, halogen, CN, C₁-C4 alkyl, C₃-C₆ cycloalkyl, C₂-C₄ alkenyl, C₂-C₄ alkynyl, OH, C₁-C₄ alkoxy, NH₂, NH(C₁-C₄ alkyl), N(C₁-C₄ alkyl)₂, CO₂(C₁-C₄ alkyl) and CO₂(C₁-C₄ alkyl), wherein the alkyl, cycloalkyl, alkenyl and alkynyl are optionally substituted by one or more groups independently selected from halogen, CN, methyl, halomethyl, methoxy and halomethoxy;
G¹ represents —CH₂—;
G² represents —C(R¹²R¹³)—;
G³ represents —C(R¹²R¹³)—, O, N(R¹⁴) or S;
each R¹² and R¹³ independently of one another represent hydrogen or C₁-C₄ alkyl;
R¹⁴ represents hydrogen or C₁-C₄ alkyl;
p represents 1 or 2;
X represents X-3;
Z³ and Z⁵ independently of one another represent CR¹⁵R¹⁶ or C═CR¹⁷R¹⁸;
Z⁴ represent CR¹⁹R²⁰;
each R¹⁵ and R¹⁶ independently of one another represent hydrogen, halogen, C₁-C₄ alkyl or C₁-C₄ haloalkyl;
each R¹⁷ and R¹⁸ independently of one another represent hydrogen, halogen, methyl or halomethyl;
each R¹⁹, R²⁰ independently of one another represent hydrogen, halogen, CN, OH, C₁-C₄ alkyl or C₁-C₄ haloalkyl;
or R¹⁹ and R²⁰ together with the carbon atom to which they are attached may form a C₃-C₆ cycloalkyl group or a C₃-C₆ halocycloalkyl group;
wherein the grouping X-3 contains at most one ring which contains either only one of the radicals Z³ to Z⁵ or two radicals Z³ to Z⁵ or three radicals Z³ to Z⁵ as ring members;
Y¹ and Y² each represent H;
Y³ represents hydrogen, methyl, methoxy, methoxymethyl, wherein the methyl, methoxy, methoxymethyl are optionally substituted by one or more halogen;
each R⁸ independently of one another represents hydrogen, C₁-C₆ alkyl, C₃-C₆ alkenyl, C₃-C₄ alkynyl, phenyl or benzyl.

18. A compound of formula (II) 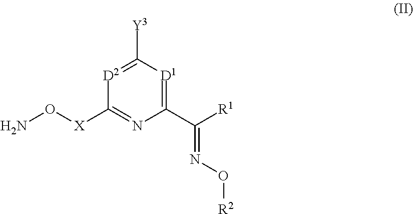
wherein D¹, D², X, Y³, R¹ and R² are as defined for a compound of formula (I) in claim 1; or a salt or N-oxide thereof;
or a compound of formula (III) 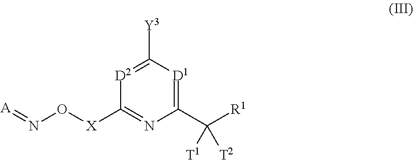
wherein T¹ and T² independently of one another represent C₁-C₈ alkoxy, or T¹ and T² together with the carbon they are attached to form a carbonyl group or an acetal or ketal function of the form C(O—C₁-C₆-alkylidene-O), wherein the alkylidene fragment is optionally substituted by one to four C₁-C₆ alkyl;
D¹, D², A, X, Y³ and R¹ are as defined for a compound of formula (I) in claim 1; or a salt or N-oxide thereof;
or a compound of formula (IV) 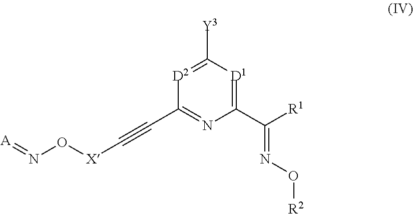
wherein X′ represents X′-1, X′-2 or X′-3 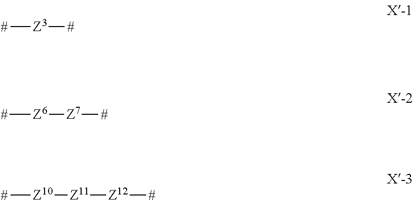
wherein D¹, D², A, Z3, Z6, Z7, Z¹⁰, Z¹¹, Z¹², Y³, R¹ and R² are as defined for a compound of formula (I) in claim 1; or a salt or N-oxide thereof;
or a compound of formula (V) 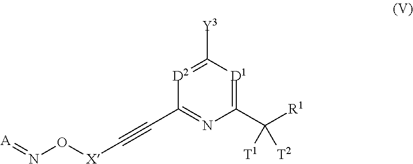
wherein X′ represents X′-1, X′-2 or X′-3 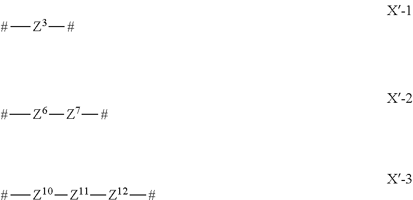
T¹ and T² independently of one another represent C₁-C₈ alkoxy, or T¹ and T² together with the carbon they are attached to form a carbonyl group or an acetal or ketal function of the form C(O—C₁-C₆-alkylidene-O), wherein the alkylidene fragment is optionally substituted by one to four C₁-C₆ alkyl;
D¹, D², A, Z³, Z⁶, Z⁷, Z¹⁰, Z¹¹, Z¹², Y³ and R¹ are as defined for a compound of formula (I) in claim 1; or a salt or N-oxide thereof;
or a compound of formula (VI) 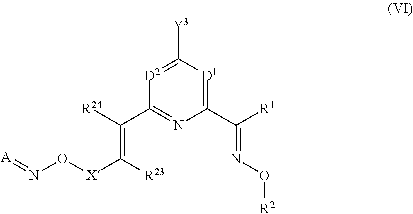
wherein X′ represents X′-1, X′-2 or X′-3 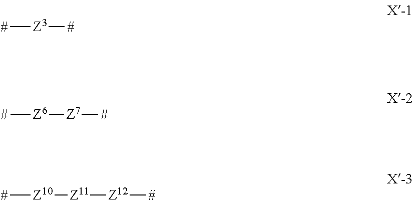
R²³ and R²⁴ independently of one another represent hydrogen, halogen, CN, C₁-C₄ alkyl, C₁-C₄ haloalkyl or phenyl, wherein phenyl is optionally substituted by one or more groups independently selected from halogen, CN, C₁-C₄ alkyl, C₁-C₄ haloalkyl, C₁-C₄ alkoxy and C₁-C₄ haloalkoxy;
D¹, D², A, Z³, Z⁶, Z⁷, Z¹⁰, Z¹¹, Z¹², Y³, R¹ and R² areas defined for a compound of formula (I) in claim 1; or a salt or N-oxide thereof;
or a compound of formula (VII) 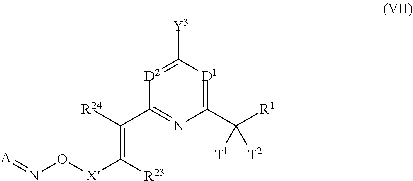
wherein X′ represents X′-1, X′-2 or X′-3 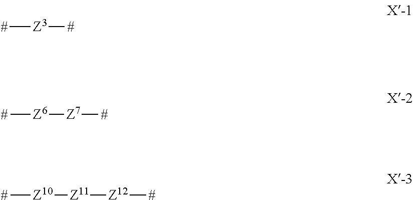
R²³ and R²⁴ independently of one another represent hydrogen, halogen, CN, C₁-C₄ alkyl, C₁-C₄ haloalkyl or phenyl, wherein phenyl is optionally substituted by one or more groups independently selected from halogen, CN, C₁-C₄ alkyl, C₁-C₄ haloalkyl, C₁-C₄ alkoxy and C₁-C₄ haloalkoxy;
T¹ and T² independently of one another represent C₁-C₈ alkoxy, or T¹ and T² together with the carbon they are attached to form a carbonyl group or an acetal or ketal function of the form C(O—C₁-C₆-alkylidene-O), wherein the alkylidene fragment is optionally substituted by one to four C₁-C₆ alkyl;
D¹, D², A, Z³, Z⁶, Z⁷, Z¹⁰, Z¹¹, Z¹², Y³ and R¹ are as defined for a compound of formula (I) in claim 1; or a salt or N-oxide thereof;
or a compound of formula (VIII) 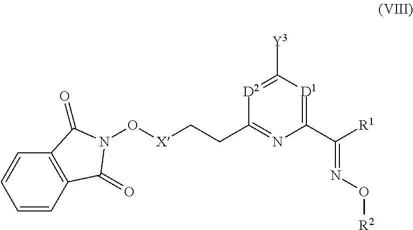
wherein X′ represents X′-1, X′-2 or X′-3 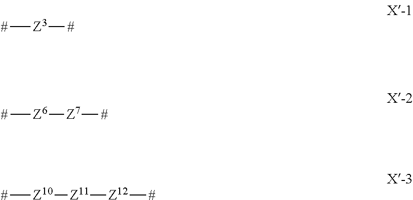
D¹, D², Z³, Z⁶, Z⁷, Z¹⁰, Z¹¹, Z¹², Y³, R¹ and R² are as defined for a compound of formula (I) in claim 1; or a salt or N-oxide thereof;
or a compound of formula (IX) 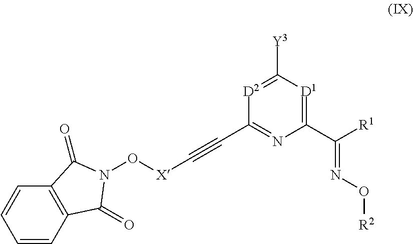
wherein X′ represents X′-1, X′-2 or X′-3 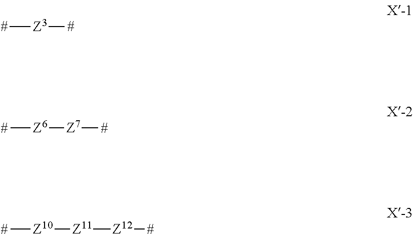
D¹, D², Z³, Z⁶, Z⁷, Z¹⁰, Z¹¹, Z¹², Y³, R¹ and R² are as defined for a compound of formula (I) in claim 1; or a salt or N-oxide thereof;
or a compound of formula (X) 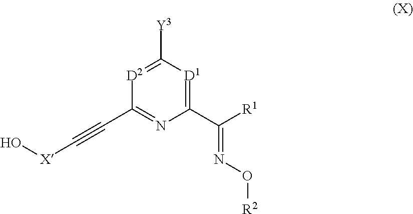
wherein X′ represents X′-1, X′-2 or X′-3 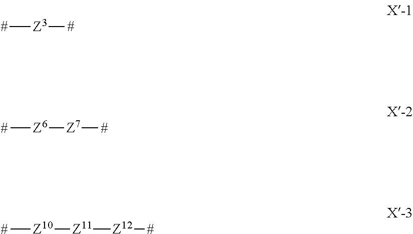
D¹, D², Z³, Z⁶, Z⁷, Z¹⁰, Z¹¹, Z¹², Y³, R¹ and R² are as defined for a compound of formula (I) in claim 1; or a salt or N-oxide thereof;
or a compound of formula (XI) 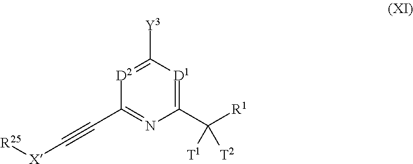
wherein R²⁵ is a halogen or a sulfonic acid ester group;
T¹ and T² independently of one another represent C₁-C₈ alkoxy, or T¹ and T² together with the carbon they are attached to form a carbonyl group or an acetal or ketal function of the form C(O—C₁-C₆-alkylidene-O), wherein the alkylidene fragment is optionally substituted by one to four C₁-C₆ alkyl;
X′ represents X′-1, X′-2 or X′-3 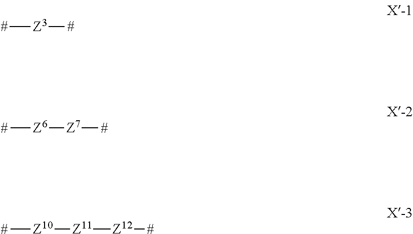
D¹, D², Z³, Z⁶, Z⁷, Z¹⁰, Z¹¹, Z¹², Y³, and R¹ are as defined for a compound of formula (I) in claim 1; or a salt or N-oxide thereof;
or a compound of formula (XII) 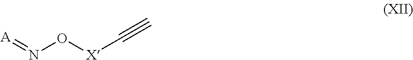
wherein X′ represents X′-1, X′-2 or X′-3 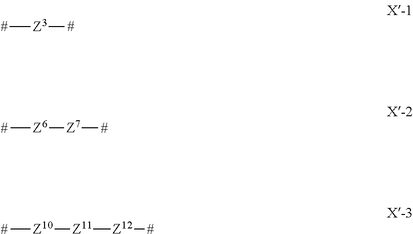
A, Z³, Z⁶, Z⁷, Z¹⁰, Z¹¹ and Z¹² are as defined for a compound of formula (I) in claim 1; or a salt or N-oxide thereof;
or a compound of formula (XIII) 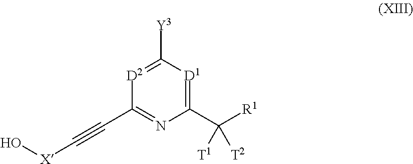
wherein X′ represents X′-1, X′-2 or X′-3 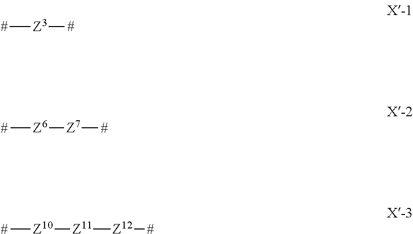
T¹ and T² independently of one another represent C₁-C₈ alkoxy, or T¹ and T² together with the carbon they are attached to form a carbonyl group or an acetal or ketal function of the form C(O—C₁-C₆-alkylidene-O), wherein the alkylidene fragment is optionally substituted by one to four C₁-C₆ alkyl;
D¹, D², Z³, Z⁶, Z⁷, Z¹⁰, Z¹¹, Z¹², Y³ and R¹ are as defined for a compound of formula (I) in claim 1; or a salt or N-oxide thereof;
or a compound of formula (XV) 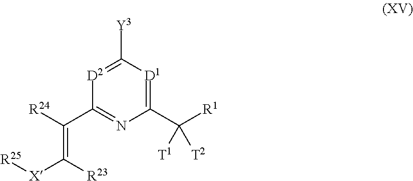
wherein R²⁵ is a halogen or a sulfonic acid ester group;
X′ represents X′-1, X′-2 or X′-3 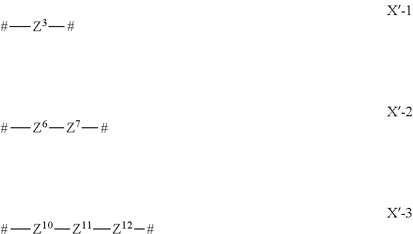
R²³ and R²⁴ independently of one another represent hydrogen, halogen, CN, C₁-C₄ alkyl, C₁-C₄ haloalkyl or phenyl, wherein phenyl is optionally substituted by one or more groups independently selected from halogen, CN, C₁-C₄ alkyl, C₁-C₄ haloalkyl, C₁-C₄ alkoxy and C₁-C₄ haloalkoxy;
T¹ and T² independently of one another represent C₁-C₈ alkoxy, or T¹ and T² together with the carbon they are attached to form a carbonyl group or an acetal or ketal function of the form C(O—C₁-C₆-alkylidene-O), wherein the alkylidene fragment is optionally substituted by one to four C₁-C₆ alkyl;
D¹, D², Z³, Z⁶, Z⁷, Z¹⁰, Z¹¹, Z¹², Y³ and R¹ are as defined for a compound of formula (I) in claim 1; or a salt or N-oxide thereof
or a compound of formula (XVI) 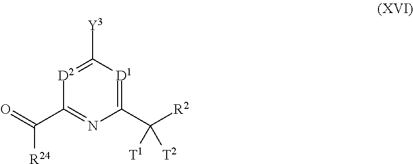
wherein R²⁴ represents hydrogen, halogen, CN, C₁-C₄ alkyl, C₁-C₄ haloalkyl or phenyl, wherein phenyl is optionally substituted by one or more groups independently selected from halogen, CN, C₁-C₄ alkyl, C₁-C₄ haloalkyl, C₁-C₄ alkoxy and C₁-C₄ haloalkoxy;
T¹ and T² independently of one another represent C₁-C₈ alkoxy, or T¹ and T² together with the carbon they are attached to form a carbonyl group or an acetal or ketal function of the form C(O—C₁-C₆-alkylidene-O), wherein the alkylidene fragment is optionally substituted by one to four C₁-C₆ alkyl;
D¹, D², Y³ and R¹ are as defined for a compound of formula (I) in claims 1; or a salt or N-oxide thereof;
or a compound of formula (XVIII) 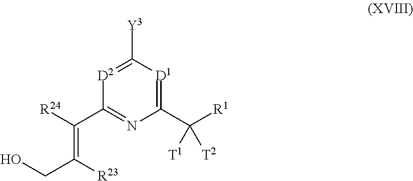
wherein R²³ and R²⁴ independently of one another represent hydrogen, halogen, CN, C₁-C₄ alkyl, C₁-C₄ haloalkyl or phenyl, wherein phenyl is optionally substituted by one or more groups independently selected from halogen, CN, C₁-C₄ alkyl, C₁-C₄ haloalkyl, C₁-C₄ alkoxy and C₁-C₄ haloalkoxy;
T¹ and T² independently of one another represent C₁-C₈ alkoxy, or T¹ and T² together with the carbon they are attached to form a carbonyl group or an acetal or ketal function of the form C(O—C₁-C₆-alkylidene-O), wherein the alkylidene fragment is optionally substituted by one to four C₁-C₆ alkyl;
D¹, D², Y³ and R¹ are as defined for a compound of formula (I) in claim 1; or a salt or N-oxide thereof;
or a compound of formula (XIX) 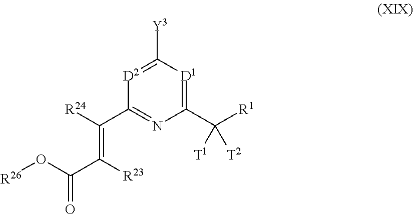
wherein R²⁶ represents C₁-C₄ alkyl;
R²³ and R²⁴ independently of one another represent hydrogen, halogen, CN, C₁-C₄ alkyl, C₁-C₄ haloalkyl or phenyl, wherein phenyl is optionally substituted by one or more groups independently selected from halogen, CN, C₁-C₄ alkyl, C₁-C₄ haloalkyl, C₁-C₄ alkoxy and C₁-C₄ haloalkoxy;
T¹ and T² independently of one another represent C₁-C₈ alkoxy, or T¹ and T² together with the carbon they are attached to form a carbonyl group or an acetal or ketal function of the form C(O—C₁-C₆-alkylidene-O), wherein the alkylidene fragment is optionally substituted by one to four C₁-C₆ alkyl;
D¹, D², Y³ and R¹ are as defined for a compound of formula (I) in claim 1; or a salt or N-oxide thereof.

19. A compound of formula (XI) according to claim 18, wherein R²⁵ represents chlorine, bromine, iodine, mesylate, tosylate, triflate, phenylsulfonic acid ester, nitro-phenylsulfonic acid ester, or nonafluorobutylsulfonic acid ester;
or a compound of formula (XV) according to claim 18 wherein R²⁵ represents chlorine, bromine, iodine, mesylate, tosylate, triflate, phenylsulfonic acid ester, nitro-phenylsulfonic acid ester, or nonafluorobutylsulfonic acid ester.

20. A fungicidal composition comprising a fungicidally effective amount of a compound of formula (I) as defined in claim 1, optionally comprising an additional active ingredient.

21. A method of controlling or preventing phytopathogenic diseases on useful plants or on propagation material thereof, which comprises applying to the useful plants, the locus thereof or propagation material thereof a fungicidally effective amount of a compound of formula (I) as defined in claim 1.
